(19) United States
(12) Patent Application Publication
(10) Pub. No.: US 2025/0181420 A1
(43) Pub. Date: Jun. 5, 2025

(54) COMPLEX COMPUTING NETWORK FOR CONTROLLING COMPUTING OPERATIONS BASED ON A COMPUTING LOAD

(71) Applicant: Lilly R. Talavera, Allen, TX (US)

(72) Inventor: Lilly R. Talavera, Allen, TX (US)

(21) Appl. No.: 18/916,544

(22) Filed: Oct. 15, 2024

Related U.S. Application Data
(63) Continuation-in-part of application No. 18/402,659, filed on Jan. 2, 2024, now Pat. No. 12,124,881.
(60) Provisional application No. 63/436,582, filed on Dec. 31, 2022.
(60) Provisional application No. 63/543,101, filed on Oct. 8, 2023.
(60) Provisional application No. 63/546,235, filed on Oct. 29, 2023.
(60) Provisional application No. 63/617,051, filed on Jan. 2, 2024.
(60) Provisional application No. 63/544,227, filed on Oct. 15, 2023.
(60) Provisional application No. 63/461,314, filed on Apr. 23, 2023.

(51) Int. Cl. G06F 9/50

(52) U.S. Cl. CPC G06F 9/5083

(57) ABSTRACT

This disclosure is directed to intelligent synchronization of computing users, and associated timing data, based on parameters or data received from computing systems connected via wireless, satellite, wire-based, optical-fiber based, etc., computing networks.

### CROSS-REFERENCE TO RELATED APPLICATIONS

This application is a continuation-in-part of U.S. application Ser. No. 18/402,659, filed on Jan. 1, 2024, which claims the benefit of U.S. Provisional Application No. 63/436,582, filed on Dec. 31, 2022, U.S. Provisional Application No. 63/461,314, filed on Apr. 23, 2023, U.S. Provisional Application No. 63/543,101, filed on Oct. 8, 2023, and U.S. Provisional Application No. 63/546,235, filed on Oct. 29, 2023, all of which are incorporated by reference into this application for all purposes. This application also claims the benefit of U.S. Provisional Application No. 63/617,051, filed on Jan. 2, 2024 and U.S. Provisional Application No. 63/544,227, filed on Oct. 15, 2023, both of which are incorporated by reference into this application for all purposes.

### TECHNICAL FIELD

This disclosure is directed to efficiently and/or intelligently synchronizing computing users based on parameters and/or data received from disparate computing systems. This disclosure is directed to network communication and controlled access.

### BACKGROUND

There is a need to improve the speed and efficiency of synchronizing computing device users and their timing data in complex computing networks. There is a need for improved network communication and improved controlling of access to database records.

### BRIEF DESCRIPTION OF THE DRAWINGS

FIG. 1A is a network diagram for executing any methods described herein, in accordance with some embodiments of the disclosure;

FIG. 1B is a system diagram for executing any methods described herein, in accordance with some embodiments of the disclosure;

FIGS. 2 to 187 are user interfaces for implementing any of elements, processes, techniques, etc., described herein, in accordance with some embodiments of the disclosure.

All of these drawings are illustrations of certain embodiments. The scope of the claims is not limited to the specific embodiments illustrated in the drawings and described herein.

### DETAILED DESCRIPTION OF THE EMBODIMENTS

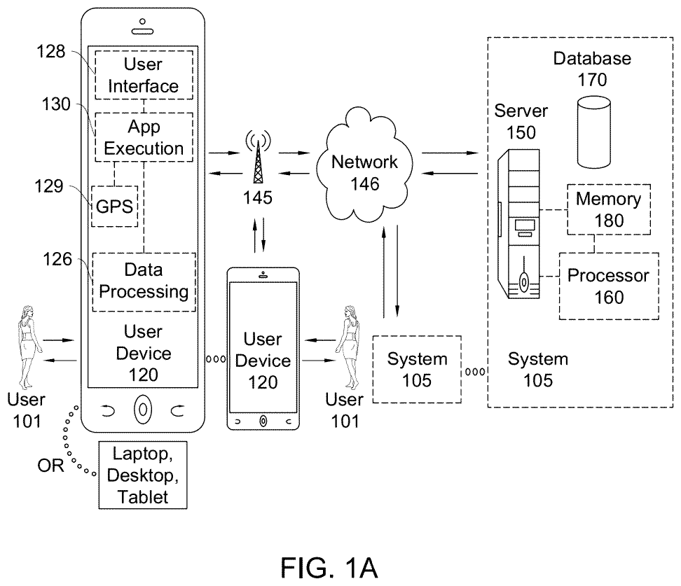

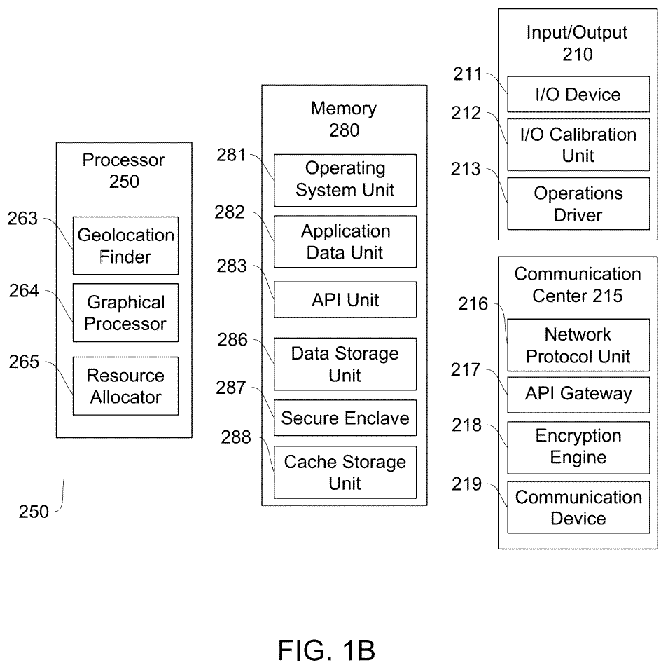

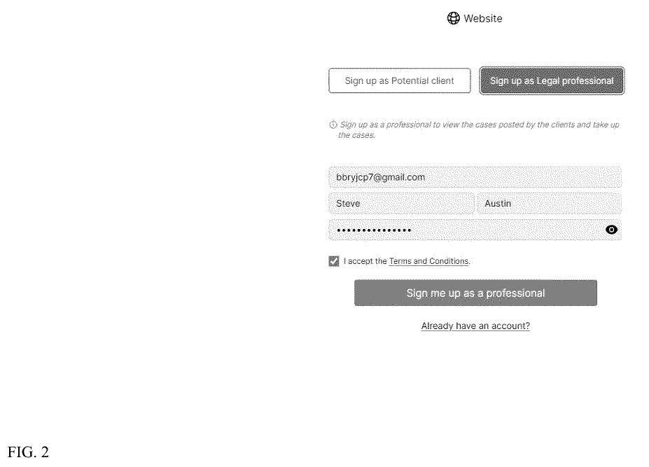

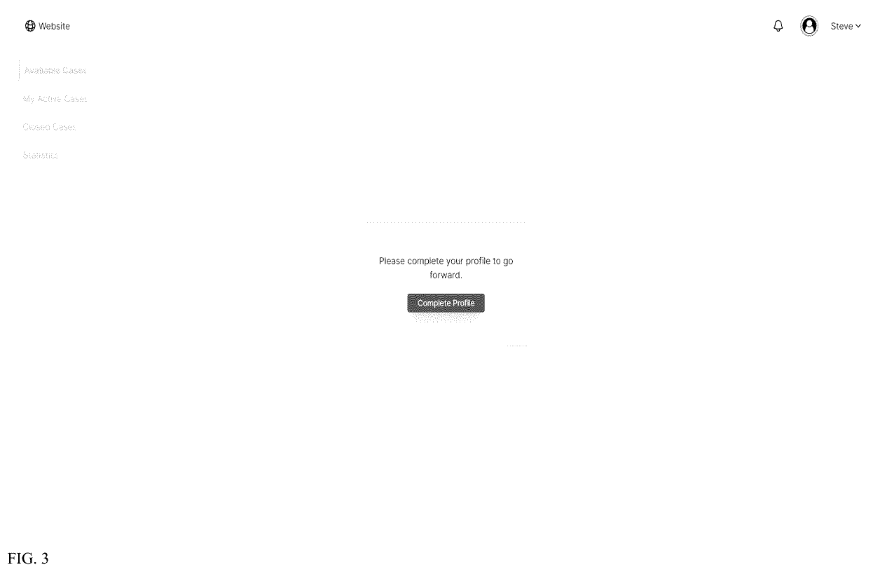

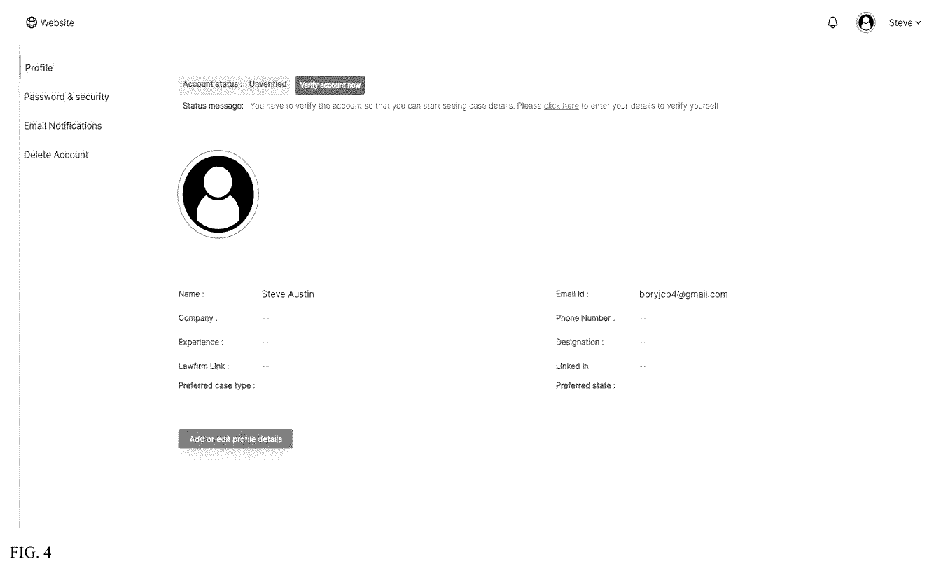

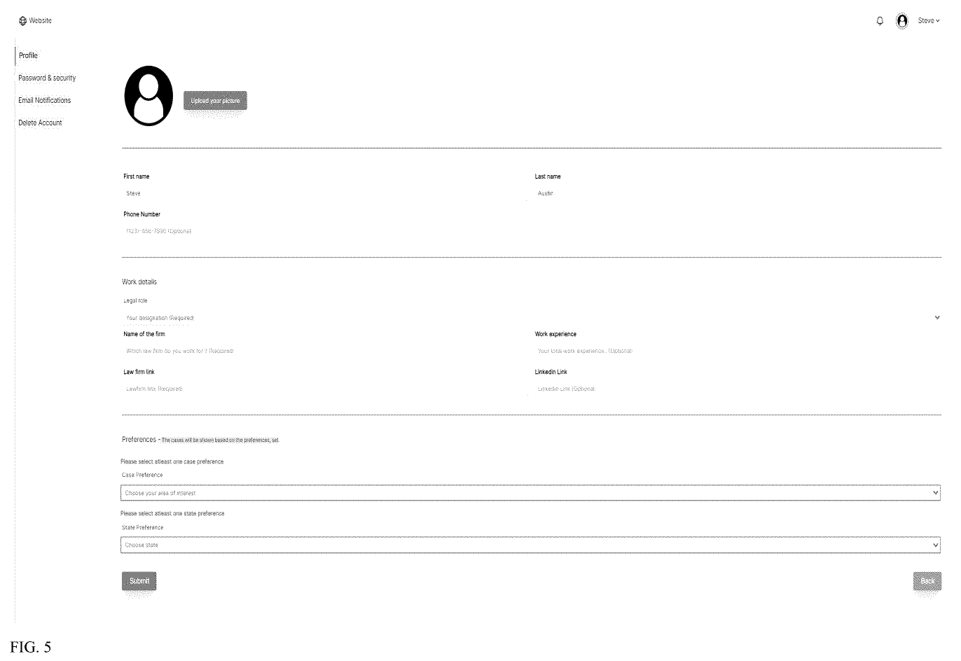

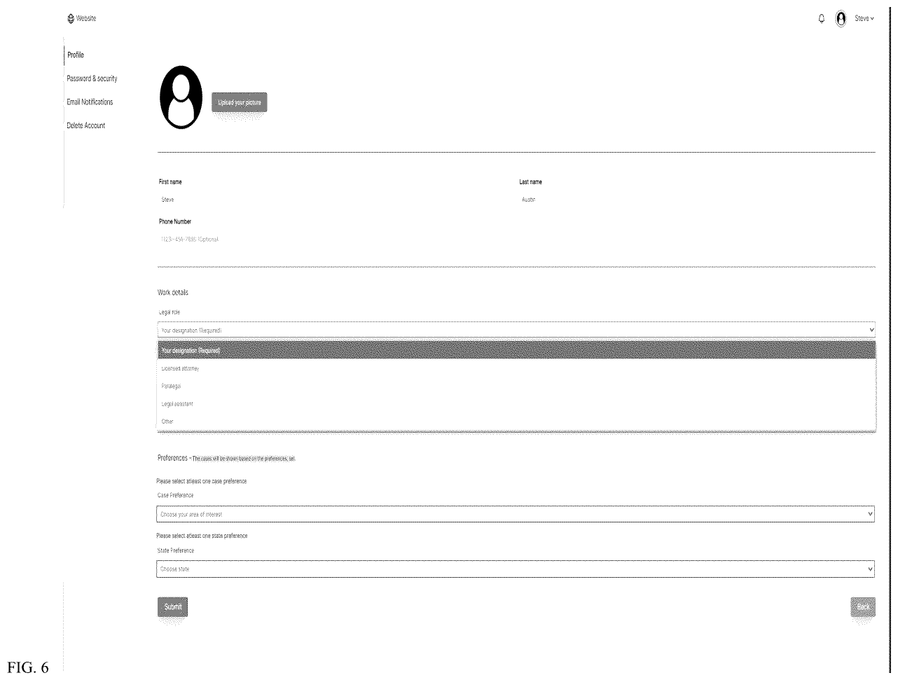

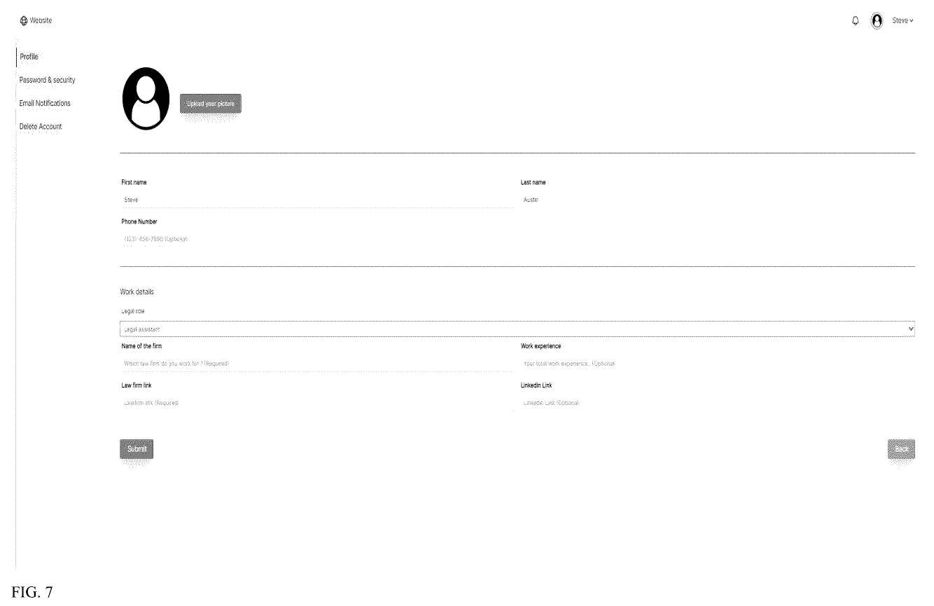

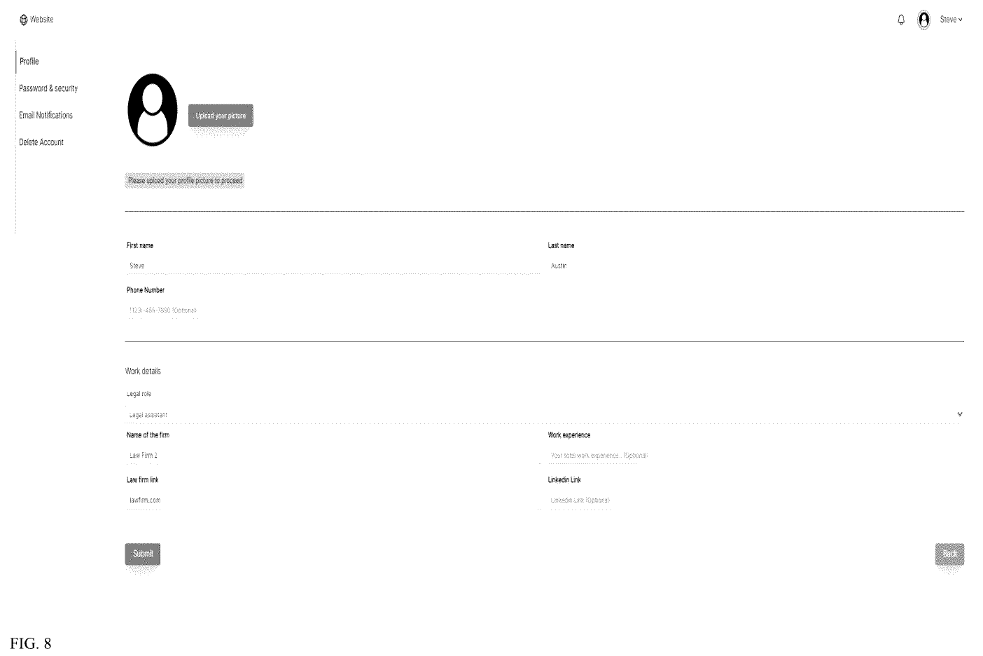

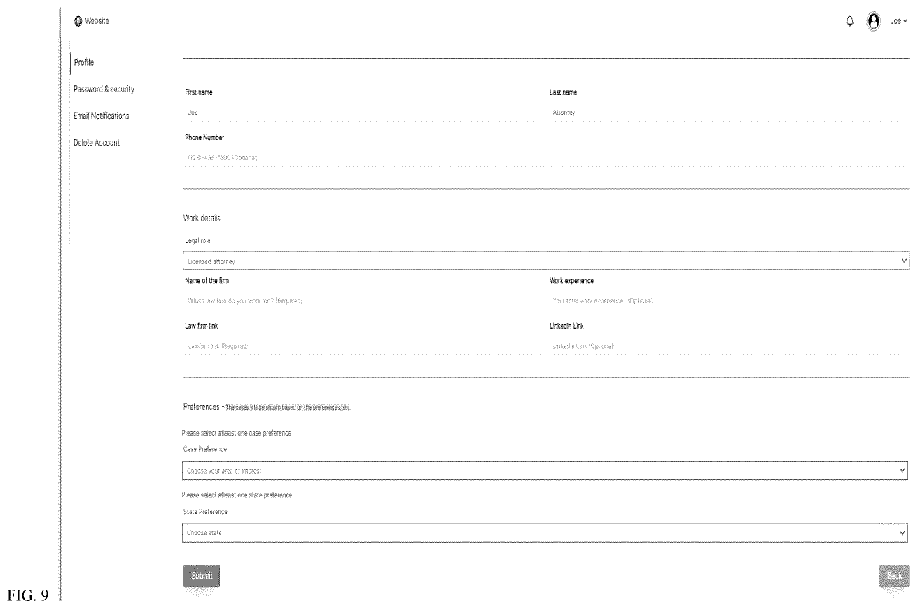

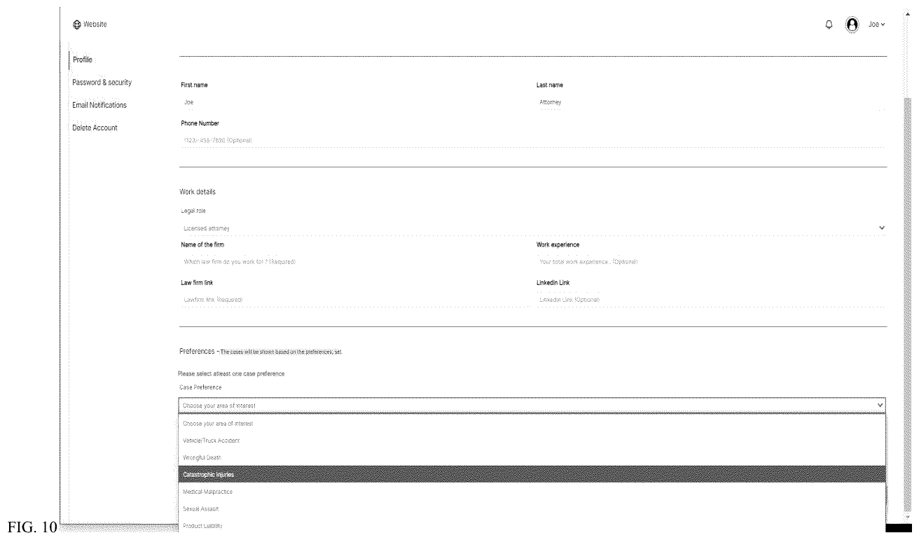

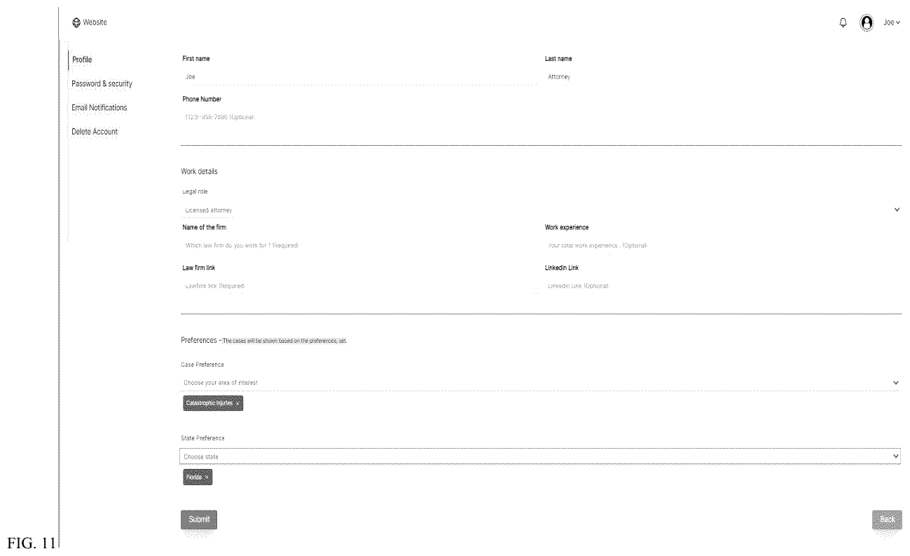

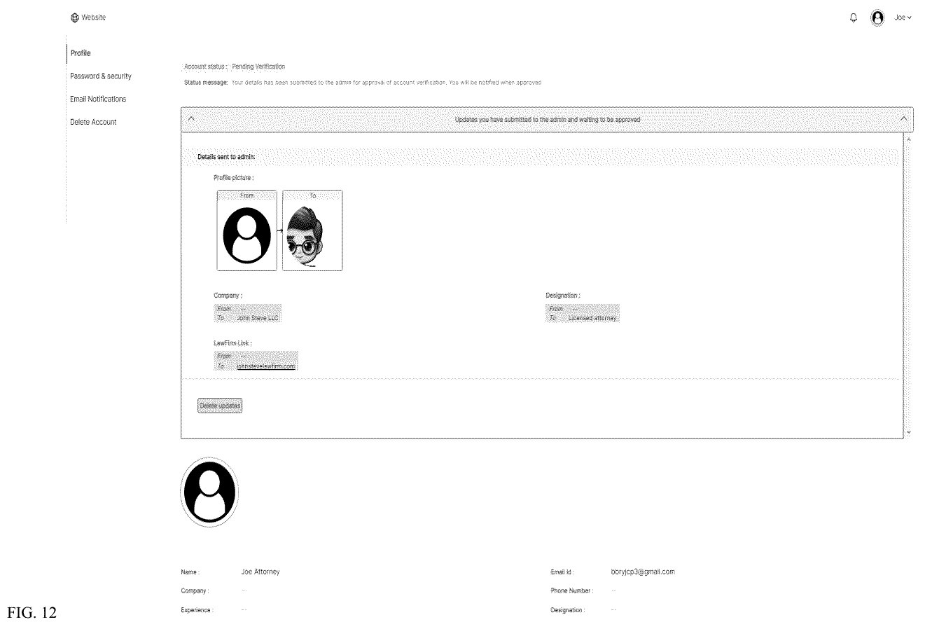

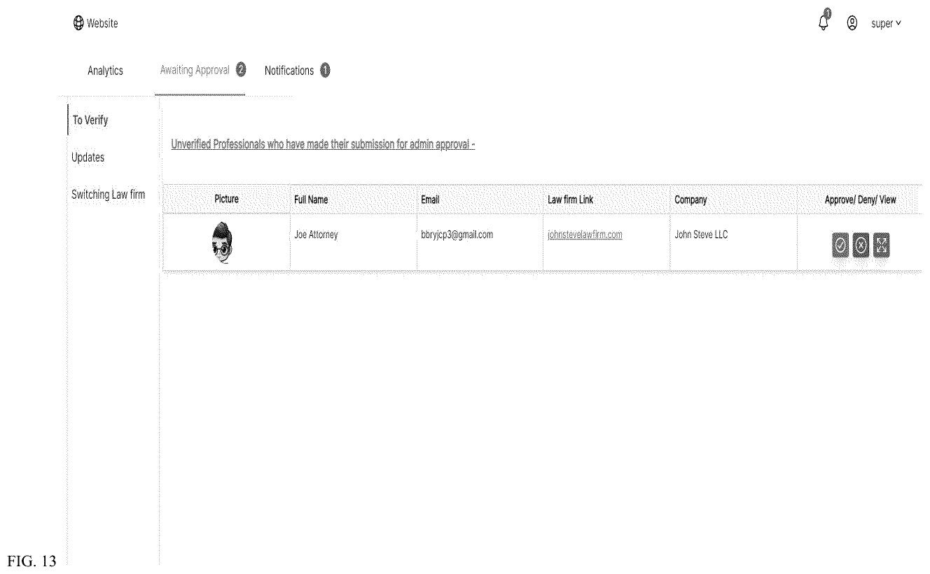

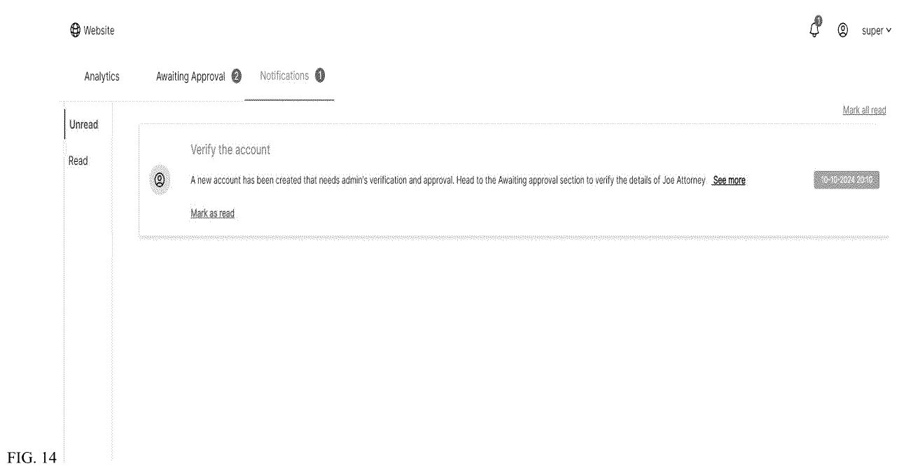

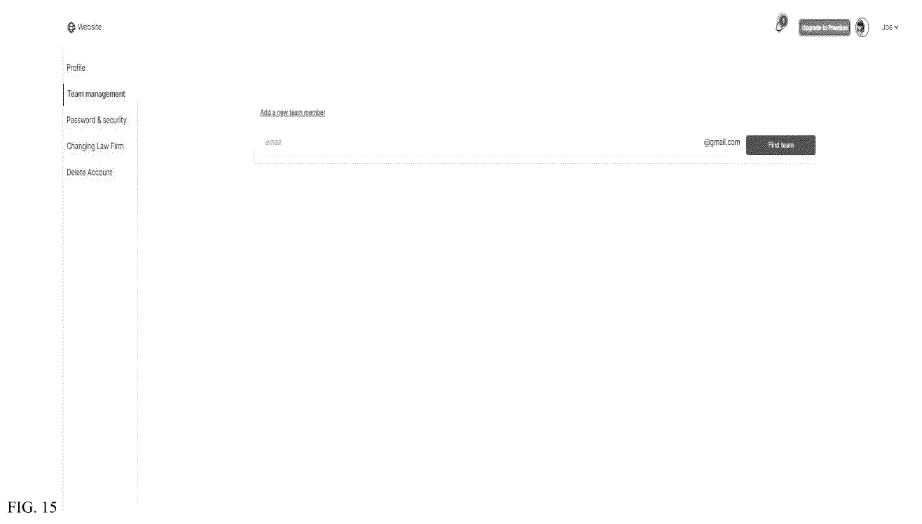

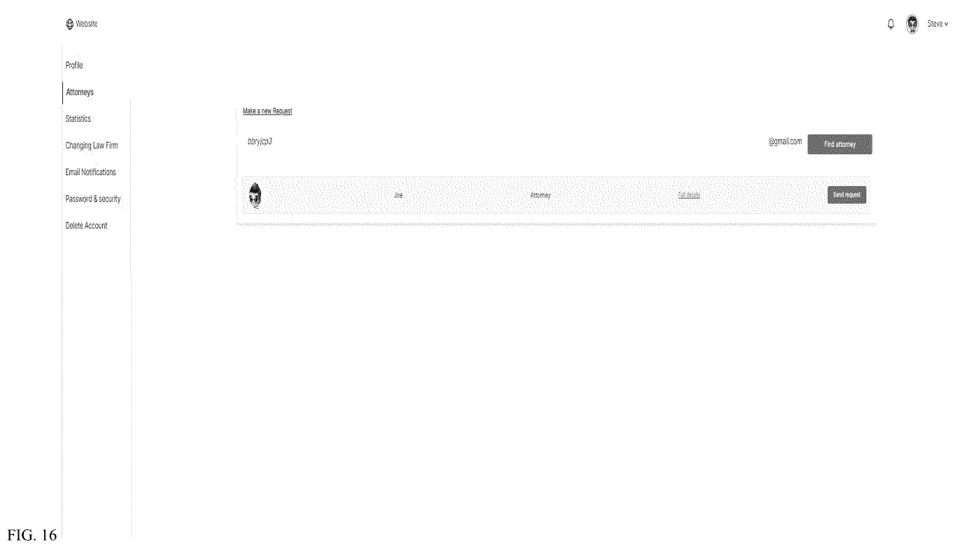

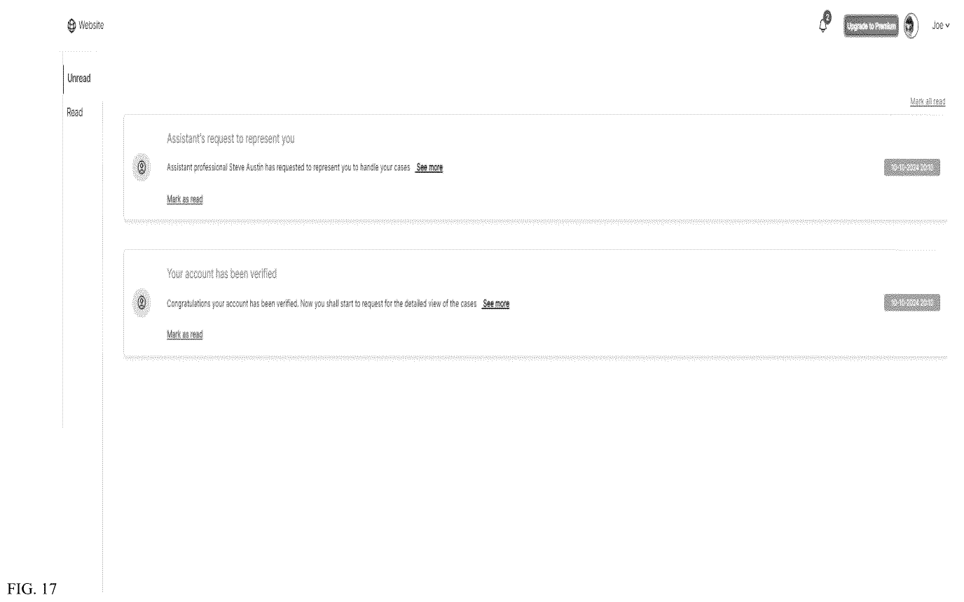

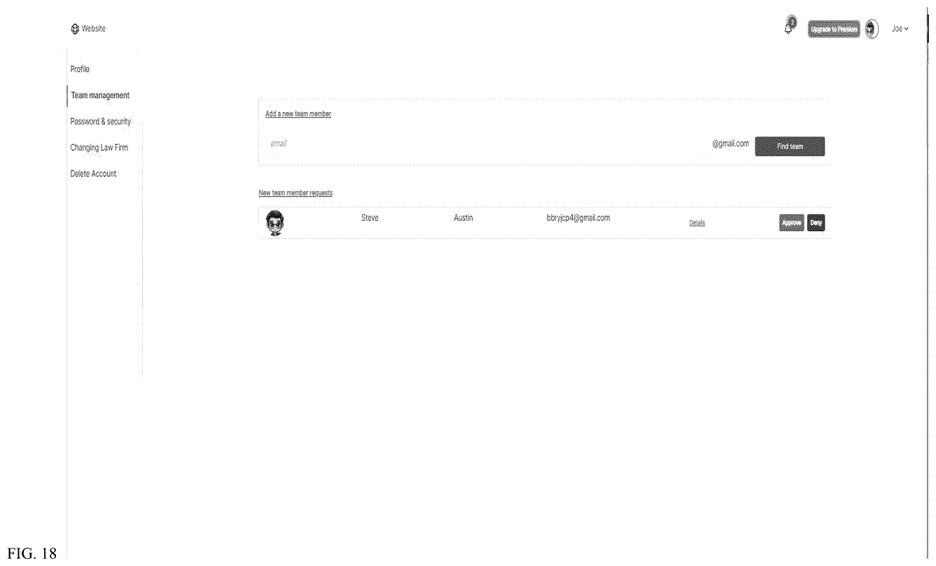

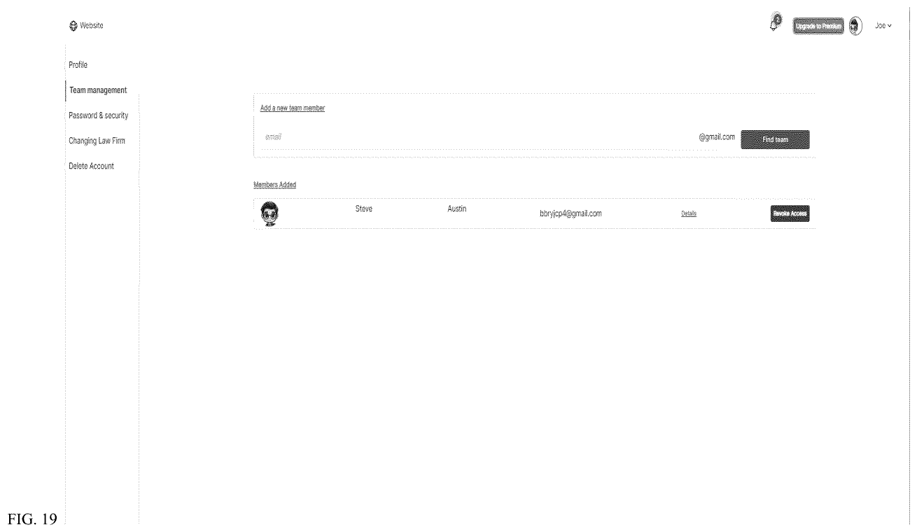

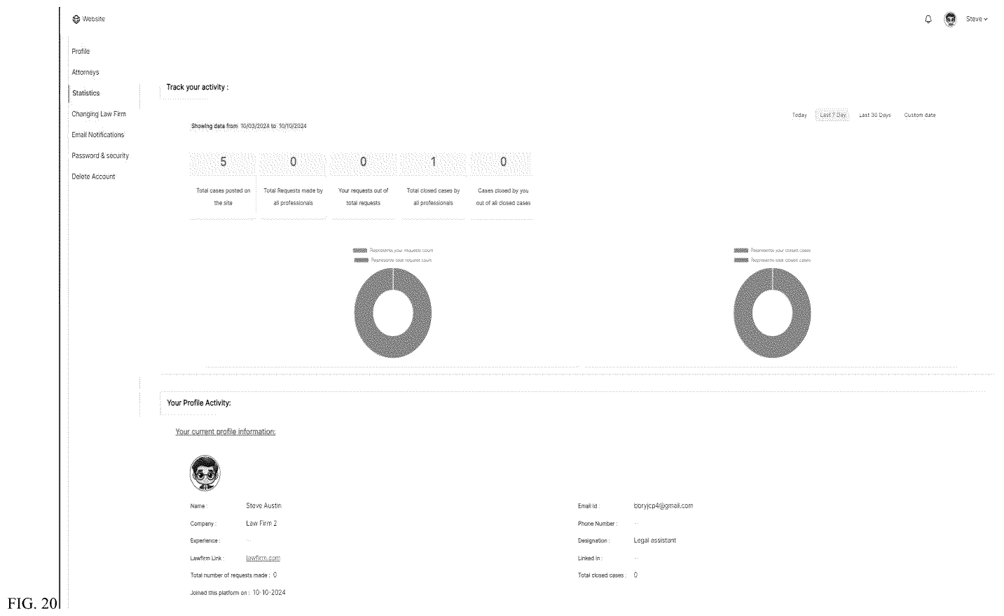

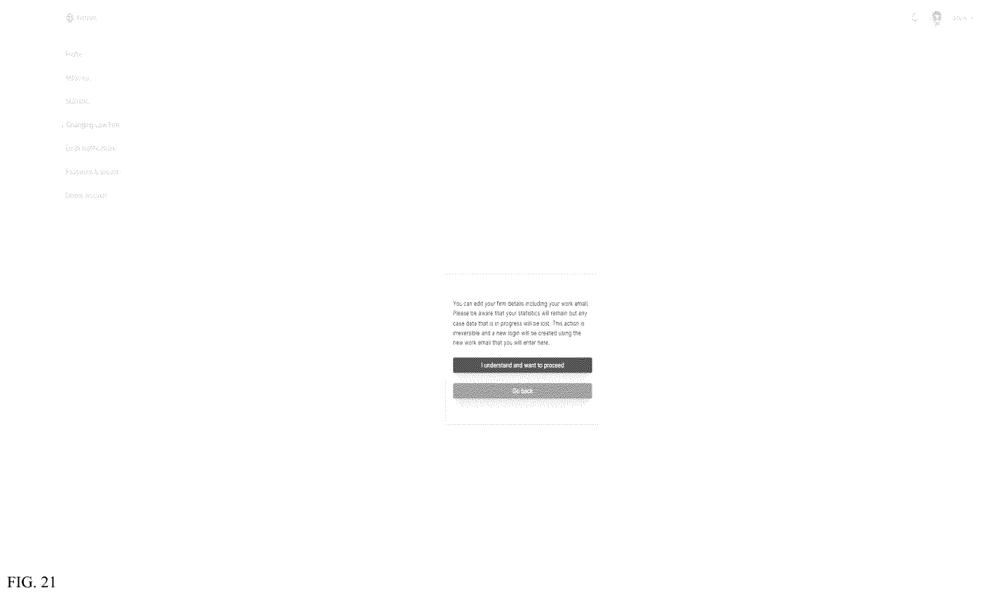

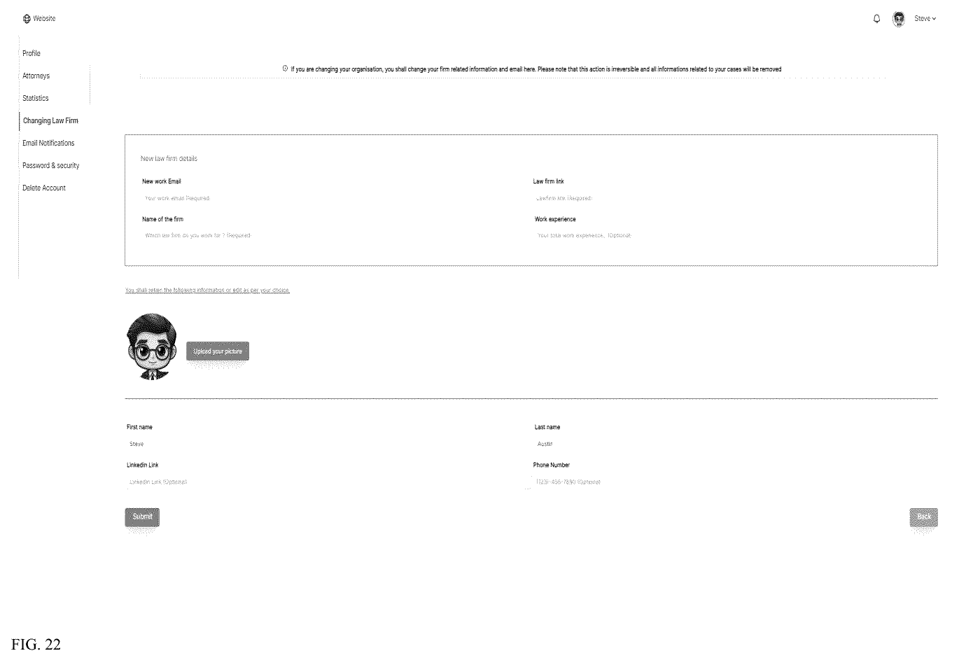

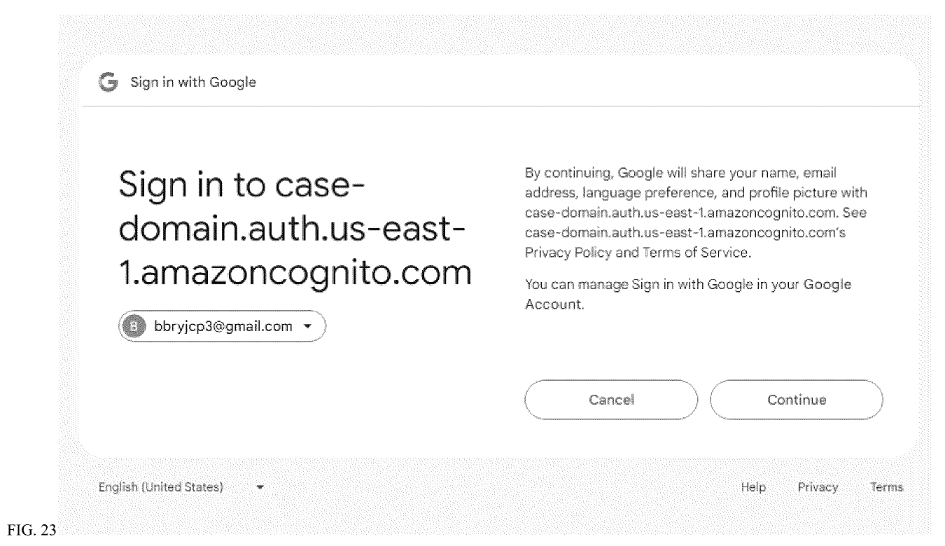

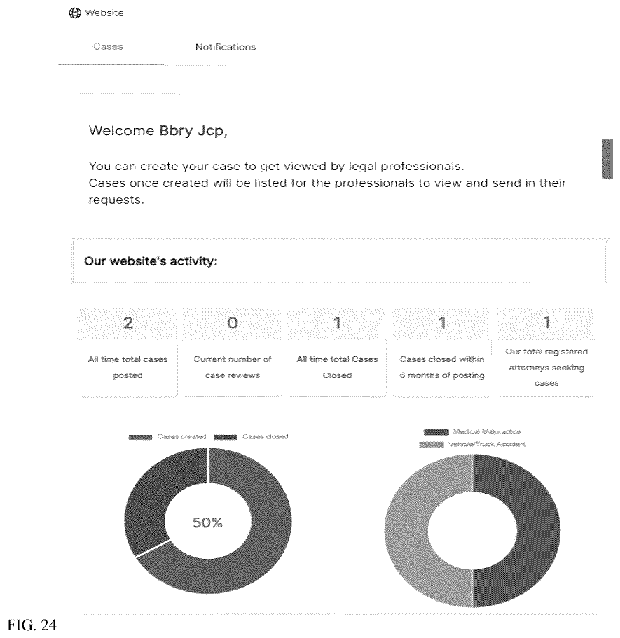

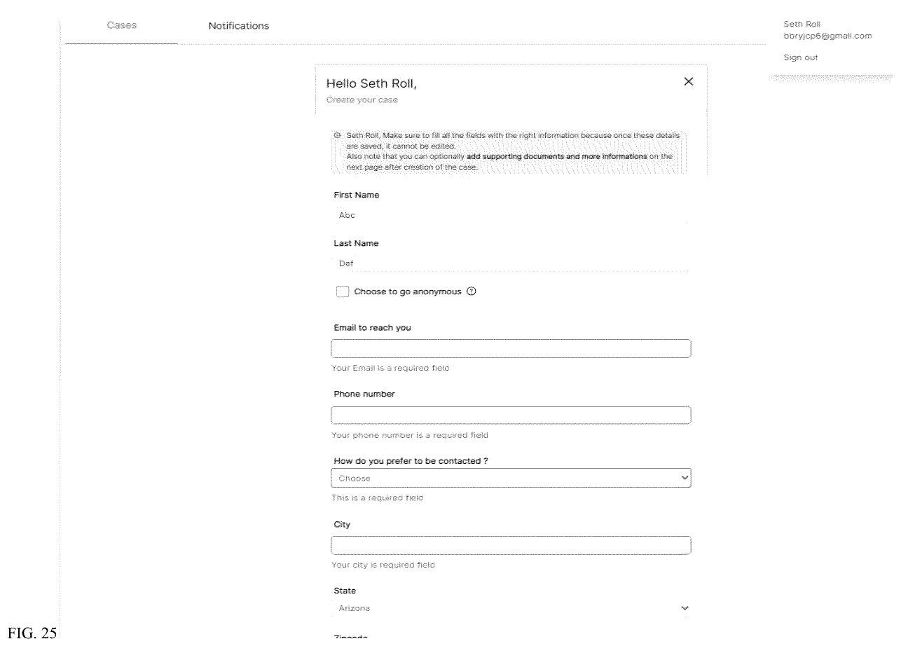

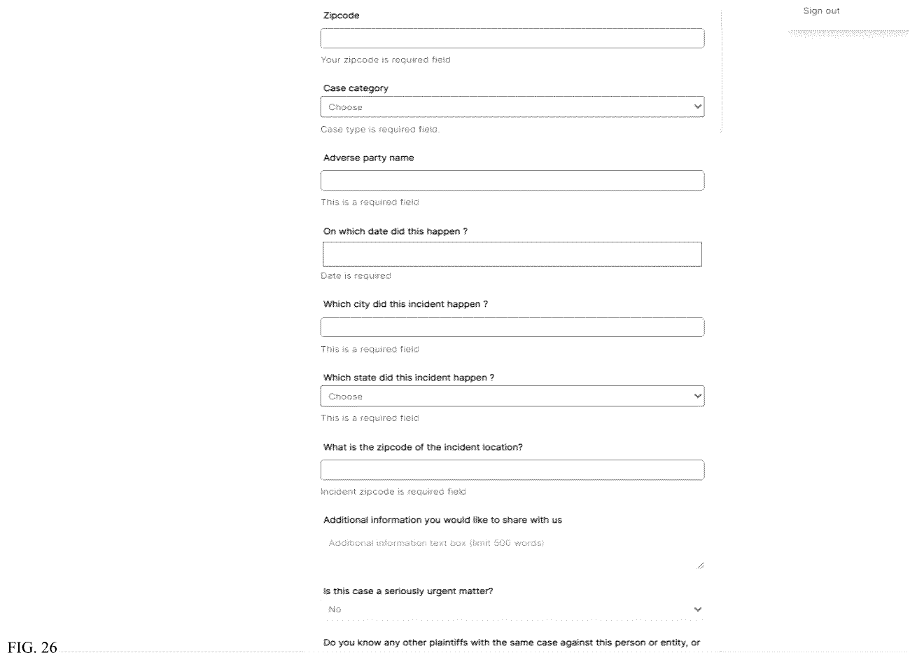

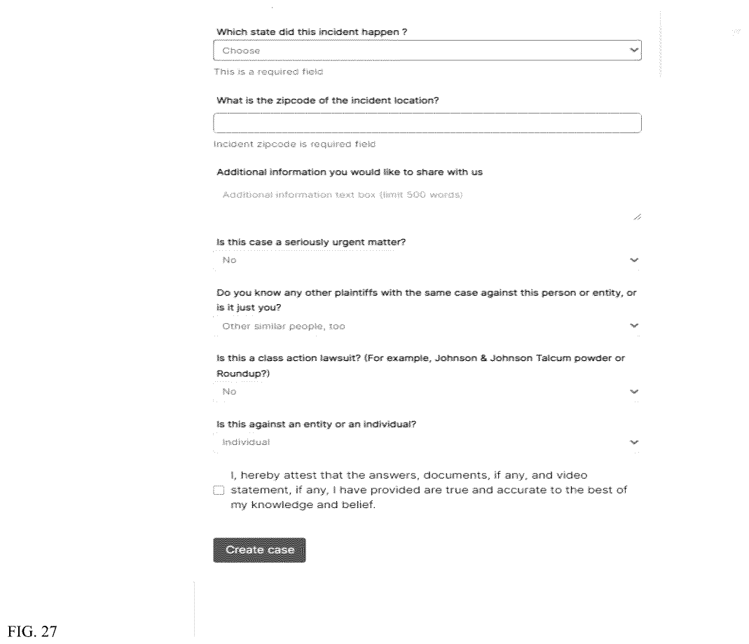

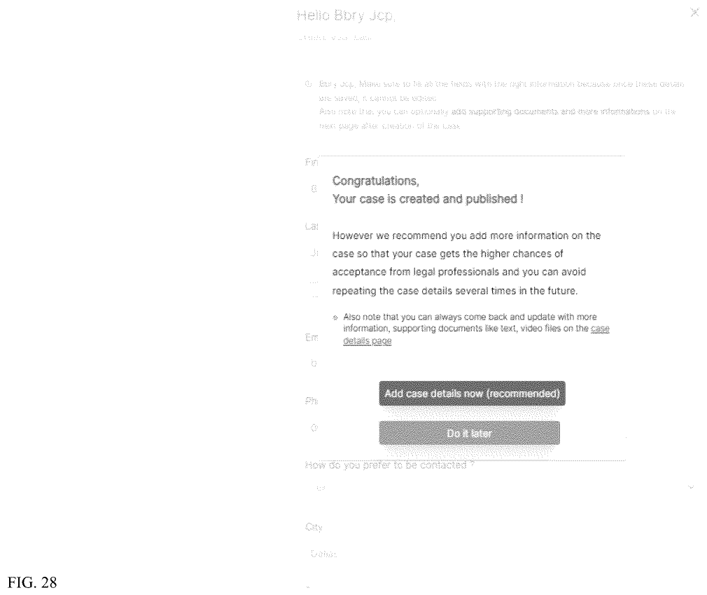

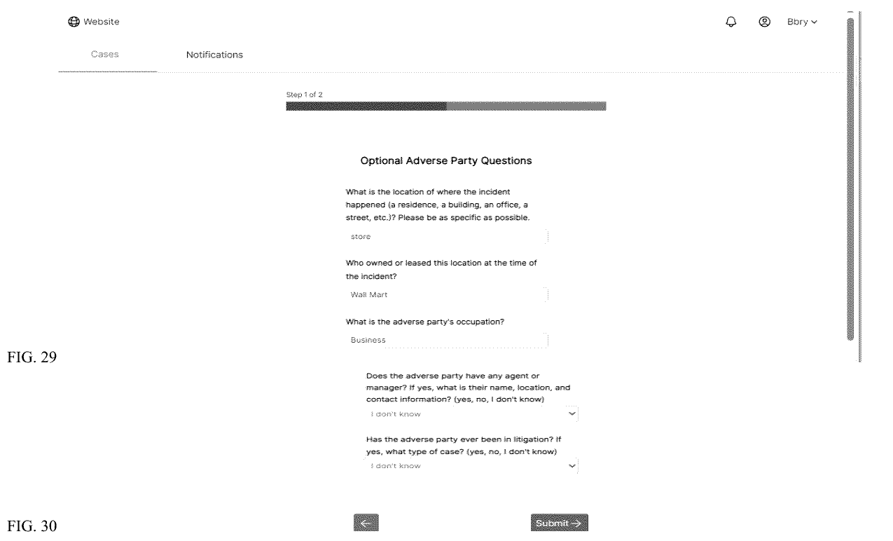

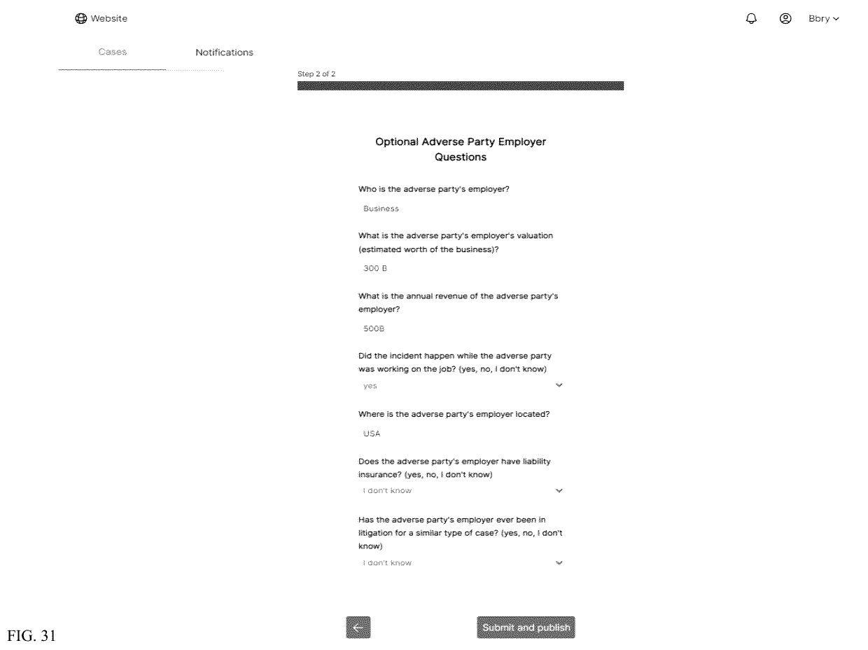

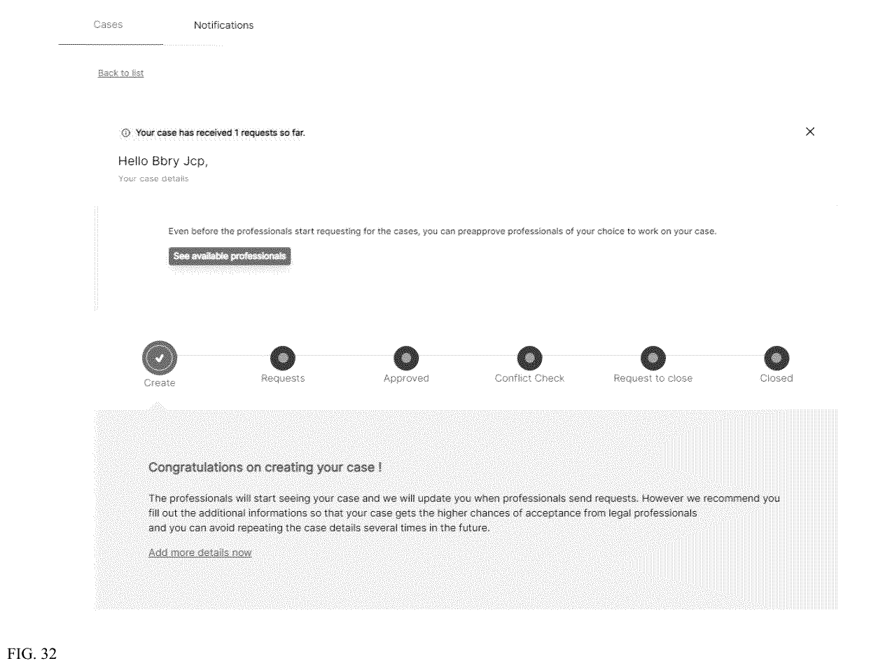

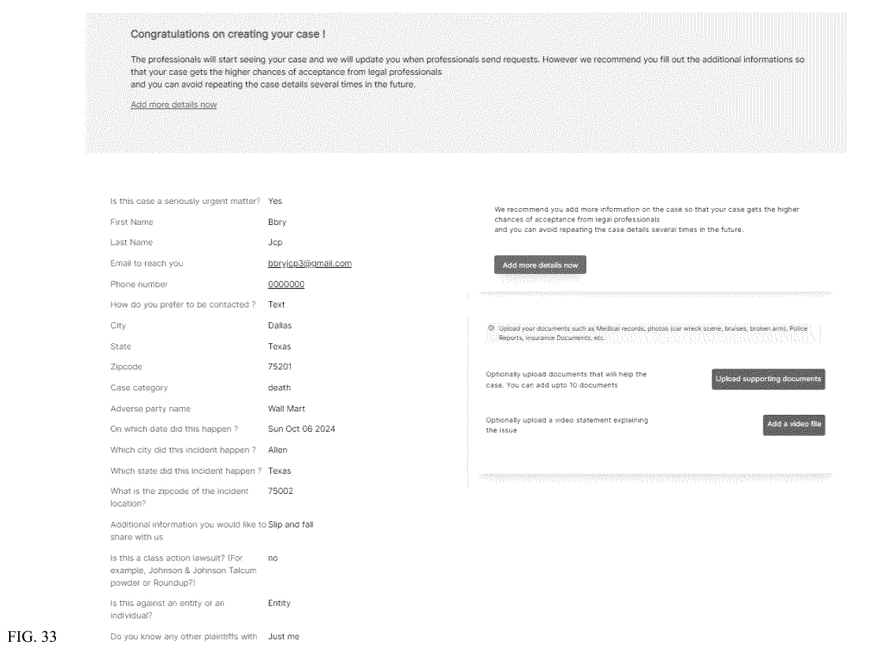

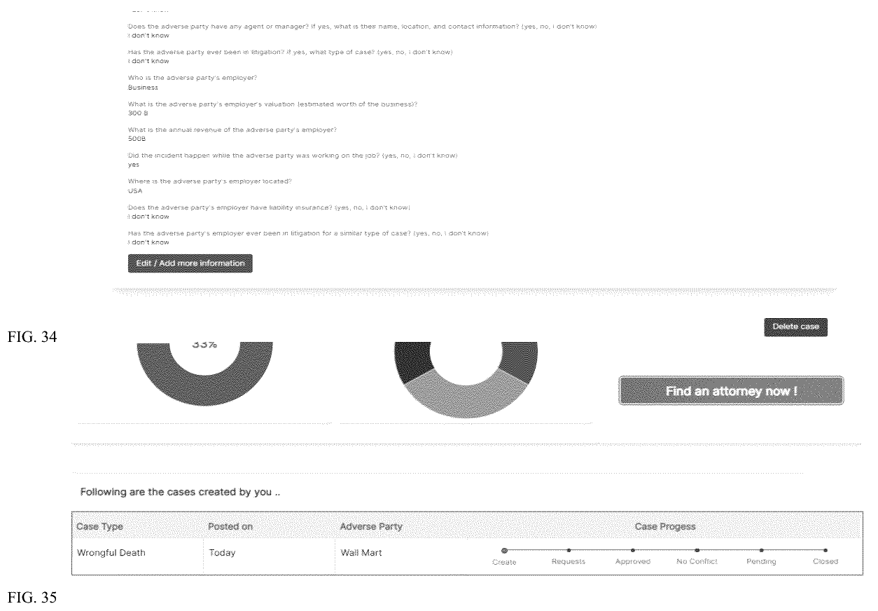

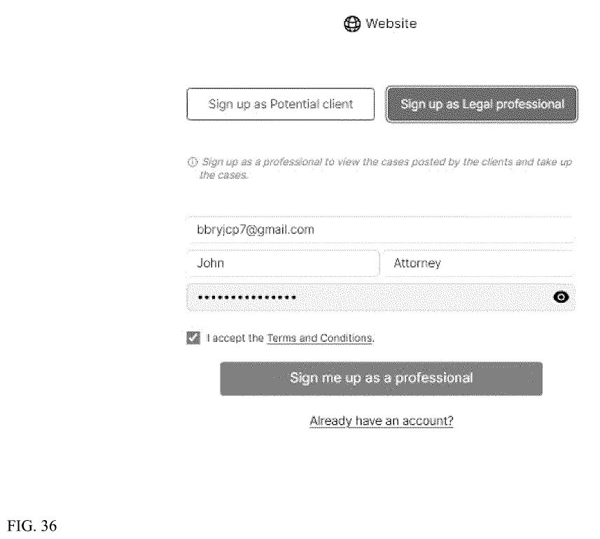

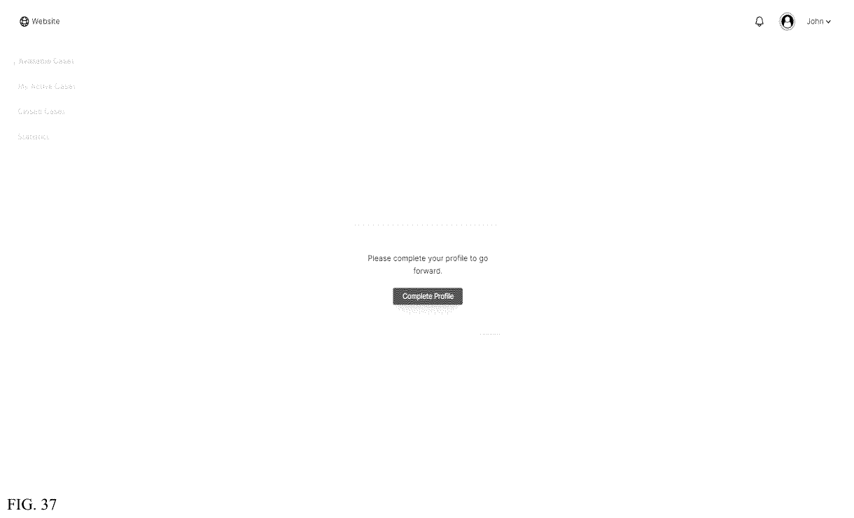

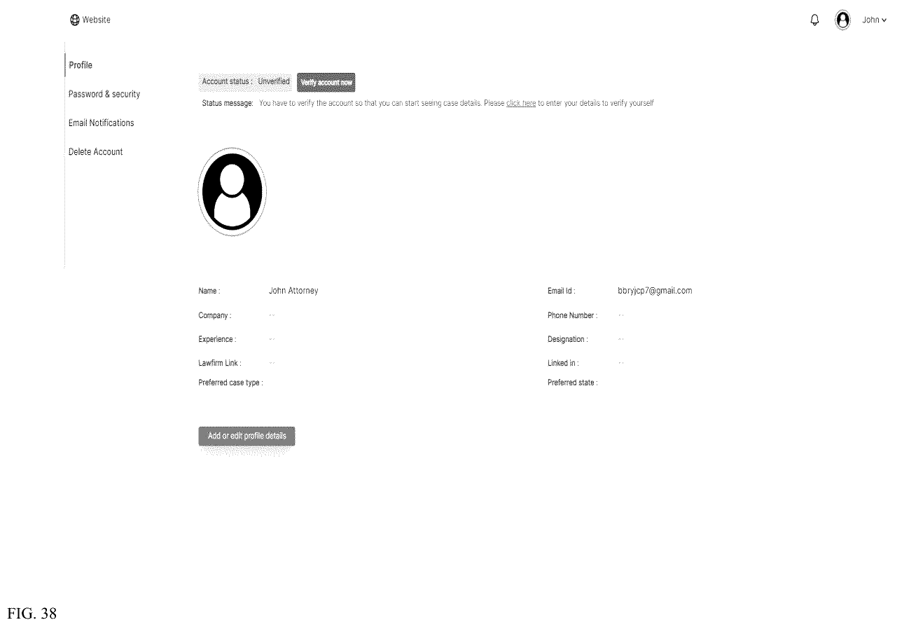

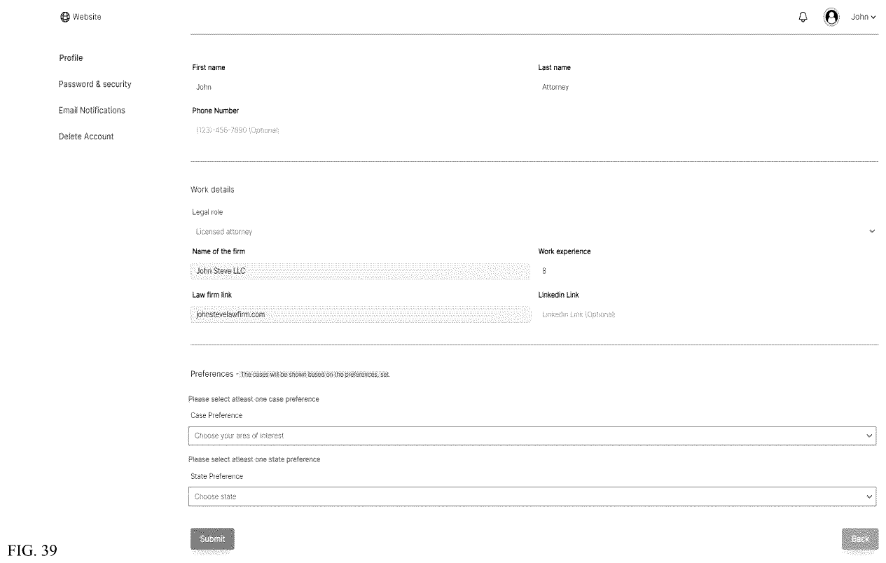

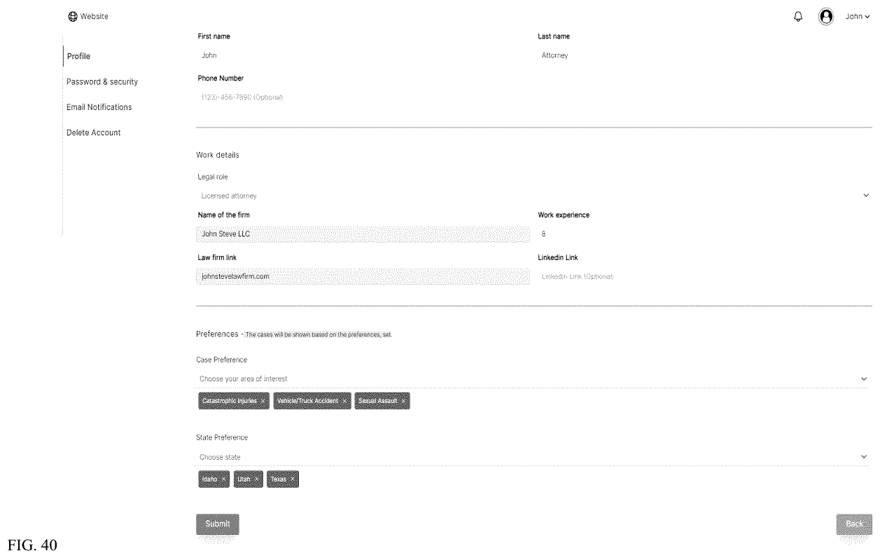

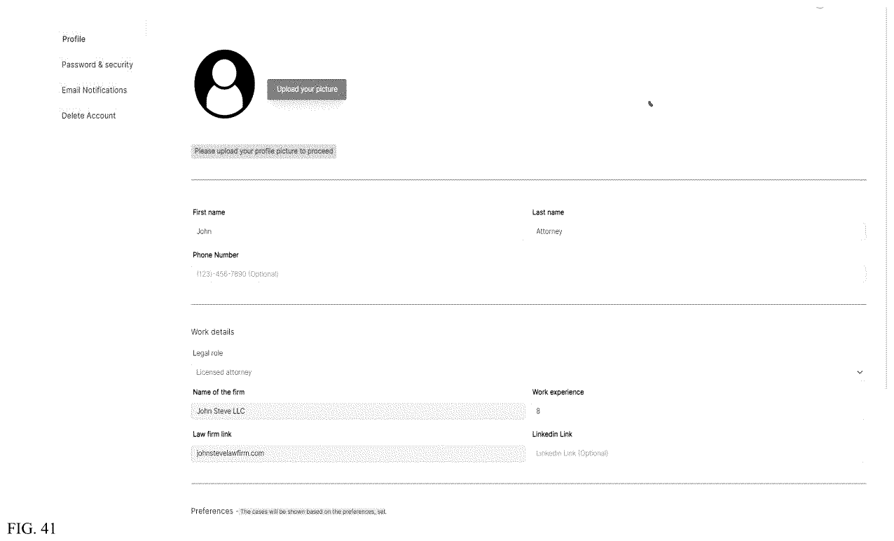

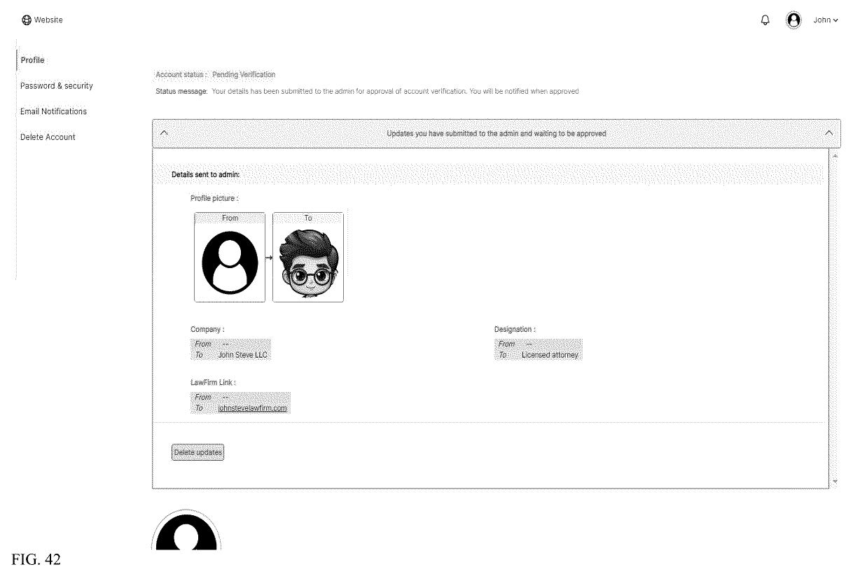

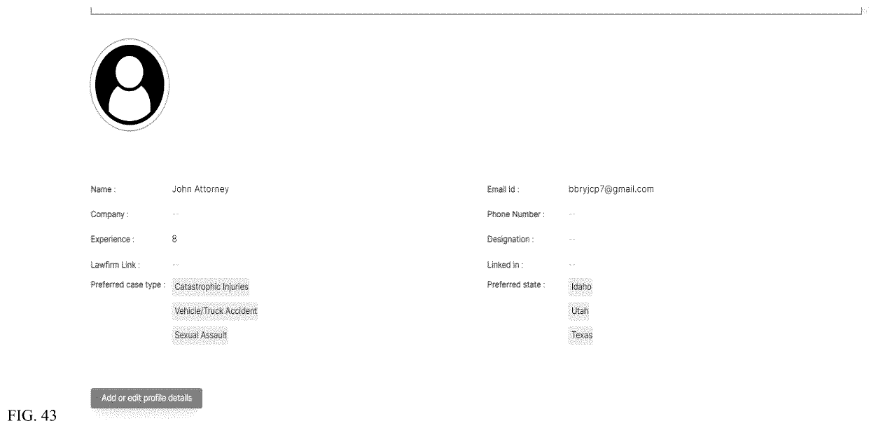

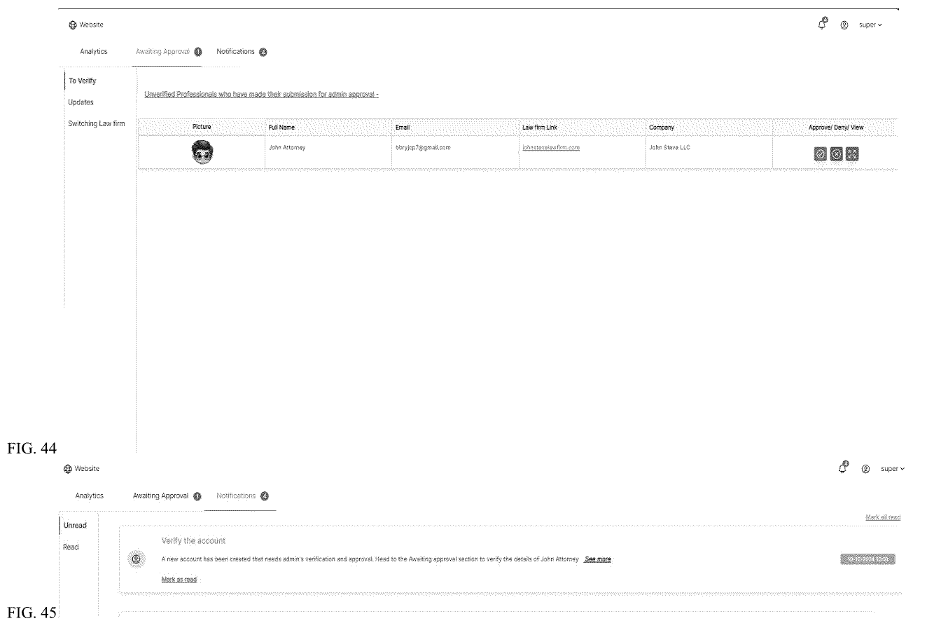

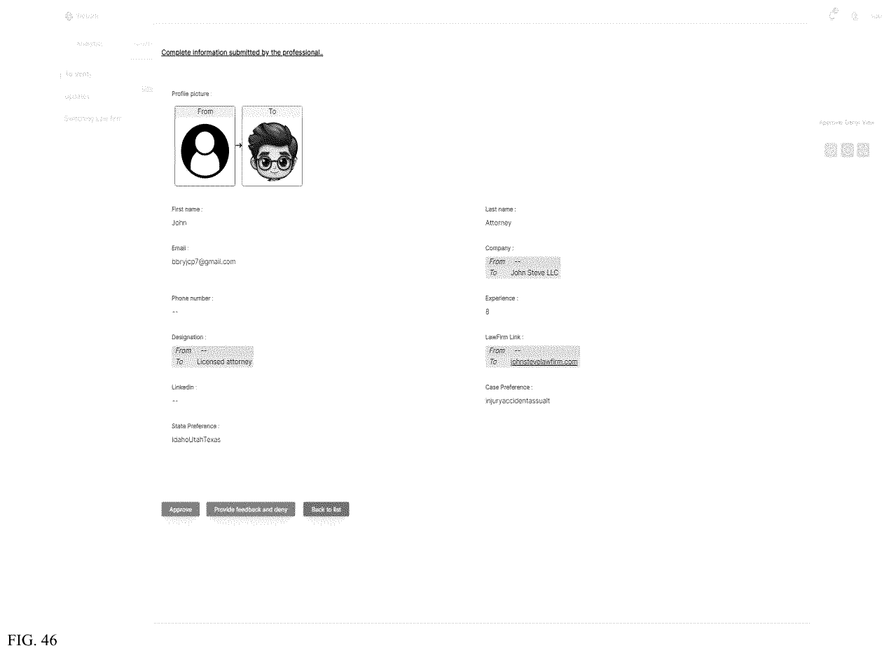

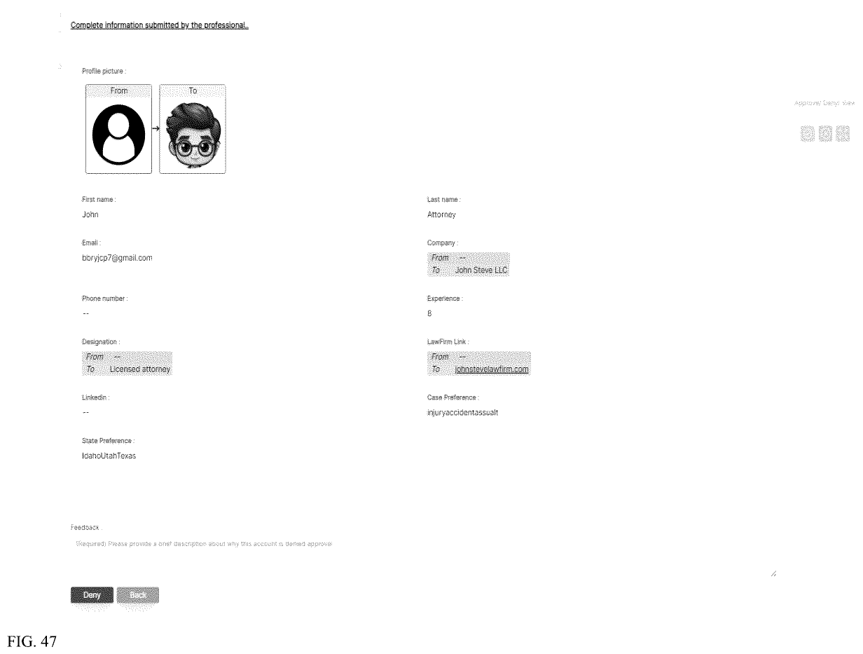

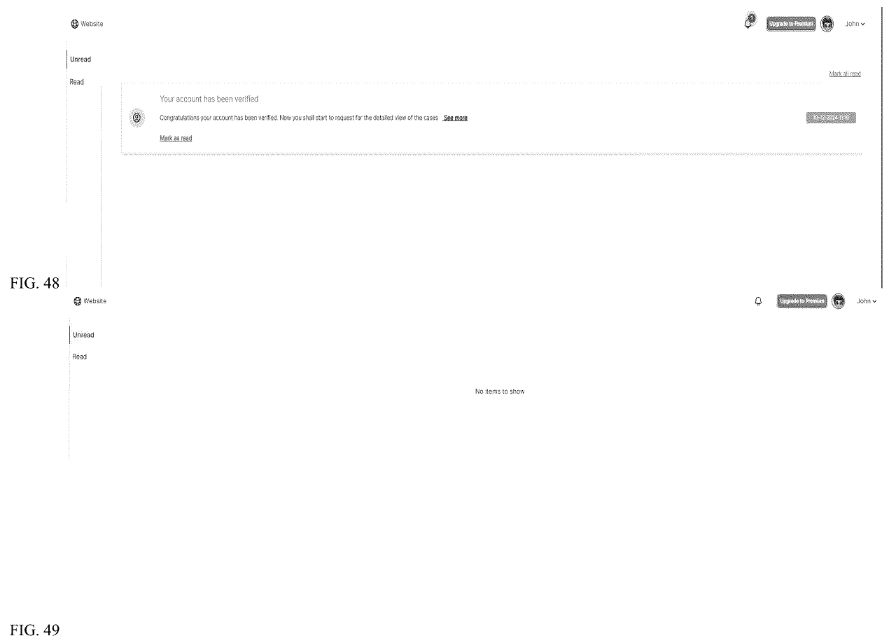

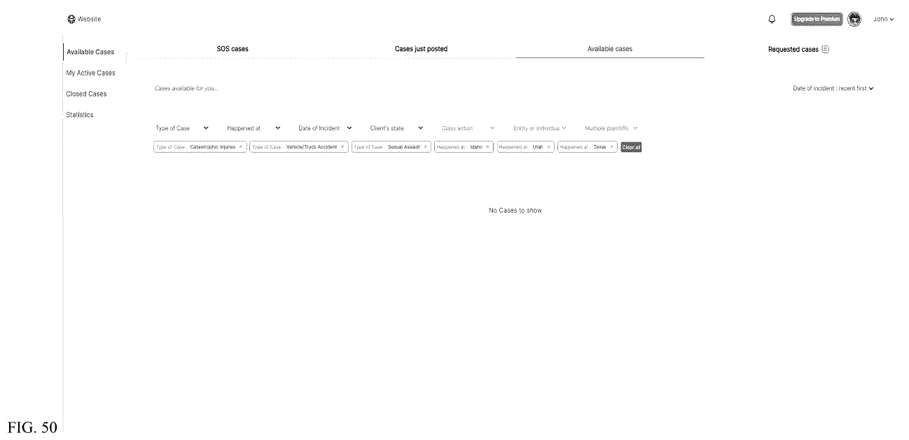

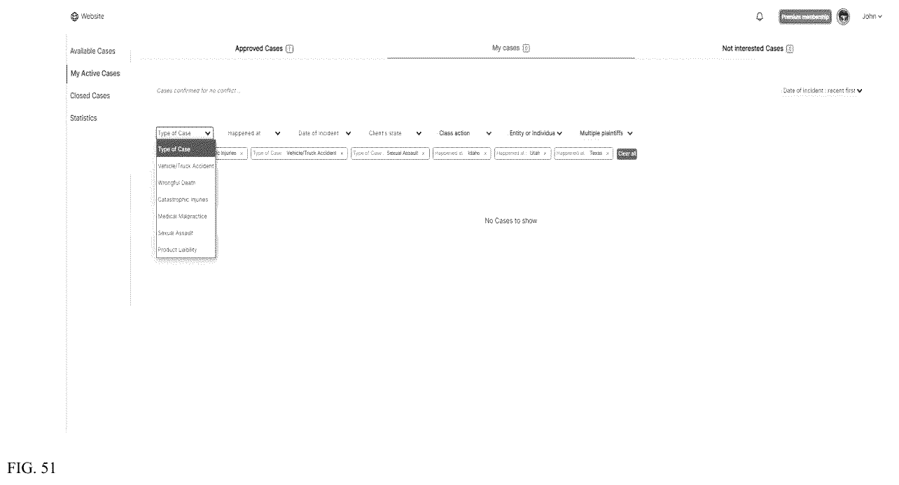

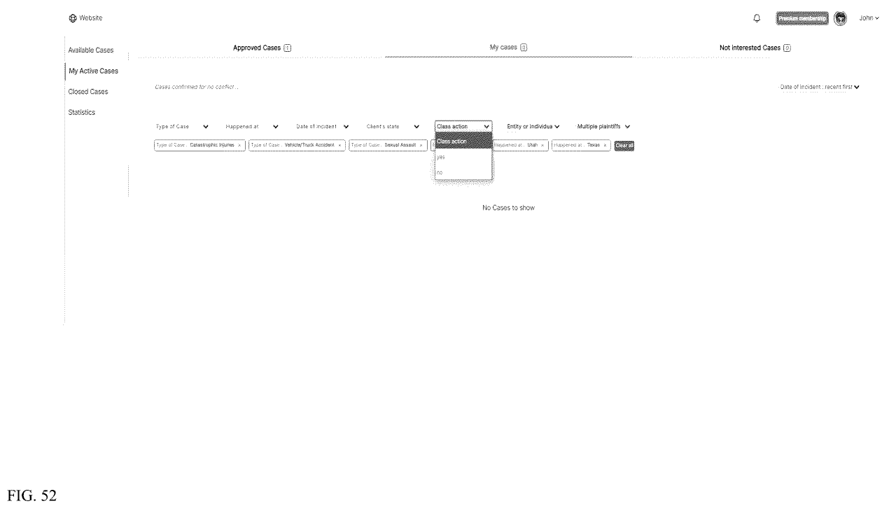

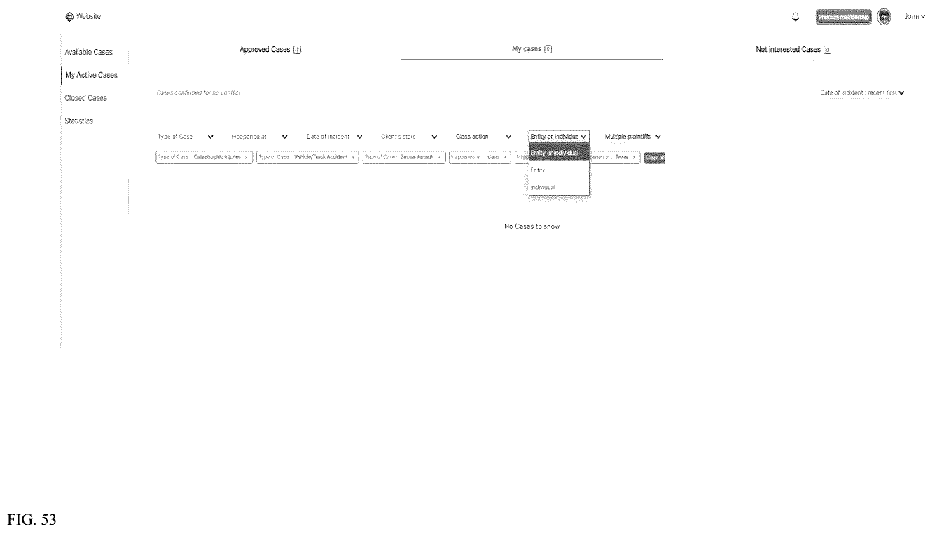

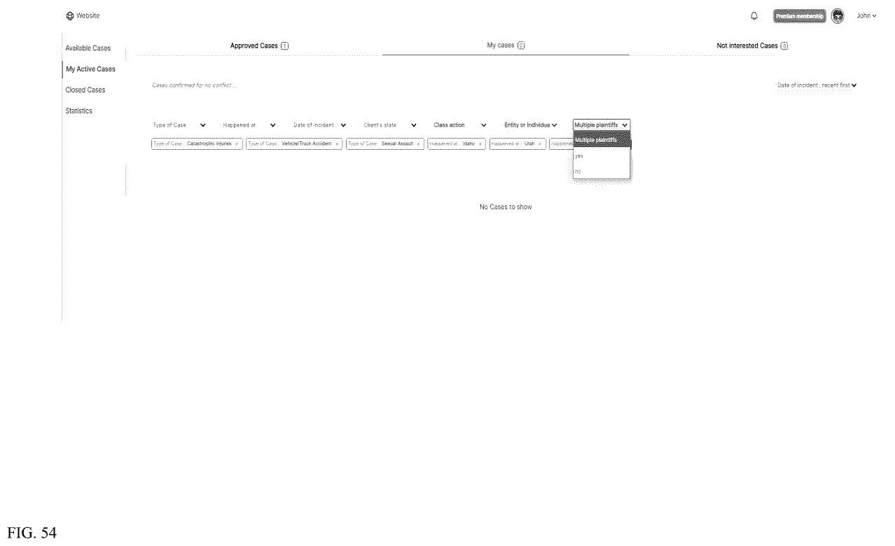

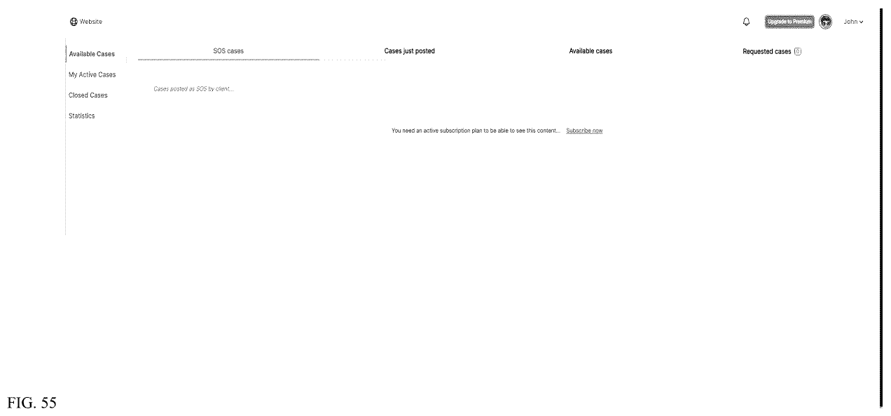

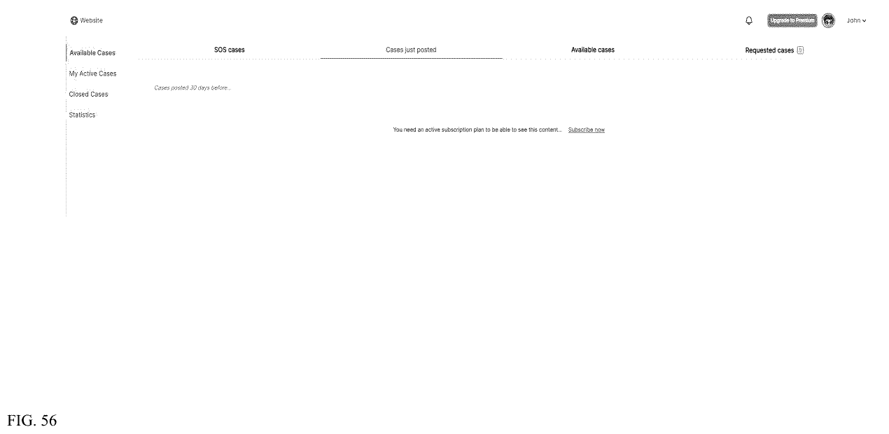

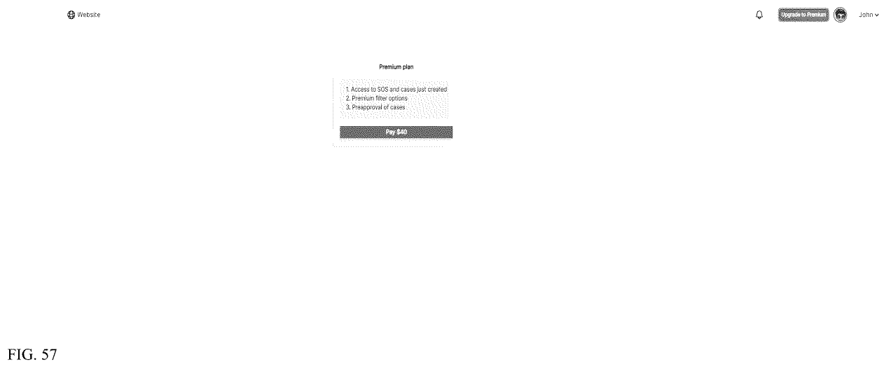

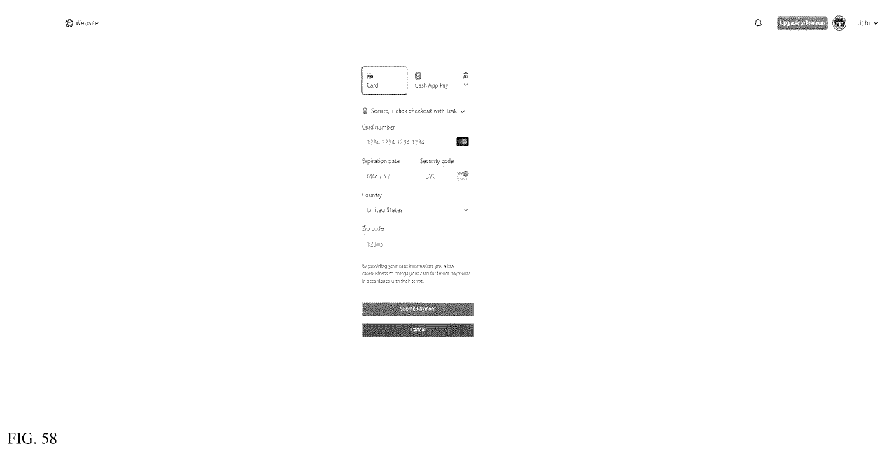

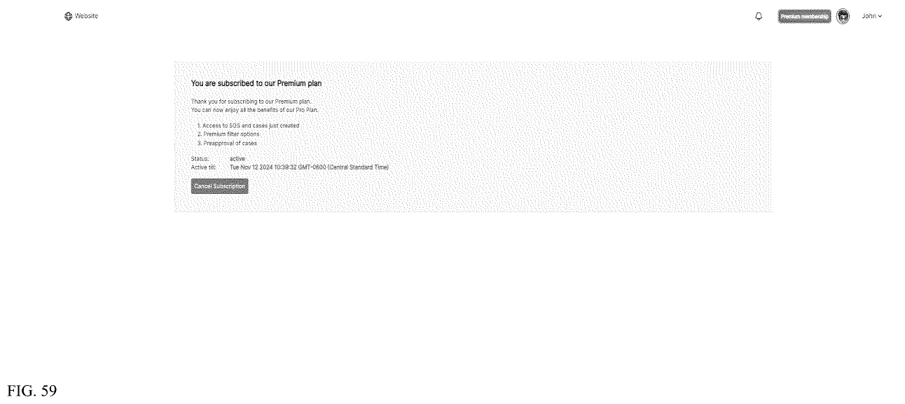

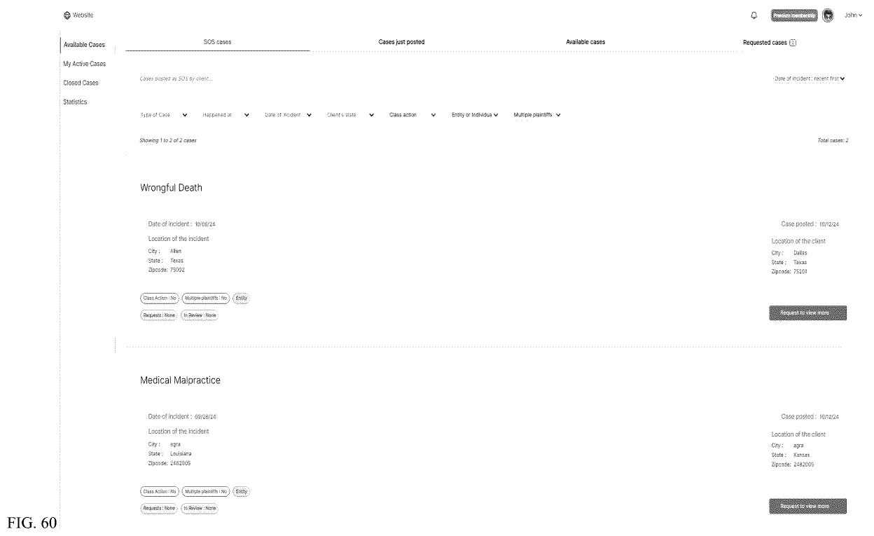

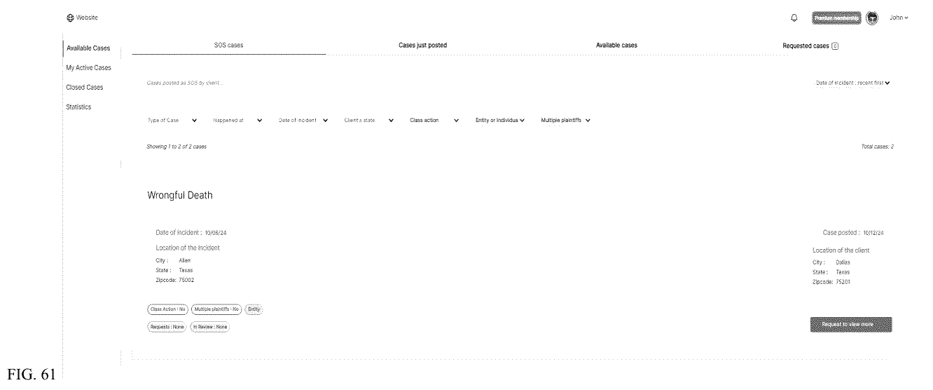

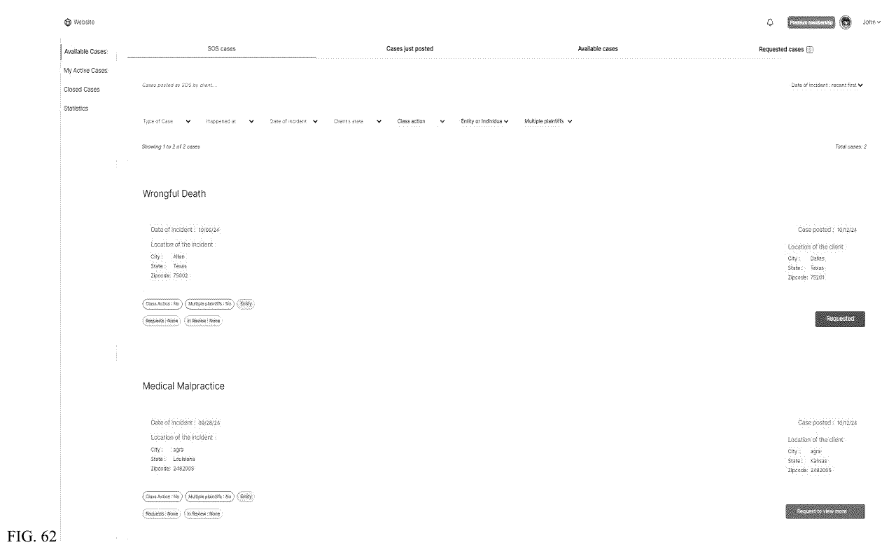

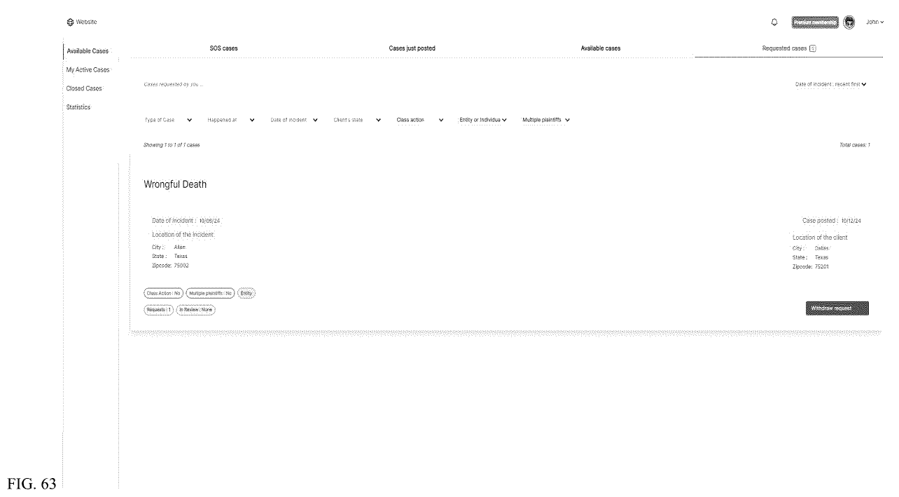

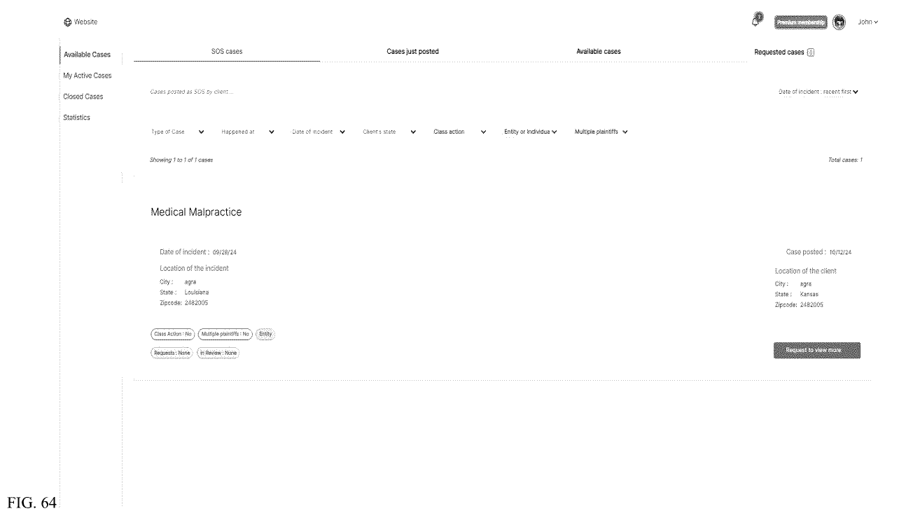

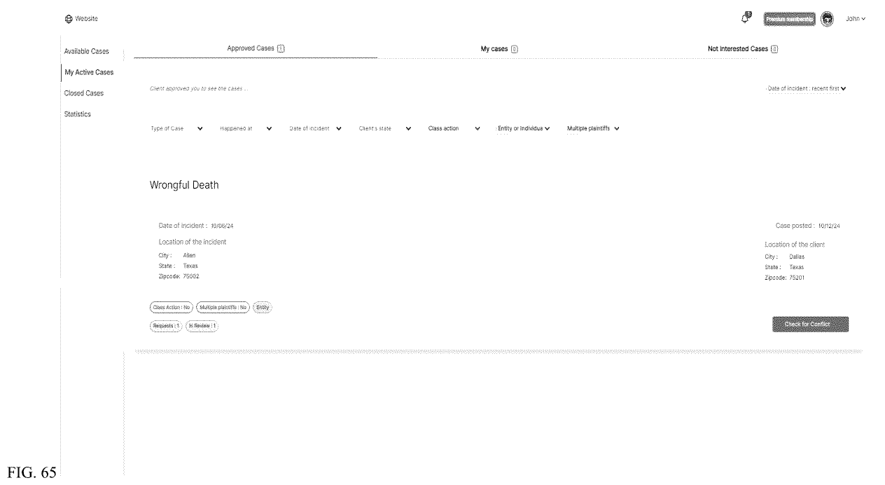

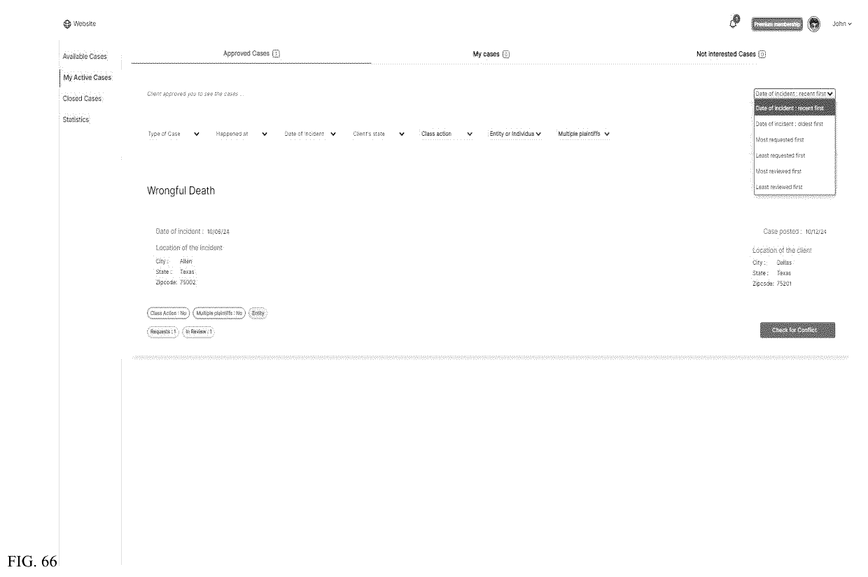

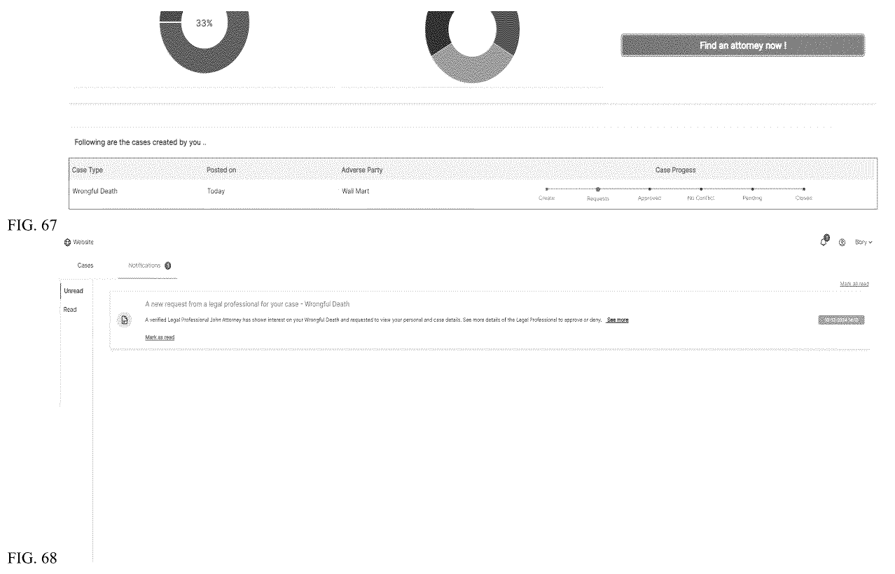

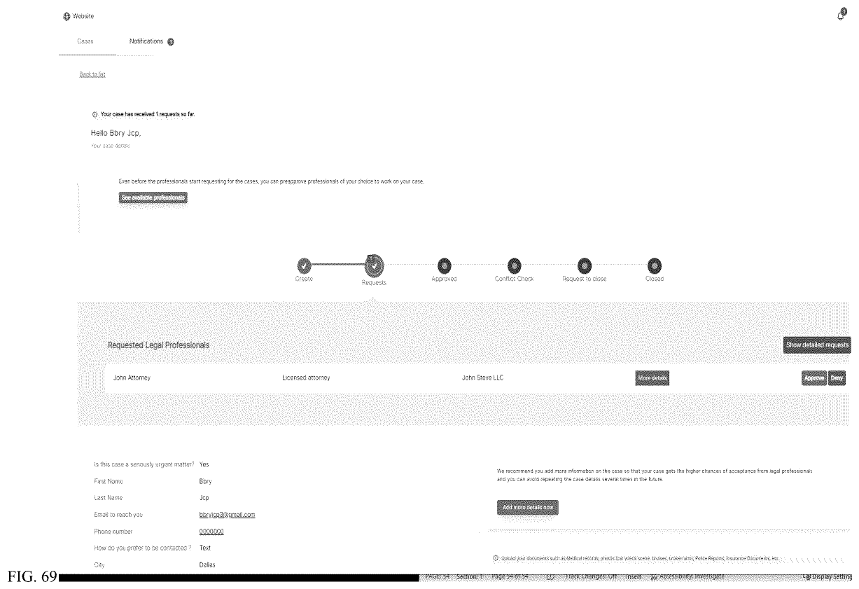

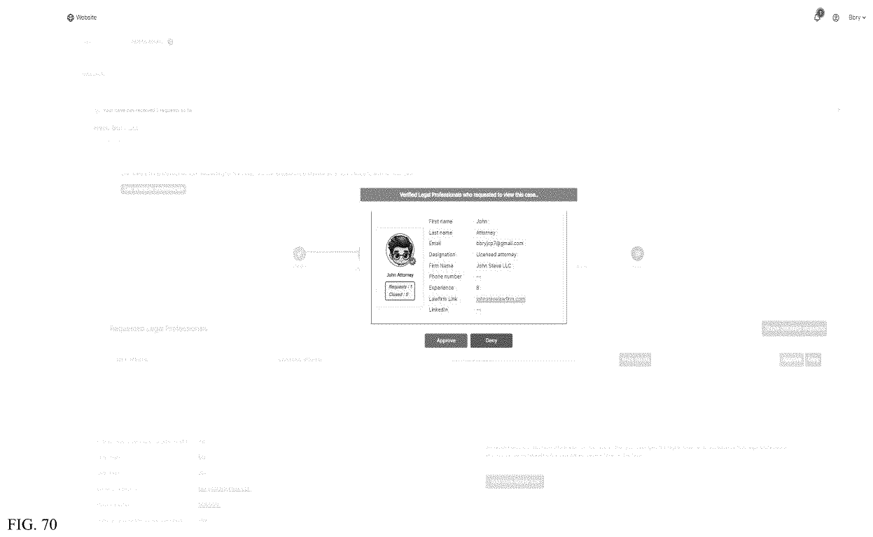

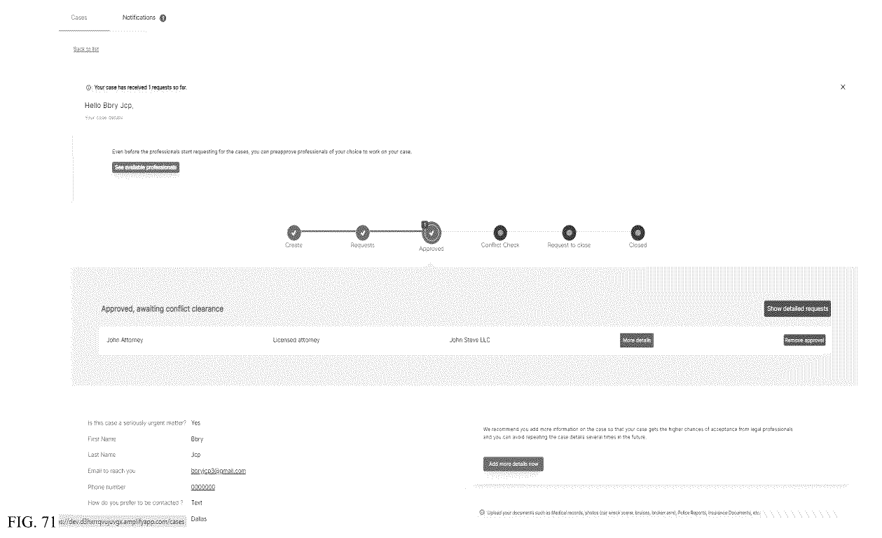

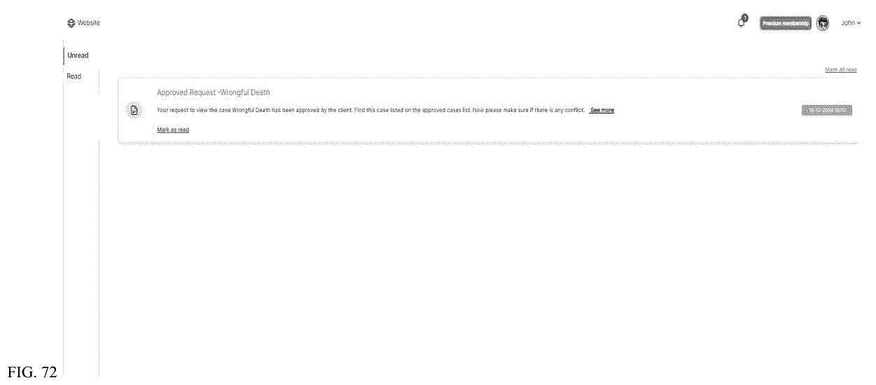

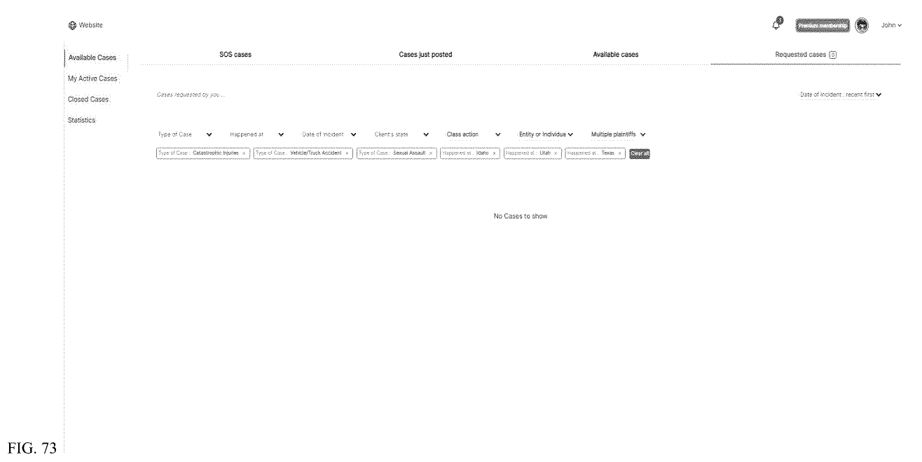

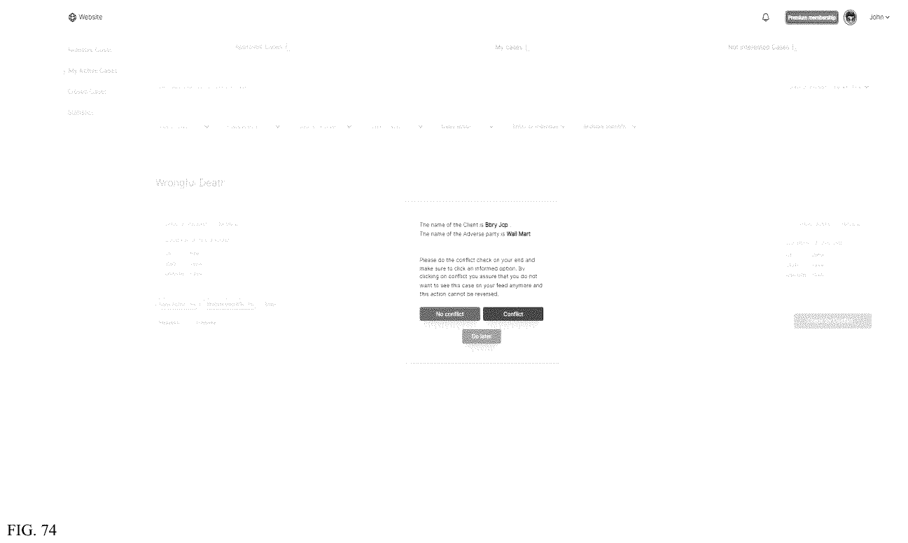

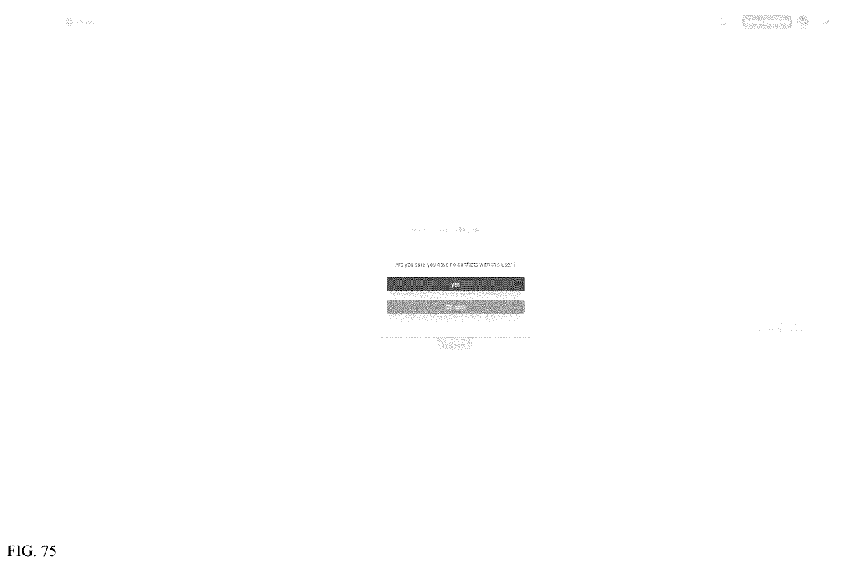

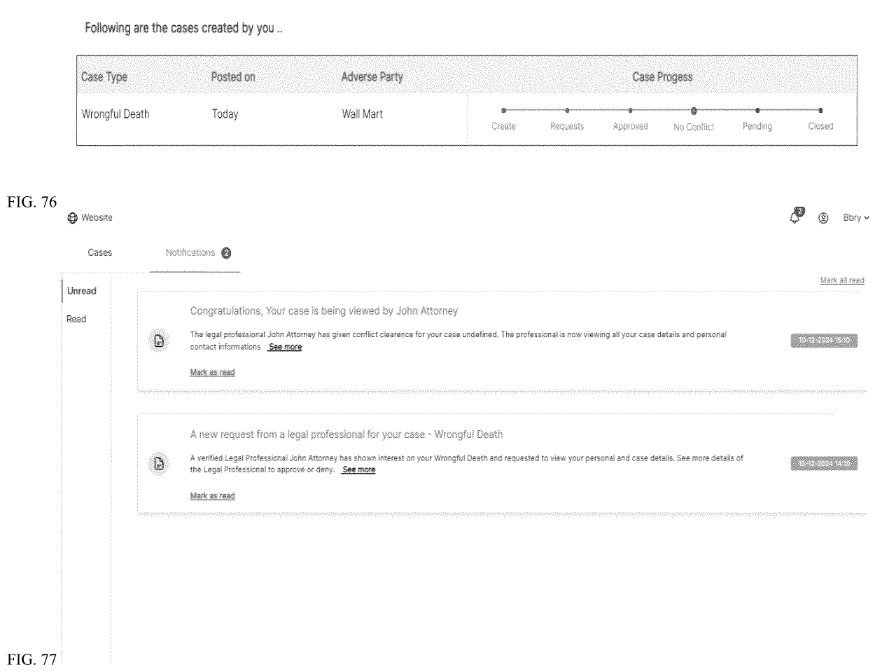

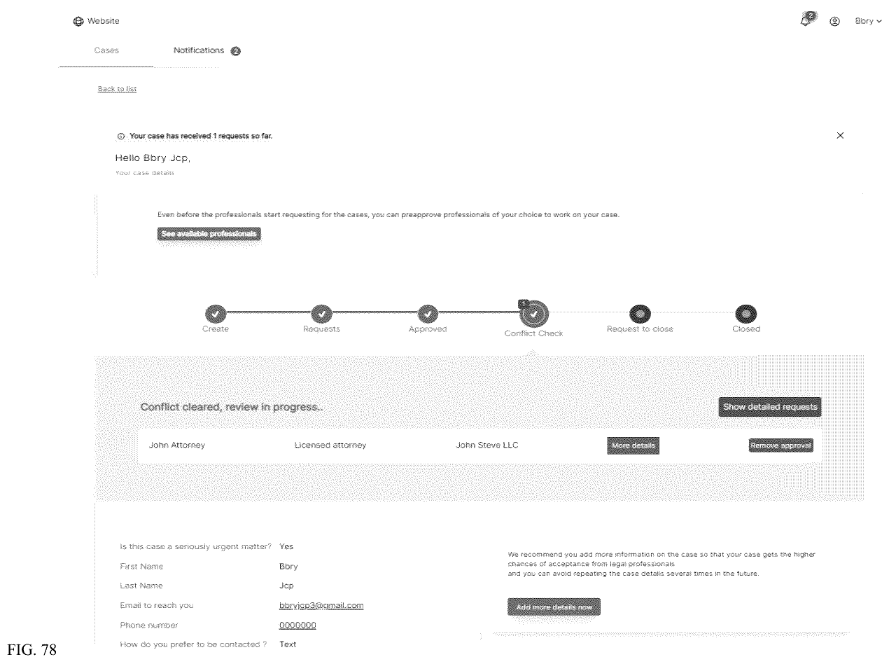

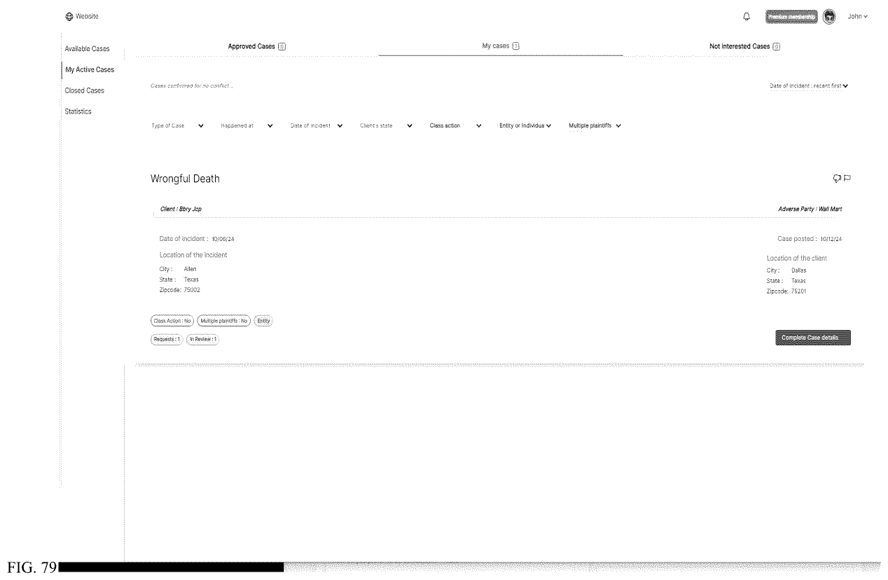

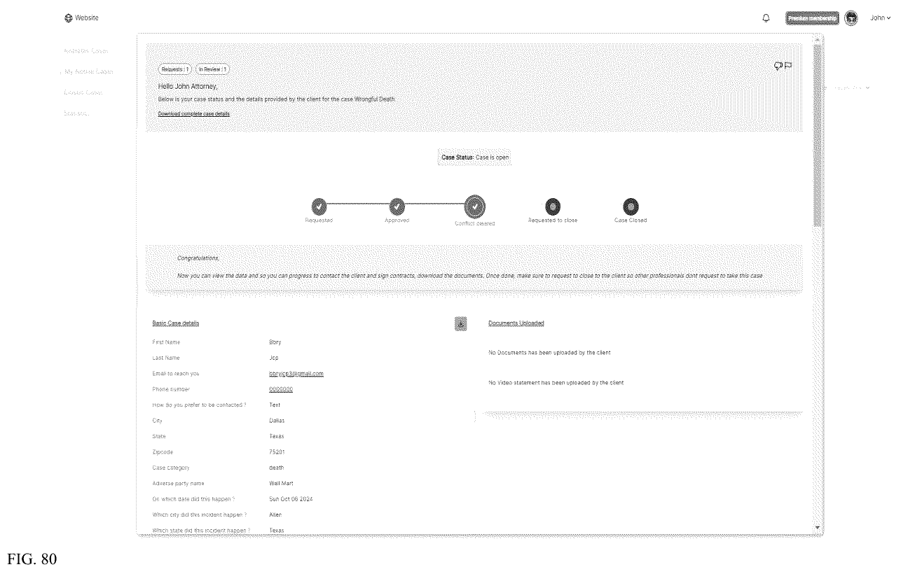

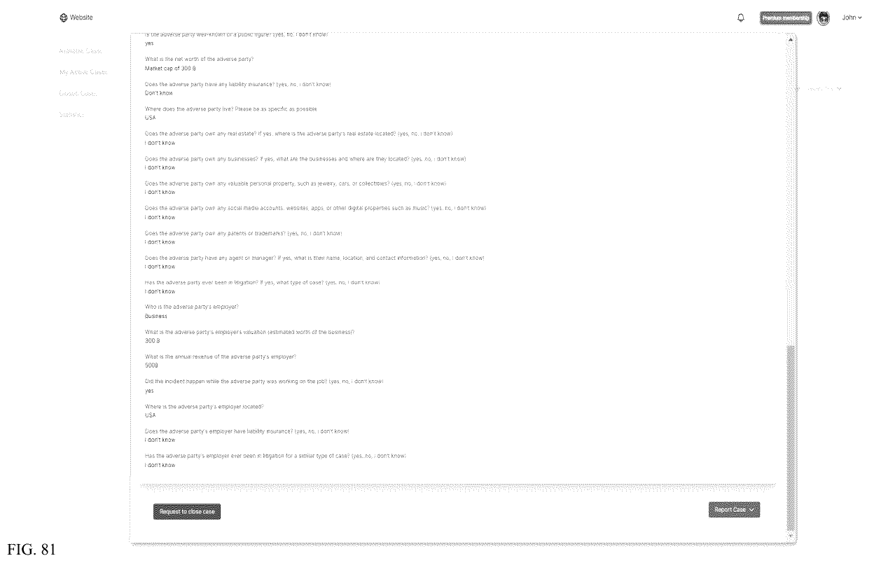

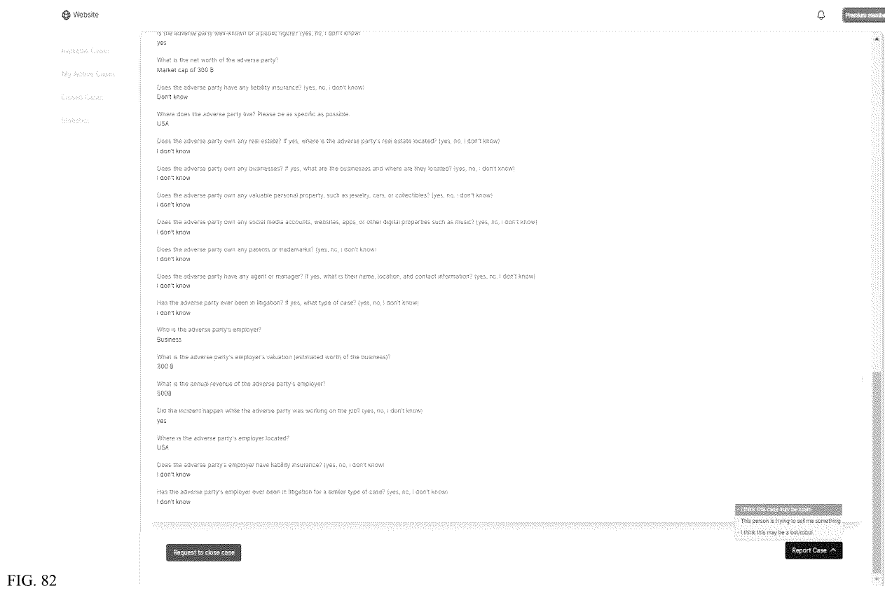

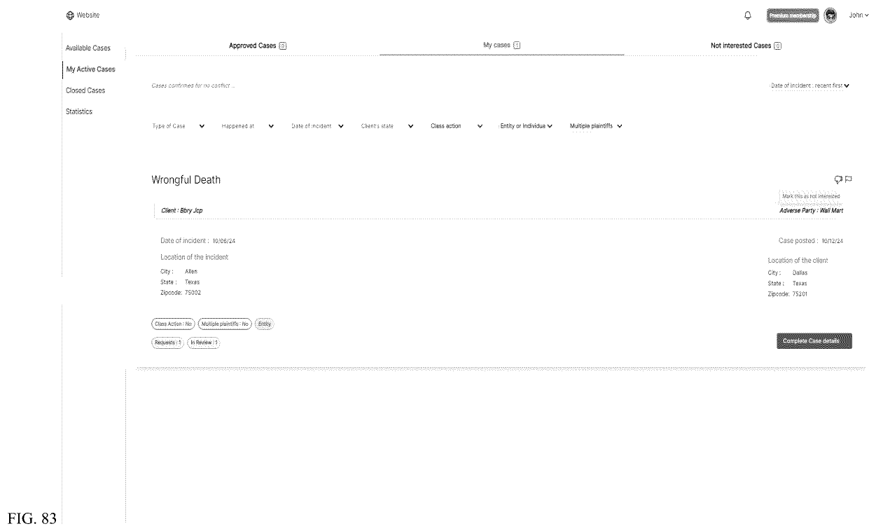

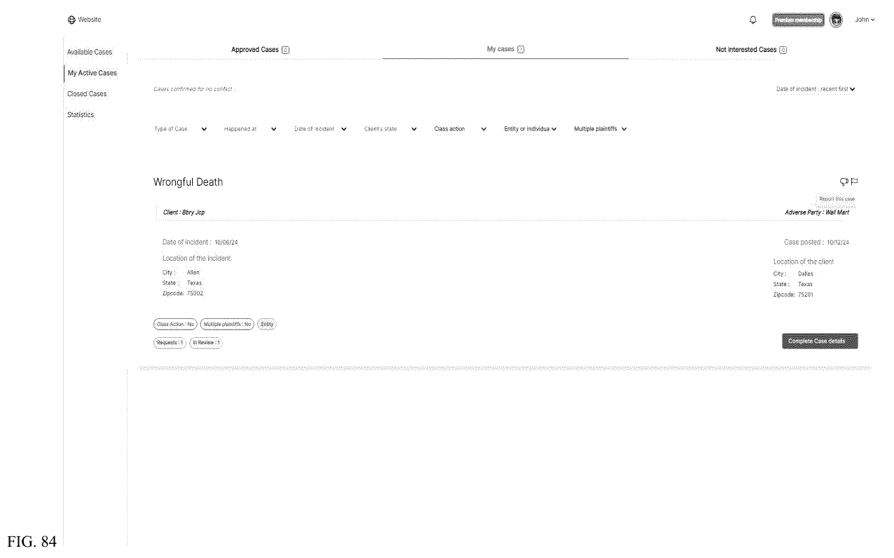

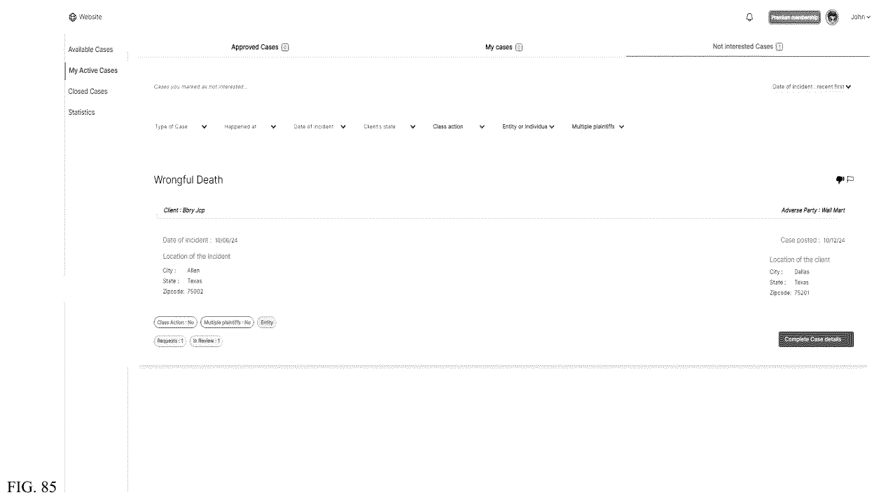

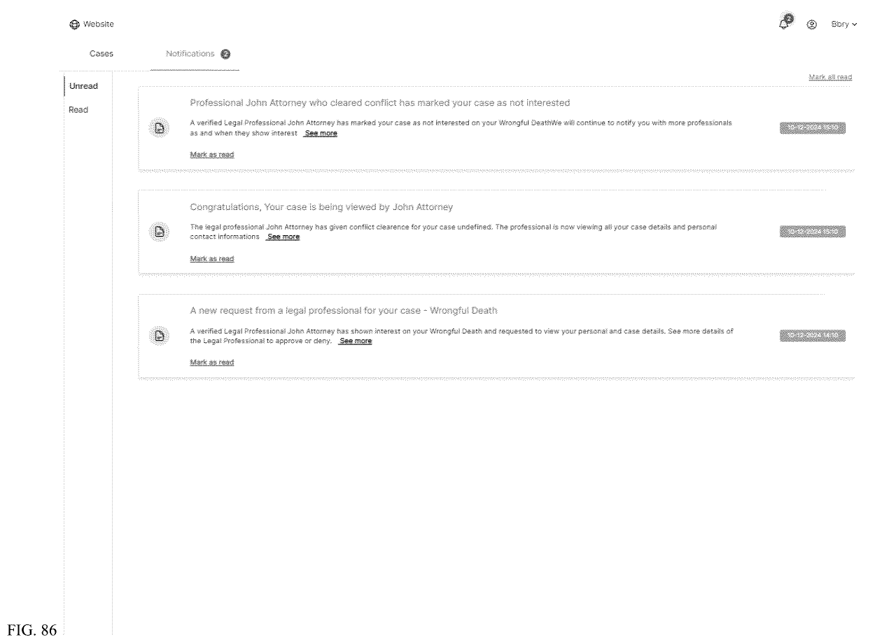

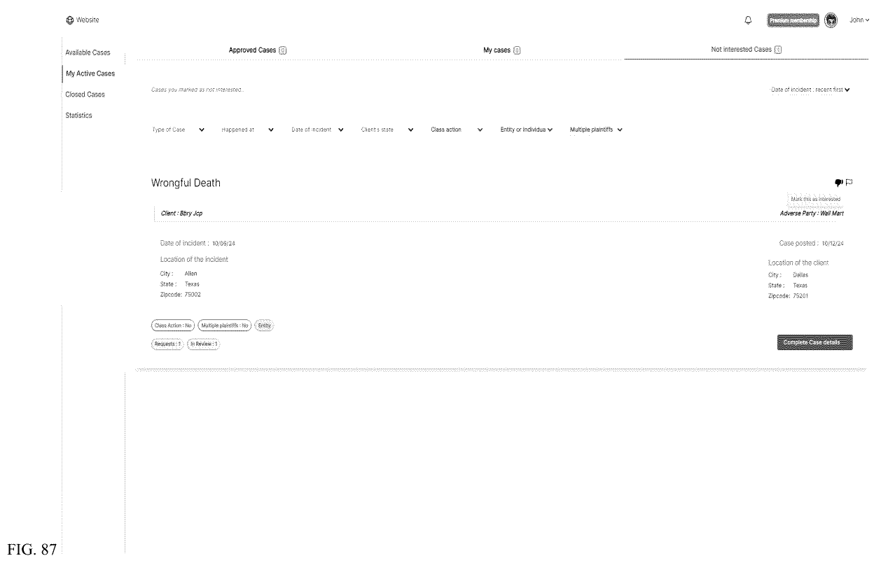

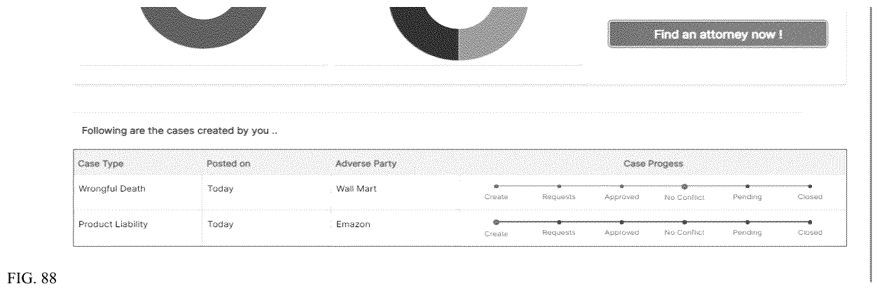

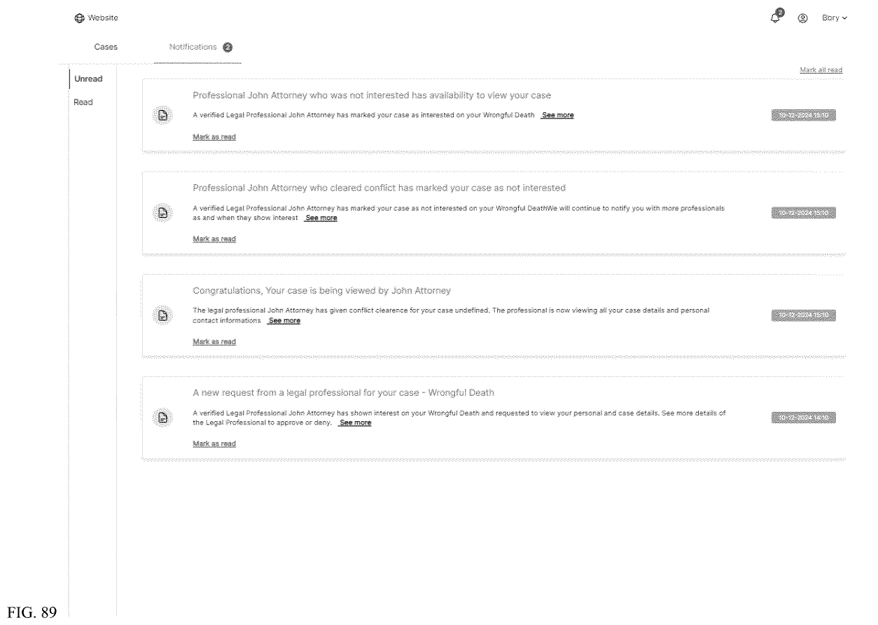

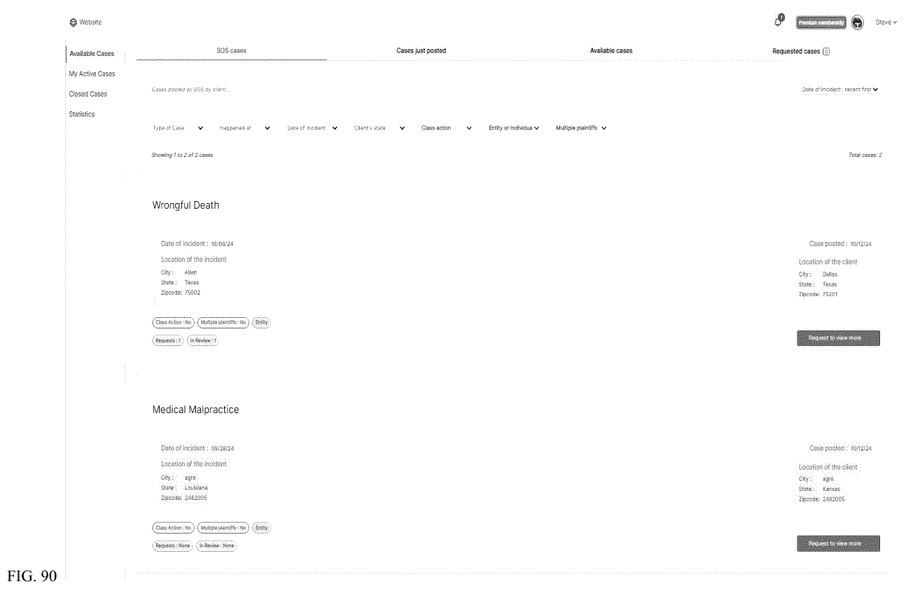

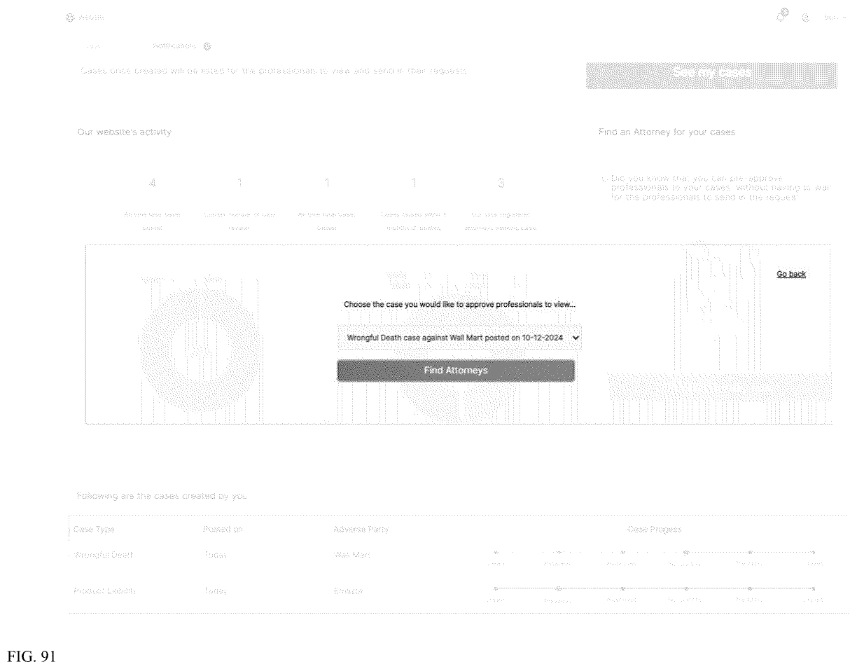

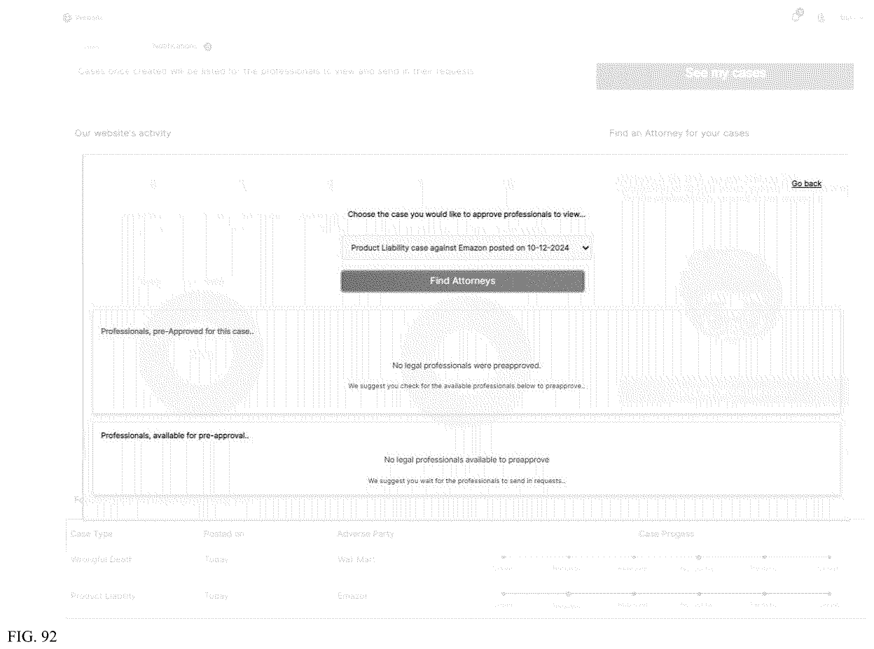

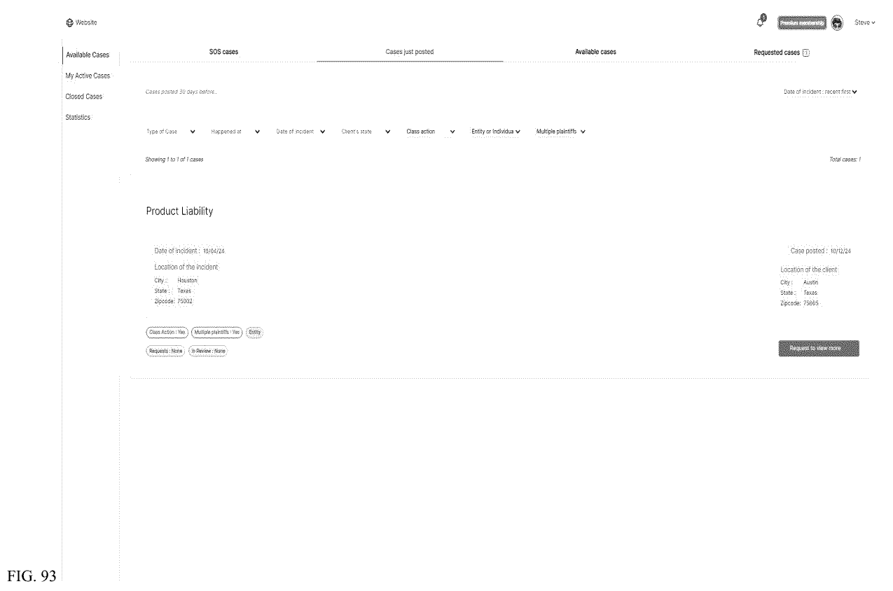

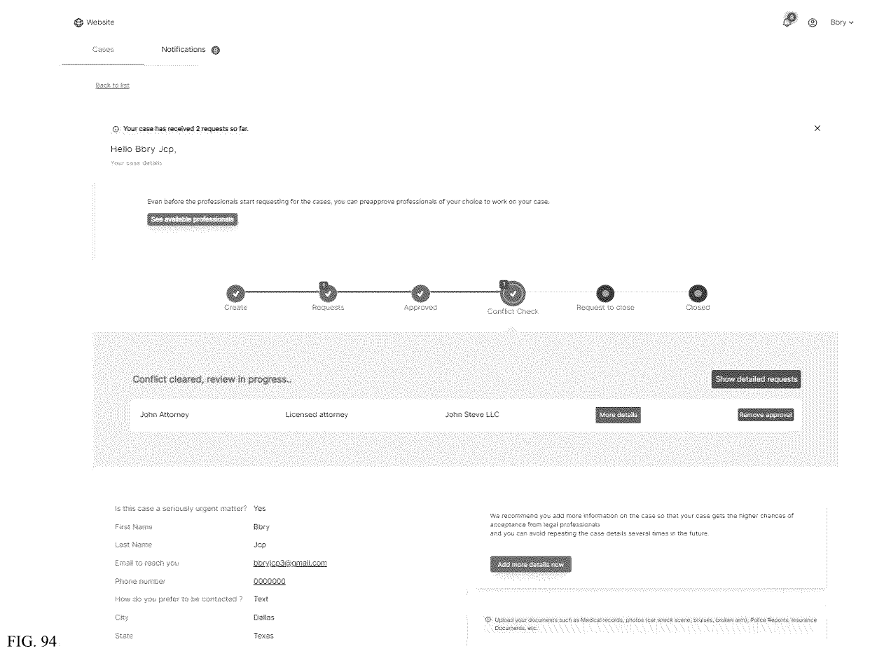

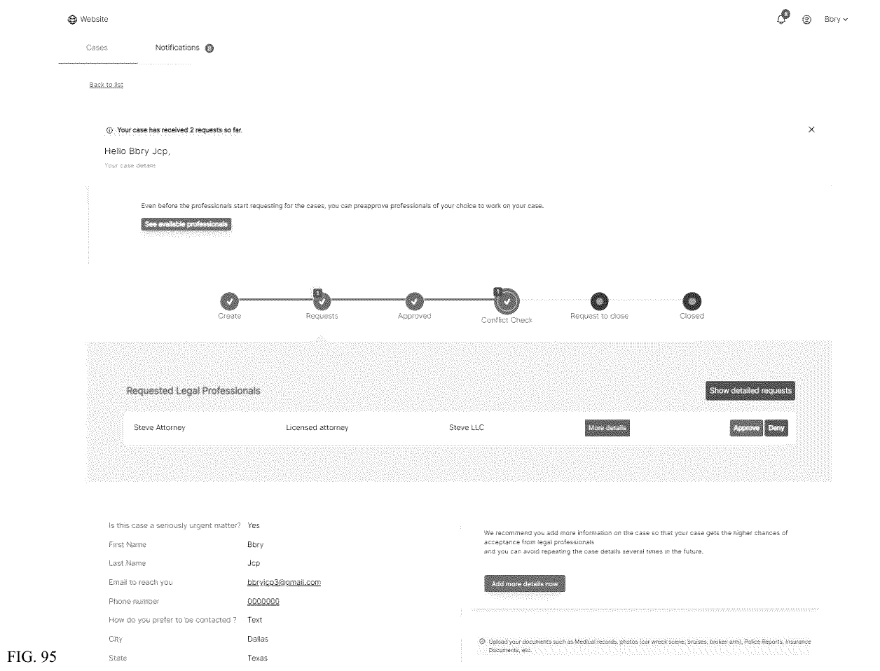

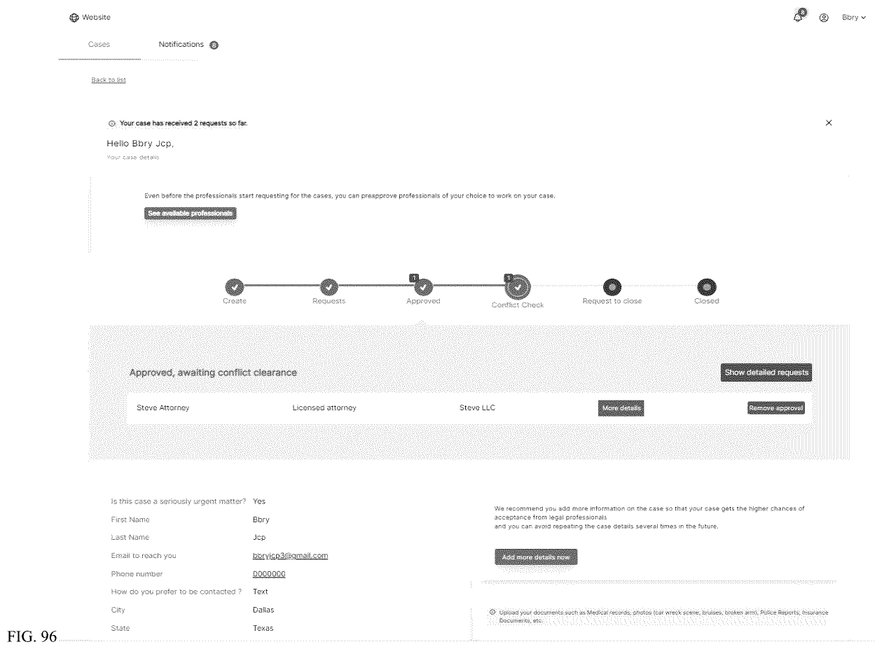

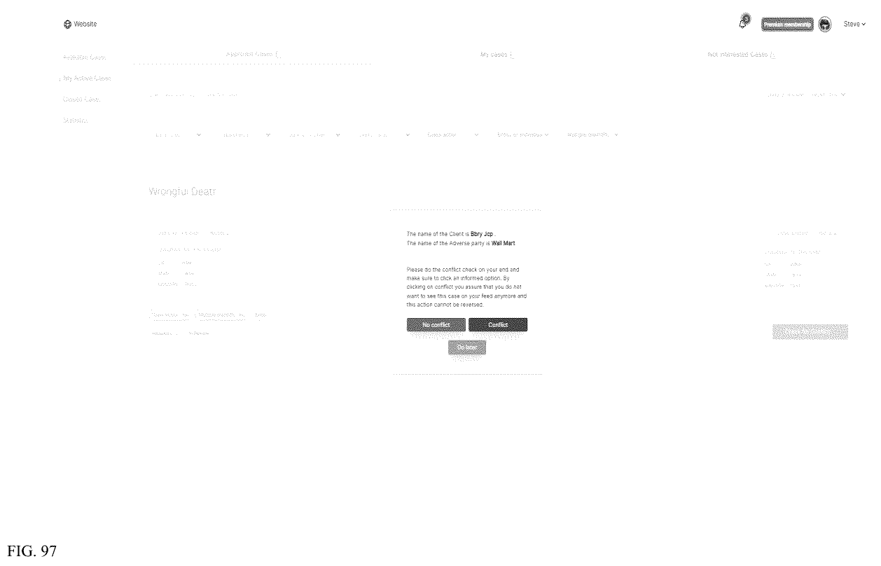

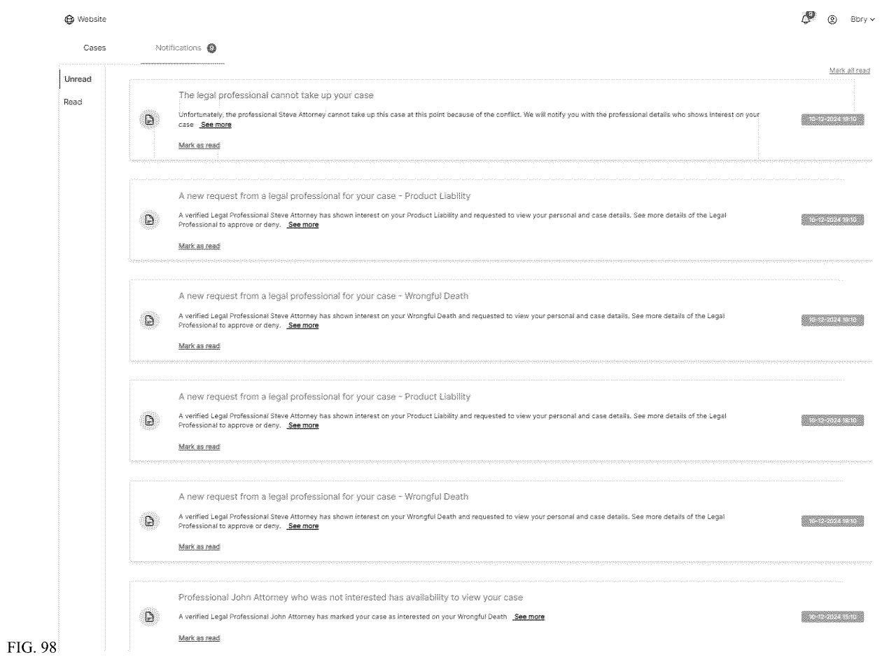

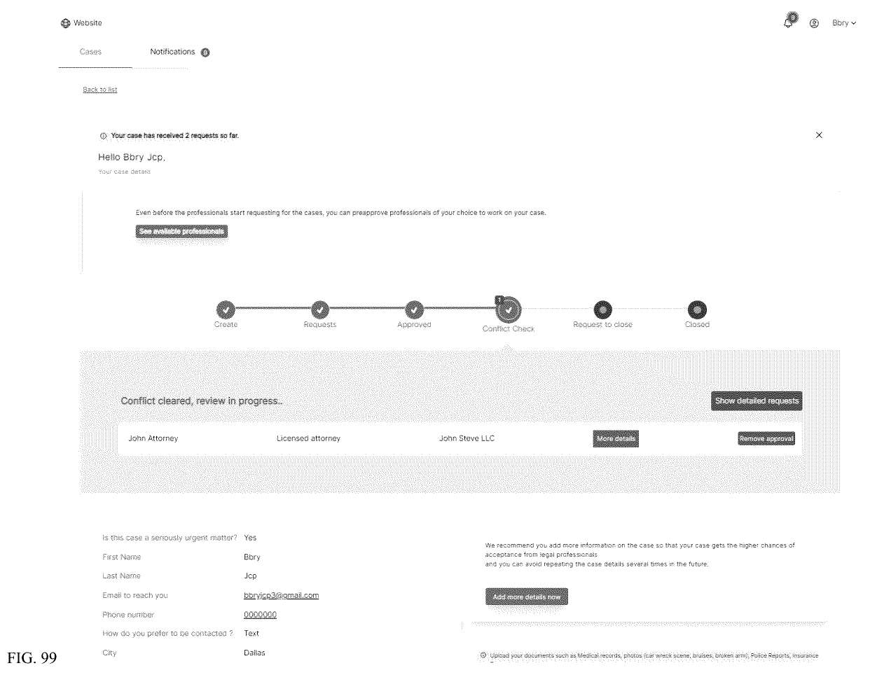

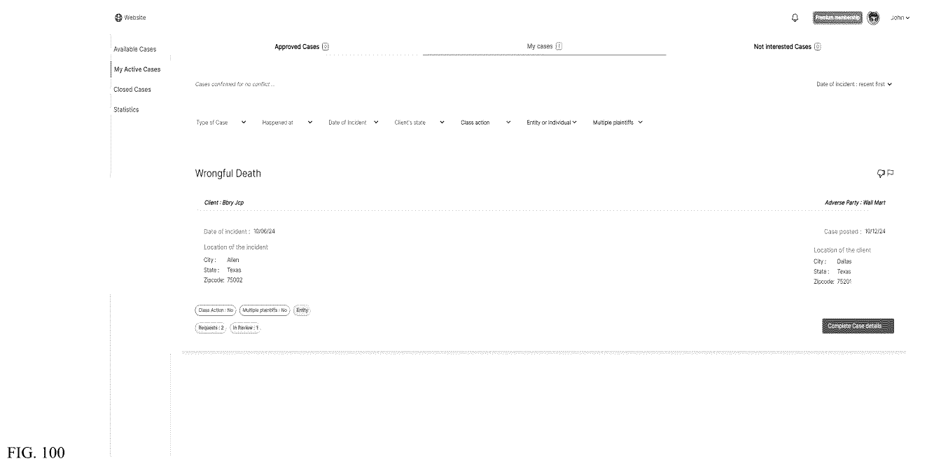

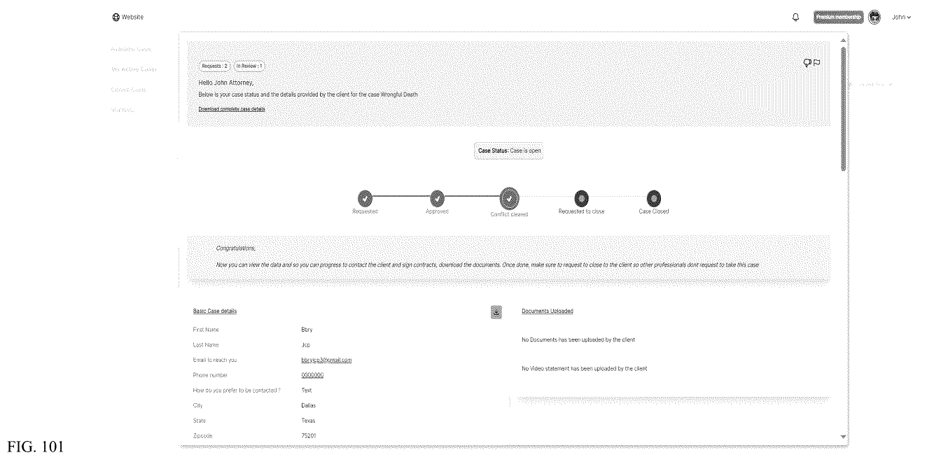

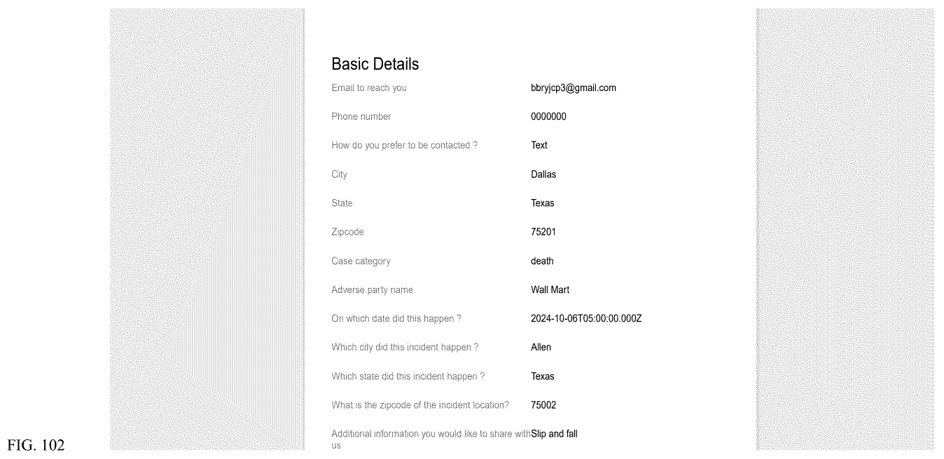

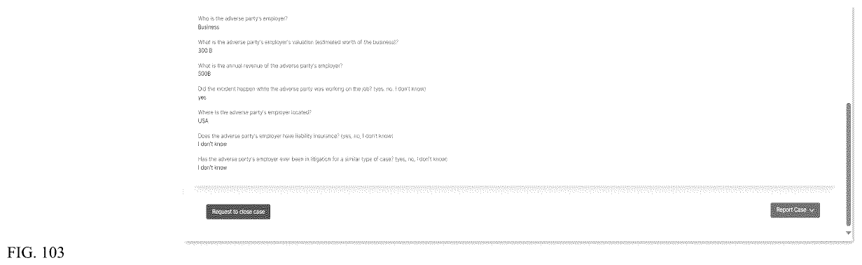

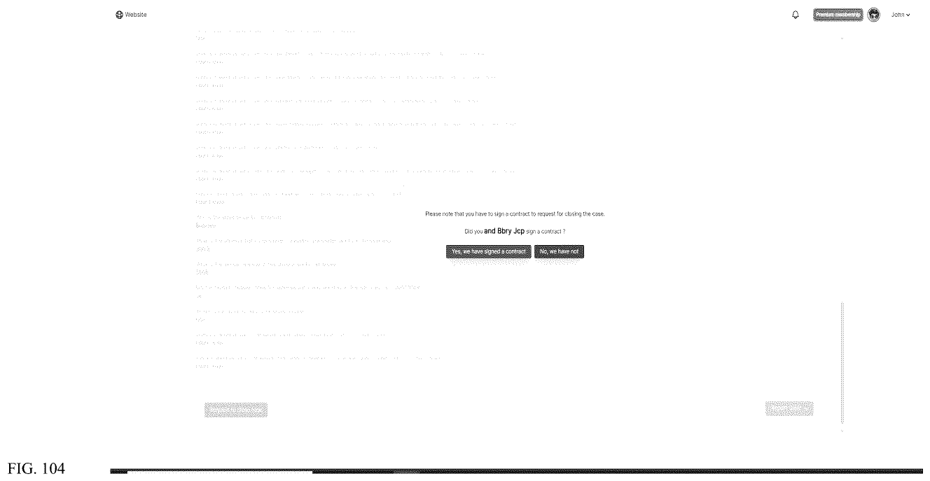

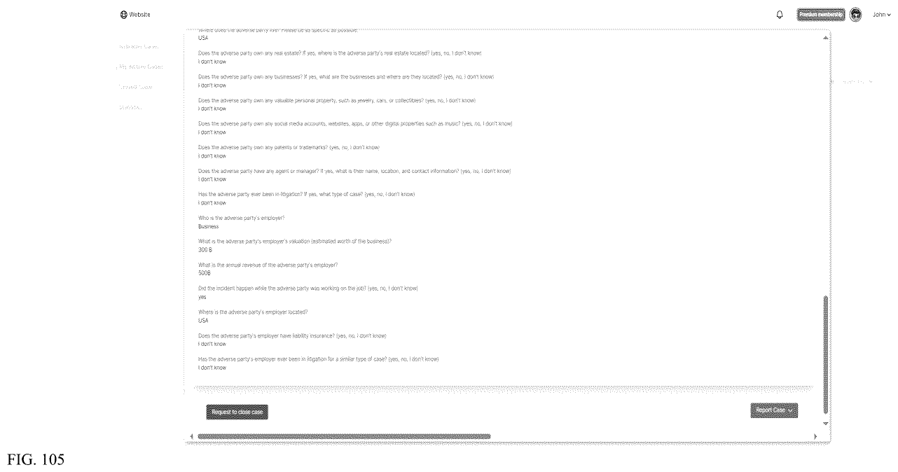

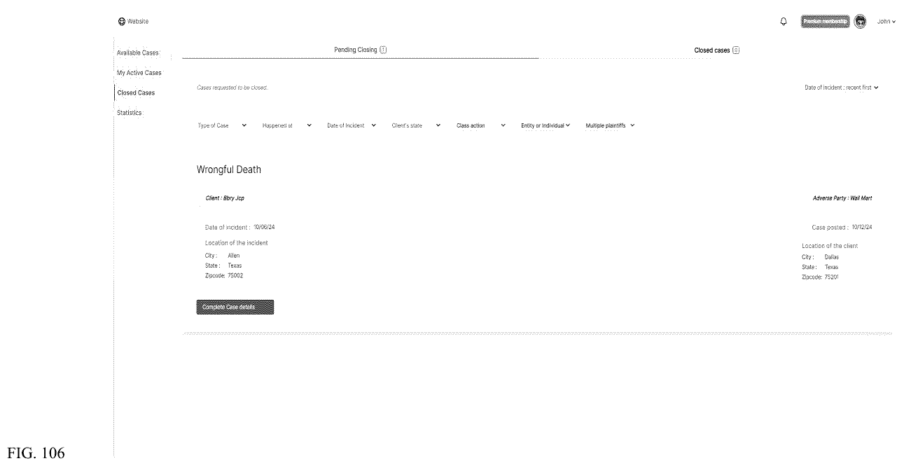

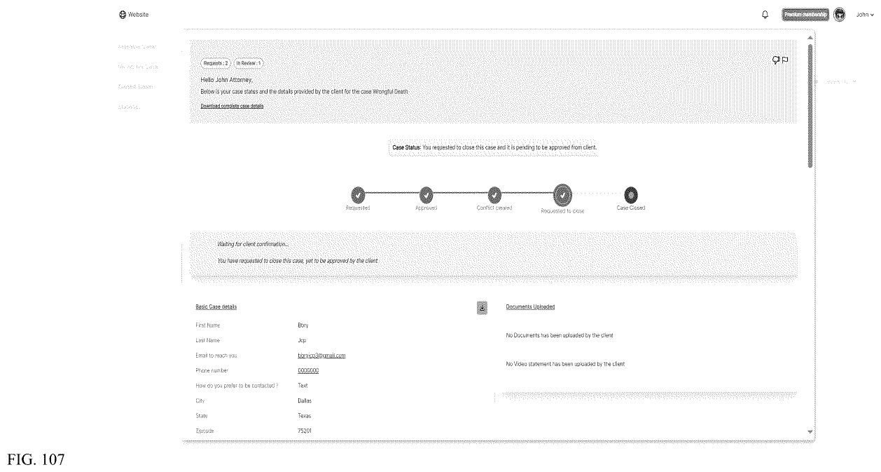

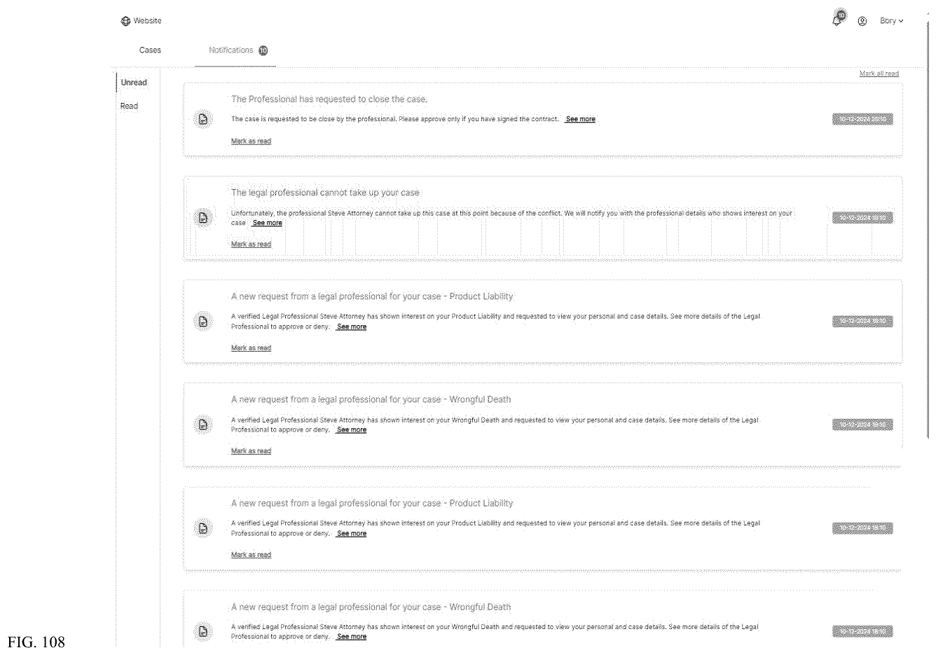

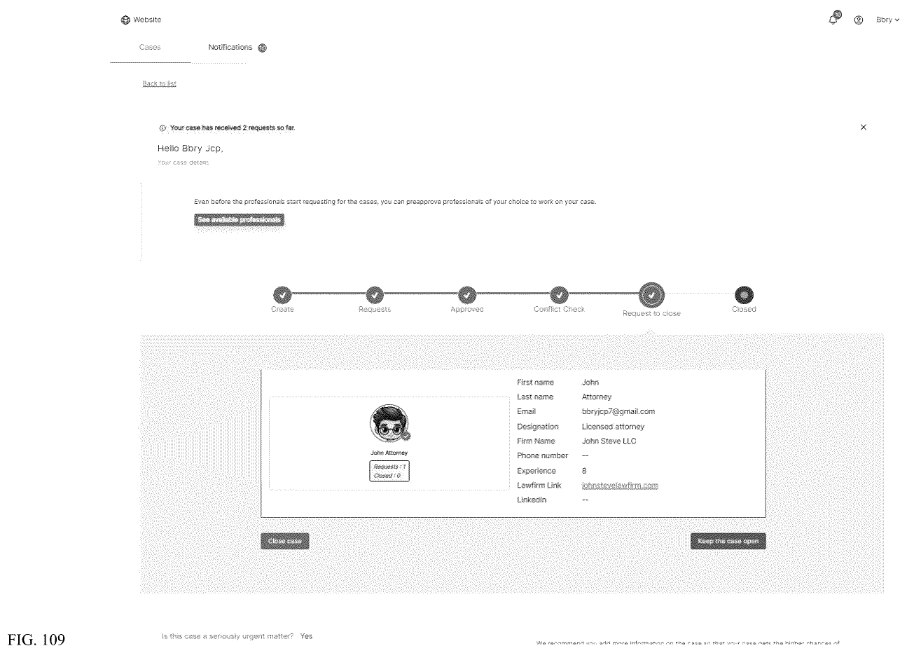

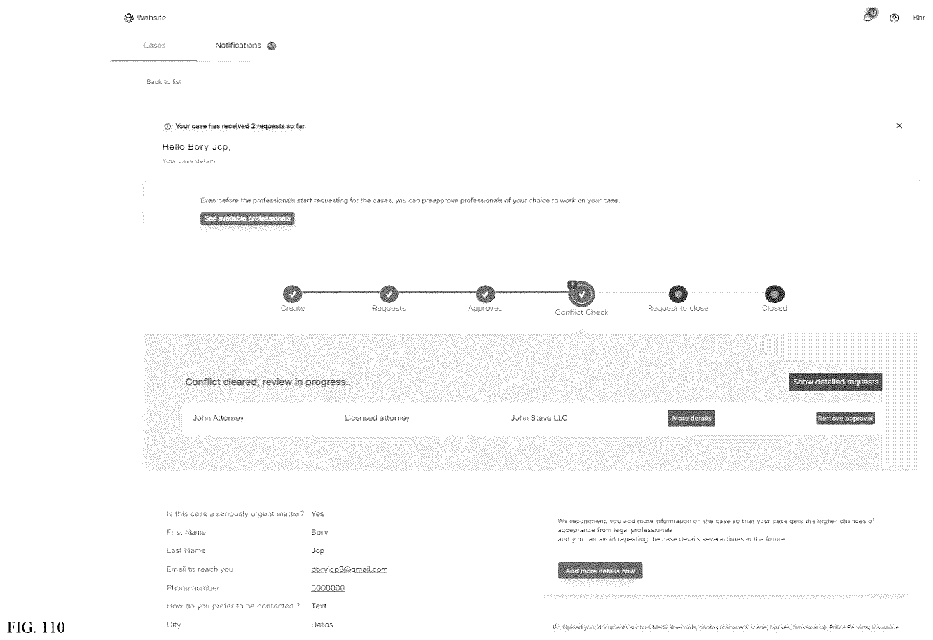

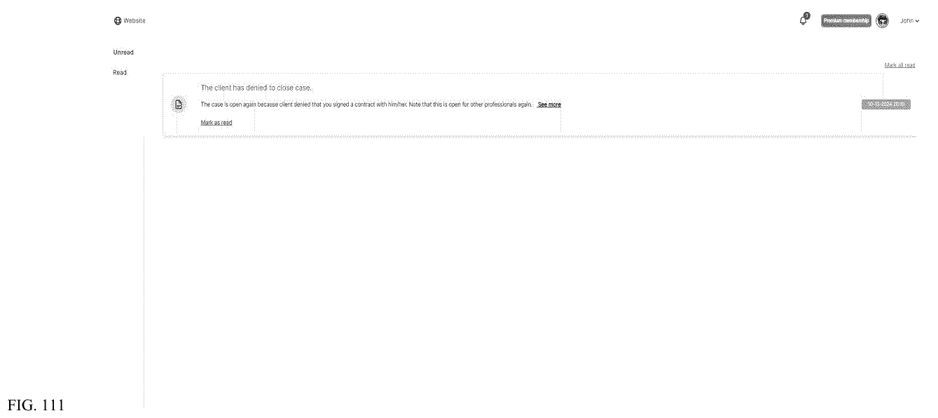

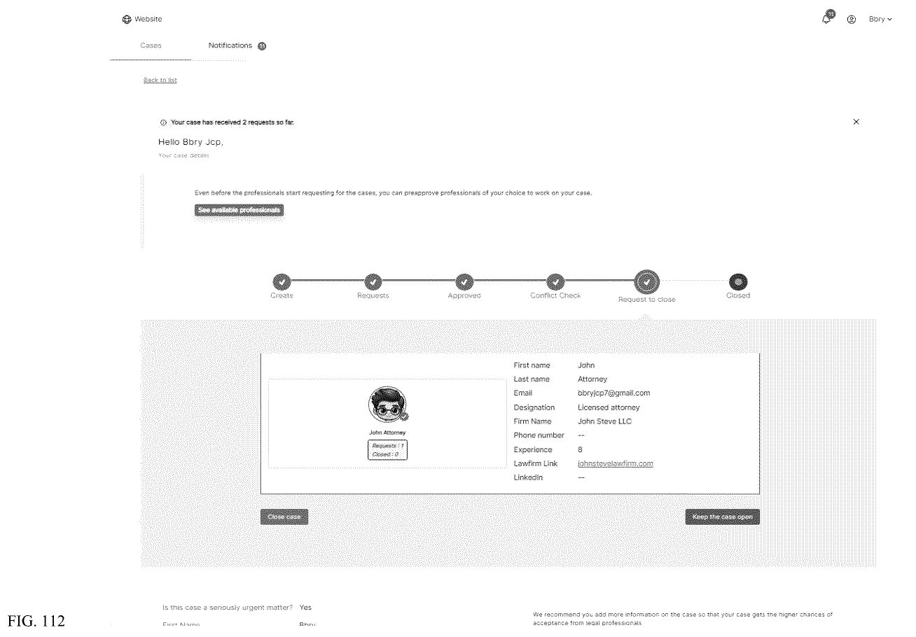

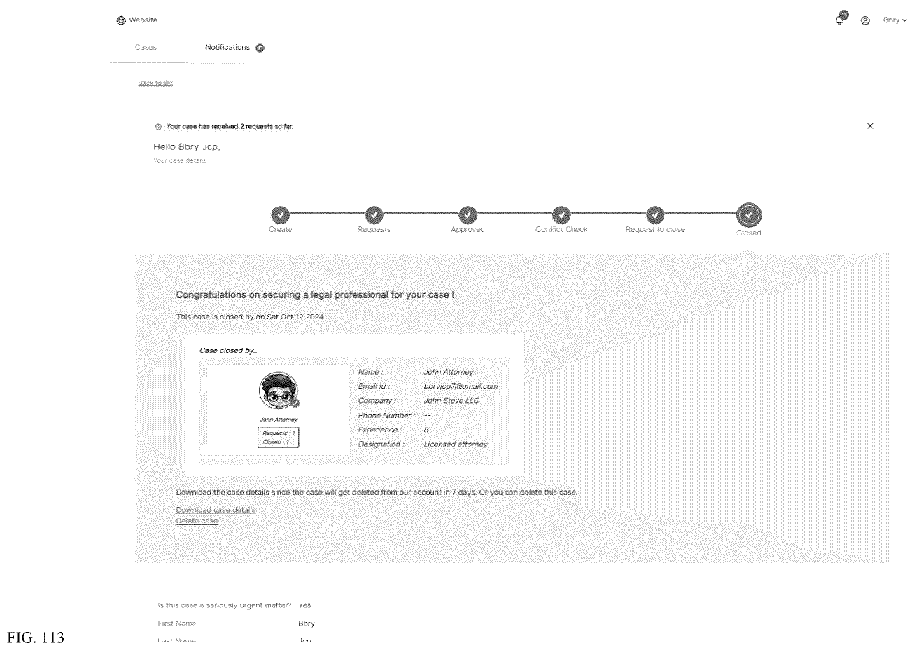

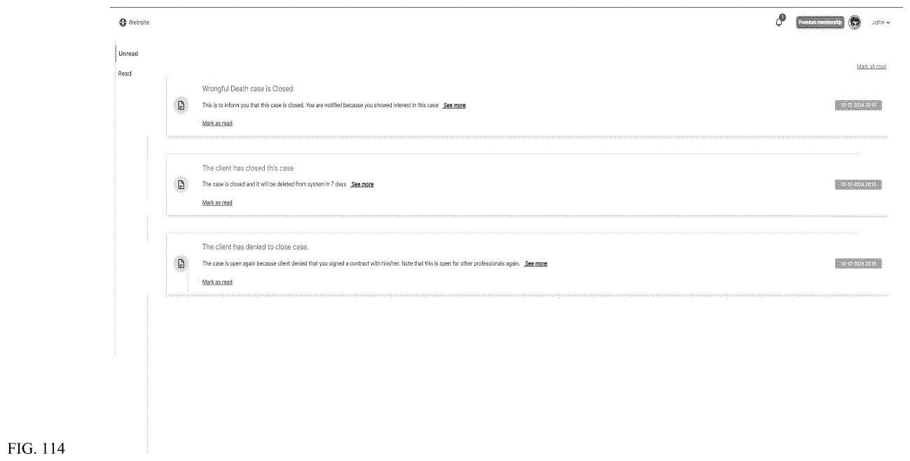

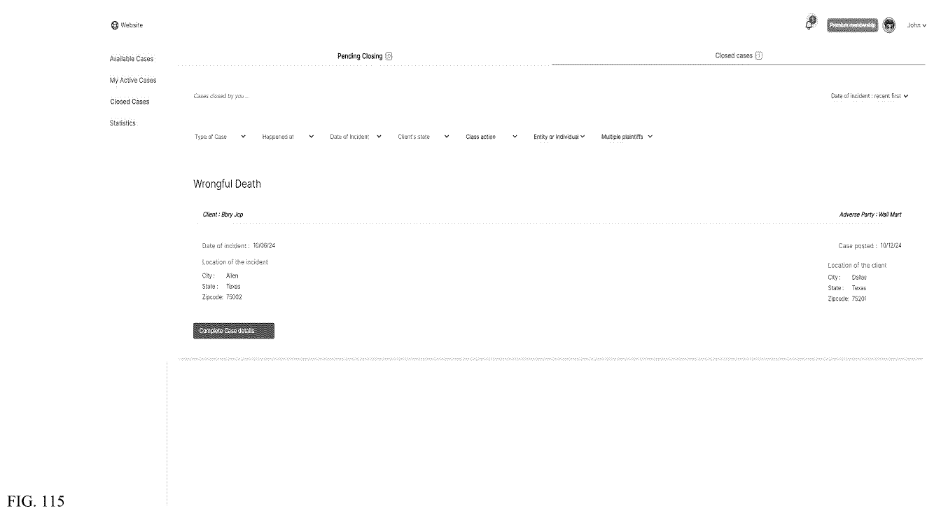

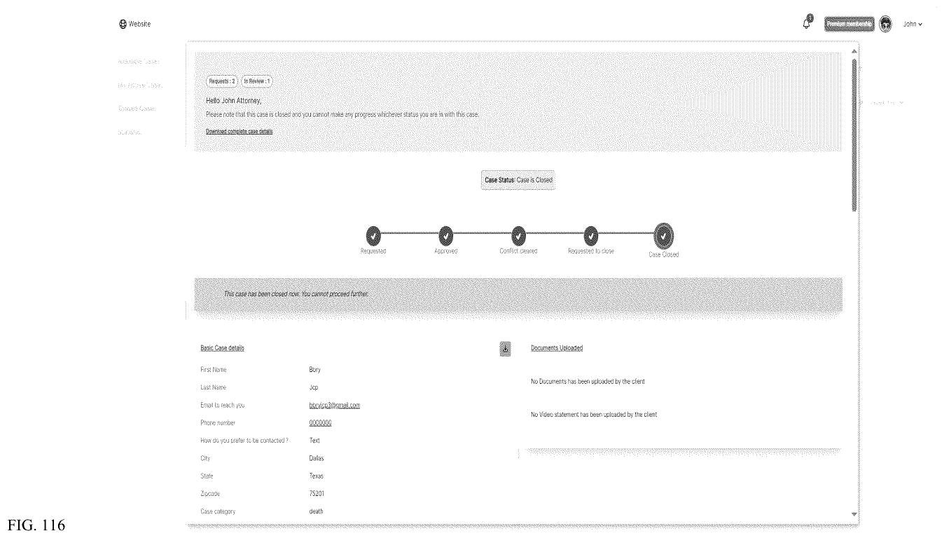

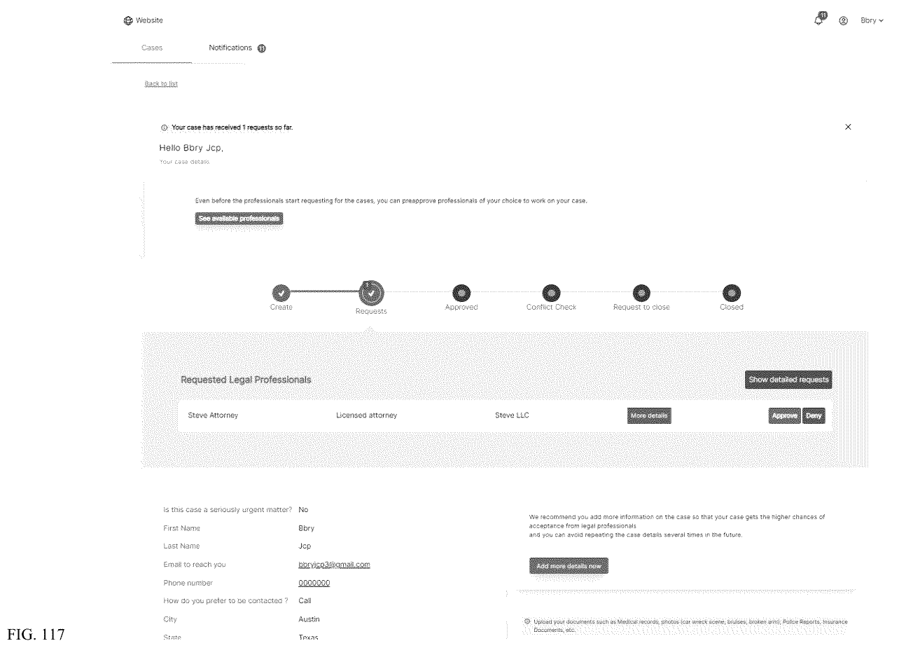

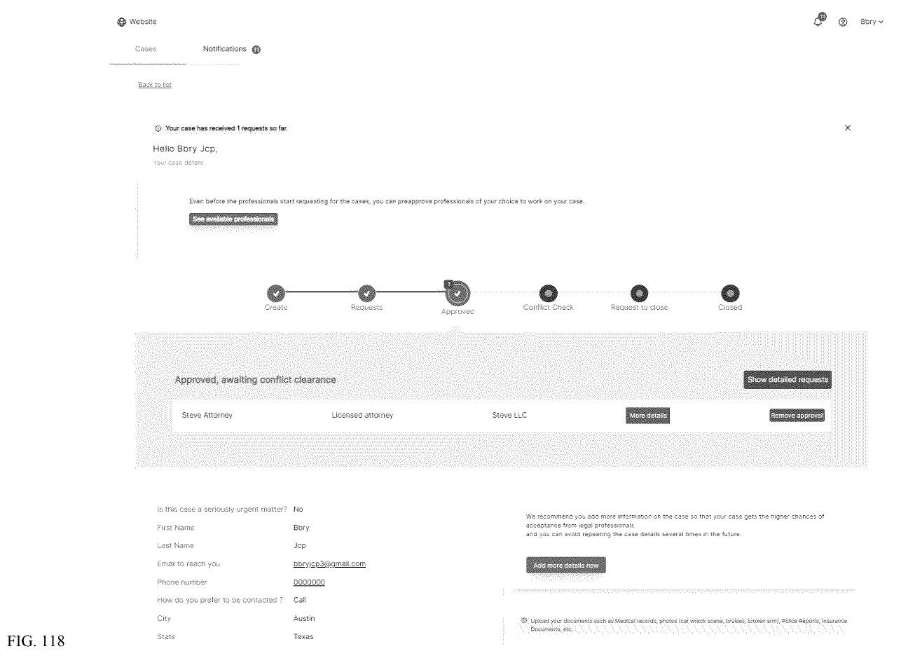

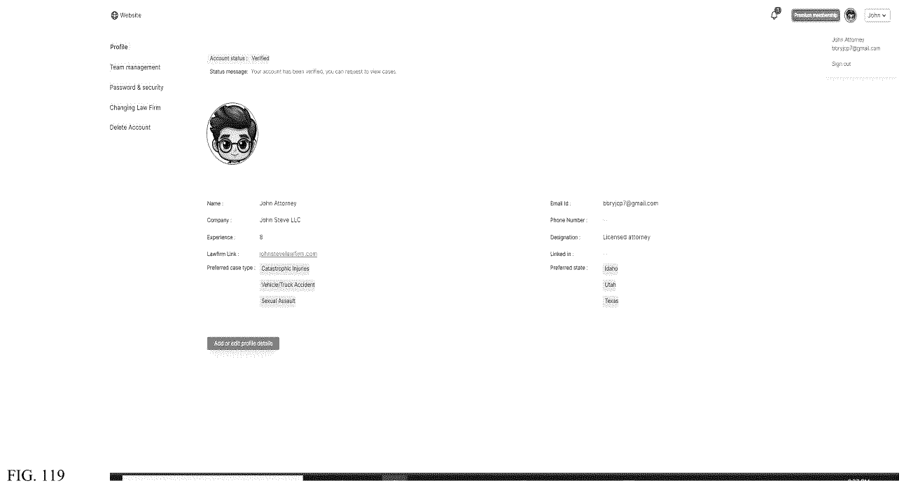

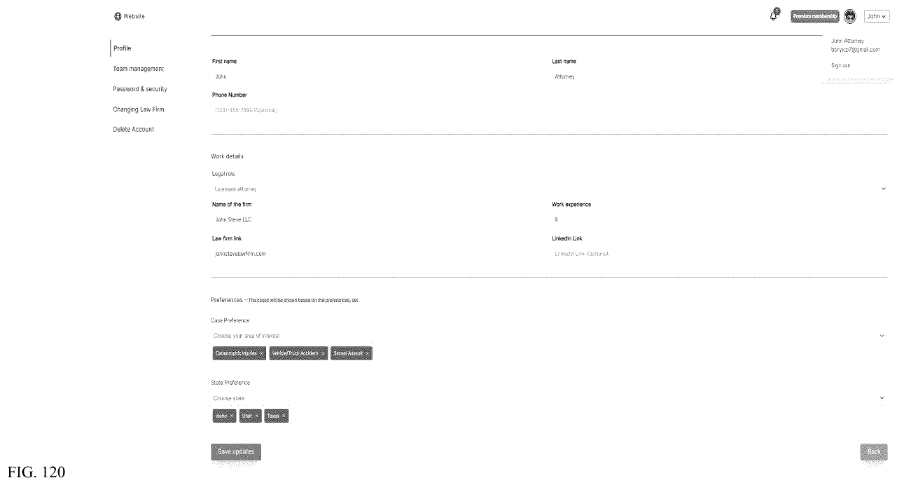

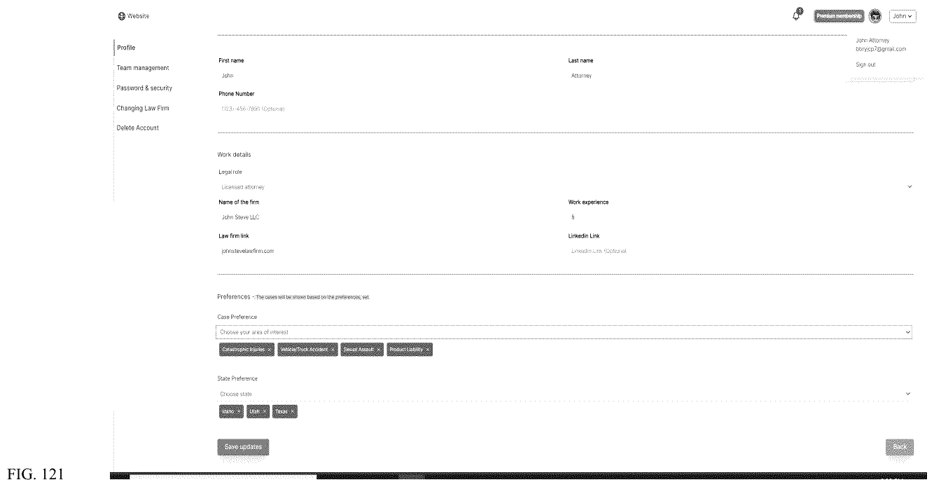

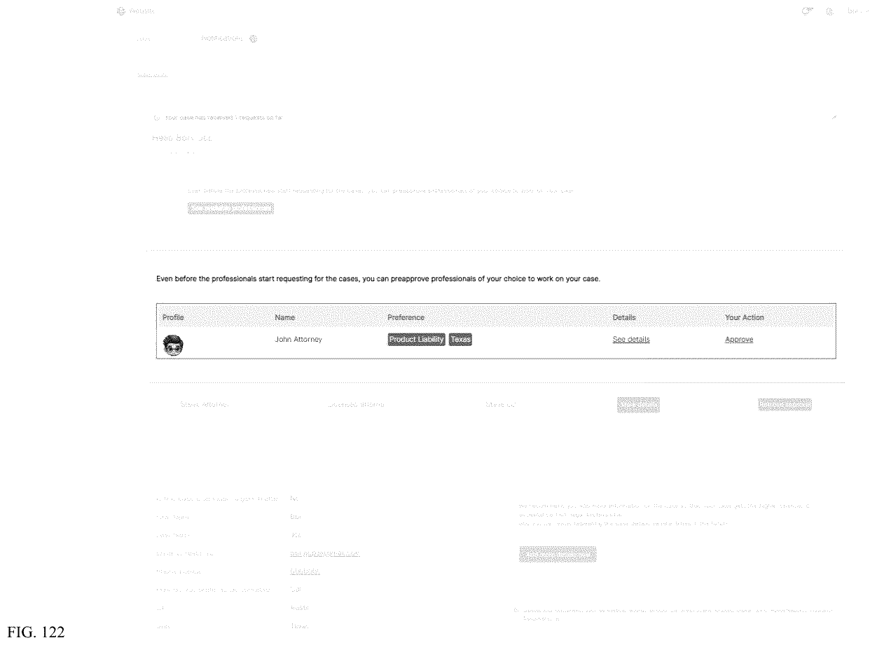

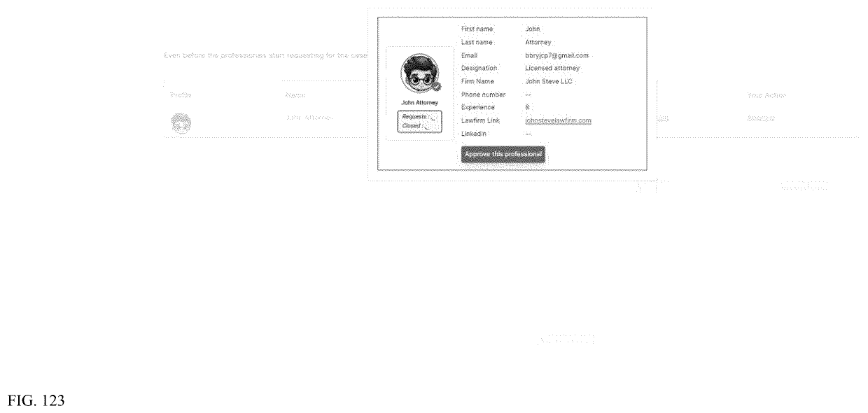

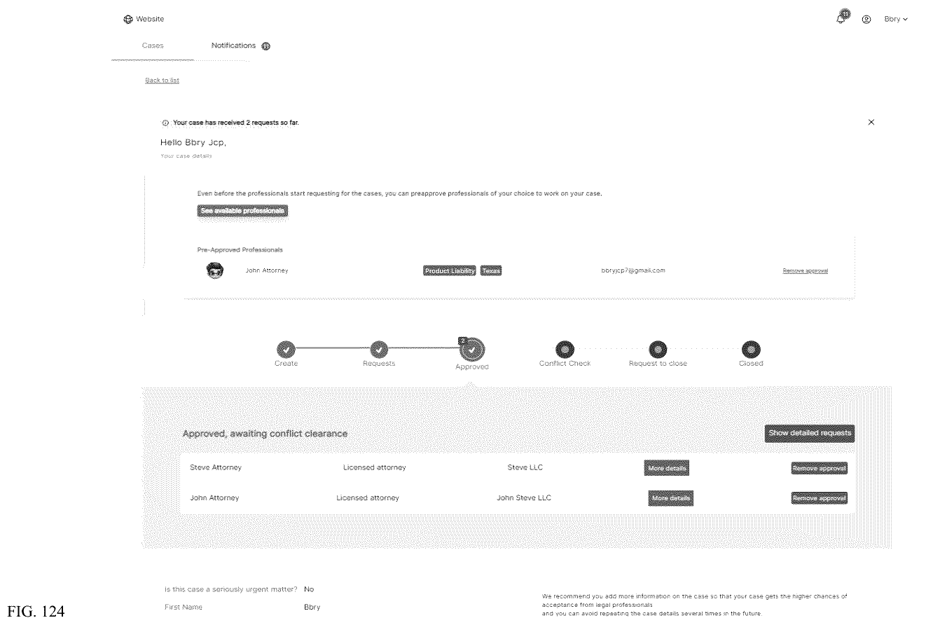

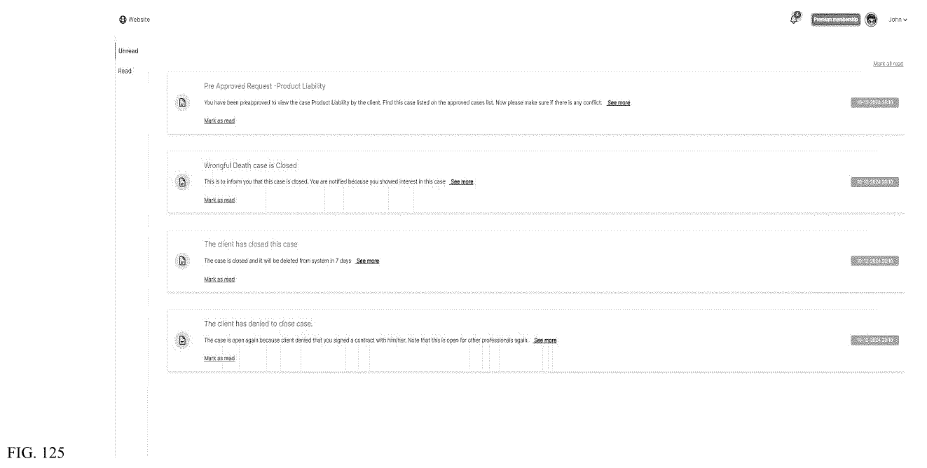

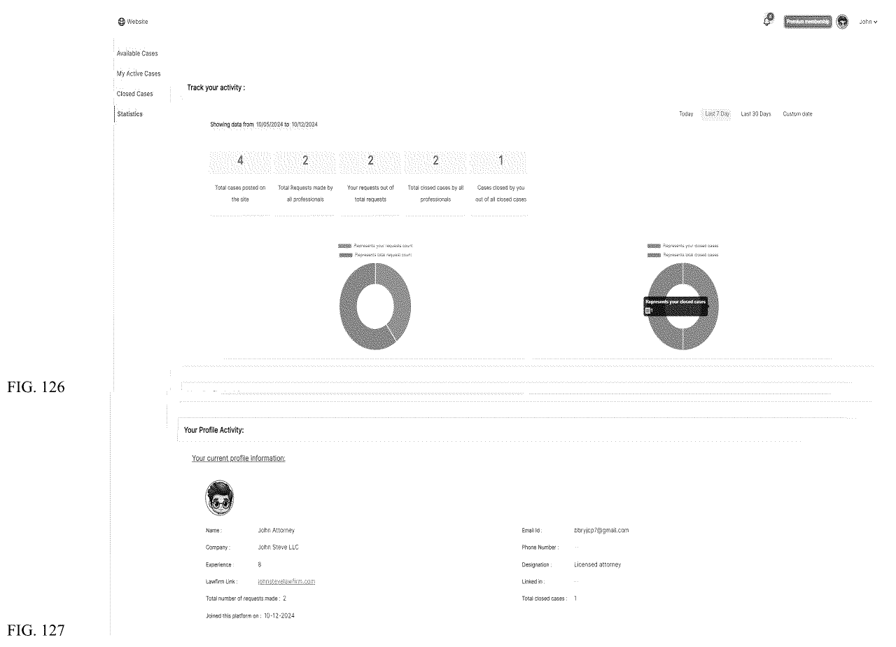

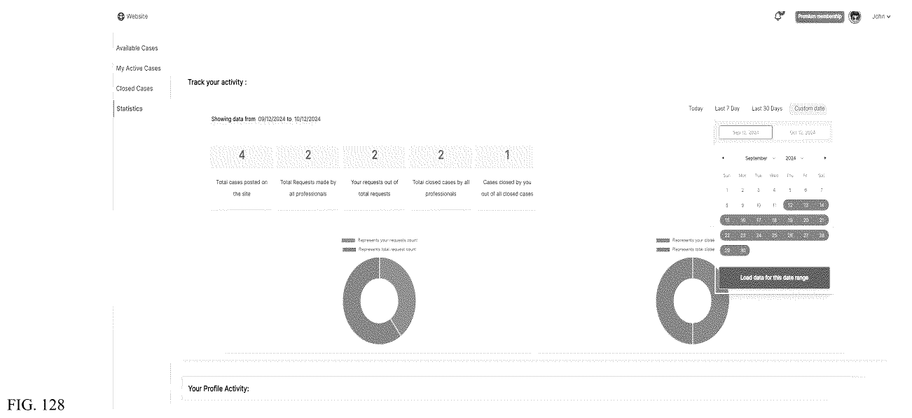

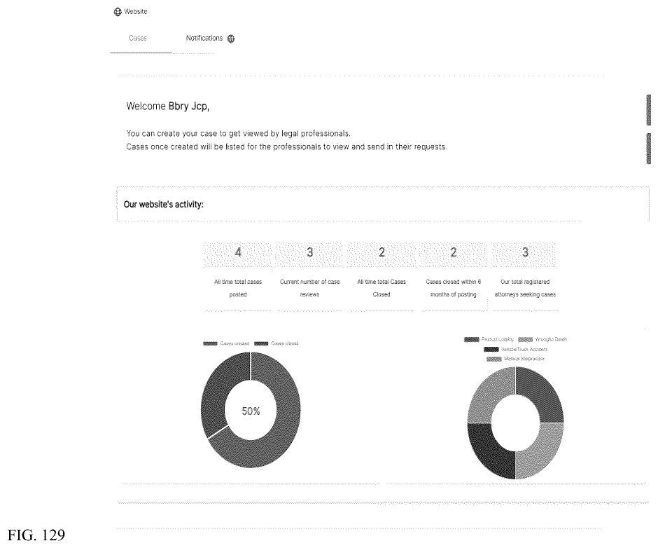

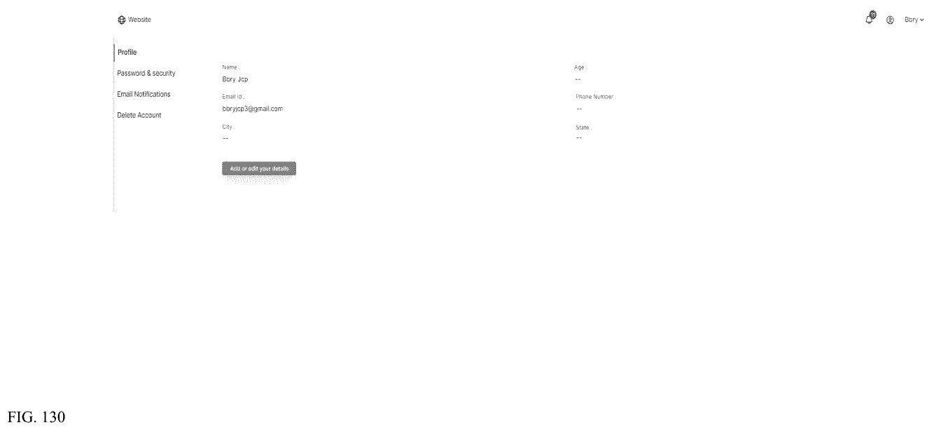

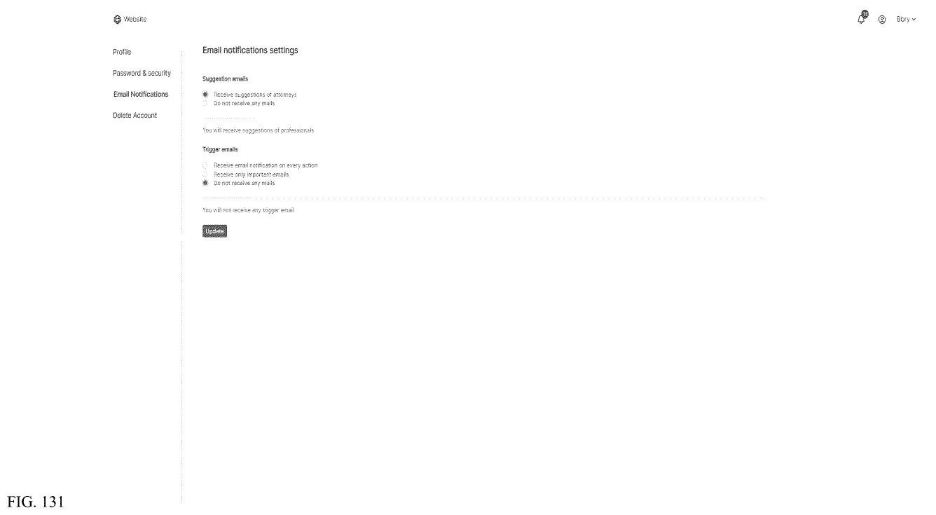

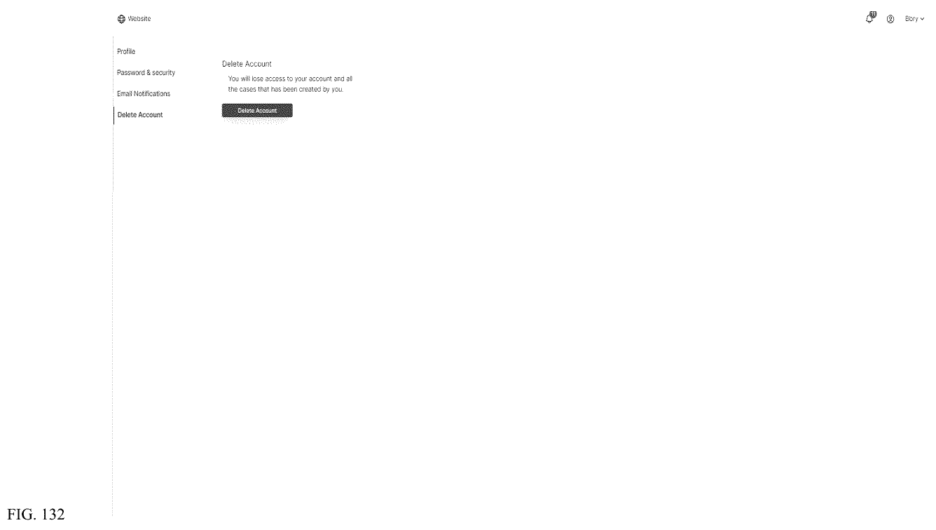

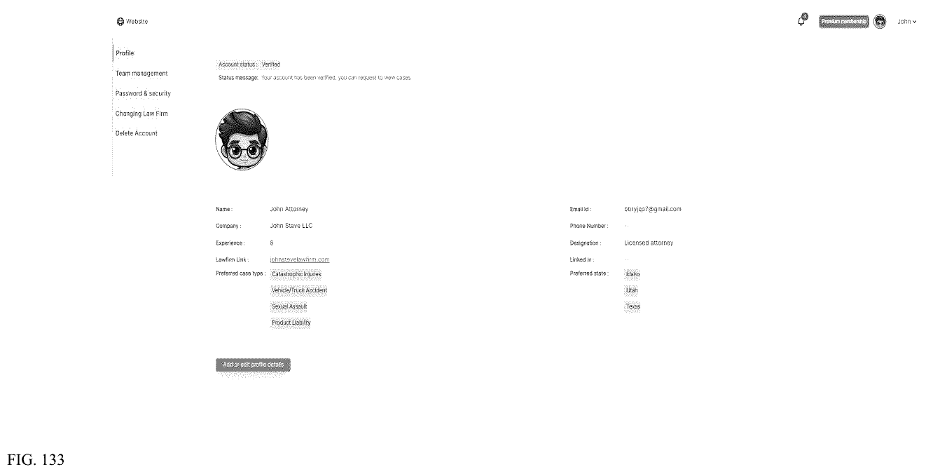

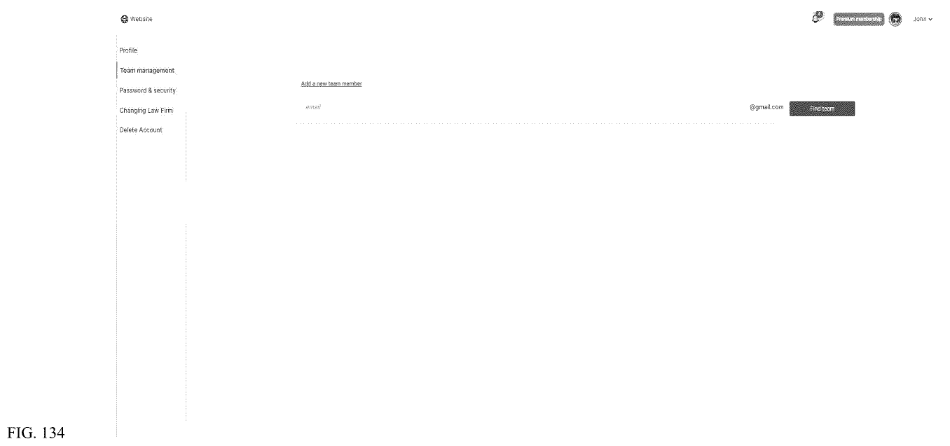

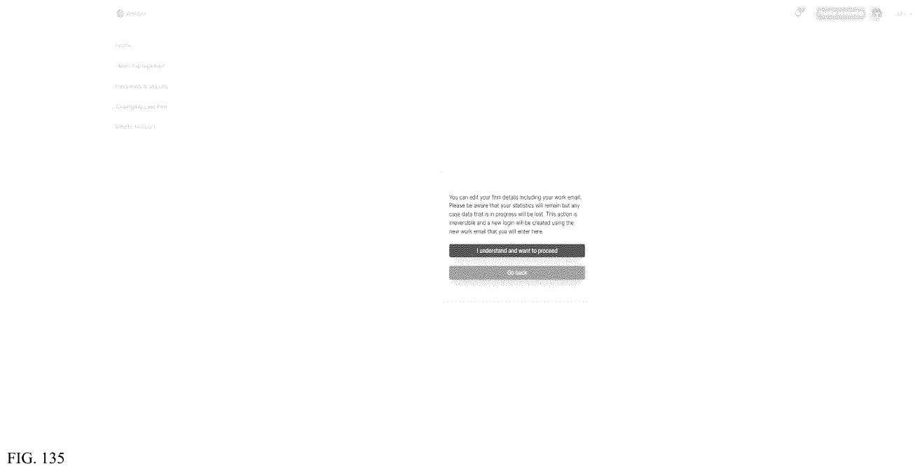

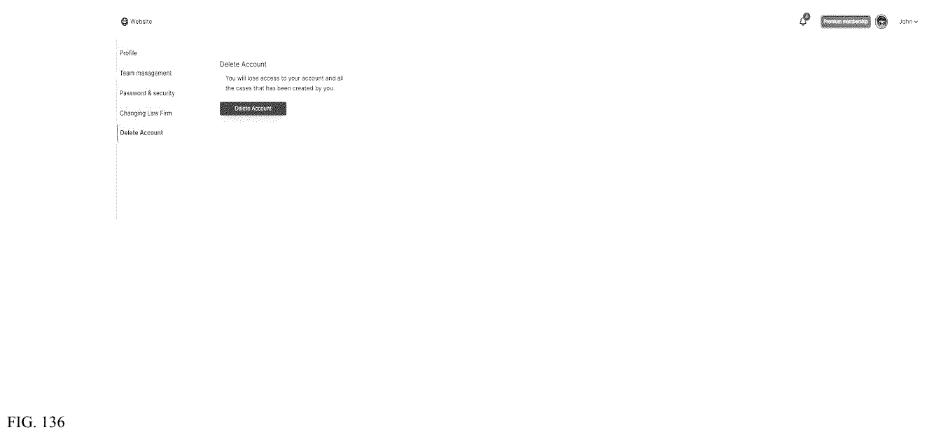

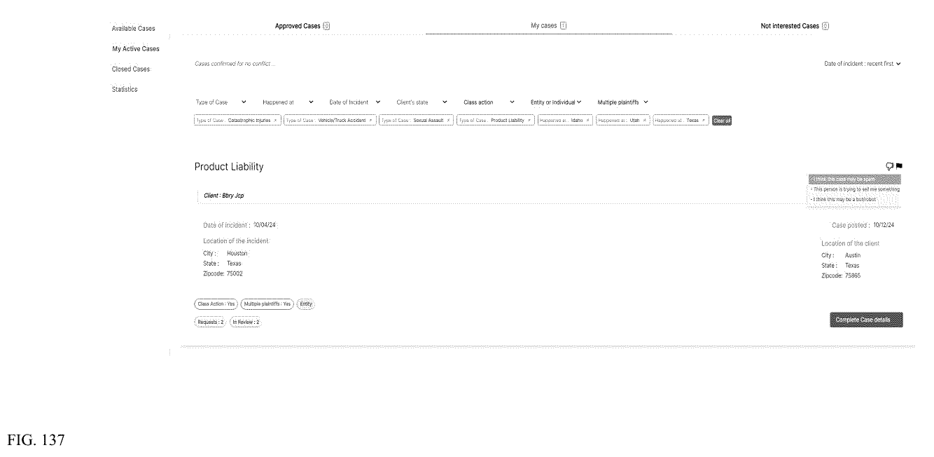

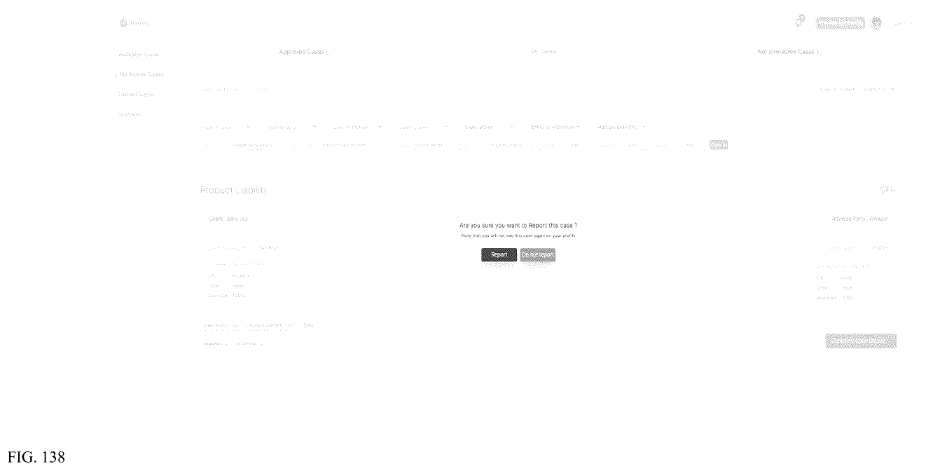

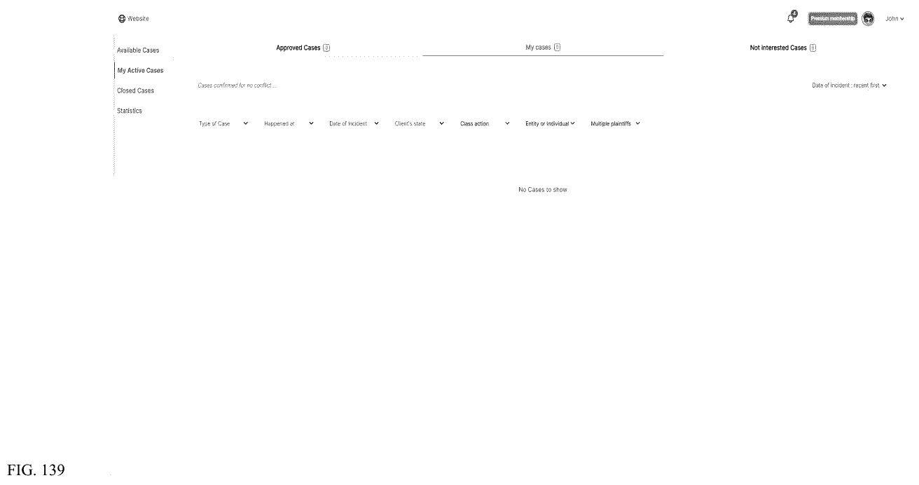

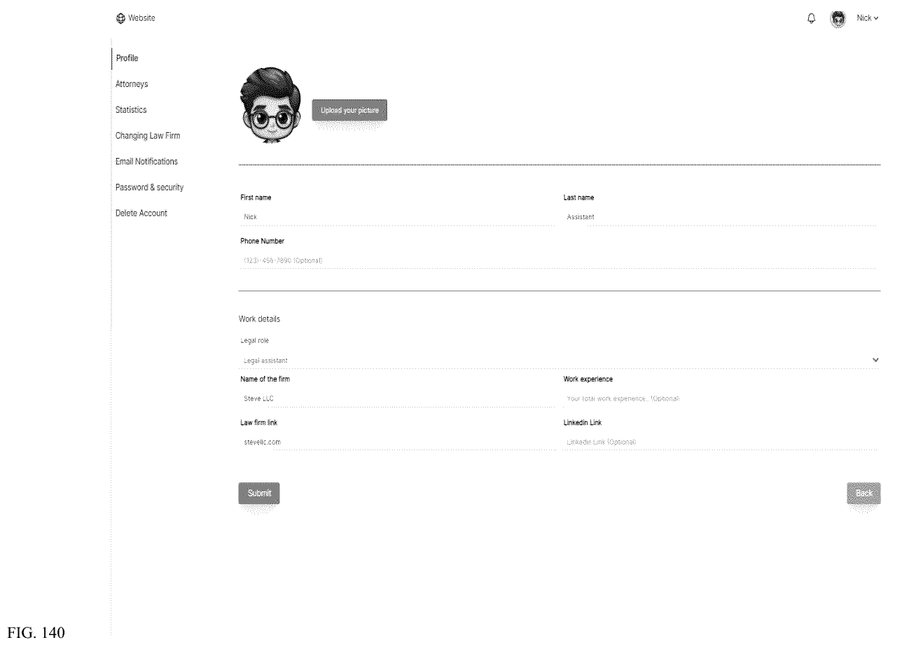

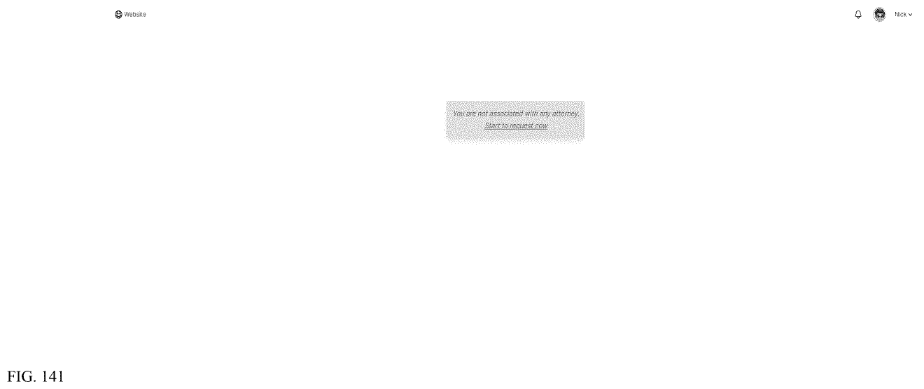

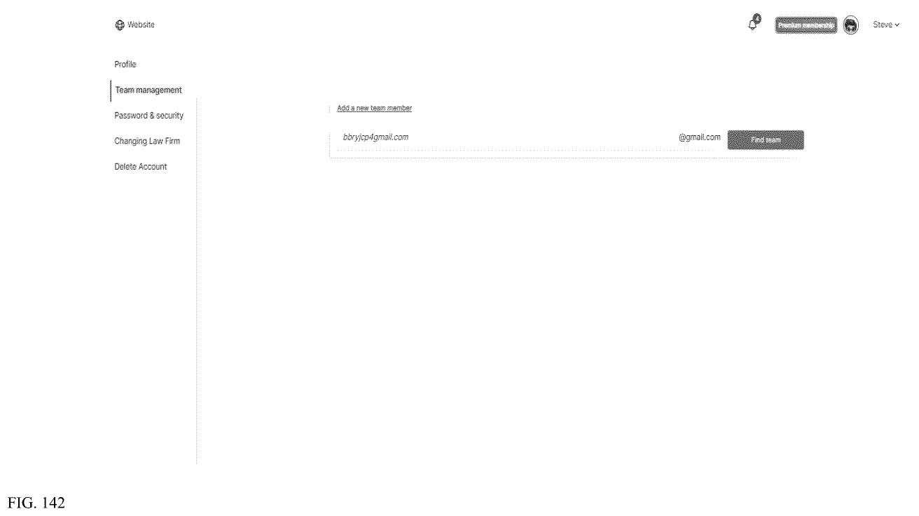

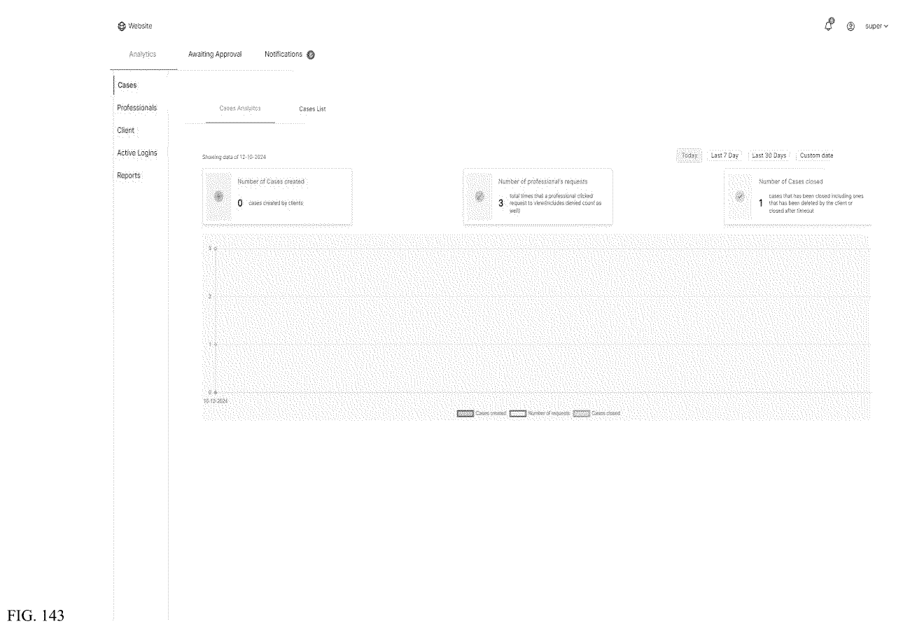

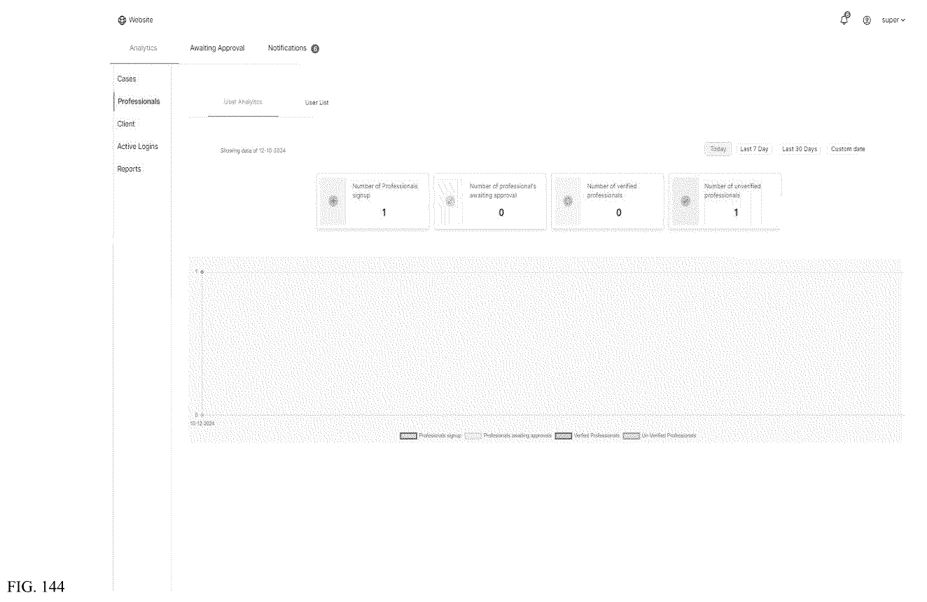

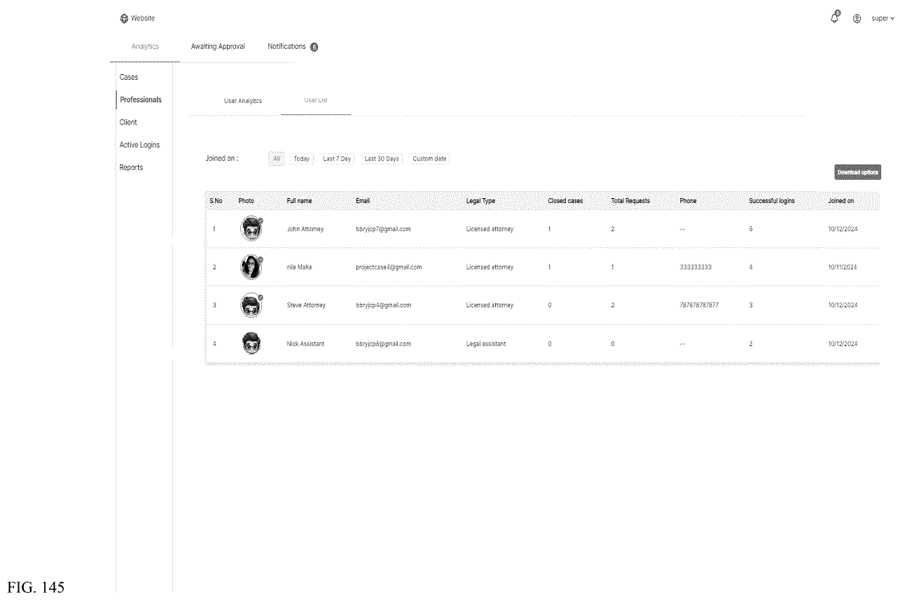

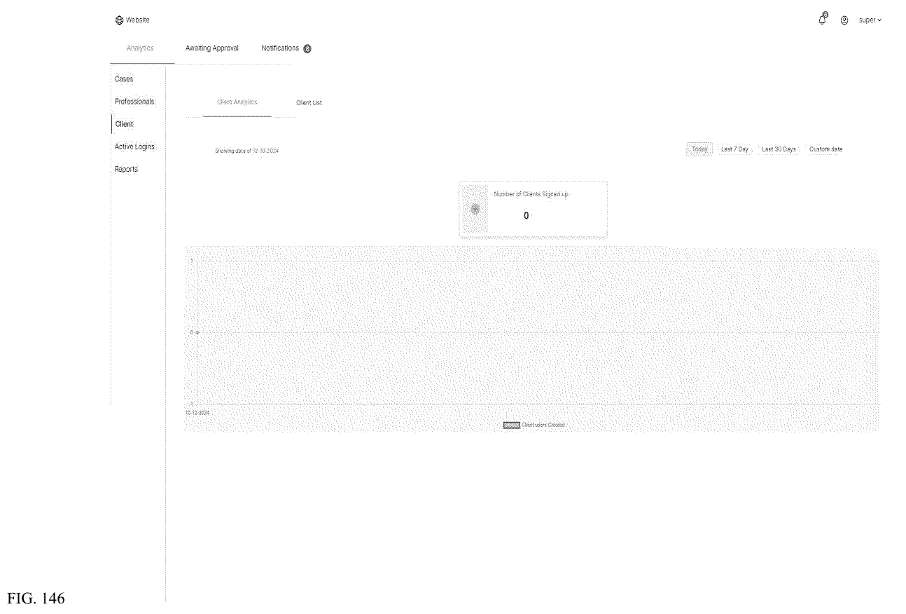

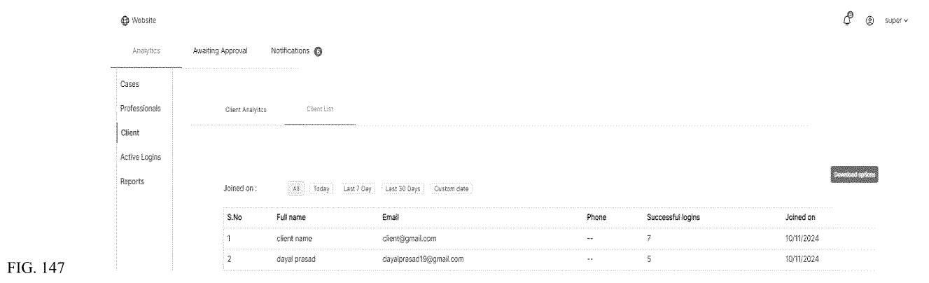

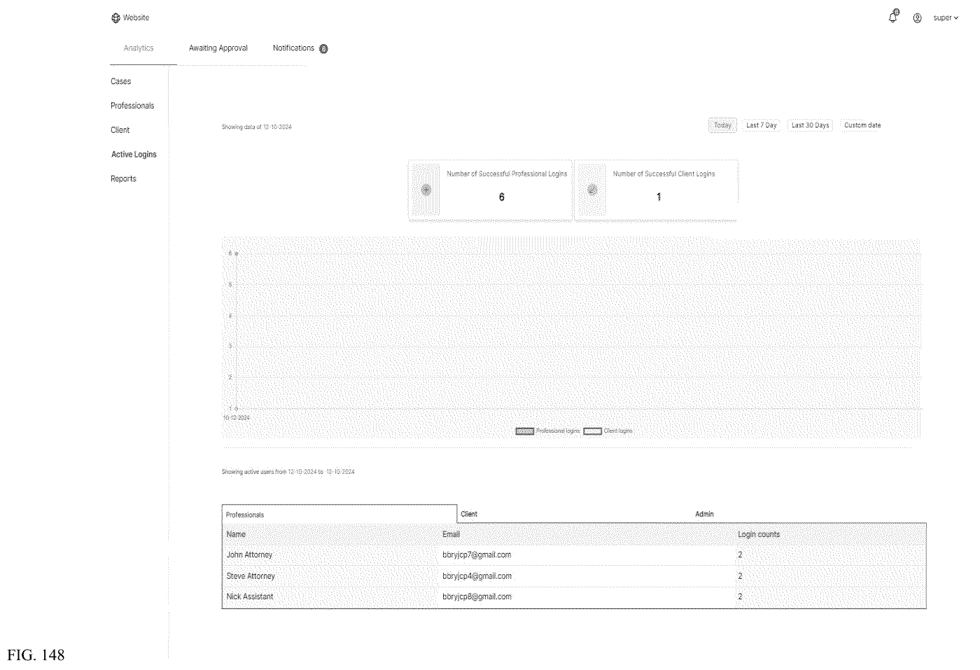

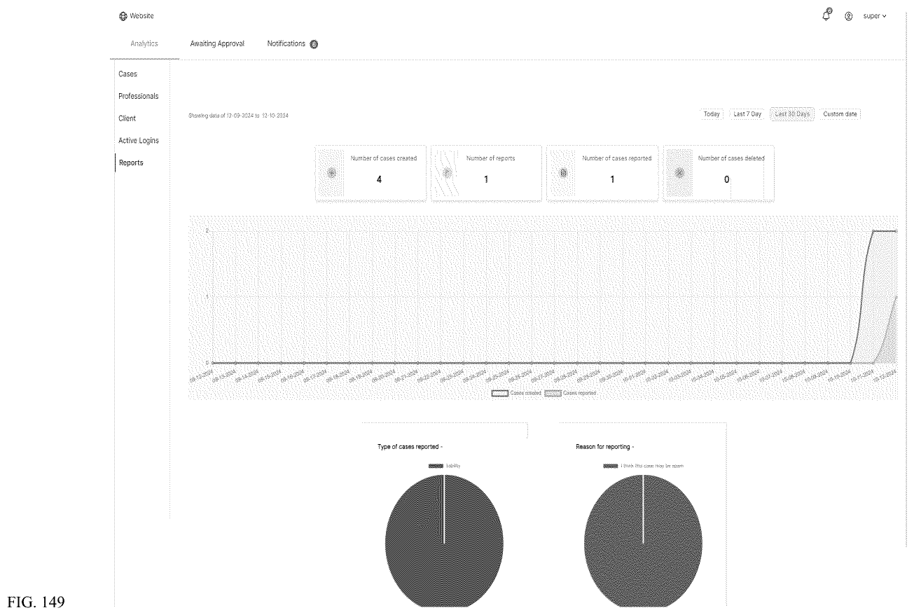

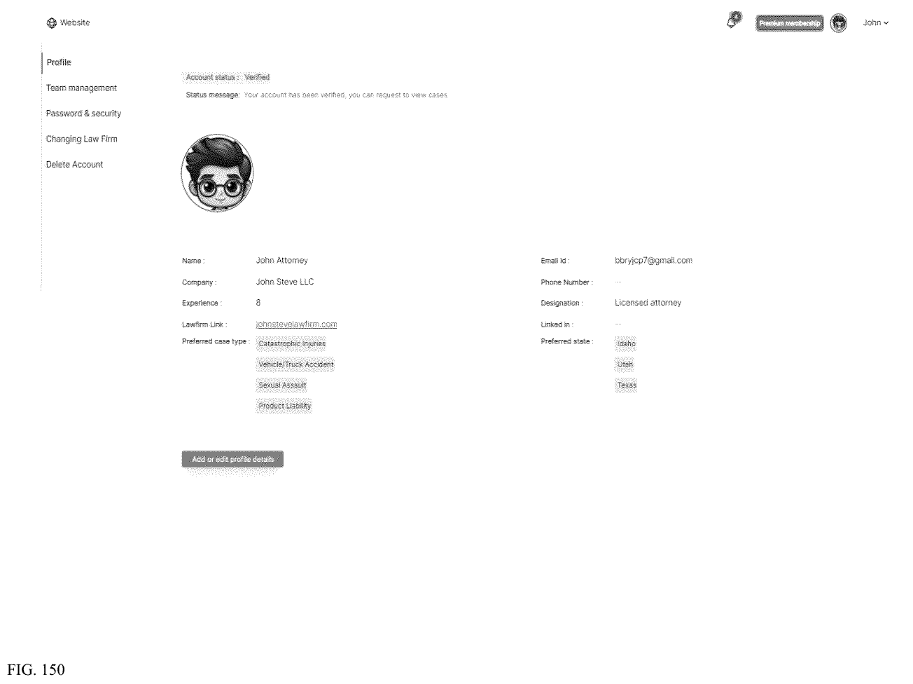

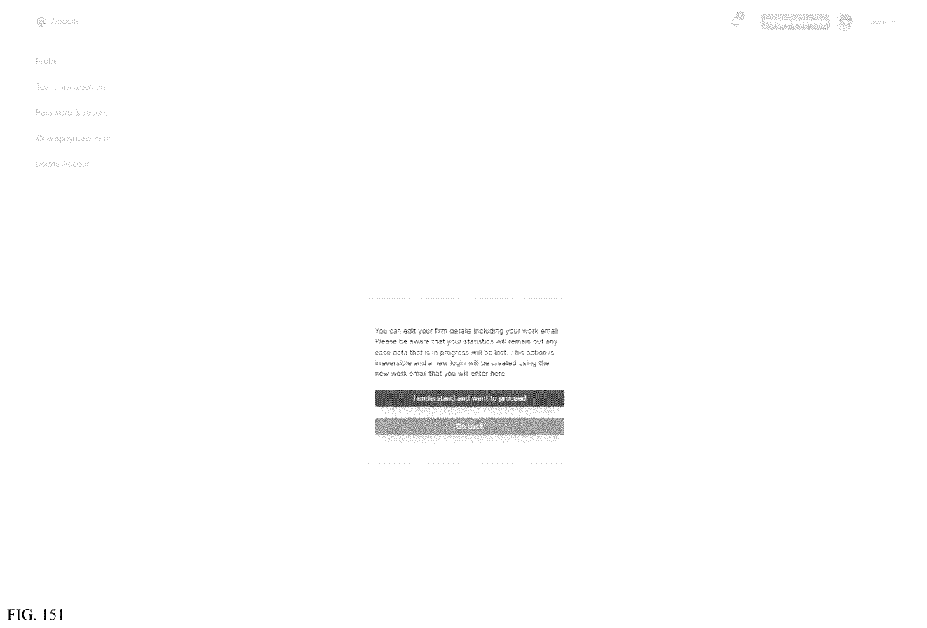

In some embodiments, any computing device, system, or apparatus described herein may be a mobile or non-mobile computing device, a mobile phone, laptop, tablet, watch, e-reader, headgear, eyewear, a front-end or back-end server, etc. Any computing device may have voice and data capabilities. In some embodiments, the term “data” may refer to “signal” or “information.” In some embodiments, the terms “signal,” “data,” and “information” may be used interchangeably. Any reference to data may also include references to the contents of the data. Any signals described herein may be electronic or electromagnetic signals. Additionally, any signals described herein may be either be transitory or non-transitory signals. Additionally, any signals described herein may be analog signals, digital signals, and/or mixed analog and digital signals. The terms “system,” “apparatus,” “server,” “box,” “agent,” “device,” “unit,” “sub-unit,” “element,” “application,” “infrastructure,” etc., may be used interchangeably in some embodiments. In some embodiments, any data or data set described herein may be structured or unstructured. In some embodiments, a method is provided for performing the various steps performed by any system described herein. In some embodiments, a non-transitory computer-readable medium comprising code is provided for causing a system to perform the various methods described herein. In some embodiments, a system may comprise one or more physical housings that include various units, such as those illustrated in FIG. 1B. In some embodiments, a chipset may be disposed in the one or more housings and may be interfaced with one or more hardware processors. The chipset may have hardware (e.g., electronic components in an electronic circuit) for supporting various connections within the system, or any other connection from the system to external systems. Any of the embodiments, elements, features, processes, compounds, portions of compounds, etc. can be combined with any other embodiments, elements, features, processes, compounds, portions of compounds, etc.

FIG. 1A describes a schematic block diagram of a network system for executing the various methods described herein. While the user device 120 is shown as a mobile phone, in other embodiments, the user device 120 may be any other mobile or non-mobile computing device, including laptops, desktops, tablets, gaming devices, wearable devices, eyewear, headgear, Internet of Things (IoT) devices, etc.) The illustrated network 146, such as the Internet or an intranet, may be able to be used to exchange data between the server 150 and the user device 120.

According to some embodiments, a user 101 and/or another computer interacts with the disclosed systems 100 for executing the methods disclosed herein. Disclosed user devices 120 may include computing device capable of sending data and communicating over the internet with one or more servers 150, other user devices 120, or other type of computing devices. The methods described herein may be executed by at least one of the user device 120 which may include but not be limited to (e.g., using the app execution 130 and data processing 126 systems), the server 150 which may include but not be limited to (e.g., using the processor 160), or a combination of both.

A wireless communications network 145 may be a 3G network, 4G, LTE, 5G, Wi-Fi, Bluetooth, or any other network protocol and may be a combination of any number of networks. Further, as mentioned above a wired network connection such as a conventional Ethernet connection could be used, such as with a personal computer with an Ethernet port. User devices 120 or servers 150 may include processors 430 such as digital signal processors or a microprocessors for performing the different methods described in this specification.

Although the servers 150 illustrated in the present FIG. 1A are illustrated as stand-alone computing machines, the computing functionality, including servers 150, processors or processor instances 160, memory or computing data storage areas 180, and databases 170 may be able to be provided through a cloud implementation or by a hybrid enterprise/cloud architecture. It is understood that the terms system, apparatus, device, etc.) may be used interchangeably in this specification. In some embodiments, a method is provided for performing the various steps performed by any computing device, e.g. user device 120 and/or server 150, described herein. In some embodiments, a non-transitory computer-readable medium comprising code is provided for causing any user device 120, computing device, or server 150, to perform the various methods described herein. The scope of any claims that may be a part of this application or any application stemming from the present application shall be determined by those claims as read in light of the claims, but the elements of the particularly illustrated embodiments shall not be imputed to the claim language unless particularly invoked through the use of means-plus-function language under 35 U.S.C. Section 112 (f).

FIG. 1B illustrates an exemplary complex computing environment, in accordance with some embodiments of the disclosure. For example, the computing environment may be included in and/or utilized by the system or computing system, the user device, and/or any other system described herein. The computing environment and/or any of its units and/or sub-units described herein may include general hardware, specifically-purposed hardware, and/or specially purposed-software.

The computing environment may include, among other units, a processor 260, a memory 280, an input/output (I/O) unit 210, and a communication center 215. As described herein, each of the processor, the memory, the I/O unit, and/or the communication unit may include and/or refer to a plurality of respective units, sub-units, and/or elements. The various units may be implemented entirely in hardware, entirely in software, or in a combination of hardware and software. Some of the units may be optional. Any software described herein may be specially purposed software for performing a particular function. In some embodiments, hardware may also be specially purposed hardware for performing some particular functions. Furthermore, each of the processor, the memory unit, the I/O unit, the communication unit, and/or the other units in FIG. 1B, may be operatively and/or otherwise communicatively coupled with each other using a chipset such as an intelligent chipset or a non-intelligent chipset. The chipset may have hardware for supporting connections in the computing environment and connections made to external systems from the computing environment. While various units of FIG. 1B are presented as separate units, some of the units may be comprised in other units. Additionally, some of the units may be optional. Additionally, one or more units may be coupled or connected which may include but not be limited to (e.g., via a wired or wireless connection) to other units. For example, the processor may be connected to one or more other units in FIG. 1B.

As illustrated in FIG. 1B, a server 250 (which may be the system or computing system 105 or may be comprised in the system or computing system 105) may include, among other elements, any combination of a processor 260, a memory 280, an input/output (I/O) 210, and a communication center 215. As described in present embodiments, each of the processor 260, the memory 280, the I/O 210, and communication center 215 may include a plurality of respective units, subunits, and/or elements. Furthermore, each of the processor 260, the memory 280, the I/O 210, and the communication center 215 may be operatively or otherwise communicatively coupled with each other so as to facilitate the methods and techniques described herein. In some embodiments, at least some of the processor 260, the memory 280, the I/O 210, and the communication center 215, or any portions thereof, may be present include in one or more user devices 120. In some embodiments, methods, or portions thereof, may be performed entirely by one or more servers 150, one or more user devices 120, or may be performed by a combination of one or more servers 150 and one or more user devices 120. In some embodiments, an application server may be provided for downloading an application or software to user devices for performing the various methods described herein.

The processor 260 may control any one or more of the memory 280, the I/O 20, the communication center 215, or any other unit which may include the server 250, as well as any included subunits, elements, components, devices, or functions performed by each or a combination of the memory 280, the I/O 210, the communication center 215 or any other unit which may include the server 250. Any of the elements or sub-elements of the server 250 presented here may also be included in a similar fashion in any of the other units, subunits, and devices included in the operating system 100 of FIG. 1A. Additionally, any actions described herein as being performed by a processor 260 may be taken by the processor 260 alone, or by the processor 260 in conjunction with one or more additional processors, units, subunits, elements, components, devices, and the like. Additionally, while only one processor 260 may be shown in the figures included here, multiple processors may be present or otherwise included in the server 250 or elsewhere in the operating system of FIG. 1A. Thus, while instructions may be described as being executed by the processor 260 or the various subunits of the processor 263, 264, 265, the instructions may be executed simultaneously, serially, or otherwise by one or more multiple processors 260.

In some embodiments, a processor 260 may be implemented as one or more computer processor (CPU) chips, graphical processor (GPU) chips, or some combination of CPU chips and GPU chips, and may include a hardware device capable of executing computer instructions. The processor 260 may execute any combination of instructions, codes, computer programs, and scripts. The instructions, codes, computer programs, and scripts may be received from, stored in, or received from and stored in any combination of the memory 280, the I/O 210, the communication center 215, subunits of the previously described elements, other devices, other computing environments. In some embodiments, various portions of any of the methods described herein may be executed either in series or in parallel.

In some embodiments, the processor 260 may include, among other elements, subunits. Subunits may include any combination of a geolocation finder 263, a graphical processor 264, and a resource allocator 265. Each of these subunits of the processor 260 may be communicatively or otherwise operably coupled with each other. Any of the subunits described with respect to any units or systems may be optionally included those units or systems.

The geolocation finder 263, particularly in communication with geolocation information provided by GPS subsystems 129 of user devices 120 (see FIG. 1A) may facilitate any combination of detection, generation, modification, analysis, transmission, and presentation of location information. Location information may include any combination of global positioning system (GPS) coordinates, an internet protocol (IP) address, a media access control (MAC) address, geolocation information, an address, a port number, a zip code, a server number, a proxy name, a proxy number, device information, serial numbers, and the like. In some embodiments, the geolocation finder 263 may include any one or a combination of various sensors, specifically-purposed hardware elements for enabling the geolocation finder 263 to acquire, measure, and transform location information.

The graphical processor (GPU) 264 may facilitate any combination of generation, modification, analysis, processing, transmission, and presentation of visual content. In some embodiments, the GPU 264 may be configured to receive multiple images from a user and perform analysis on and/or modifications to the images. Further, the GPU 264 may be configured to facilitate adjustments to videos and images associated with a user. The GPU 264 may also be configured to render visual content for presentation on a user device 120 and/or to analyze visual content for metadata associated with a user or a user device. The GPU 264 may include multiple GPUs and may therefore be configured to perform and/or execute multiple processes in parallel.

The resource allocator 265 may facilitate any one or combination of the determination, monitoring, analysis, and allocation of resources throughout the server 250, the system or computing system 100, any component of the system or computing system 100, or other computing environments. For example, the resource allocator 265 may facilitate interaction between the server 250, any subunit of the server 250, and a high volume (e.g. multiple) of users or associated user devices 120. As such, computing resources of the server 250 utilized by any one or a combination of the processor 260, the memory 280, the I/O 210, the communication center 215, and any subunit of these units, such as processing power, data storage space, network bandwidth, and the like may be in high demand at various times during operation. Accordingly, the resource allocator 265 may be configured to manage the allocation of various computing resources as they are required by particular units or particular subunits of the server 250.

In some embodiments, the resource allocator 265 may include sensors and/or other specially-purposed hardware for monitoring performance of each unit and/or subunit of the server 250, as well as hardware for responding to the computing resource needs of each unit or subunit. In some embodiments, the resource allocator 265 may utilize computing resources of a second computing environment separate and distinct from the server 250 to facilitate a desired operation.

In some embodiments, factors affecting the allocation of computing resources by the resource allocator 265 may include the number of ongoing user device connections and/or other communication channel connections, a duration during which computing resources are required by one or more elements of the server 250, and/or the like. In some embodiments, computing resources may be allocated to and/or distributed amongst a plurality of second computing environments included in the server 250 based on one or more factors mentioned above. In some embodiments, the allocation of computing resources of the resource allocator 265 may include one or more resource allocators 265 flipping a switch, adjusting processing power, adjusting memory size, partitioning a memory element, transmitting data, controlling one or more input and/or output devices, modifying various communication protocols, and the like. In some embodiments, the resource allocator 265 may facilitate utilization of parallel processing techniques such as dedicating a plurality of GPUs included in the processor 260 for processing high-quality analysis and manipulation of images and/or videos.

In some embodiments, the memory 280 may be utilized for one or any combination of storing, recalling, receiving, transmitting, and/or accessing various files and/or information during operation of the server 250. For example, the memory 280 may be utilized for storing recalling, and/or updating any datasets described herein. The memory 280 may include various types of data storage media such as solid state storage media, hard disk storage media, and any other type of data storage medium which may be known to a person of ordinary skill in the art. The memory 280 may include dedicated hardware elements such as hard drives and/or servers, as well as software elements such as cloud-based storage drives. For example, the memory unit 280 may include various subunits such as an operating system unit 281, an application data unit 282, an application programming interface (API) unit 283, a data storage unit 286, a secure enclave 287, and/or a cache storage unit 288.

The memory 280 and any of its subunits described here may include any one or any combination of random access memory (RAM), read only memory (ROM), and various forms of secondary storage. RAM may be used to store volatile data and/or to store instructions that may be executed by the processor 260. For example, the data stored may be any one or a combination of a command, a current operating state of the server 250, an intended operating state of the server 250, and the like. As a further example, data stored in the memory 280 may include instructions related to various methods and/or functionalities described here. ROM may be a non-volatile memory device that may have a smaller memory capacity than the memory capacity of a secondary storage. ROM may be used to store instructions and/or data that may be read during execution of computer instructions. In some embodiments, access to both RAM and ROM may be faster than access to secondary storage. Secondary storage may include one or more disk drives and/or tape drives and may be used for non-volatile storage of data or as an over-flow data storage device if RAM is not large enough to hold all working data. Secondary storage may be used to store programs that may be loaded into RAM when such programs are selected for execution. In some embodiments, the memory 280 may include one or more databases for storing any data described here, e.g. the database 170 of FIG. 1A. Additionally or alternatively, one or more secondary databases located remotely from the server 250 may be utilized and/or accessed by the memory 280.

The operating system unit 281 may facilitate deployment, storage, access, execution, and/or utilization of an operating system utilized by the server 250 and/or any other computing environment described herein. In some embodiments, the operating system may include various hardware and/or software elements that serve as a structural framework for enabling the processor 260 to execute various operations such as the analysis of data received from user devices 120, etc.) The operating system unit 281 may further store various pieces of information and/or data associated with operation of the operating system and/or the server 250 as a whole, such as a status of computing resources which may include but not be limited to (e.g., processing power, memory availability, resource utilization, and/or the like), runtime information, modules to direct execution of operations described herein, user permissions, security credentials, and the like.

The application data unit 282 may facilitate deployment, storage, access, execution, and/or utilization of an application utilized by the server 250 or any other computing environment described herein which may include but not be limited to (e.g., a user device 120). For example, users may be required to download, access, and/or otherwise utilize a software application on a user device 120 such as a smartphone or other internet-enabled device in order for various operations described herein to be performed. As such, the application data unit 282 may store any information and/or data associated with the application which may allow the application and/or user device 220 to perform methods described herein. As such, information included in the application data unit 282 may enable a user to execute various operations described here. The application data unit 282 may further store various pieces of information and/or data associated with operation of the application and/or the server 250 as a whole, such as a status of computing resources which may include but not be limited to (e.g., processing power, memory availability, resource utilization, and/or the like), runtime information, modules to direct execution of operations described herein, user permissions, security credentials, and the like.

The application programming interface (API) unit 283 may facilitate deployment, storage, access, execution, and/or utilization of information associated with APIs of the server 250 and/or any other computing environment described herein which may include but not be limited to (e.g., a user device). For example, server 250 may include one or more APIs for enabling various devices, applications, and/or computing environments to communicate with the server 250, multiple other servers, databases, or other user devices. Accordingly, the API unit 283 may include API databases containing information that may be accessed and/or utilized by applications and/or operating systems of other devices and/or computing environments associated with the methods described herein. An API may direct communications between the background component of the user device 120 and the server 250. In some embodiments, each API database may be associated with a customized physical circuit included in the memory unit 280 and/or the API unit 283. Additionally, each API database may be public and/or private, and so authentication credentials may be required to access information in an API database.

The data storage unit 286 may facilitate one or more of deployment, storage, access, analysis, and utilization of data content by the server 250 and any other computing environment described herein which may include but not be limited to (e.g., a user device). Data content may be text, numbers, images, videos, audio files, and any other form of media. For example, the data storage unit 286 may store one or more images which may be uploaded from a user device. Further, the data storage unit 286 may store one or more images which have been manipulated by any unit or subunit of a server 150 or user device. In some embodiments, the data storage unit 286 may communicate with the GPUs 264 to facilitate any of the processes described here.

The secure enclave 287 may facilitate secure storage of data. In some embodiments, the secure enclave 287 may include a partitioned portion of storage media included in the memory unit 280 that is protected by various security measures. For example, the secure enclave 287 may be hardware secured. In other embodiments, the secure enclave 287 may include one or more firewalls, encryption mechanisms, and/or other security-based protocols. Authentication credentials of a user may be required prior to providing the user access to data stored within the secure enclave 287. In some embodiments, the secure enclave 287 may store sensitive user information such as medical history, credit card data, and/or data associated with the progression of skin damage from ultraviolet radiation.

The cache storage unit 288 may facilitate short-term deployment, storage, access, analysis, and/or utilization of data. In some embodiments, the cache storage unit 288 may serve as a short-term storage location for data so that the data stored in the cache storage unit 288 may be accessed quickly. In some embodiments, the cache storage unit 288 may include RAM and/or other storage media types that enable quick recall of stored data. The cache storage unit 288 may include a partitioned portion of storage media included in the memory 280. In some embodiments, the cache storage unit 288 may store any data described herein.

In some embodiments, the memory 280 or the processor 260 may include one or more data sensors for sensing parameters associated with any data described herein.

The I/O unit 210 may include hardware and/or software elements for enabling the server 250 to receive, transmit, and/or present information. For example, elements of the I/O unit 250 may be used to receive user input from a user via a user device 220, and the like. In this manner, the I/O unit 210 may enable the server 250 to interface with a human user in a manner such that the user may use the methods described here. As described, the I/O unit 210 may include subunits such as any one or a combination of an I/O device 211, an I/O calibration unit 212, and/or operations driver 213.

The I/O device 210 may facilitate any one or any combination of the receipt, transmission, processing, presentation, display, input, and output of information as a result of executed processes described here. In some embodiments, the I/O device 210 may include a plurality of I/O devices. In some embodiments, the I/O device 210 may include one or more elements of any one or a combination of a user device 120, a server 250, and/or a similar device(s).

The I/O device 211 may include a variety of elements that enable a user to interface with the server 250. For example, the I/O device 211 may include a keyboard, a touchscreen, a button, a sensor, a biometric device, a toner, a laser, a microphone, a camera, an internet-enabled device, and/or another element for receiving and/or collecting input from a user. Additionally and/or alternatively, the I/O device 211 may include a display, a screen, a sensor, a vibration mechanism, a light emitting diode (LED), a speaker, a radio frequency identification (RFID) may be able toner, and/or another element for presenting and/or otherwise outputting data to a user. In some embodiments, the I/O device 211 may communicate with one or more elements of the processor 260 and/or the memory unit 280 to execute operations described herein. For example, the I/O device 211 may include a display, which may utilize the GPU 264 to present media content stored in the data storage unit 286 to a user of a user device 120.

The I/O calibration unit 212 may facilitate the calibration of the I/O device 211. For example, the I/O calibration unit 212 may detect and/or determine one or more settings of the I/O device 211, and then adjust and/or modify settings so that the I/O device 211 may operate more efficiently. In some embodiments, the I/O calibration unit 212 may utilize an operations driver 213 (or multiple operations drivers) to calibrate the I/O device 211. The operations driver 213 may alternatively be installed on a user device 120 so that the user device 120 may recognize and/or integrate with the I/O device 211, thereby enabling media content to be displayed, received, generated, and the like. In some embodiments, the I/O device 211 may be calibrated by the I/O calibration unit 212 by based on information included in the operations driver 213.

The communication center 215 may facilitate establishment, maintenance, monitoring, and/or termination of communications between the server 250 and other devices such as user devices 120, other computing environments, third party server systems, and the like. The communication center 215 may further enable communication between various elements which may include but not be limited to (e.g., units and/or subunits) of the server 250 as needed to perform the methods described herein. In some embodiments, the communication center 215 may include a network protocol unit 216, an API gateway 217, an encryption engine 218, and/or a communication device 219. The communication center 215 may include hardware and/or software elements.

The network protocol unit 216 may facilitate establishment, maintenance, and/or termination of a communication connection between the server 250 and another device (e.g. user device 120) by way of a network. For example, the network protocol unit 216 may detect and/or define a communication protocol required by a particular network and/or network type. Communication protocols utilized by the network protocol unit 216 may include Wi-Fi protocols, Li-Fi protocols, cellular data network protocols, Bluetooth® protocols, WiMAX protocols, Ethernet protocols, powerline communication (PLC) protocols, and the like. In some embodiments, facilitation of communication between the server 250 and any other device, as well as any element internal to the server 250, may include transforming and/or translating data from being compatible with a first communication protocol to being compatible with a second communication protocol. In some embodiments, the network protocol unit 216 may determine and/or monitor an amount of data traffic to consequently determine which particular network protocol is to be used for establishing a connection with a user device, transmitting data, and/or performing other operations described herein.

The API gateway 217 may facilitate the enablement of other devices and/or computing environments to access the API unit 283 of the memory 280 of the server 250. For example, a user device 120 may access the API unit 283 via the API gateway 217. In some embodiments, the API gateway 217 may be required to validate user credentials (e.g. login ID 225, password 226 of FIG. 1B) associated with a user of a user device 120 prior to providing access to the API unit 283 to the user. The API gateway 217 may include instructions for enabling the server 250 to communicate with another device.

The encryption engine 218 may facilitate any one or any combination of translation, encryption, encoding, decryption, and decoding of information received, transmitted, and/or stored by the server 250. For example, the encryption engine 218 may encrypt data associated with a user's medical history, credit card information, analysis of skin damage from ultraviolet radiation, etc.) Using the encryption engine, each transmission of data may be encrypted, encoded, and/or translated for security reasons, and any received data may be encrypted, encoded, and/or translated prior to its processing and/or storage. In some embodiments, the encryption engine 218 may generate any one or combination of an encryption key, an encoding key, a translation key, and the like, which may be transmitted along with any data content.

The communication device 219 may include a variety of hardware and/or software specifically purposed to enable communication between the server 250 and another device (e.g. user device 120), as well as communication between elements of the server 250. In some embodiments, the communication device 219 may include one or more radio transceivers, chips, analog front end (AFE) units, antennas, processors, memory, other logic, and/or other components to implement communication protocols (wired or wireless) and related functionality for facilitating communication between the server 250 and any other device. Additionally and/or alternatively, the communication device 219 may include a modem, a modem bank, an Ethernet device such as a router or switch, a universal serial bus (USB) interface device, a serial interface, a token ring device, a fiber distributed data interface (FDDI) device, a wireless local area network (WLAN) device and/or device component, a radio transceiver device such as code division multiple access (CDMA) device, a global system for mobile communications (GSM) radio transceiver device, a universal mobile telecommunications system (UMTS) radio transceiver device, a long term evolution (LTE) radio transceiver device, a worldwide interoperability for microwave access (WiMAX) device, and/or another device used for communication purposes.

In some embodiments, implementation of any unit of any system described herein is contemplated in discrete components or fully integrated circuits in silicon, gallium arsenide, or other electronic materials families, as well as in other technology-based forms and embodiments. It should be understood that various embodiments of the disclosure may be able to employ or be embodied in hardware, software, microcoded firmware, or any combination thereof. When an embodiment is embodied, at least in part, in software, the software may be stored in a non-volatile, machine-readable medium.

In some embodiments, the client or potential client may be able to search for legal professionals or attorneys and ‘pre-approve’ the attorney to open their case, which may mean doing a conflicts check first prior to having access to their full case. In some embodiments, the ‘name of the client,’ the ‘opposing parties,’ ‘current city of residence,’ and ‘city where the issue took place’ and ‘type of case’ and ‘some answers to the questionnaire’ such as ‘statute of limitations check’ etc.) In some embodiments, On the signup form, it is minimal. Professional sign-up page: Required: Work email (no Gmail), Required): password, (Required): first and last name, (Required): (simple type in box) company work for. Required: Click Box (may be able to read) Agree to terms and conditions. In some embodiments, the next step may be a ‘drop-down menu or a selection menu’ for all legal types, such as licensed attorneys, paralegals, or legal assistants. In some embodiments, paralegals or legal assistants may have to be approved by a connected attorney on the site to be able to open cases on their behalf. In some embodiments, there is also a drop-down or selection menu for what state the professional attorney is licensed in ‘such as (Texas, California, etc.) In some embodiments, there is also a box for attorneys to type in their ‘attorney license number.’ In some embodiments, ‘may be able to unapproved professionals may be able to still view the cases?’—Yes, but the button or ‘option to choose’ “Request Case Details” is not clickable, only viewable. In some embodiments, Admin approval is needed to change a few of these fields: admin approval to change the name, workplace, and or email.

In some embodiments, 1st Type Filtering options are available for professionals when searching for ‘cases.’ Such as type of case, city/state of issue, and current residence city/state. Secondary filtering options may be some of the ‘required selections from the case questionnaire. The second step is to sign up for a page for legal professionals and set up a profile page. Not required: phone number, Not required: (simple type in box) Which law firm do you work for? (Required): first and last name, Not required: Type of Cases you want to see (for filtering/recommendations) Not required: Fill Out Profile of Work history/experience. Not required: upload a photo. Required: A ‘drop-down menu or a selection menu’ for all legal types such as licensed attorney, paralegal, legal assistant, or other. For paralegals, legal assistants, or others, these non-attorneys may have two or more additional boxes to fill out. Required: 1. What is the attorney's first and last that you are reviewing cases on behalf of? Required: 2. What is the attorney's work email address? Next: The attorney may be notified that someone is trying to ‘view cases on their behalf’ through email/text. Not required: Submit for Admin Approval to act on cases. In some embodiments, required or not required may be interchangeable. In some embodiments, an unapproved professional may still be able to view the cases.-Yes, but the button “Request Case Details” is not clickable; it is only viewable (they must be approved first). Admin approval is needed to change a few of these fields: admin approval to change the name, workplace, email

In some embodiments, The computing environment may include, but is not limited to, computing grid systems, distributed computing environments, cloud computing environments, etc.) In some embodiments, such networked computing environments include hardware and software infrastructures configured to form a virtual organization comprised of multiple resources, which may be in geographically dispersed locations. In some embodiments, a method for processing textual data may include receiving user input and selecting a pre-written question. In some embodiments, the (e.g., pre-written or pre-presented, etc.) question serves as a query to guide the processing of textual data.

In some embodiments, the method further involves extracting textual data relevant to the selected question. In some embodiments, This extraction process aims to isolate and retrieve textual data that is directly related to the pre-selected question for further analysis. In some embodiments, the method may include analyzing the extracted textual data to identify factual or key information. In some embodiments, The analysis may involve natural language processing techniques, data mining, or other methods to discern important facts or key elements within the text. In some embodiments, the method comprises generating a concise summary of the textual data based on the identified factual or key information. In some embodiments, This summary aims to provide a shorter, more digestible version of the original textual data, focusing on the relevant information. In some embodiments, the method encompasses storing or presenting a concise summary for data analysis purposes. This allows for further data analysis or decision-making based on the processed and summarized information in some embodiments. In some embodiments, the method further allows the user to customize the concise summary generation parameters. In some embodiments, Users may be able to tailor the system or computing system's behavior to their specific preferences or needs, influencing how the textual data is processed and summarized. In some embodiments, a computing system is provided to simplify textual data for data analysis. The system or computing system may include a user interface designed to receive user input for selecting a pre-written question. In some embodiments, This interface streamlines the process of engaging with the system or computing system. In some embodiments, the computing system incorporates a data extraction module. This module is configured to extract textual data related to the selected question. In some embodiments, It automates the retrieval of relevant textual information. In some embodiments, the computing system may include a text analysis module. In some embodiments, The text analysis module is responsible for identifying factual or key information within the extracted textual data. In some embodiments, It employs various techniques and algorithms for this purpose. In some embodiments, the computing system features a summary generation module. In some embodiments, This module is designed to generate a concise summary of the extracted textual data based on the identified factual or key information. In some embodiments, It ensures that the summarized information remains relevant and useful. The computing system is equipped with a data storage or presentation module in some embodiments. This module handles the storage or presentation of the concise summary, making it available for data analysis purposes. In some embodiments, the computing system further may include a feature where the user interface allows users to customize concise summary generation parameters. In some embodiments, This customization empowers users to adapt the system or computing system to their specific requirements, ensuring flexibility and user-friendliness.

As may be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.), or an embodiment combining software and hardware aspects that may all generally be referred to herein as a “circuit”, “module” or “system”. Furthermore, aspects of the present disclosure may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that may be able to contain or store a program for use by or in connection with an instruction execution system, apparatus, or device.

A computer-readable signal medium may include a propagated data signal with computer-readable program code embodied therein, for example, in a baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that may be able to communicate, propagate, or transport a program for use by or in connection with an instruction execution system, apparatus, or device.

Program code embodied on a computer-readable medium may be transmitted using any appropriate medium, including, but not limited to, wireless, wireline, optical fiber cable, RF, etc., or any suitable combination of the foregoing.

Computer program code for carrying out operations for aspects of the present disclosure may be written in any combination of one or more programming languages, including an object-oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems), and computer program products according to embodiments of the disclosure. It may be understood that each block of the flowchart illustrations and/or block diagrams and combinations of blocks in the flowchart illustrations and/or block diagrams may be able to be implemented by computer program instructions. These computer program instructions may be provided to a processor of a general-purpose computer, a special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In some embodiments, These computer program instructions may also be stored in a computer-readable medium that may be able to direct a computer, other programmable data processing apparatus, or other devices to function in a particular manner, such that the instructions stored in the computer-readable medium produce an article of manufacture including instructions which implement the function/act specified in the flowchart and/or block diagram block or blocks. In some embodiments, The computer program instructions may also be loaded onto a computer, other programmable data processing apparatus, or other devices to cause a series of operational steps to be performed on the computer, other programmable apparatus, or other devices to produce a computer-implemented process such that the instructions that execute on the computer or other programmable apparatus provide processes for implementing the functions/acts specified in the flowchart and/or block diagram block or blocks.

Any transmission, reception, connection, or communication may occur using any short-range which may include but not be limited to (e.g., Bluetooth, Bluetooth Low Energy, near field communication, Wi-Fi Direct, etc.) or long-range communication mechanism which may include but not be limited to (e.g., Wi-Fi, cellular, etc.). Additionally or alternatively, any transmission, reception, connection, or communication may occur using wired technologies. Any transmission, reception, or communication may occur directly between systems or indirectly via one or more systems.

One potential application of the embodiments described herein is in the legal space. The legal space is totally inefficient and very discouraging to those who need legal help which may include but not be limited to (e.g., victims of sexual assault, etc.) A potential plaintiff needs to interview tens of attorneys generally (including repeating the potentially tragic or triggering facts of the plaintiff's case and providing documentation) before zeroing in on an attorney. The present disclosure serves to eliminate this problem.

In some embodiments, there may be a docket report system where all the cases are filed in the United States or other countries which may include but not be limited to (e.g., patent cases, etc.). In some embodiments, the software system may allow attorneys or clients to contact them based on their company profile, name, type of case, client, and value. In some embodiments, there may be an email with all the patent cases or any cases filed per day. In some embodiments, Each law firm which may include but not be limited to (e.g., defense firm) or each attorney may be able to use artificial intelligence to use keywords or manual knowledge or inputted knowledge to search for cases using AI, and it may be able to show recommendations rather than manually searching through lists or dockets to see if attorney, law firm, or client has any interest. In some embodiments, the firm inputs a list of their clients or practice areas of interest into the software. The software creates a list of newly filed cases based on matching the firm's clients to parties named in the newly filed cases or based on matching the firm's practice area/experience to the subject matter of the newly filed cases.

In some embodiments, a software computing system is provided, comprising a user interface module configured to receive and display cases submitted by users. In some embodiments, This user interface module streamlines the process of case submission and interaction with the system or computing system. In some embodiments, the system or computing system further may include a bidding module configured to allocate a specific time frame during which lawyers or professionals may be able to submit bids for the cases. In some embodiments, This bidding module ensures that the bidding process is organized and efficient. In some embodiments, a communication module is integrated into the system or computing system, facilitating the exchange of information between users and lawyers or professionals. In some embodiments, This module enables lawyers or professionals to provide reasons for their bids and present their work related to the case. It fosters a comprehensive and transparent exchange. In some embodiments, the system or computing system also incorporates a recommendation module. In some embodiments, This recommendation module is designed to provide recommendations to users based on the bids and the information exchanged between users and lawyers or professionals. In some embodiments, It assists users in making informed decisions. In some embodiments, the system or computing system further may include a case creation interface within the user interface module.

In some embodiments, This interface allows users to input case details and specifications. In some embodiments, The bidding module is then configured to categorize and match lawyers or professionals with cases based on these details and specifications. In some embodiments, the communication module enables real-time messaging and video conferencing between users and lawyers or professionals. In some embodiments, This functionality allows for direct interaction during the bidding process, fostering efficient communication. The recommendation module utilizes machine learning algorithms to analyze user preferences and feedback in some embodiments. In some embodiments, It leverages this analysis to provide personalized recommendations to users regarding which lawyer or professional to select for their case. In some embodiments, Personalization enhances the quality of the service. In some embodiments, the bidding module may include a review and rating system. This system enables users to provide feedback and ratings for lawyers or professionals in some embodiments. In some embodiments, The feedback and ratings collected are used to enhance the quality of recommendations and to build a reputation system for lawyers or professionals. In some embodiments, a method is provided to facilitate the selection of legal or professional services for cases submitted by users. In some embodiments, This method may include the steps of receiving case details and specifications from users, allocating a specific time frame for lawyers or professionals to submit bids, enabling communication between users and lawyers or professionals, and providing recommendations to users based on the bids and information exchanged. In some embodiments, what may legal professionals see in the list of submitted cases? 1. Type of Case (most important information shown) 2. City of client's current residence 3. Zip code of client's current residence 4. State of client's current residence 4. City incident took place 5. zip code incident took place 5. state incident took place 6. date incident happened 7. The time that has passed since the incident happened, such as (the incident happened four months ago), and any and all details, maybe not sensitive details, yes or no question answers, and any non-sensitive personal information such as male or female or city, or state, or distance, Distance away that the incident happened from legal professional's listed zip code, What may be able to legal professional see in the list of submitted cases? 1. Type of Case 2. City, State, and Zip Code of client's current residence 3. State, City, and Zip Code incidents took place 4. Calendar date incident happened 5. The time has passed since the incident happened, such as (this occurred 4 months ago). Most Important information shown (state incident happened, and type of case), etc.) In some embodiments, an auto-deletion model may be present for the information provided by the potential client. In some embodiments, auto-deletion of case information may be deleted after any time period, such as 7 days, 30 days, 6 months, etc.) In some embodiments, attorneys or legal professionals may have auto-deletion tied to the information that they receive or view from the potential client. In some embodiments, there may be written contracts in place or provided or suggested. In some embodiments, auto-deletion or deletion of a case file or any information related to a case file may be implemented.

In some embodiments, the method further may include the step of categorizing and matching lawyers or professionals with cases based on case details and specifications provided by users. In some embodiments, This step ensures efficient pairing. In some embodiments, the method involves analyzing user preferences and feedback using machine learning algorithms to provide personalized recommendations to users regarding the selection of lawyers or professionals for their cases. In some embodiments, personalization enhances the user experience. In some embodiments, the method implements a review and rating system to collect feedback and ratings from users for lawyers or professionals. In some embodiments, this feedback is used to enhance the quality of recommendations and build a reputation system for lawyers or professionals. In some embodiments, a computer-readable storage medium is provided, containing instructions for executing the method of facilitating the selection of legal or professional services for cases submitted by users, as described in the previous claims. This allows users to execute and access the method on a variety of computing devices.

In some embodiments, there may be a plaintiffs' cases which may include but not be limited to (e.g., personal injury, patent, medical malpractice, sexual assault, etc.) database(s) in which potential clients and attorneys may meet, discuss, learn about the potential case, submit information for a case, submit their case, submit documents, etc.) In some embodiments, the cases, leads, or database information submitted by the potential client may be used in a pay-per-view model, or a subscription-based model to view unlimited cases for a time period, or a combination of any of these or other types of payment or paying ways, where a subscription may be less if there are more pay per view case, or a subscription may be more if the request to view cases are less. In some embodiments, the case information approved by the client to view may be used to be exported by an attorney or legal professional after they have agreed or signed to take the case outside of the platform or computing system. In some embodiments, the case files may be deleted after some time period. In some embodiments, the number, name, time period the case was submitted, or less sensitive information, and or any analytics may be recorded even though private case details have been deleted. In some embodiments, the various methods and embodiments described herein may be implemented as a website, a mobile website, a mobile application, etc.)

In some embodiments, the client may submit their issue to the computing system or database and see if an attorney wants to use this data to contact the client directly. In some embodiments, the client may fill out a form, insert a form, fill out questions, write a description, or answer pre-made questions in relation to their ‘issue’ or ‘case’ or ‘needs’ or ‘legal needs.’ In some embodiments, a lawyer or legal professional may be able to ‘download, report, submit, obtain a copy of information’ and relay it to their superior or someone else in their office, or their boss, or another person by downloading or relaying the information or sending the information; therefore the ability to help with the case may be known to the client if they want to take the case or not. In some embodiments, there may be categories or options of types of cases to choose from, and there may be a different set of questions that may show based on the type of case. In some embodiments, the pre-made questions may already be there for the client to click on. In some embodiments, The clicked-on answers may be used to obtain a ‘smaller factual data list’ in order to relay that information to the attorney or legal professional or person in a ‘smaller format or easier to understand format, for example, there may be fewer words or the ‘main point or ‘main idea’ is only shown rather than the extra details that may be irrelevant when first evaluating a case. In some embodiments, a database may be separate for ‘potential class actions lawsuits’ such as gathering similar data or gathering those that have said another person has also had this same problem, for example, a response to a defective product or multiple rape survivors of the same perpetrator, etc.) In some embodiments, information inserted into the case may be used to identify or gather data for potentially multiple people with the same problem, which may either be multiple people coming forward for the same issue or potentially class action lawsuits, which may be its own separated database in which attorneys or legal professionals may need to pay per view pay to access pay a subscription, etc.) to view these potentially multiple person-related cases.

In some embodiments, The present invention relates generally to the field of insurance, and more particularly, to a system and method for automating the management, purchase, and administration of insurance policies using a web-based platform. In some embodiments, The present invention provides a novel system and method for automating the management of date or experience insurance policies through a web-based platform and mobile application. In some embodiments, The system or computing system leverages artificial intelligence (AI) to streamline the underwriting process, automate policy recommendations, and expedite claims processing. In some embodiments, The system or computing system comprises a cloud-based server, a user interface accessible via both web browsers and mobile applications, a database for storing user information and policy details, and an AI-driven engine that automates key date or experience insurance functions. In some embodiments, The user registers via the web app or mobile app by entering personal details. In some embodiments, The AI engine analyzes the user data to suggest the most suitable insurance policies based on the user's profile and risk factors. In some embodiments, Users may review and customize policy recommendations before purchase.

In some embodiments, Once a date or experience policy is purchased, the system or computing system automatically manages renewals, premium payments, and coverage adjustments based on real-time user data and preferences. In some embodiments, Users may access their policy details, update personal information, and file claims directly through the platform. In some embodiments, The AI engine evaluates claims submitted by the user through the app, cross-referencing with policy coverage and relevant data stored in the system or computing system. In some embodiments, The system or computing system automates the approval process for straightforward claims, reducing processing time significantly. In some embodiments, For more complex claims, the system or computing system routes the case to a human adjuster while providing an initial analysis to expedite the decision-making process. In some embodiments, The system or computing system employs end-to-end encryption to secure all user data and transactions. In some embodiments, Regular security audits and updates ensure compliance with industry standards and regulations.

In some embodiments, a computer-implemented method is provided for prioritizing access to legal cases among attorneys based on a tier or subscription level. In some embodiments, This method involves a computing software system receiving subscription information from a plurality of attorneys. In some embodiments, The subscription information may include tier levels associated with each respective attorney. Furthermore, the software system receives requests from the attorneys to view cases stored in a database. In some embodiments, the method proceeds by analyzing the tier levels of the attorneys and the case requests to determine priority access to cases based on the tier levels. In some embodiments, This analysis takes into consideration the tier levels and other factors to allocate access efficiently and fairly. In some embodiments, the method may include periodically updating the database of legal cases with new case data and notifying attorneys of new case opportunities. In some embodiments, this ensures that attorneys may access the latest and most relevant cases in their practice areas and expertise. In some embodiments, a user interface is generated for attorneys to input case requests and manage their subscription information, including tier levels.

In some embodiments, This user interface provides a convenient and user-friendly way for attorneys to interact with the system or computing system, allowing them to customize their preferences and view available cases. In some embodiments, the tier levels are associated with subscription fees, and the priority access is determined based on a combination of the tier level and subscription fee. In some embodiments, This enables a flexible and customizable approach to prioritizing case access based on the financial commitment of attorneys. In some embodiments, a computer system is provided to implement the above-described method. This computer system comprises a processor configured to execute the software system, memory for storing the database of cases, subscription information, and case request history, and a communication module for receiving subscription information and case requests from attorneys and notifying them of their priority access. In some embodiments, the computer system further may include a user interface for attorneys to input case requests and manage their subscription information. This user interface enhances the user experience, making it more convenient for attorneys to interact with the system or computing system. In some embodiments, the computer system is designed to prioritize access to legal cases as described In some embodiments. In some embodiments, a non-transitory computer-readable storage medium is provided, encoded with instructions that, when executed by a computer, cause the computer to perform the method of prioritizing access to legal cases among attorneys based on their subscription levels and other relevant criteria.

In some embodiments, the potential client (i.e., a first user) creates an account and submits raw information associated with their potential case. In some embodiments, users may be able to select anonymous, which may change what the ‘legal professionals’ see on their list of cases, their searchable lists, or what they may see on their ‘conflicts check.’ Anonymous may be a selection in which instead of displaying their ‘name’ or ‘contact information’ or ‘sensitive’ information, it may show or allow other forms of communication instead so that user two may be able to contact user one and ask user one if they are able to share their information privately with user 2. In some embodiments, user 1 information may be anonymized, and user 2 may display alternative information rather than the information that was then anonymized. In some embodiments, documents or any uploaded information may be changed, submitted, or downloaded by user 2 only after they are approved by user 1 or the person who uploaded the content or information. In some embodiments, The raw information may include the name of the submitting user, the name of the potential defendants, dates associated with the incidents, records which may include but not be limited to (e.g., medical records), whether a criminal case is pending, etc.) In some embodiments, This raw information may also include a video statement, whether uploaded or recorded, of any relevant information associated with the incidents. In some embodiments, This raw information may be processed using a large language model to anonymize names or other entities which may include but not be limited to (e.g., anonymizing any identification information or contact information) mentioned in the submitted information. In some embodiments, Once the raw information is processed, the processed information is entered as a record in a database. In some embodiments, The first user may have the option to review and revise the processed information before entering it into a database. In some embodiments, The first user may receive a message indicating that the processed information (but not the raw information such as name and/or contact information) may be available for viewing and interacting with by second users (firms/attorneys/paralegals/legal funders, etc.) with access to the database. Any reference to the database may refer to multiple databases. In some embodiments, an administrative user which may include but not be limited to (e.g., a computer, a human, etc.) may review the processed information and/or the raw information before the processed information is published for viewing by second users.

In some embodiments, augmented information generated using one or more large language models may be added to the processed information. In some embodiments, This augmented information may include expected case or settlement value, litigation history of a potential defendant, other information which may include but not be limited to (e.g., publicly available information) of a potential defendant, etc.) In some embodiments, users may submit case-related information based on their cases by including but not limited to which may include but not be limited to (e.g., answering questions, selecting pre-made questions or answers, choosing from a drop-down menu, choosing pre-selected questions or answers, typing in their answers in a box or a type-in section, recording or uploading a video statement, uploading documents, selecting answers, selecting pre-selected answers, inserting information and an artificial intelligence model may process the information and put it into a form or a uniform format for attorneys to understand or view or process each case based on the uniform method or data shown for each case, or artificial intelligence may process the data and put a number or a value on the case and or process it for attorneys to review the amount of value for their case, or their information may be process into a format that is easy to read or understand or view or read their data different from exactly how they wrote it, etc.)

In some embodiments, a method for processing textual data is disclosed. In some embodiments, The method commences with the reception of user input by selecting a pre-written question. In some embodiments, It then proceeds to extract textual data relevant to the chosen question. In some embodiments, the extracted textual data is subsequently subjected to analysis to identify factual or key information. In some embodiments, Based on the identified factual or key information, a concise summary of the textual data is generated. In some embodiments, This concise summary is then either stored or presented for data analysis purposes. In some embodiments, the method described allows users to customize the parameters governing the generation of concise summaries. This enables users to tailor the summarization process to their specific needs and preferences. In some embodiments, a computing system for simplifying textual data for data analysis is presented. In some embodiments, this system encompasses a user interface designed to receive user input when selecting pre-written questions. In some embodiments, It also may include a data extraction module responsible for extracting textual data related to the chosen question. In some embodiments, Further components of the system or computing system consist of a text analysis module tasked with identifying factual or key information within the extracted textual data and a summary generation module for generating concise summaries based on the identified information. In some embodiments, The system or computing system is completed by a data storage or presentation module, which stores or presents concise summaries for data analysis purposes.

In some embodiments, the computing system may include a user interface that allows users to customize the parameters used in the generation of concise summaries, enhancing the system or computing system's flexibility and adaptability to user needs. In some embodiments, a computer-implemented method for facilitating attorney case selection is provided. The method initiates with a computing software system receiving bids from a group of attorneys, indicating their interest in viewing cases stored in a database. Subsequently, the bids are analyzed according to predetermined criteria, encompassing case relevance, attorney experience, and bid amount. The method proceeds by determining a winning bid for each case, with the winning bid corresponding to the highest bid that satisfies the predetermined criteria. In some embodiments, the selected cases are granted access to attorneys associated with the winning bids. In some embodiments, there may be bidding on case leads or case information. In some embodiments, there may be immediate bidding or bills due for case leads or pre-payments for case leads or case details. In some embodiments, a conflicts check may be built in before a legal professional or attorney may be able to look at the details of the case, see the names of the parties of the case, view the adverse party or parties, or view any specific details of the case or the potential issue or conflict or legal issue. In some embodiments, there may be an undo tab for closing cases or a change once someone has requested to complete or close a case or remove a case from the database. Some embodiments may have a sublist for interested and uninterested cases. In some embodiments, ‘Did you sign a contract’ may be a pop-up or a ‘contract has to be signed’ to continue. In some embodiments, ‘contracts may be signed to continue closing a case, etc.’ In some embodiments, requested cases, approved cases, viewing cases, requests to close cases, and closed cases may be options for legal professionals on their viewing tabs, etc.) In some embodiments, there may be counters or counting or data displayed on how many interactions the legal professional has on the site, such as ‘how many closed cases’ each legal professional has, or ‘how many requested cases the attorney makes’ or ‘how many approved cases’ legal professional has been authorized to view or see or obtain, etc.)

In some embodiments, the present invention provides a computer-implemented method and system for managing subscription pricing, enabling dynamic negotiation between subscribers and service providers. In some embodiments, through this system, subscribers may be able to propose lower subscription fees, which are then evaluated against a set of criteria pre-defined by the service provider. In some embodiments, this evaluation considers factors such as revenue growth, projected revenue, and other financial indicators. In some embodiments, offers meeting these criteria are automatically accepted, facilitating a flexible and adaptive pricing model. In some embodiments, bid system pricing is patent. In some embodiments, a Bid submission system on SAAS, enterprise, or subscription to request a lower price on a monthly, yearly, daily, weekly, or any time period plan or usage.

In some embodiments, Based on the Businesses' specific users or revenue at that time, they may accept or reject the bidding price or bid pricing, based on their user base at that time or based on how much money they want for that month etc.) In some embodiments, This patent application outlines a subscription-based computing system that enables dynamic negotiation of subscription prices between subscribers and service providers. In some embodiments, Leveraging a user interface and backend processors, the system or computing system allows subscribers to propose lower prices, which are then evaluated against pre-defined financial criteria set by the service provider, such as revenue growth and projected revenue. In some embodiments, one person business or entity may be rejected; one may be accepted either manually or automatically based on numerous factors about the business, or about the person or entity or computing system inputting the request, etc.)

In some embodiments, offers meeting these conditions are automatically, manually, or condition-based accepted. In some embodiments, subscribers are notified, and subscription prices are adjusted accordingly. In some embodiments, The system or computing system incorporates functionalities for analyzing subscriber usage and payment patterns and allows for the criteria to be manually or automatically updated by service providers based on their financial situation or external economic factors.

In some embodiments, Implemented on various computing platforms, including cloud services, this system offers a scalable, flexible solution to subscription pricing, aiming to optimize value for subscribers and service providers by adapting to real-time financial data. In some embodiments, ‘just posted cases’ may be a separate tab from ‘all posted cases’ which may be a separate tab from ‘ai-created cases’ etc.) In some embodiments, there may be a time disparity between case tabs or listings of tabs or showing tabs, or available tabs, based on timing, time between cases, time frequency that may be able to change, etc.) In some embodiments, any combination may be able to be made between any time periods, etc.) In some embodiments, a leaderboard may show different people, cases, types of cases, lawyers, legal professionals, settlement amounts, etc.) In some embodiments, cases, lawyers, and legal types may be offered in order based on settlement amounts awarded, how many years the attorney or legal person has been in business, how many current cases they have, how much case load, marketing preferences, etc.)

In some embodiments, the method detailed is further augmented by periodic updates to the database of cases with new case data and the notification of attorneys about new case opportunities. In some embodiments, attorneys or legal professionals may be able to search for cases, or clients or public persons may be able to search for attorneys or legal professionals that are opt-ed into allowing a random person to ‘pre-approve’ their case for the legal professional to view or consider. In some embodiments, clients or potential clients or persons may be able to ‘pre-select’ or ‘pre-approve’ attorneys to view their information or case details to consider them as clients and/or sign a contract. In some embodiments, legal professionals may be able to only access a limited amount of data before payment to view more data. In some embodiments, This ensures that attorneys may be able to access the latest and most relevant cases for their practice areas. In some embodiments, the method described may include generating a user interface that empowers attorneys to input their bids and view relevant case information. In some embodiments, This user interface streamlines the bidding process and enhances the overall user experience, making it more user-friendly for attorneys. In some embodiments, the method, as outlined in some embodiments, incorporates predetermined criteria for bid analysis. In some embodiments, these criteria may include at least one case type, case location, case status, and case timeline, further refining the process of prioritizing and allocating cases to attorneys. In some embodiments, a computer system designed for implementing the method as described in In some embodiments is presented. In some embodiments, This computer system features a processor for executing the software system, memory for storing the database of cases, bids, and bid history, and a communication module responsible for receiving bids from attorneys and notifying them of winning bids. In some embodiments, the computer system also may include a user interface that displays case information and enables attorneys to place bids, making it a comprehensive and user-friendly platform for attorneys to interact with the system or computing system. In some embodiments, the computer system is described in any way. In some embodiments, it is configured to perform the method detailed in any of In some embodiments, providing a seamless and efficient implementation of the case selection process. In some embodiments, a non-transitory computer-readable storage medium is disclosed.

In some embodiments, This medium is encoded with instructions that, when executed by a computer, enable the computer to perform the method detailed in some embodiments, ensuring the method's reproducibility and accessibility. In some embodiments, the process in which selected icons or selected lists may be used as ‘identifying information’ or ‘general information’ or ‘generally answered questions such as ‘medical records? Yes or no.’ ‘Hashtags’ or ‘blocks’ to represent a ‘fact’ or a ‘knowledge’ and displayed in a ‘formatting form’ or a ‘database form’ to be understood by another party to decide if the facts conclude that they want to learn more about a case. In some embodiments, the posted or submitted potential case database list may list the adverse party or any information listed or submitted on the original form. In some embodiments, the adverse party and name of the potential plaintiff may be listed and shown only to the approved attorneys or attorney manually or automatically approved by the potential client or the poster of the case. In some embodiments, each approval, denial, or request to view a case may or may not be notified to the potential client for each time, change, or notification. In some embodiments, the approval or denial may or may not be shown or notified to the client.

In some embodiments, a which may include but not be limited to (e.g., law firm, professional, person for a job, person needing a job, paralegal, legal assistant, recruiter, etc.) may be able to access the website, site, cases, information, sensitive information, etc.) In some embodiments, the (e.g., professional, etc.) may be able to log their preferences for type of case such as which may include but not be limited to (e.g., business dispute cases, workplace injuries, sexual assault, spinal cord injuries, medical malpractice, etc.) which may be (e.g., created, logged, recorded, preferences selected, preferences suggested, etc.) which may which may include but not be limited to (e.g., combine with or use ai-suggestions instead or combined with or in place of etc.) to create (e.g., summaries, breakdowns, suggestions, notifications, summaries, etc.) In some embodiments, some of those summaries may be a list of cases and sensitive or nonsensitive material or information regarding the case. In some embodiments, in other ways, an ai-which may include but not be limited to (e.g., suggested case or ai-created case may come from outside sources such as which may include but not be limited to (e.g., news articles, social media postings, social media information, text from social media, messages, postings, hologram messages, ai-created messages, ai-created news, news articles, news stations, news, speaking, talking, conversations private or public, podcasts, YouTube videos, videos, videos posted online, video clips, social media postings, pictures, videos, holograms, data, data gatherings, etc.) and then be placed on the internal database or suggestions or notifications, or options, or postings, or posted cases or emails or notification, etc.)

In some embodiments, any which may include but not be limited to (e.g., case, reference, suggestion, legal notice, suggestion, marketing, advertisement, news article, news posting, legal information or legal client, or legal posting, or client posting, or suggested posting, or ai-created posting, or site created posting, or computing system created posting, etc.) may come from outside sources such as which may include but not be limited to (e.g., news articles, social media postings, social media information, text from social media, messages, postings, hologram messages, ai-created messages, ai-created news, news articles, news stations, news, speaking, talking, conversations private or public, podcasts, YouTube videos, videos, videos posted online, video clips, social media postings, pictures, videos, holograms, data, data gatherings, etc.) In some embodiments, any ai-created posting or human-created posting may be able to be moved to which may include but not be limited to (e.g., request more information tab, suggestion tabs for their contact information, it may show ai-created contact information, or may show public information such as from public records, or it may show their typed in or exact contact information or contact information, etc.)

In some embodiments, separate computing system tabs may be implemented to which may include but not be limited to (e.g., combine, separate, or group, etc.) each which may include but not be limited to (e.g., type of case, status of the case, just posted cases, or all cases, or opened cases, or approved cases, or closed cases, or requested cases, etc.) In some embodiments, a which may include but not be limited to (e.g., datasheet, a data entry, a fill questionnaire, a insert information page, maybe a which may include but not be limited to (e.g., sheet, area, etc.) may be displayed or be which may include but not be limited to (e.g., active or be interactive, or showing, or make up their own questions, or insert their own information, or insert their own documents, or insert or type their own answers, questions, or questionnaire, etc.)

In some embodiments, ads may be displayed on the side, or there may be an option for users to which may include but not be limited to (e.g., create their own ads to display on the side page based on target audience, time limits, or time span, or states, or cities, or type of case, or a combination of any, etc.) In some embodiments, a client summary or a client description or a client's account of the event or tragedy or story may be converted by ai into a which may include but not be limited to (e.g., standard readable version of the words or phrases, etc.) for example, a paragraph written by the which may include but not be limited to (e.g., client or a client's representative or a client's surviving members, etc.) may be converted into two sentence in order to make it similar to read all case descriptions or case intros or case displays, or case headlines or case basic information, etc.) In some embodiments, the case description that may be written in long form may be converted by ai into which may include but not be limited to (e.g., hashtags, or categories, or sections, or pages, or areas, or types, etc.) which may be which may include but not be limited to (e.g., automatically or manually by human or computing system etc.)) In some embodiments, for example a client may type a long paragraph and it may convert into which may include but not be limited to (e.g., 25-YEAR-OLD, SEXUAL ASSAULT, NEW YORK CITY, CHURCH, URGENT, or 33 YEAR OLD, FIRED CORPORATE, TEXAS, FORTUNE COMPANY, PREGNANCY DISCRIMINATION, etc.) In some embodiments, AI language models may be used, ai, created ai. Holograms, computing systems, etc., may be used, etc.) In some embodiments, clients may be able to approve an attorney and disapprove their paralegal or legal assistant for looking at their case and reviewing their case. In some embodiments, a recorded statement may be a video upload, a summary, an AI summary, typed-in information, converted by AI information into a specific visual state or visual representation of the information, etc.)

In some embodiments, the client submitted to software or computing system, attorney or attorney assistant, or paralegal or other professional requests to view case file, the original client accepts or denies the request to view their case file, the case file may be an entire case file, part of a case file, an introduction case file, a brief summary, or the entire case file, attorney or representative or professional reviews case and decides on options such as but not limited to which may include but not be limited to (e.g., accept, denials, not interested, interested, don't like, report, etc.) legal person may now call or contact client, client then may be able to decide to formally release their docket or information, or full information or full summary, or full documentation, or case, to the attorney or professional or representative, etc.) In some embodiments, a case file may be released software to attorney or representative, or it may be deleted from software, or it may be pending until attorney or client closes the case, or it may be deleted, or it may be downloaded, or it may be read-only, or it may be sent to legal persons email or it may be converted into email to attorney or assistant, or it may be released to a 3rd party case management system, or it may be released to converted to transferred to an attorney or legal case software management system, etc.) In some embodiments, client's information may be converted into an ai-version of a picture model of their case; for example, of the attorney or legal professional is a visual learner or visual person, some pictures may show to represent the type of case, or the medical records or the injuries, or the state, or the video, or the pictures, etc.) In some embodiments, AI may convert any information into an easy-to-read system, or model or etc.)

In some embodiments, the paralegal or attorney or any professional or legal person's data, whether from the internet, imported, typed in, ai-founded from the internet, or any type of data related to that professional, may be visible, shown, sent to the client, shown to the client, displayed for the client, whether before or after approval from that attorney or person in order to view their case or to consider allow this person to view their case, or the law firm to see their case. In some embodiments, law firms may be able to request cases as a whole and not a specific attorney or representative. In some embodiments, law firms may request to view and say that they want to assign it at a later date depending on if the case is accepted by the firm's reviewers, such as the paralegals or assistants, attorneys, interns, students, etc.) In some embodiments, a summary may be shown or displayed based on the documents uploaded, any documents, and any information related to the case, whether inputted by the client or by anyone else or by the internet as public information, etc.) in some embodiments, a process may go as follows, attorney, law firm, legal assistant, paralegal, or representative may see a posted summary or listing for a case, a request to view case from potential client, client gets a notification that an attorney wants to view their case, etc.) In some embodiments, clients may be able to approve or deny each person at a law firm to handle or view their case based on who they want to handle their case, rather than what the attorneys want to assistant to the case or to view the case. In some embodiments, a client may able to say that they do not want a paralegal to review their case; they only want an attorney to review their case. In some embodiments, clients may be able to block a paralegal or assistant from viewing their case and only allow an attorney who is signed in on their account and confirmed to view their case, etc.)

In some embodiments, a summary may be sent back to the law firm stating which persons are allowed to view their case and which persons are not. In some embodiments, those denials may be blocked from that person viewing their case moving forward, but the approved persons may be able to view their case. In some embodiments, the administrator or admin may be able to view a summary of types of cases posted. In some embodiments, law firms or legal professionals may be requested to sign up with @.com emails or @ emails or emails that don't end in large corporation emails and only end in a website email such as a law firm email. In some embodiments, the computing system may block users from not signing up if they don't have the correct email, etc.) In some embodiments, a list of cases may show for cities, states, months, days, years, types of cases, types of resolution accepted such as mediation or want to go for a lawsuit, or how long a case has been posted on the site, or if they want a pro bono attorney, or if they want to expedite the process, or if they want to specify what type of solution they want or if they believe there are other victims or survivors, etc.) In some embodiments, barred attorneys may be able to view the sensitive data only; for example, paralegals may be blocked from viewing specific types of details on a case, etc.)

In some embodiments, attorneys may be able to connect their account to a paralegal account and remove them as a paralegal at any time. In some embodiments, a time may pass based on how long a case has been posted. In some embodiments, the time since the case has been posted may be the most important tab, another tab, separate tabs, premium filters, etc.) In some embodiments, cases may be shown to law firms that only specialize in that particular area, such as truck accident cases. In some embodiments, different lists such as pro bono, states, cities, workplace injuries, and types of injuries may be separated into different lists. In some embodiments, filters may be by time passed, such as two months, 3 months, weeks, etc.) In some embodiments, ai may be able to recognize a person based on their internet showcase or information about them on the internet, such as the state they work in, where they were barred as an attorney, their law school, where they work, what law firm they work at, and it may be able to create a profile for the attorney or person on the computing system without user having to input information or type out their own information, etc.)

In some embodiments, favorite cases or favorite clients or cases they want to review later may be able be an separate tab, marked, or shown in a different list for professionals or attorneys. In some embodiments, cases may show ‘attorney-client privilege information’ or it may show that there is no privileged information, or they may be a warning, or there may be a release or a document to sign, or there may be a waiver marked, or there may be a document that was signed or marked by client prior to attorney viewing their entire case, etc.) In some embodiments, there may be options on the case itself or the information that is given that may affect the folder of the case or what happens next, for example, which may include but not be limited to (e.g., message, accept case, request more information, ask for a phone call, call client, email client, send client a contract, request a video call, call client via video message, call client, etc.) In some embodiments, there may be squares or boxes, or separations for the medical records, video, pictures or information, additional information, etc.)

In some embodiments, an attorney or legal person, or professional may be professional may have a dashboard such as which may include but not be limited to (e.g., case contract proposal documents that may be editable or uploaded, editable, documents that are signed or agreed on, or send or review contracts, software agreements, documents signed, export or manage files, or case proposals, or documents signed, or paralegal or assistant agreement or law firm hiring agreement, or termination contractions, or proposals, or requests or views or cases requested or cases reviewed, or a total of cases reviewed or viewed, review or sign contracts, interested clients, proposals, review proposals, consideration cases, accepted cases, denied open cases, view case files, download case files, remove paralegal or assistant from authorization access, revoke attorney assistant, or paralegal access, view case posts, invite clients for review, invite clients, review proposals, accepted cases, all cases, cases by distance/state, messages, saved cases, request to view case, message, hashtags, picture, profile, age, etc.) In some embodiments, the intake form may be editable, changeable, not changeable, typing in, giving your story, and it types or fills in the information based on your summary, changes your summary to an attorney-readable version, etc.)

In some embodiments, on the intake form or ‘case post’ form, you may be requested to answer specific questions, and the computing system may block the user from moving forward without the proper entering or information or doing it based on the instructions, drag and drop file upload, etc.) In some embodiments, law firms or professionals may be able to type in their preferences or show the specific type of cases they have experience in or select, for example, business dispute cases, workplace injuries, retaliation, employment issues, etc., and then their logged preferences may be combined or sent or evaluated by ai software and ai may suggest specific or certain type of cases based on those preferences or keyword without the use of filters or searching, etc.) In some embodiments, AI may suggest summaries or preferences or types of cases, etc.) In some embodiments, AI may auto request to view cases based on their previous activities or preferences or learning machine learning preferences, and AI may be able to send client a request to view cases, or even a contract that is specific to them, or schedule a call, or schedule a video call. In some embodiments, AI may be able to auto-suggest a video chat, video call, or call or email to send to client or to discuss their case, etc.)

In some embodiments, which may include but not be limited to (e.g., medical professional or medical person, or medical assistant, or receptionist, or assistant, or surgeon, or doctor, or client, or nurse, etc.) may be exchanged for any word such as which may include but not be limited to (e.g., attorney, client, assistant, paralegal, law firm, etc.)

In some embodiments, user 1 submitted form or data or information may be processed into not showing ‘sensitive data’ such as ‘identifying data’ such as first and last name or adverse party’ when posted publicly for all attorneys or legal professions to view. In some embodiments, the process in which user 1's data or submitted data or form is now showing sensitive or ‘identifying data or identifying information’ that would identify the person who submitted the form when the ‘user 2’ or ‘legal professional views the list or gathered data or gets an email or gets a notification or clicks or views the database list. In some embodiments, artificial intelligence may be used to obtain data from (e.g., ‘legal professionals’ history, work, profile, picture, website, work history, cases, etc.) and use that data to which may include but not be limited to (e.g., connect, match, suggest, show, etc.) cases that may be of interest to the attorney based on any or some of their which may include but not be limited to (e.g., skills or knowledge or area of expertise, etc.)

In some embodiments, artificial intelligence may be used to gather work history, data, wins, educational background, etc.) from any computing system or internet and use that information to auto-fill in a ‘professional’ profile or work profile. In some embodiments, artificial intelligence may be used to gather data from public information or records such as public filings, news articles, news, social media posts, social emails, leaked emails, etc.) to make an ‘Artificial-intelligence posted case’ on the website or site or database or computing system’ which would add to the list of unrepresented cases on the website or site or database.

In some embodiments, Attorneys may be able to review these cases, view these cases, see these cases, or get updates on these cases similar to any other cases they would receive information about or be able to search for or be able to see in the database or be able to contact or be able to request more information. In some embodiments, artificial intelligence may gather work emails, emails, addresses, and phone numbers of unrepresented clients, such as ‘public information or posted on social media problems or cases’ and gather that information and turn it into a post on the computing system inserting the information that is of public knowledge such as ‘registered addresses or email addresses’ on any database or public records search. In some embodiments, artificial intelligence may analyze or gather new public data such as ‘news articles’ and post potential cases or details that may be a case for attorneys or legal professionals to review and reach out to the client themselves, etc.) In some embodiments, once a legal professional requests a case and the potential client accepts their request to view it, there may be an option for the legal professional to send an immediate calendar invite to schedule a discussion live over the phone or via video chat or in-person to go over the case with the potential client, etc.) In some embodiments, drones may be able to deliver a lawsuit or paperwork, or serve a paper or a client, etc.)

In some embodiments, The system or computing system described herein provides a method for managing the posting, viewing, and interaction with business leads on an online platform, etc. In some embodiments, This method allows lead posters to submit business opportunities, which are then made available to potential claimants under a structured access model, etc. In some embodiments, When a user posts a business lead, the platform captures all relevant details, including the nature of the business opportunity, contact information, and any additional information that may be pertinent to potential claimants, etc. In some embodiments, The lead poster may also set restrictions on who may view the lead immediately based on subscription status and may pre-approve specific users to view the lead based on their profiles or links to other profiles, etc. In some embodiments, Upon posting, the lead enters a predefined restricted access period during which only premium subscribers may view the details of the lead, etc. This period may vary based on the platform's settings or the lead poster's preferences. Premium subscribers are granted immediate access to the lead, allowing them to claim it or initiate contact with the lead poster before others have the opportunity. In some embodiments, Non-premium users are informed of the existence of new leads but are unable to view the full details until the restricted access period expires, etc. In some embodiments, During this time, they may opt to wait or upgrade to a premium subscription to gain immediate access. In some embodiments, If they choose to wait, they are notified when the restricted access period ends, or it may appear on their timeline or their dashboard or their area, or their view with no notification, etc. In some embodiments, provided the lead has not already been claimed or marked as “in process” or “taken.” In some embodiments, Non-premium users may still view leads potentially claimed by premium users but with a lower likelihood of engaging the lead poster, who may already be in discussions with another party, etc. In some embodiments, ‘taken’ may be marked or not marked, and it just means that someone has already contacted them or had the opportunity to do so by being able to view their lead first, etc. In some embodiments, users may be able to update their email with approval from admin or 3rd party service, etc. In some embodiments, When a premium subscriber claims a lead, the platform updates the lead's status to “in process” or “taken,” depending on the actions of the subscriber., etc. In some embodiments, Leads marked as “taken” remain visible but are flagged to indicate that they may not be available for further discussion, etc. In some embodiments, This transparency ensures that non-premium users are aware of the lead's current status and may make informed decisions about whether to pursue the opportunity. In some embodiments, Users may create and manage profiles that include pictures, business details, and contact information. In some embodiments, Lead posters may view these profiles and pre-approve certain users for immediate access to their leads based on relevant criteria, etc. In some embodiments, This feature allows for more targeted and efficient matching between lead posters and potential claimants, etc. In some embodiments, The user interface is designed to be intuitive, allowing users to easily navigate between available leads, claim opportunities, manage their profiles, and track the status of their interactions. In some embodiments, The dashboard provides a central hub for managing all aspects of the user's experience on the platform, including lead management, profile updates, subscription settings, etc. In some embodiments, The premium subscription model offers several enhanced features, including early access to leads, advanced search and filtering options, and access to more detailed information within each lead, etc. In some embodiments, These features provide a competitive advantage to premium subscribers, enabling them to act quickly and effectively in pursuing business opportunities.

In some embodiments, the user may have a Dashboard or computing system or visuals of (e.g., statistics regarding potential cases, potential clients, video calls, video recordings from calls, phone call recordings, phone calls, potential client information, lead information, case information, number of cases, number of clients, number of requests, number of approvals, approved profiles, approved case details, etc.) In some embodiments, users may be able to Manage employees, approve employees, confirm employees, unlock employees' case dashboards from an attorney's dashboard based on the type of profile they claim “lawyer,” etc.)

In some embodiments, statistics may be on the side panel or somewhere listed or shown to attorneys with information regarding (e.g., how many cases they've seen, opened, requested, viewed, accepted, spoken to, how many video chats, video calls, phone calls, etc.) In some embodiments, there may be a premium filter for viewing options. In some embodiments, the attorney or managing user may be able to (e.g., manage profile access of other users, such as adding, accepting, moving, representing others, etc.) In some embodiments, users may be able to accept, revoke access to, or give access to other users on the site; for example, the attorney may be able to give access to an assistant's profile on the computing system and also revoke access if the assistant is no longer employed for example, etc.) In some embodiments, users may be able to see attorneys' profiles that have viewed their case and or download a spreadsheet or something that shows that this attorney looked at their profile on this specific day or time or both or in general, etc.) In some embodiments, users may be able to search using (e.g., tags, keywords, names, information, etc.) In some embodiments, cases may be viewed for free with no subscription required, etc.)

In some embodiments, This patent application describes a method and system for managing access to and interaction with business leads on an online platform, emphasizing a subscription-based model that prioritizes access based on user status. In some embodiments, The system or computing system allows lead posters to pre-approve specific users for early access, while non-premium users may access leads after a waiting period, provided they remain available. The platform may include comprehensive tools for profile management, lead tracking, and communication, all designed to optimize the process of connecting lead posters with interested parties. In some embodiments, Premium subscribers gain significant advantages through early access, detailed lead information, and advanced filtering options, making this system an effective solution for managing business opportunities in a competitive environment.

In some embodiments, a visual device may be worn around the body, which may include the face or eyes; a visual may appear from the computing system into the device or in front of the device, or hologram or holographic. In some embodiments, dates may be visual or streamed via a medical device, portable device, handheld device, hologram device, holographic device, drone device, etc.) In some embodiments, dates may be visual or visually seen through a device in which both parties or one party may be streaming a visual, sound, experience, etc.) In some embodiments, visual experiences may be seen or experienced using other devices such as touch, hands, senses, smell, visuals, hearing, etc.) In some embodiments, experiences may be connected to physical devices in which people may be able to experience visuals or experiences or streaming or videos or visuals through the use of streaming or visuals, etc.) In some embodiments, a physical device may enter the body, touch the body, feel the body, feel the senses, create senses such as smell or products, etc.)

In some embodiments, When a (e.g., firm, attorney, client, person, ai) etc. and/or a (i.e., a second user, (e.g., other users, user, client, person, human, ai, system,) creates an account, the firm may enter information associated with the firm/attorney, including name, location, practice areas, experience (how many cases they have worked on, how many cases they take through to trial, how many settlements, average settlement number, average trial judgment number, etc.) In some embodiments, The second user may be presented with the records (e.g., organized/sorted/arranged, etc.) based on the information associated with the second user and/or information associated with the case. In some embodiments, For instance, the large language model(s) may be used to present the records in an order based on the suitability of the second user, which may include but not be limited to (e.g., the location of both the first user and the second user, the nature/type of the case, etc.).

In some embodiments, one or more options may be provided to sort the records (or search for the records) based on one or more parameters which may include but not be limited to (e.g., date of incident, date the record was created/processed/edited, names of first users, names of potential defendants, location of first user, location of incident, subject matter or type of case, potential $ value of case, potential length of pre-litigation or litigation, AI-generated predicted information, etc.). In some embodiments, the second user may select an option to view the raw information associated with the record. In some embodiments, In response to selecting this option, the record moves to the (e.g., “List of Requested Cases” etc.) area of the second user's account, and a notification is transmitted to the first user. In some embodiments, a notification invites the first user to approve the second user to view the raw or any information associated with the record. In some embodiments, The notification may be transmitted electronically, which may include but not be limited to (e.g., by email, text message, app notification, etc.). In some embodiments, The notification may also include information or links to the firm/attorney's profiles, including any photos of the firm/attorney, their experience/education, cases handled by them, the number of first users they have viewed, requested records for, signed up, etc.)

In some embodiments, The first user may deny the request. In some embodiments, the first user may approve the request. In some embodiments, In response to the first user approving the request, the second user receives a notification indicating that the first user has approved the request. In some embodiments, there may be different tabs or sections for ‘requested to view case files, approved case files, opened case files, taken on case files, accepted case files, accepted cases, etc.) In some embodiments, the first user's record then moves to a “List of Approved Cases” area of the second user's account. In some embodiments, The first user's contact information, video statement, documents, etc., are then made available for viewing by the second user. In some embodiments, The first user may reach out to the second user using the contact information, if desired, or through the website. In some embodiments, when the first user's record is entered into the “List of Approved Cases” area of the second user's account, the first user's record is still available for request by other users, which may include but not be limited to (e.g., law firms, attorneys, paralegals, legal funders, etc.). In other embodiments, when the first user's record is entered into the “List of Approved Cases” area of the second user's account, the first user's record is not available for request by other users, which may include but not be limited to (e.g., law firms, attorneys, paralegals, legal funders, etc.) until it is released by the second user which may include but not be limited to (e.g., the second user may be given a limited time to sign up the second user or the case is released back for other users to request).

In some embodiments, there may be a bidding or negotiation system between licensed attorneys/paralegals/legal professionals who want to view cases first/get access to view cases first, or in order to receive emails or notifications on cases first. In some embodiments, there may be a bidding or a negotiation system between licensed attorneys/paralegals/legal professionals, and the platform for those who want to view cases first gets access to view cases first or receive emails or notifications on cases first. In some embodiments, there may be a subscription tier between the platform and licensed attorneys/paralegals/legal professionals or professionals or persons that want to view cases first, second, third, a week later, or any period after they are posted, and or receiving notifications or emails or submissions directly to their inbox, email, or phone, or their assistant, or their paralegal. In some embodiments, some options of requirements may be required but not limited to Required: Type of Issue, Required: First and Last Name, Required: city and state of residence (current city/state client lives in), Required: city and state (that the issue took place in), Required: Party Case is Against (Adverse Party), Optional: age range, Optional: a brief description of the case, Optional: Upload supporting documents, Optional: Uploaded or recorded video statement. In some embodiments, it may be required but not limited to ‘Each form may reveal a different set of questions based on the type of case.’ In some embodiments, each case may have additional requirements to fill in.

In some embodiments, an (e.g., alert button, alert system, alert computing system, etc.) may be (e.g., clickable, summonable, voice-activated, physical item to click or press, timer, within the app or website, etc.) to call the (e.g., police, bodyguards, security, staff, assistants, etc.).

In some embodiments, users may be able to revoke or give access to another account, add staff members, revoke or add any other profile or any other person to give access or access their account on their behalf, accept, use, or look at profiles, or act on behalf of another profile, etc.)

In some embodiments, a selection of a type of case may result in a (e.g., specific dashboard, screen, type of advertisement, or resources specific, etc.) to that type of case or input, etc.)

In some embodiments, the Above is generally what each form may need as requirements across all forms. In some embodiments, there may be a bidding system in which a user (e.g., posts a case, sees a case, obtains a case, closes a case, sees a case, etc.) In some embodiments, a specific time frame is allotted for lawyers or professionals to bid on the user's case and give reasons why they should go with them, show them their work and explain why they want their case, or show a link to their work, or show their resume, or show why they are qualified, or why they want to help you, or why they have the tools to help you, or their place of employment, or their firm, etc.) In some embodiments, the client chooses the type of case and fills out a form or lists information in a database, software, or computing system. In some embodiments, the Professional Requests to view, for example, only the Name of Client and/or the ‘adverse party’ or some less details ‘not all the details’ that may show (instead of a full case form filled out by client or submitted by client). In some embodiments, the Professional receives only the name and location of the client and or the incident the issue or injury or incident took place or fewer details than the entire full form, and then may decide in their professional opinion if they have the tools to take this case, if there are any conflicts of interest, or if they want to proceed with viewing rest of case for whatever reason. In some embodiments, the legal professional or attorney may have a profile that may have education, work history, cases they've done, specialization, educational background, bar number, eligibility to practice law and where and what states or where, their verification status within the platform, what type of legal professional they are a.k.a lawyer, legal assistant, etc.

In some embodiments, Professional clicks (yes or no? Or some confirmation that they have completed an internal conflicts check to represent the client) to proceed with viewing the entire case. In some embodiments, the Professional now has access to the full case. In some embodiments, the Client may still be able to delete the case file at any time. In some embodiments, accepted cases are immediately deactivated from the list of available cases. In some embodiments, accepted cases or ‘taken on cases’ may be automatically deleted after 30 days. In some embodiments, lawyers, legal professionals, or any professional may only request to view the entire case or ‘open entire case’ if they have completed an internal or external conflict of interest check in regards to the client's name to see if they have any issues potentially representing the client. In some embodiments, Form to enter user details and submit (sign-in/signup) button, forgot password field-Agree to terms and conditions (one for professional and one for client). In some embodiments, For professionals, it may not allow them to move forward when it is not work email. In some embodiments, An option to choose if a user is a client or professional. In some embodiments, the user may create a list of cases or a case. In some embodiments, the list may be filtered and/or sorted with factors. In some embodiments, cases may be able to be deactivated or be in an activated state. In some embodiments, clients may view cases at any time. In some embodiments, cases may be able to be deleted not after a professional takes on a case.

In some embodiments, the user and professional may still be able to view the case that has been deactivated, and it may not be listed on the database list of available cases to view, but they may be able to edit it. In some embodiments, the Client may be able to delete a case at any time prior to the case being taken on. In some embodiments, Once the case is taken by a professional, it may automatically be deleted in the time frame or time period. In some embodiments, On the database list, it says “Request Case Details.” Legal professionals click this button. In some embodiments, the Client is informed or notified that a specific person wants to view their case. In some embodiments, they either approve or deny. If approved, it may then show (“name, location, location of the incident, party case is against (adverse party), and original case details listed on the database.) In some embodiments, once these details are shown, it says, “Conflicts Cleared? Yes or No. In some embodiments, If Yes, then further case details may show the rest of the details, such as ‘written description, uploaded documents, video message, address, email, phone number, etc.) In some embodiments, if not, then this specific case may automatically become deactivated to that specific professional. In some embodiments, they may be able to avoid seeing this case again. In some embodiments, a detailed description of the case+the professionals who have taken up that case and the professionals who have shown interest in viewing more information on the case. A form with-Required: First and Last Name, Required: city/state of current residence, Required: city/state that issue took place, Required: type of issue (case type), Required: Party Case is Against (Adverse Party) not required: a brief description of the case, age range, record documents, video upload/record, etc.) Each type of case gets a different set of questions. In some embodiments, the ‘quick case’ tab may contain required fields and/or the most important or basic information. In some embodiments, ‘quick case’ may submit a portion of information, and then there may be an option to continue with more information. In some embodiments, that information may already go into the database for ‘legal professionals’ to view, request, see, open, request to open, show up in the search bar, show up in the list of cases, show up in the case filters, show up as a new case, etc.) In some embodiments,-create a shorter version for the create case; required fields may be-state and zip code of case and client, phone, email ID, date of the incident, type of cases, Terms and conditions popup, may exclude the type of email account, link to profile on notifications, link to more details on notifications of admin, green for positive use cases and red for negative-explore, Deleted accounts receive an email and then periodic emails later-explore options, short create case form will have above req fields and a text area to enter extra information, attesting, For the longer version do a left panel that has the topics that the user may be able to click and enter details on them.

In some embodiments, the Analytics tab is used for the Admin Dashboard. In some embodiments, Main Analytics (most important) (auto-updated) How many legal professionals have signed up (means submitted for approval on the second stage) How many potential cases have been posted (even if the case has been deleted, we want to keep that as an analytical number for the record), How many times has a legal professional requested to view a case (every time a case has been requested to be viewed, this recorded number is saved even if the case has been deleted), How many cases have been ‘taken on,’ secondary Analytics (less important) (auto-updated), How many times a legal professional was denied after requesting to view a case, How many times a legal professional was accepted after requesting to view a case, How many times a first-page sign-up has been made for potential clients, In some embodiments, a computer-implemented method is disclosed for organizing and presenting information related to legal cases in a database. In some embodiments, The method encompasses a computer system that is configured to access a database containing a plurality of legal cases, each with a set of associated data points. In some embodiments, This database is designed to be searchable and sortable based on the data points, providing a comprehensive repository of legal cases. In some embodiments, A user interface is provided, enabling a user to pre-select or select a list of facts or ranges to define filter criteria. In some embodiments, This user-friendly interface empowers users to tailor their searches and obtain results that align with their specific needs. In some embodiments, The method may include a processor that executes instructions to apply the filter criteria to the database, identifying legal cases that meet the selected filter criteria. In some embodiments, this enables users to filter legal cases quickly and efficiently based on their specific requirements. In some embodiments, the method involves a processor configured to present the identified legal cases in a list or visual representation. In some embodiments, users that may register on-site or computing applications may be able to be (e.g., swiped, clicked, upwards motion, side motion in order to view each user's profile, their offer, their site, their external links, a resume, etc.) In some embodiments, attorneys may be able to show up in an order, whether swiping left to right, up and down, down and up, right to left, etc.) In some embodiments, users may (e.g., view their case offers by swiping or viewing each person's offer via a swiping-type method etc.). In some embodiments, the swiping method may be on a hologram, a holographic viewing, a 3D viewing, a drone view, a drone, a light show, a light visual state, a see-through state, etc.) In some embodiments, a case management system with a (e.g., dashboard, management tools, or any management devices may be able to be accessed by any users at any time, etc.) In some embodiments, paying staff, managing staff, managing access, revoking access, granting access to users, etc.) In some embodiments, artificial intelligence may be able to (e.g., manage dates, calendar dates, deadlines, update rules and regulations per state or city or area, update or change dates due to laws being passed, change or update cases based on passed laws or changes in laws or regulations, etc.)) In some embodiments, artificial intelligence may be able to (e.g., manage and or change clients, cases, give notifications, contact clients, give client updates, tell clients the new law or update, change or manage lawsuits, create proposals for, create or propose decisions or updates, or proposals, etc.) In response to, or based on, etc., any external or internal database information such as (e.g., live information such as law just being passed, updates on websites, updates on regulations, laws changing, or case type changes, etc.) In some embodiments, artificial intelligence may be able to put a dashboard or homepage or any notifications or ‘game plans’ for the users or attorneys or professionals that affect their cases or their divisions to take cases or their clients and be able to give the information or the proposal of changing a game plan, or proposals in changing, or suggestions, or information in order to make a decision, based on artificial intelligence running may be able to on the computing system or database or internet or external sources to gather the information that may affect the system or computing system, or clients, or dashboard, or divisions, or regulations, or lawsuits, or legal proceedings, or case management, etc.)

In some embodiments, a list of legal work, the details, the information, the clients, the parties, and then a submission to a list, and then the professional gives their bid on the legal work, how long, how many hours, the price expected to be, and the total costs, and the client either (e.g., accepts, denies, or renegotiates by requesting a lower bid or a higher bid, etc.) In some embodiments, a bid is made by the client for price plus details of what they need help with. In some embodiments, the professional either has options to accept, deny, or negotiate, or they may be able to either accept the non-negotiable price, etc.) In some embodiments, the client may be able to put their work bid in for a non-negotiable price, etc.) In some embodiments, professionals may be able to either accept, deny, call, message, learn more, non-negotiable, etc.) In some embodiments, a legal contract may be put in place with screenshots of the discussion, another written contract, etc.) In some embodiments, before closing a case, there may be a (e.g., mandatory review, such as a star review may be able to be put in place, or some type of comment or review, etc.) In some embodiments, the computing system may require comments on the (e.g., quickness of the professional or their mannerism, etc.)

In some embodiments, in anywhere the term (e.g., medical case, medical need, medical necessity, medical evaluation, medical-related need, etc.)

In some embodiments, user may be able to (e.g., request, pay, inquire, submit a group inquiry, submit a group payment, gather with other users in order to request user to do their request, etc.) In some embodiments, user may be able to (e.g., submit a request for a singer to come to a city, along with payment or just as an inquiry, etc.) In some embodiments, user may be able to submit or pre-pay for shows or tickets ahead of time for shows or tickets to shows that don't yet exist, for example user may be able to submit a request for a singer's tour in “Dallas” for example along with what they want to pay for the ticket, or actually submit a refundable payment along with their inquiry and the status or the amount or the sales may be considered in order to do a tour to a show by another user, etc.) In some embodiments, ticket sales may be able to be requested by the client or the users or the ticket-show goers, and then singer for example may be able to plan a show around that or not have a show and refund all users, etc.)

In some embodiments, ai may be able to automatically detect the adverse party and show other relevant or filed cases or past cases against the party or adverse party etc.)

In some embodiments, a user may be able to have a set rate in which in order to give a quote for legal work, medical work etc.) they might estimate how long it may take, how many hours involved, what is may include, what it doesn't include, etc.) and then send it which may or may not include a discount percentage, etc.) In some embodiments, users may increase their hourly charge and may send a quote plus a percentage or a discount, etc.)

In some embodiments, a user may be able to post jobs such as (e.g., flat tire need a change, need help with oil change, need someone to fix my sink, my taillights went out, a car is making weird noises, etc.) and other users may be able to (e.g., inquire about those postings and offer money or offer their free or exchange of services or offer free services, etc.) In some embodiments, users may be able to (e.g., send a message regarding posting or inquiry, send money, send an offer of assistance, or send their resume or their page or their links in order to be able to unlock and messaging system or a way to respond or a way to inquire regarding the inquiry, posting, job posting, etc.) In some embodiments, users may be able to post any jobs or requirements on their database, their profile, their communication device, their computing system, etc., in which other users may be able to inquire about, send resumes for, offer services for, etc.)

In some embodiments, an artificial intelligence drone may be able to be connected to your phone with a basket or a device that holds a phone or a camera or the latest new technology in order to get better shots than existing with a drone, etc.) In some embodiments, the drone may be able to carry a phone or a device or a camera and make any device fly and film; there may be connections that user may be able to control it from their phone or another device while it is in the air or flying or moving by itself or being controlled in a moving manner, etc.)

In some embodiments, in some computing systems, for example, as an (e.g., client or user, etc.) is (e.g., typing, speaking, voicing, speaking, searching up, writing, etc.) (e.g., what happened to them or why they need an attorney or help or assistance, etc.) artificial intelligence may be (e.g., reading, studying, searching, etc.) what they're (e.g., writing, needing, voicing, suggesting, etc.) that this may be a for example ‘sexual assault case’ and then it may show similar cases such as legal known cases that may be already public, etc.) or it may show (e.g., suggested attorneys, what categories [type of case], or it may show suggested law firms, or it may show suggested actions on the site, or actions in real life such as finding a rape center that is local to their location, or therapists near me, etc.)

In some embodiments, case type may be able to be used for analytical purposes or put into analytics or case data formatting or visuals or graphs. In some embodiments, case types may be able to also be added as tags to existing or main case types, for example, car accident cases, plus tags that may contain information such as ‘truck accident, spinal cord injury, emotional distress, loss of enjoyment of life,’ etc.) In some embodiments, computing systems may be

In some embodiments, Each legal case that matches the selected filter criteria is displayed as a separate piece of data in the list, distinct from non-matching legal cases. In some embodiments, this visual representation simplifies the process of identifying relevant legal cases. In some embodiments, the method also features a processor configured to order the identified legal cases in the list based on one or more factors, which may include relevance, recency, the degree of match to the selected filter criteria, or user-defined criteria. This ensures that the most pertinent cases are prominently displayed in some embodiments. In some embodiments, the method may include a processor that dynamically reorders the list as new data points are added or updated, ensuring that a legal case matching the filter criteria is brought to the top of the list or displayed in a specific manner in real time. In some embodiments, This real-time updating enhances the user experience and ensures the most relevant cases are continuously prioritized. In some embodiments, the user interface allows users to interact with the legal cases in the list, including accessing detailed information about each legal case. In some embodiments, this comprehensive interaction capability makes it convenient for users to explore and learn more about the cases they are interested in. In some embodiments, The method also involves a processor configured to update the list and reorder the legal cases as the user interacts with the legal cases in the user interface, adapting to the user's preferences and choices in real time. In some embodiments, the processor is configured to store the filter criteria for future use and allows users to save, modify, or delete the criteria. In some embodiments, this feature enhances user flexibility and saves time by enabling the reuse of filter criteria. In some embodiments, the processor is equipped to notify the user when new legal cases that match the selected filter criteria are added to the database. In some embodiments, This keeps users informed about relevant developments. In some embodiments, the processor provides reporting and analytics based on the selected filter criteria and user interactions with the legal cases, offering users valuable insights and data-driven information.

In some embodiments, this computer-implemented method provides a powerful and flexible system for organizing and presenting legal case information, catering to the unique needs and preferences of users in the legal field. In some embodiments, exporting data may not be allowed at all. In some embodiments, attorney-client privilege may be implied or understood or given at the top of the screen when information is presented to the attorney to review after being manually approved for an attorney or legal person to view their case details for the purpose of deciding whether or not to take their case. In some embodiments, automatic deletion of files, information, and sensitive information may be kept. In some embodiments, even the ‘type of case’ or any part of their information that may be identifying may not be kept or deleted.

In some embodiments, The required ones above remain the same across all types of case forms. How many times a first-page sign-up has been made for legal professionals, legal professional database master client list (exportable by CSV file, google file, other file types, etc.) (auto-updated, meaning every time someone signs up, etc.), database list of all emails, phone numbers, state, type of cases they are interested in, first and last name, type of professional they are (licensed attorney, paralegal, legal assistant, other), etc.) (everything may be saved even if they don't proceed, profile photo does not need to be saved), Potential Client Database Master Client List (exportable by CSV file, google file, other file types, etc.) (auto-updated, meaning every time someone signs up, etc.), Database list of all emails, phone numbers, state, type of cases they have posted, first and last name, etc.) (everything besides the case details, everything may be saved even if they don't proceed), In some embodiments, advertising or paid advertising or shown ads, or advertisement may be based on the user clicking a selection such as ‘type of case’ or ‘potential client’ or ‘legal professional’ etc.) In some embodiments, a video statement or an upload with an icon may give information about how to make the video when hovered. In some embodiments, videos may be uploaded, or documents may be uploaded.

In some embodiments, if a legal professional decides to take a case, the client may be required to accept this, or they may remove their case from our database using the honor code. In some embodiments, the client may not be able to obtain the case details back if a legal professional or an attorney has selected that they have decided to take their case on. In some embodiments, the client's details may be able to export or be exportable by the client after submission or after their case has been accepted by the attorney, legal persons, or law firm. In some embodiments, A submit button—to proceed and a back button—to go back. In some embodiments, allowed documents are PDF, word, spreadsheet, PNG, PDF, screenshots, etc.) In some embodiments, video size may be anything required for a video, such as a video link, a private or public video link, an uploaded MOV, or any video file type. In some embodiments, multiple videos, documents, and pictures are allowed to be uploaded with no upload limit. In some embodiments, all documents may be saved or exported only by a professional who takes on the case, the chosen professionals, or the approved professionals who receive that data. In some embodiments, Until the case is taken, all information uploaded is viewed only with no option to save any. In some embodiments, options to download case details or case or information regarding a case may be approved or not approved, asked to be approved, automatically approved by the client, etc.) In some embodiments, emails or triggers may be submitted or sent to their email based on their notifications or what they want to have trigger emails for or the type of trigger emails or emails regarding their status, or emails regarding if a case has been pre-approved, approved, taken, or any other important details, etc.) In some embodiments, trigger emails or notifications may be related to how frequently they want to be notified regarding their account or their dashboard or their statuses, etc.)

In some embodiments, the User may only be able to add “documents” or “notes” in a note section after the case has been created. In some embodiments, Clients may be able to delete a case and restart a new case at any time if they mess up. In some embodiments, After a professional shows interest, no case may be able to be edited, only added documents or a “notes box or tab.” In some embodiments, the Client may be able to delete the case at any time until someone takes the case. In some embodiments, if someone takes the case, it may automatically be deleted after 30 days. In some embodiments, On the database list, it may say “Request Case Details.” In some embodiments, a legal professional clicks this button. In some embodiments, the client is notified that a specific person wants to view their case. In some embodiments, they either approve or deny. If approved, it may then show (“Name, location, location of the incident, party case is Against (Adverse Party), and original case details listed on the database.) In some embodiments, Once these details are shown, then it says, “conflicts cleared or something similar or asks if there has been some type of internal check to make sure representation may be able to take place, etc.) In some embodiments, yes or no may be an option. In some embodiments, if yes or there is an indication of no internal conflict for representation, then further case details may show the rest of the details, such as ‘written description, uploaded documents, video message, address, email, phone number, etc.) In some embodiments, if not, then this specific case may only automatically become deactivated to that specific professional. In some embodiments, they may not be able to see this case again. Detailed description of the case+the professionals who have taken up that case and the professionals who have shown interest in viewing more information on the case. In some embodiments, the User may only be able to add “documents” or “notes” in a note section after the case has been created. In some embodiments, Clients may be able to delete a case and restart a new case at any time if they mess up. In some embodiments, After a professional shows interest, no case may be able to be edited, only added documents or a “notes box or tab.” In some embodiments, the client may be able to delete the case at any time until someone takes the case. In some embodiments, if someone takes the case, it may automatically be deleted after 30 days. In some embodiments, On the database list, it says “Request Case Details.” In some embodiments, a Legal professional clicks this button. In some embodiments, the Client is informed or notified that a specific person wants to view their case. They either approve or deny. In some embodiments, If approved, it may then show (“Name, location, location of the incident, Party Case is Against (Adverse Party), and original case details listed on the database.) In some embodiments, once these details are shown, it says, “Conflicts Cleared? Yes or No.

In some embodiments, the various features described in this disclosure may be able to be used in a dating application or web application, for example, a woman creates a dating profile, having only one photo or piece of information that is available to the public or to users, e.g., men, a man must request the woman to approve the viewing of her full profile, her full profile may have more photos and or more information about her. If the woman approves the man's request, the man may receive a notification and may now be able to view the full profile of the woman. The woman would have full access to the requestor's profile to decide whether or not to approve or deny. In the denial, the man may never be able to view her profile again. The woman may be able to change her mind and allow him to view it later. In some embodiments, one user may request to view the entirety of a profile, the user 2 or any other person may be able to accept, deny, or give a reason for a decline, or decline for a reason and prompt the user to return when they fixed reason, etc.) In some embodiments, the user may be shown a short amount of data or a low amount of data, such as one picture and a limited amount of information, and the user may have to request to view a profile or request to view information or request to view lead, or request to view the rest of the information, etc.) In some embodiments, users may have to request to open a messaging platform or system or messaging option between user 1 and user 2 based on approval, viewing, or acceptance of their profile, etc.)

In some embodiments, a food delivery app may add a price in order to view a special menu or make special requests. In some embodiments, a food delivery application may have a process where a user may be able to add a tip, a price, a fixed fee, etc., in order to order from a secret menu, view a hidden menu, or have items specially made that are not listed on regular menu or non priced menu or free menu or non-subscriber menu. In some embodiments, users may be able to subscribe to restaurants, etc.)

In some embodiments, The present invention discloses a computer-implemented method and system for generating new postings on an application or software platform. T In some embodiments, the system or computing system receives news data or filing data from various sources such as online news articles, blogs, social media platforms, patent filings, regulatory filings, and financial reports. In some embodiments, natural language processing techniques are employed to analyze the received data and identify relevant topics or subjects. In some embodiments, by utilizing machine learning algorithms, new postings are generated based on the identified relevant topics or subjects. In some embodiments, These postings are then published on the application or software platform. In some embodiments, the system or computing system monitors user engagement with the new postings and adjusts future posting generation based on the observed user engagement. In some embodiments, The present invention relates to an AI-powered system and method for automatically generating new postings on an application or software platform based on news data or filing data obtained from various sources. In some embodiments, The disclosed invention addresses the aforementioned challenges by providing a computer-implemented method and system for automatically generating new postings on an application or software platform. In some embodiments, The system or computing system leverages news data and filing data obtained from diverse sources, including online news articles, blogs, social media platforms, patent filings, regulatory filings, and financial reports. In some embodiments, Upon receiving the news data or filing data, the system or computing system employs natural language processing (NLP) techniques to analyze the textual information, artificial intelligence, or manual or human-assisted creation. In some embodiments, human assistant AI-creation may be able to be implemented. In some embodiments, a human may be able to prompt, direct, or train an AI model. In some embodiments, These NLP techniques may include tokenization, part-of-speech tagging, named entity recognition, sentiment analysis, topic modeling, and text summarization. In some embodiments, Through this analysis, the system or computing system identifies relevant topics or subjects that are of interest for generating new postings.

In some embodiments, These machine learning algorithms may include deep learning models, recurrent neural networks (RNNs), convolutional neural networks (CNNs), or generative models. The generated postings are tailored to appeal to the preferences and interests of the target audience. In some embodiments, Once the new postings are generated, they are published on the application or software platform; this may result in enhancing the content available to users. In some embodiments, the system or computing system continuously monitors user engagement with the new postings. By analyzing metrics such as views, likes, shares, and comments, the system or computing system evaluates the effectiveness and relevance of the generated content. In some embodiments, based on the observed user engagement, the system or computing system dynamically adjusts its posting generation strategies. In some embodiments, This adaptive approach ensures that future postings are optimized to maximize user satisfaction and engagement. In some embodiments, Automation: The invention automates the process of content generation, reducing the need for manual intervention. In some embodiments, By analyzing news and filing data, the system or computing system ensures that the generated postings are relevant to current events and topics. In some embodiments, Monitoring user engagement allows the system or computing system to adapt and improve its content generation strategies over time, leading to higher levels of user engagement. In some embodiments, The use of natural language processing and machine learning techniques enables efficient analysis and generation of postings. In some embodiments, the disclosed invention provides a novel solution for automatically generating new postings on an application or software platform. In some embodiments, leveraging news data and filing data, combined with advanced NLP and machine learning techniques, the system or computing system produces relevant and engaging content for users. In some embodiments, the system or computing system's adaptive approach to posting generation ensures continuous improvement and optimization based on user feedback and engagement metrics.

The use of a progress bar, stepper, or progress visual that shows the case progress. In some embodiments, a stepper or progress bar may be shown at each stage, or a progress bar page or visual state that shows where each ‘case’ or ‘client’ or ‘client's case’ is in the process of being picked up by a legal professional or an attorney. In some embodiments, a progress bar is present for each individual case. In some embodiments, each case has its own progress bar, button, or visual state that shows where the case is progressing. In some embodiments, each attorney may show their own progress, or each client may show their own progress. In some embodiments, each case may have its own progress. In some embodiments, In some embodiments If Yes, then further case details may show the rest of the details, such as ‘written description, uploaded documents, video message, address, email, phone number, Detailed description of the case, + all information listed by client when creating this case. In some embodiments, if not, then this specific case may only automatically become deactivated to that specific professional. In some embodiments, this professional and other professionals listed at the same workplace may not be able to see this case again. − List of cases the user created. In some embodiments, the Client may be able to make up to 3 cases simultaneously. In some embodiments, The List may be able to be filtered and/or sorted with factors cases that may be able to be deactivated or activated state. In some embodiments, clients may view cases at any time. In some embodiments, the Client may be able to delete a case at any time prior to the case it is taken on. Once the case is taken by a professional, it may automatically be deleted in 30 days. In some embodiments, the user and professional may still be able to view the case that has been deactivated, and it may not be listed on the database list of available cases to view, but they may be able to edit it. Updated: A form with-Required: First and Last Name Required: city/state of current residence, zip code, distance, mile radius, (required separate insertions of city and separate choosing of state. Drop down menu state, type-in city) Required: city/state that issue taken place (required separate insertions of city and separate choosing of state. In some embodiments, Drop down menu state, type-in city), Required: type of issue (case type), Required: Party Case is Against (Adverse Party) not required: brief description of case, age range, record documents, video upload/record, etc.) Each type of case gets a different set of questions. In some embodiments, The required ones above remain the same across all types of case forms

In some embodiments, upon signing up, the first user to represent them, the second user, or the first user may select an option indicating that the second user has signed up the first user. The first user's record is then deleted from the databases. In some embodiments, the agreement of representation may be transmitted through the application or website such that the signature of the first user and the second user on the agreement may be accomplished through a third-party plug-in that would enable such an agreement with electronic signatures. A message board or inbox may be provided for the first user and the second user to negotiate or exchange messages regarding the contingency fee percentage or any other matters associated with the representation. In some embodiments, the system or computing system may enable the first user and/or the second user to conduct voice and/or video calls through the system or computing system. In some embodiments, a certain period after the second user requests the first user's record, the second user is sent a reminder to contact the first user, the second user is sent a message indicating whether the second user signed up the first user, etc.) In some embodiments, additionally, the first user is sent a message asking whether the first user has been signed by the second user. In response to receiving information indicating that the first user has been signed up by the second user, the first user's record is deleted from the database. In some embodiments, all potential clients' email or first and last names or no sensitive material may be kept in the system or computing system or exported or kept for analytical purposes. In some embodiments, an attorney, legal professional or professional or user, or person may now be listed on the Pre-Approval submission list, where the computing system may allow Potential Clients may now be able to pre-approve professional, user, or person to view their details, information, profile, etc.) In some embodiments, automatic deletion of case details may be done from the computing system where data may be deleted in any frequency or form, amount, etc.) In some embodiments, conflicts of interest, a list check, a background check, or any time the check may be able to be performed prior to admitting, accepting, responding to, checking in with, looking at, etc., a potential case, information, data, person, profile, etc.) In some embodiments, users, professionals, etc., may be able to add themselves to the list or remove themselves from the list of pre-approved submission acceptances, etc.) submission accepting, amount of data submitted, accepting requests, etc.)

In some embodiments, which may include but not be limited to (e.g., attorneys or law firms representatives of law firms or patent agents, or any legal assistance, etc.) may be able to review cases or ask clients if they may be able to review their case or view their case file or case information submitted. In some embodiments, the attorney's profile may be summarized, or their previous cases may be summarized into ‘easy to read the language,’ or artificial intelligence (AI using large language models) may pull their information or profile from the internet or information that may be on their official website or law firm site or google or the internet to process it down into ‘easy to read or understand biographies,’ so the client understands what they are reading and what types of cases these attorneys or personnel have done previously and how it may relate to their potentially submitted case. In some embodiments, elite subscribers or higher-tier subscribers attorneys may view cases first or get exclusive rights to view cases first, which may include but not be limited to (e.g., for a 24 or any time period before the cases are released for the lower-tier subscribers). In some embodiments, the higher-tier subscribers may receive an email or a notification when a new case enters the database. In some embodiments, the higher-tier subscribers may also receive additional processed and/or augmented information associated with a record. In some embodiments, when an attorney requests to view a case, and the person approves it, it may be locked for a period of time, or they may be able to speak to other attorneys as well during that time. In some embodiments, cases may be confidential. In some embodiments, In contrast, the network, site, employees, and software may not be able to access the confidential case file, only the approved attorney, after an approval or manual approval from the client or survivor unless otherwise chosen unlimited viewing of attorneys by potential client or standard manual approval each time. In some embodiments, attorneys may receive a follow-up notification for cases they have requested to view, have opened, seen, or responded to, etc.) In some embodiments, which may include but not be limited to (e.g., ‘adverse party’ or names or first and last name or entity, or product, or group, etc.) may be used as a ‘class action database’ to use a pay-per-subscription model or pay-per-lead model or subscription unlimited data viewing model, or a ‘receiving a notification first model’ or ‘view cases first model’ or ‘view a list of potential class action lawsuit data model’ etc.) In some embodiments, redeeming money, payments, likes, gifts, etc.) in exchange for money, stocks, investments, investment accounts, real estate, cash, etc.)

In some embodiments, a user may be able to insert or input information into an AI system or a database that may be able to analyze data and give back, for example, a risk factor associated with a case such as a contingency fee case or a legal case. In some embodiments, users may be able to ask ai or input data into a system where a percentage of winning, a percentage of return, a percentage of fees that may be won, etc.) In some embodiments, information from the AI or returned on the database may be analyzed data from input and taken into consideration information that already exists, such as publicly settled or won cases, and gives the user some type of percentage chance of winning, how much, if it's worth their time, etc.)

In some embodiments, there may be multiple-tier subscriptions for attorneys. In the higher tier, they may be able to see cases for a period of time before the cases become available to all attorneys on the database, the network, or the software. In some embodiments, cases may be submitted, and attorneys may have options to view ‘locked cases’ for 24 hours or any time period that may be time-sensitive or, new or urgent. In some embodiments, attorneys may get urgent notifications or notifications on serious or new cases. In some embodiments, pro bono attorneys or ‘law students’ or ‘legal organizations for non-profit purposes’ ‘non-profit legal organizations’ may be able to access cases with the signed legal agreement that may not be able to ‘recommend or suggest cases to any contingency fee attorneys or defense attorney or discuss cases with any non-pro bono attorney counsel for purposes of recommending or suggesting cases for contingency fee or paid representation bases’ and only operate for pro bono non-paid purposes to help or assist victims in need of counsel.

In some embodiments, case files that are submitted may be labeled as ‘pro bono’ or ‘contingency fee case’ or ‘defense attorney case.’ In some embodiments, attorneys or law firms may be able to filter through the types of cases they handle. In some embodiments, which may include but not be limited to (e.g., attorneys or law firms or law students, etc.) may be able to which may include but not be limited to (e.g., filter, separate, view cases by date submitted, or any other filter, etc.) In some embodiments, attorneys, law firms, or software may be able to advertise on-site or software. In some embodiments, clients or potential clients may be offered pictures, videos, websites, and all information related to each attorney or legal person reviewing their case. In some embodiments, they may approve or deny each person the right to review their case. In some embodiments, only the approved personnel may be able to access their case at the law firm after the client approves it, which may include but not be limited to (e.g., attorney's initial or otherwise request, etc.) through the software. In some embodiments, the potential client may receive which may include but not be limited to (e.g., notifications, alerts, emails, or messages, or a phone call whether from artificial intelligence or a live human or a pre-recorded call or from the attorney, etc.) which may include but not be limited to (e.g., explaining to them or requesting or asking or submitting a request, etc.) that an attorney wants to ‘have access to their case file to review their case.’ In some embodiments, the potential client may have to manually approve the attorney and/or their counterparts for each file or part of their entire file and approve each person or law firm. In some embodiments, attorneys may receive filtered cases based on their chosen preferences such as which may include but not be limited to (e.g., ‘landlord cases’ or ‘broken bones from a car wreck’ or ‘car wreck’ or ‘18-wheeler’ or medical malpractice’ or ‘business disputes,’ etc.) In some embodiments, there may be a which may include but not be limited to (e.g., vetting software or a vetting process or artificial intelligence process or filter, etc.) to ensure that the attorneys that sign up or pay for the software are not in-house counsel and are which may include but not be limited to (e.g., ‘plaintiff attorneys’ or ‘defense attorneys’ or handle cases for victims, etc.) to ensure the safety of victims or claims. In some embodiments, a user or client may be able to post their (e.g., budget, data, information, needs, wants, etc.) and another user may be able to (e.g., respond, message, insert information, share data, etc.) In some embodiments, user may be able to increase budget whenever they want on their (e.g., bid, budget, etc.)

In some embodiments, the Account of a professional may allow a photo and or need approval for photos or videos. In some embodiments, case preferences and states may be able to be like tags, tabs, or keywords in the search panel. In some embodiments, there may be options to switch sides on admin, client, or professional views. In some embodiments, the legal professional or attorney may have another professional that may be ‘represented by.’ In some embodiments, links may be clickable to external sites, viewings, other web domains, etc.) In some embodiments, filters may include but are not limited to the state of incident, date of incident, state of current residence, etc.) In some embodiments, some links or options to be included in the professional profile may be law firm links, legal links, etc.) In some embodiments, interested or not interested may be on the legal professionals' case lists or sections or parts. In some embodiments, clients or those who need legal help may be able to remain anonymous by clicking a button or doing something that remains their name or information or part of their information as showing less or changed information from the information that is actually there, or modifying the information, or showing different information instead, etc.) In some embodiments, an ai may be able to input information regarding ‘type of case, client's or person's age, their resources, their abilities, their financials, etc.’ and come up with some type of a ‘output plan for the survivor to be able to get the assistance or the help that they need, etc.

In some embodiments, a user may be able to submit a price for a procedure, cosmetic surgery, surgery, medical request, medical need, etc., and another user may be able to approve, deny, or counteroffer a price, or a note or a negotiation via a computing system, etc.) In some embodiments, medical treatments, medical reasons, and medical offers may be able to be submitted through the system or computing system or computing system, and other users may be able to agree to the terms of the price, bid, method, and negotiation, or there may be a counteroffer or counter bid or counter contract that may ensue a contract, or terms, or a valid agreement, or payment for agreement or terms of an agreement, or a pre-negotiated agreement, etc.)

In some embodiments, there may be a requirement to view ‘more cases’ than the ‘trial amount,’ which may be able to be any amount, etc.) In some embodiments, the ‘pre-approval attorney list’ may have its own separate viewing or tab or console or option to click on a separate tab or separate viewing or separate module, etc.) In some embodiments, legal professionals may be able to click on the ‘pre-approval attorneys list button or option which would allow them to join the list.’ In some embodiments, there may be requirements to subscribe to join this list or these options, lists, tabs, etc.) In some embodiments, there may be a ‘Pre-Approval Attorney List’ Subscribe Button with or without explanation and or options to subscribe or join with or without payment requirements with or without their profile photo or their information being shown to each individual or a standard view across all, etc.) In some embodiments, on the “Pre-Approval Attorney List’ there may be ‘filters, sorters, viewing options, ways to sort or view’ by anything that may include but not be limited to which may include but not be limited to (e.g., Specialty (this means their preferred listed case types such as medical malpractice or assault listed on their profile), State Licensed (states), Office Location (states), Sorting Options: #of cases closed, #of settlements, successes, closed cases, years in business, years licensed to practice law, pictures, gender, big law, small law, self-employed attorneys, etc.) In some embodiments, the viewing of the computing system or dashboard or screen may include but not be limited to which may include but not be limited to (e.g., Attorneys I've Submitted To: Profile Picture List, View All Button, Attorney Profile List: Clickable picture of the attorney that leads to the attorney's profile page or any page or no page at all, First and Last Name of attorney, identifying attorney or legal professional's information, Licensed Attorney, attorney licensing information, ‘standing information regarding their license, #of Closed Cases, Preferred Case Type(s) of any amount, Represented by: Photo of Paralegal, Other, or Assistant, clickable photo leading to paralegal's or other's or legal professional's profile page, paralegal's or other's or legal professional's First and or Last name, etc.

In some embodiments, the ‘Submit my case for review’ button may immediately put the case into the Approved Case List tab for ‘attorney or legal professional’ and or notify legal professional(s) they have been approved to view the case, etc.) In some embodiments, the Subscription Model Flow may be as follows, for example, which may be included but not limited to, etc.) ‘The professional logs in create a profile, and gets verified; professionals may be able to see that there are premium tabs such as ‘just posted’ and ‘premium filters’ but have to subscribe to premium to access; once the user is verified and may be able to request cases, the professional has limit to requests for cases for free with no subscription, The free limited requests include all the way through each case process from request to ‘take on case’ for only the first limited that they request, Once the professional requests his limited amount number case, a screen will pop up showing “You have completed your limited free case review trial.” Click here to subscribe to the ‘Unlimited Client Data Plan’ plus show its benefits (what they get if they subscribe),

In some embodiments, The price for the ‘Unlimited Client Data Plan’ will show the current cost but may change. In some embodiments, The ‘Unlimited Client Data Plan’ price is to view and request an unlimited amount of cases only for the time period. In some embodiments, The premium option is the ‘Premium & Unlimited Client Data Plan,’ which may include the (1) ‘Unlimited Client Data Plan’ plus (all) premium filters, (3) adding the attorney to the list of attorneys or legal professionals that may be able to accept case submissions and (4) also viewing the ‘just posted’ case list. In some embodiments, cases just posted may be a separate module, tab, or section for those cases that were posted within a specific time period; after the time period ends, the cases may automatically move to the next section or tab or another tab or another section or another link or another group, etc.) In some embodiments, tabs may remain the same in all modules or tabs or sections, or the tabs may change, etc.) In some embodiments, tabs may be able to be any type, such as included but not limited to ‘Type of Case, Client State, Incident Location, Incident Date, Indicated More Victims, Adverse Party’ and or sorting options may or may not include Type of Sorting Options ‘Incident Date, #of Requests, #of Reviews, etc.) In some embodiments, you may be able to post your inquiry, and another user may be able to send an inquiry or submit their information to connect to the other user, submit their proposal, introduce themselves, etc.

In some embodiments, adverse party requirements or information, information related to parties’ intentions such as money, an adverse party intentions, sensitive matters such as time-sensitive, etc.) In some embodiments, it boosts cases or boosts Time-Sensitive urgent matters to another list, section, area, etc.) In some embodiments, self-assessed highest settlement, self-assessed biggest cases, or biggest clients, etc.) In some embodiments, I sort my last login date or any options that may show logins, frequency of submission, site activity, etc.)

In some embodiments, a status bar is shown in each part of the ‘pre-approval, pre-signing, pre-negotiation, pre-contract signing or showing, discovery, scope of work, proposal of work, proposing work, etc.’ In some embodiments, the status bar assists the customer or client in providing a status update for each part, whether it be finding a lawyer, professional, or person, and each part of the pre-negotiation. In some embodiments, a proposal is made, and the status bar may be able to show what part of the status is current for each proposal or each person, each case, each business transaction, etc.) System and Method for Managing Progress of Business Processes A system and method for managing the progress of various business processes such as pre-approval, pre-signing, pre-negotiation, pre-contract signing or showing, discovery, scope of work, proposal of work, proposing work, or similar processes. The system or computing system may include a status bar interface displayed in each part of the process. The status bar interface assists a customer or client in providing a status update for each part, including finding relevant individuals involved in the processes, and dynamically indicates the current status of each part of the processes. In some embodiments, The present disclosure relates generally to systems and methods for managing business processes and, more particularly, to a system and method for tracking the progress of various business processes using a status bar interface. In various business transactions and processes, it is often challenging for customers or clients to track the progress of different stages involved. In some embodiments, This may include stages such as pre-approval, negotiation, contract signing, discovery, proposal of work, and others. Additionally, identifying and coordinating with relevant individuals, such as lawyers or professionals, may be able to further complicate the process. In some embodiments, there is a need for an efficient system and method that enables customers or clients to monitor the status of each stage of the process easily and facilitates communication with relevant parties. The present disclosure provides a system, method, and computer-readable storage medium for managing the progress of business processes. In some embodiments, The system or computing system may include a status bar interface displayed in each part of the process. In some embodiments, This status bar interface is configured to assist a customer or client in providing a status update for each part, including finding lawyers, professionals, or other relevant individuals involved in the processes. In some embodiments, the status bar interface dynamically indicates each part of the process's current status, providing real-time visibility to the customer or client.

In some embodiments, The system or computing system for managing the progress of business processes comprises a status bar interface displayed in each part of the processes. In some embodiments, The status bar interface is designed to assist a customer or client in providing a status update for each part, including finding lawyers, professionals, or relevant individuals involved in the processes. In some embodiments, the status bar interface dynamically indicates the current status of each part of the process. In some embodiments, the status bar interface further comprises means for receiving input from a user regarding each part of the process's progress. In some embodiments, This input may include updates on completed tasks, pending actions, or any other relevant information. In some embodiments, The system or computing system utilizes this input to update the status displayed on the status bar interface, ensuring accuracy and relevance. In some embodiments, The method for managing the progress of business processes involves displaying a status bar interface in each part of the processes. In some embodiments, The status bar interface assists a customer or client in providing a status update for each part, including finding lawyers, professionals, or relevant individuals involved in the processes. In some embodiments, the method dynamically indicates each part of the process's current status on the status bar interface. In some embodiments, the method may include receiving input from a user regarding the progress of each part of the process. In some embodiments, This input may be able to be provided through various means, such as user interfaces, forms, or communication channels. In some embodiments, Upon receiving this input, the method updates the status displayed on the status bar interface accordingly, ensuring that the information remains up-to-date and reflects the actual progress. In some embodiments, The computer-readable storage medium stores instructions that, when executed by a processor, cause the processor to perform the method for managing the progress of business processes. In some embodiments, The instructions facilitate the display of a status bar interface in each part of the processes, assist in providing status updates for each part, and dynamically indicate the current status of each part on the status bar interface.

In some embodiments which may include but not be limited to (e.g., personal injury victim or survivor or person or business with claims, etc.), they may be able to submit their case file to be reviewed anonymously or considered anonymously until an attorney or user or person requests to view their confidential case file. In some embodiments, The personal injury victim may be able to review the profiles or information about the law firm or attorney that wants to view their case file and approve or deny the attorney or law firm. In some embodiments, the personal injury victim or survivor may be able to await an which may include but not be limited to (e.g., acceptance response from an attorney or acceptance of the case or have additional calls or information meetings, etc.)

In some embodiments, The personal injury victim may be able to which may include but not be limited to (e.g., approve or release, etc.) their case file to the attorney's docket case file or attorney's case management system or release their file to the attorney to begin the legal process of their case on another software system or through the original software system. In some embodiments, victims may be able to, which may include but are not limited to (e.g., review the site, leave feedback, recommend, send, etc.) In some embodiments, the which may include but not be limited to (e.g., attorney, law firm, counterparts or licensed persons, etc.) may be able to which may include but not be limited to (e.g., ‘separate, filter, search, see, view results for’ etc.) In some embodiments, the separation or filter or results viewing may be which may include but not be limited to (e.g., cases or information based on any information, etc.) such as but not limited to which may include but not be limited to (e.g., how many hours have passed since the anonymous case has been submitted for attorney reviews such as 10 hours or 3 hours, or how many days it has been on there, or how many months it has been on there, city, state, region, city, type of case, the age range of a victim, type of damages such as ‘unpaid rent’ or ‘broken arm,’ merits or the overall value of the case such as against a ‘big corporation,’ etc.) In some embodiments, each selected question may become a ‘fact box’ or a box or a list of data organized for a ‘professional’ or an ‘attorney’ to view and understand their case as streamlined in a ‘fact-based data sheet or organized data points.’ In some embodiments, a legal assistant or non-attorney may submit to view a case, which may or may not include their supervising attorney or law firm's contact information or information.

In some embodiments, The client inputs a summary of their case into a box or area for a summary. In some embodiments, As the client does that, the AI language model or AI model extracts the important words that make up a one-sentence summary that may be public to the barred attorneys or their counterparts to be able to determine what type of case it is. In some embodiments, the client may be able to see the public sentence showing their case and what the attorneys may see. In some embodiments, the case summary or sentence is anonymous. In some embodiments, it may not be tied to the client's name or identifying information, such as the company or person who hurt or damaged the client. In some embodiments, the client or victim is allowed to edit that to make it make sense if the AI doesn't have it making sense, such as “changing 22-year-old female named Jessica Joeseph work retaliation” to remove their name, for example, or if it shows their personal information. In some embodiments, AI may be able to translate other languages into English or the language of the attorneys, such as if the client speaks another language. In some embodiments, Attorneys may be required to sign up with a firm email, and they are not allowed to sign up using a common email account for privacy purposes.

In some embodiments, a marketplace in which dates may be able to be purchased or reserved and then resold to other users or people using the computing system or platform, for example, a user may be able to buy or purchase multiple dates or times or reservations or experiences and then resell them for higher prices, etc. In some embodiments, when the user opens or publishes their schedule, dates may be able to be reserved, resold, exchanged, gift cards may be able to be used, gift cards may be able to be utilized, etc. In some embodiments, there is a pre-sale auction of dates, times, places, reservations, time booking, etc. for dates, etc. In some embodiments, a user may be able to sell pre-sell auctions or pre-sale prices before the public auction or prices or ticket prices, etc. In some embodiments, each date may be seen as a ticket, which may have a printed ticket, a digital ticket, etc. In some embodiments, a date may create a ticket; the other user may be able to the ticket to begin the date, confirm the date, or create the transaction completion, etc. In some embodiments, ‘date insurance’ may be sold on top of the ticket or transaction sale for the user, etc. In some embodiments, a ticket may be sold for a date, and then the user may be offered insurance for the date or the time or the day, or for any unexpected occurrences. In some embodiments, a cell phone video or picture or may be able toner app or may be able toner method on user's phone may be able to may be able to the other user's ticket for the date, the experience, the time, the day, the date, etc. In some embodiments, user may be able to add ticket to their phone database or wallet or may be able toner via their device, etc. In some embodiments, the ticket may be holographic in the air with another holographic may be able toning device or a code via a may be able toner or type of may be able toner. In some embodiments, the code or the ticket to be may be able toned may be a picture, a code, a visual representation of something that is moving, it may be a bunch of pixels floating and creating a special code that only the person who is may be able toning it may be able to activate the code transaction or method that the code is trying to convey or complete such as a date ticket or a date transaction, etc. In some embodiments, users may have a primary marketplace where dates may be able to be reserved, paid for, auctioned off, and the user gets initial payment, etc. In some embodiments, there may be a secondary marketplace within the computing system where users may be able to resell already paid tickets, etc. In some embodiments, the initial user created the payment total and then received a reservation or payment or date reservation for that time and date, and another user pays the total, with the initial to resell the ticket and not to go on a date, the initial user still gets paid and assumes the user will show up to the date if the user does not show up due to the secondary user trying to resell their ticket, the initial user still gets paid because the user showed up for the date, etc. In some embodiments, first user may be able to raise their own prices or their tickets may be able to be sold on the secondary marketplace as a resell or as a higher price or a changed price, or a secondary user marketplace, but still within the same computing system or computing app or web app or platform, or may even be a secondary connected platform, etc. In some embodiments, there may be no refunds for the initial or secondary transaction of ticket sales, which may be for the date. In some embodiments, ticket sales may refer to a date or experience or time reservation, dinner or movie, golfing, breakfast, lunch, dinner, dessert, etc. In some embodiments, the payment of the date to obtain a ticket or transaction completion may not be refunded because it is a time reservation to the other user, so the secondary user may be able to resell the time reserved that was already paid or reserve to the first user, etc. In some embodiments, the user may be able to sell auction dates, times, reservations, times at the restaurant, food at a restaurant, payment for the meal, payment for the nightclub date, nightclub dates, nightclub sales or payments or transactions, etc. In some embodiments, users may be able to auction items, clothing, times, experiences, dates, lunches, dinners, breakfasts, tea time, gym dates, movie dates, etc. In some embodiments, users may be able to post their calendar with their pre-sell tickets, their pre-sell dates, their pre-sale auctions, their reservations, etc. In some embodiments, user may be able to charge other users to obtain their pre-sell ticket prices, or pre-sell reservations, or to see their calendar or their schedule or their dates prior to the rest of the public, etc.

In some embodiments, Ticket Purchase: In some embodiments, Online Platform: Customers visit website or mobile app or webapp, or hologram, or device, or software to browse and purchase tickets or reserve dates or reserve clothing, merchandise, or experiences, or dates, etc. In some embodiments, Selection: Users select the date or experience they want to attend, choose their seats (if applicable), and proceed to purchase. In some embodiments, Payment: Customers may be able to pay using various methods such as credit/debit cards, PayPal, or other payment options by 3rd parties. The transaction is completed through computing system secure payment gateway or through any third party that may be connected or with the computing system, etc. In some embodiments, Ticket Delivery: After payment, customers receive their tickets digitally (e-tickets), may be able to print their tickets, or may be able to opt for physical tickets to be mailed to them. In some embodiments, E-tickets may be stored in mobile wallets or accessed through the computing system, or device, or app. In some embodiments, computing systems may offer a resale marketplace where users may be able to resell tickets they have purchased but may be able to no longer use. In some embodiments, the computing system facilitates the transaction between the buyer and seller, handling payment processing and ticket delivery.

In some embodiments, The invention relates to a method and system for managing the posting and retrieval of business leads on an online platform. In some embodiments, The system or computing system allows users to post business leads, which may be accessed by individuals or companies seeking such leads. Access to newly posted leads is restricted for a predefined time period unless a user subscribes to a premium service, granting them early access. In some embodiments, If a lead is claimed by a premium subscriber during this exclusive access period, it may become unavailable to others. In some embodiments, Non-premium users may access leads after the exclusive period expires, provided the lead has not been claimed or marked as taken. In some embodiments, The system or computing system described herein provides a method for managing the posting and retrieval of business leads on an online platform, with a specific focus on prioritizing access based on a user's subscription status. In some embodiments, This method allows lead providers to submit business opportunities, which are then made available to potential claimants under a structured access model. In some embodiments, When a user posts a business lead, the platform captures all relevant details, including the nature of the business opportunity, contact information, and any additional information that may be pertinent to potential claimants. In some embodiments, Once submitted, the lead is stored in the platform's database, and its availability is governed by the system or computing system's access control mechanisms. In some embodiments, Upon posting, the lead enters a predefined restricted access period during which only premium subscribers may view the details of the lead. In some embodiments, This period may vary based on the platform's settings or the lead provider's preferences. In some embodiments, Premium subscribers are granted immediate access to the lead, allowing them to claim it before others have the opportunity. In some embodiments, Non-premium users are informed of the existence of new leads but are unable to view the full details until the restricted access period expires. In some embodiments, During this time, they may opt to wait or upgrade to a premium subscription to gain immediate access. In some embodiments, If they choose to wait, they are notified when the restricted access period ends, provided the lead has not already been claimed by a premium subscriber.

In some embodiments, When a premium subscriber claims a lead, the platform updates the lead's status to “in process” or “taken,” depending on the actions of the subscriber. In some embodiments, Once marked as taken, the lead is removed from the general availability pool, ensuring that non-premium users may not access it. In some embodiments, The system or computing system also prevents multiple users from claiming the same lead simultaneously by implementing real-time updates and status checks. In some embodiments, The system or computing system may include a notification mechanism that alerts non-premium users when the restricted access period has expired, provided the lead is still available. In some embodiments, This feature ensures that users are informed promptly and may act quickly to claim available leads. In some embodiments, the platform continuously updates the status of leads to reflect their availability, ensuring transparency for all users. In some embodiments, The user interface is designed to be intuitive, allowing users to easily navigate between available leads, claim opportunities, and manage their subscription settings. In some embodiments, The subscription management module tracks users' payment status, renewals, and access privileges, ensuring that only eligible subscribers may access premium features. In some embodiments, This patent application describes a method and system for prioritizing access to business leads on an online platform based on a subscription model. In some embodiments, The invention provides premium subscribers with early access to newly posted leads, while non-premium users must wait until the restricted access period expires. In some embodiments, If a lead is claimed by a premium subscriber, it becomes unavailable to others, ensuring exclusivity and incentivizing the purchase of premium subscriptions. In some embodiments, The system or computing system may include features for secure lead management, real-time updates, and user-friendly interfaces, designed to optimize the process of connecting lead providers with interested parties. In some embodiments, This outline covers the unique aspects of the business method and system, emphasizing the differentiated access based on subscription status and the mechanisms for managing lead availability and exclusivity.

In some embodiments, advertisements may be offered, placed, or put anywhere within the ticket or date system or website or web app, etc. In some embodiments, users may be able to use a computing system platform to manage their dates, experience times, and calendars, track sales, and gather data on attendee or date demographics and preferences. In some embodiments, For some or all events or dates, the computing system may use dynamic pricing, where ticket prices fluctuate based on demand, much like airlines. In some embodiments, the computing system may offer customer support for issues like ticket refunds, exchanges, and date cancellations. In some embodiments, They also may handle disputes between buyers and sellers on their resale marketplace. In some embodiments, AI may be able to detect the face of the person the body of the person, show the shown outfit or jewelry or piece of clothing or makeup option, and try it on directly through the computing system and or display screen, etc. In some embodiments, 3rd party apps such as photo or video editing apps or web apps may be able to be integrated into the computing system before uploading a picture or a video on the computing system, etc. In some embodiments, date or ticket Listing (For Sellers): In some embodiments, Creating a Listing: Individuals or users who have tickets, or dates, or times they want to sell, they may be able to use or want to sell may be able to create a listing. In some embodiments, Sellers set their own prices, which may be able to be higher or lower than the original face value of the tickets, depending on demand. In some embodiments, Ticket Upload: Sellers may be able to upload e-tickets directly to the computing system or ship physical tickets to buyers using a shipping method. For some events, sellers may also provide ticket barcodes, which buyers may be able to use to enter the event. In some embodiments, Sellers or users may be able to adjust their prices at any time based on market demand. In some embodiments, a computing system or platform may provide tools and insights to help sellers price their tickets competitively. In some embodiments, Ticket Purchase (For Buyers): In some embodiments, Browsing and Selection: Buyers browse platform or computing system's listings by creator, model, person, race, city, looks, hair color, body type, gender, event, date, location, or price. In some embodiments, They may be able to see the available dates or tickets, date locations, and prices set by sellers. In some embodiments, Purchase Process: Once a buyer selects date or times or tickets, they proceed to checkout. In some embodiments, webapp or app or system may charge the buyer the ticket price set by the seller, plus additional service fees (which may be able to vary based on the type of date, demand for a date, model, creator, person, event, or ticket price).

In some embodiments, Payment: Buyers pay using credit/debit cards, 3rd party methods, crypto, or other supported payment methods. In some embodiments, a web app, computer system, or 3rd party securely processes the payment. In some embodiments, Ticket Delivery: After payment, the buyer receives their tickets electronically (e-tickets) or by email, or by mail. In some embodiments, E-tickets may be able to be downloaded or accessed through the web app or computer system app. In some embodiments, tickets may be able to be transferred directly to the buyer's account on the primary ticketing platform for some dates or events. In some embodiments, it offers valid tickets in time for the event. In some embodiments, the computing system provides a replacement date ticket or a refund in some embodiments. In some embodiments, the Customer Support computing system offers customer support to resolve any issues related to ticket sales, purchases, or event cancellations. In some embodiments, The platform may integrate with mobile wallets and ticketing apps to streamline the ticket delivery, date delivery, entry process, etc.

In some embodiments, creators, models, users, may be able to list tickets directly for sale on the platform, while customers may purchase these tickets or resell them if needed. In some embodiments, users may have options such as “reflect current market conditions” or “set their own price” or “change price due to demand etc.” In some embodiments, users may be able to charge based on market demand for their date, their experience, their day, their time, their availability, etc. In some embodiments, users may be able to manage their dates, events, including real-time sales tracking, customer analytics, and targeted marketing capabilities, their marketing campaigns, their analytics, their pricing, their resell ticket allowance or their no selling of tickets, or no reselling of tickets, or choose their own customer base to sell tickets to etc. In some embodiments, users may be able to allow only paid subscribers or paid persons who have spent at least a minimum amount of money to be able to purchase tickets, dates, experiences, etc.

In some embodiments, the user may be able to pay their employees, staff, co-founders, owners, and shareholders using their wallet, their platform, the platform, the computing system, the pie share chart, and show outstanding plus what they are getting, etc. In some embodiments, the user may be able to show or make payments to their shareholders using a wallet, a crypto wallet, a shareholder wallet, a wallet for shareholders, a web app for shareholders, a payment method using shares in the company, etc. In some embodiments, a ticket may be managed or resold, or reauctioned, etc. In some embodiments, dates may be auctioned off for charities, 3rd parties, 3rd party benefits, events, experiences, etc.

In some embodiments, shares in the company may be able to be distributed using a method in which payment using USD or crypto is used, such as sending via their wallet, their ‘bank account’ payment, to pay using those ‘valid shares’ or ‘legal shares’ or ‘payment of shares’ etc. In some embodiments, payment of shares may be able to be used in the same way that payment or USD or any financial payment is made, but using a method in which ‘shares’ are shared, or shares are distributed and held in a wallet, or a legal wallet, or a crypto-similar style wallet, etc. In some embodiments, ai robotic bodyguards are being used as regular bodyguards using ai technology to view the body of the subject and make sure no hands, or bodies, or items are thrown at them or touches attempt to happen from a 3rd party or outside by blocking it by detecting the possibility of it hitting subject as the ai bodyguard, etc. In some embodiments, AI bodyguards use ‘prediction’ technology to ‘for example’ assess the possibility of the subject being hit in the face or pushed, etc., and then interfere by blocking it with the mechanical parts of the AI robot through the mechanics, etc. In some embodiments, the software then talks to the hardware to do the bodyguard blocking, moving, talking, walking, etc.

In some embodiments, A system and method for securely managing and transacting shareholder assets via a (e.g., digital or uncentralized or centralized or decentralized or crypto-style wallet, source, etc.) In some embodiments, The shareholder or founder or owner (e.g., digital wallet or bundle or source, etc.) stores shareholder keys, facilitates the creation and execution of shareholder transactions or distribution, and, or provides a user interface for interacting with various shareholder assets. In some embodiments, The (e.g., source, wallet or location or bundle etc.) ensures secure generation, storage, and use of private keys or public keys or centralized or decentralized keys or passwords, while enabling users to sign transactions, manage assets, and interact with decentralized or centralized applications. In some embodiments, a shareholder may be an employee, owner, independent contractor, worker, contract worker, associate, owner, investor, etc. In some embodiments, The shareholder wallet system comprises a digital application or hardware device designed to manage shareholder assets, such as shareholder assets or distribution of shareholder assets or currencies, etc. In some embodiments, The wallet operates by generating, storing, and utilizing shareholder keys or assets or public or private assets, primarily the public and or private keys, which are essential for shareholder transactions or distribution. In some embodiments, the wallet or distribution system may go along with whatever the laws are; for example, if it has to be public, then it is public; if it has to be private, then it is private, etc. In some embodiments, public or Private Key Generation, The shareholder wallet generates a private key using a secure random number generator. In some embodiments, The private key is a critical piece of information that allows the user to access and manage their shareholder assets. It is stored securely within the wallet, either in encrypted form on a digital device (software wallet) or within a secure hardware module (hardware wallet).shareholder.

In some embodiments, Public Key Derivation: In some embodiments, The wallet derives a public key from the private key using an elliptic curve shareholder algorithm. In some embodiments, The public key is used to generate the user's shareholder addresses, which are shared publicly to receive transactions in the form of any asset, such as shareholder assets from the company, from the owner, the founder, or from a managing partner, or board members, etc. In some embodiments, Transaction Creation: The shareholder wallet or centralized or decentralized system allows the user to create a transaction by selecting the shareholder asset, the recipient's address, and the amount to be transferred. The transaction data is compiled according to the specific shareholder protocol. In some embodiments, Transaction Signing: The shareholder wallet uses the private key or public key to sign or share or obtain or get the transaction.

In some embodiments, This signature verifies that the owner of the associated shareholder asset authorizes the transaction. In some embodiments, The signed transaction is then ready to be broadcast to the shareholder network. In some embodiments, Broadcasting Transactions: Once a transaction is signed, the wallet sends it to the shareholder network. The transaction is then validated by the network's nodes and added to the shareholder chain or public or private chain or center, updating the ledger to reflect the transfer of assets, for example, for the SEC or for the governmental regulatory agencies, etc. In some embodiments, Transaction Verification: The wallet monitors the shareholder or asset to confirm the inclusion of the transaction in a block or system or asset area or source etc. The user is notified upon successful confirmation, ensuring the transaction has been securely processed. In some embodiments, Balance Display: The wallet provides an interface that displays the balance of shareholder assets associated with the user's public keys or private keys, etc.

In some embodiments, The balance may be updated based on the latest shareholder asset data. In some embodiments, Multi-Currency Support: The wallet may manage multiple types of shareholder assets such as shareholder assets, founder assets, investor assets, dividend assets, etc., each potentially using a different shareholder asset system or showing or displaying or reporting or blocking. In some embodiments, The user may be able to select which asset, currency, or type of asset to interact with, and the wallet handles the specific protocol for each type. In some embodiments, Security Measures: The wallet may include various security features, such as biometric authentication, password protection, and backup options for private key recovery or public recovery. In some embodiments, The present invention relates to the field of electronic commerce and ticketing systems, specifically to a platform or web application that allows users to book entertainment services, obtain tickets, and manage refunds, exchanges, or transfers under varying rules and conditions set by sellers or the system itself. In some embodiments, In the digital age, the online booking of entertainment services such as concerts, theater shows, and sports events has become increasingly common. In some embodiments, Existing systems offer limited flexibility with regard to refund policies, ticket exchanges, and transfers. These systems generally impose one-size-fits-all policies, which may not be suitable for individual sellers, venues, or events. In some embodiments, There is a need for a dynamic platform that offers flexible ticketing options, customized refund rules, and the ability to manage bookings in an efficient and transparent manner.

In some embodiments, The present invention provides a method and system for booking entertainment services and issuing tickets through a web platform or mobile application. In some embodiments, The system allows for varying levels of ticket management, including the ability to apply flexible refund policies, transfer ownership of tickets, and exchange tickets based on certain conditions defined by the seller, the buyer, or platform rules. In some embodiments, Ticket Booking and Issuance: Users may be book entertainment services and receive digital tickets via the platform. Tickets may be brought to the event in person or scanned electronically upon arrival. In some embodiments, Refund and Exchange Policies: The platform enables flexible refund and exchange policies based on conditions set by the seller, the buyer, or the system itself. For example: In some embodiments, Non-refundable Tickets: Tickets may be sold as non-refundable, with clear indications on the platform during purchase. In some embodiments, Refundable under Specific Conditions: Tickets may only be refundable within a specific time window (e.g., 24 hours before the event) or under specific conditions outlined by the seller or platform rules. In some embodiments, Conditional Refunds: Refunds may be allowed if the seller provides a particular grace period for returns, such as a refund within 48 hours of purchase. In some embodiments, Ticket Transfer and Exchange: The system allows users to transfer or exchange tickets with other users, subject to conditions set by the original ticket seller or platform rules. The seller or platform may be define whether the ticket may be transferred and if any penalties or fees apply. In some embodiments, Digital Verification and Entry: Upon arrival at the entertainment service, users may present their tickets either by displaying them electronically (e.g., on a smartphone) or in print form. The tickets may be verified visually, scanned using a QR code, or authenticated via near-field communication (NFC) technology or similar methods. In some embodiments, Ticket Validity and No-Show Policies: Once purchased, tickets are valid immediately or from a specific time defined by the platform. If a user fails to attend the entertainment service and does not meet the conditions for a refund or transfer, the ticket may be considered forfeited with no refund.

In some embodiments, Seller-defined Policies: The platform allows sellers to define specific ticket management policies that apply to their entertainment service. This may include refund periods, transferability, and validity windows. These rules are presented to the user at the time of purchase and are enforced through the platform's system logic. In some embodiments, Platform-defined Policies: In addition to seller-defined policies, the platform itself may be impose certain rules, such as a minimum or maximum refund window, penalties for late transfers, or general terms of use that apply to all users. In some embodiments, The system is designed to provide a seamless user experience, where buyers may be easily purchase tickets and understand the terms of their purchase, while sellers have the flexibility to manage their events and ticket sales according to their own preferences. In some embodiments, Upon visiting the platform, the user is presented with a list of available entertainment services. The user selects an event and proceeds with the ticket booking process. During the purchase, the system displays the relevant ticket policies (refund, transfer, and exchange conditions), which may vary depending on the event or seller. In some embodiments, Once the user confirms the purchase, the system generates a digital ticket that is delivered electronically to the user's account.

In some embodiments, on each date there may be a status and timeline for each client, man, user, person, group, etc. and there may be a total report or history on that particular date, or that particular time period, or those particular clients, user may be able to add notes, upload documents such as screenshots, or upload photos and pictures, to ensure they don't forget about each date if that person asks them out on another date, for example, etc. a report may be shown daily, weekly, per user, per person, per date, per date type, per city, etc.

In some embodiments, The user may be access their purchased tickets at any time through the platform. If the ticket is eligible for a refund, transfer, or exchange, the platform provides the necessary tools for the user to initiate these actions. The system tracks deadlines and automatically disables options once they expire (e.g., after the refund window closes). In some embodiments, If a refund or exchange is allowed, the user may initiate the process through the platform. In some embodiments, The system checks the conditions, such as time limits or seller-defined rules, and processes the refund or exchange accordingly. Refunds may be partial or full, depending on the conditions. In some embodiments, Users may transfer tickets to other platform users if allowed by the ticket terms. The system validates the transfer, updates the ownership information, and ensures the new owner may be access the ticket for the event. In some embodiments, If the user does not attend the event, and the ticket is non-refundable or the refund window has closed, the ticket may be forfeited without a refund. In some embodiments, This policy may be clearly communicated to the user at the time of purchase. In some embodiments, In some embodiments, These measures ensure that the user's shareholder assets are protected against unauthorized access. In some embodiments, AI may be trained to perform internet transactions or methods, such as ‘training to edit a photo, training to edit a video, or training to go to this website and do this, or training it to post something or training it to do anything on the internet, etc.’ In some embodiments, training may be ‘editing a video and rendering the file, etc.’ In some embodiments, AI robotics may be able to give rendered files, etc. In some embodiments, the robotics may be able to learn by watching or seeing the human do the method or do the tasks, then training the AI model to perform those tasks, such as editing a video, editing a song, editing a picture, uploading documents, doing their work, doing work, sending messages, etc. In some embodiments, the AI model is then trained to manually robotically perform those using the same desktop or laptop, etc., or trained through software methods that may be done using the software and not the hardware; it may be interchangeable between hardware and software, etc.

In some embodiments, On create case form, an option to go anonymous is unchecked by default. In some embodiments, there may be two input boxes prefilled with the first and last name from the profile (it is editable). In some embodiments, the User may be able to either edit the name or keep the name as per the profile itself or choose to go anonymous, in which case there won't be any name details sent to the backend. In some embodiments, there may be an artificial intelligence language or other models that analyze the cases, the case information, the case names, and the case details, and during or once it's submitted, then it may analyze the data and depending on how it is programmed to search or identify specific types of more information that would put it into a separate tier, or category, or subscription, or notification, or category that may be paid for to view by any 3rd party or attorney or professional.

In some embodiments, The invention relates to a method and system for managing the posting, viewing, and interaction with business leads on an online platform. In some embodiments, The system or computing system allows users to post business leads, which may be accessed by individuals or companies seeking such leads. In some embodiments, access to newly posted leads is restricted for a predefined time period unless a user subscribes to a premium service, which In some embodiments, grants them early access. In some embodiments, Users may also be pre-approved by the lead poster to view specific leads based on their profile. In some embodiments, If a premium subscriber claims a lead during the exclusive access period, it remains visible to non-premium users, but In some embodiments, it may show as “in process” or “taken,” indicating that the lead has been claimed or is being discussed with another party. In some embodiments, The platform provides tools for users to manage their profiles, leads, and interactions through a customizable dashboard.

In some embodiments, the user themselves may be allowed to put a number or an estimate on what they believe their case may be worth at the time of posting, or artificial intelligence may be able to analyze the worth of the case or the potential case and separate it into tiers or category that may involve subscriptions or payments or database viewing such as a subscription. In some embodiments, it may take information from the case and compare it to public information regarding those parties, such as ‘their annual revenue’ or ‘this party has been sued for x amount of money’ or their litigation history or any publicly available information and either put a number associated with the case, or its range of estimated for successful litigation, or separate the case into a category such as a tier or a subscription tier, or a group that may have to be paid for by a 3rd party or attorneys or professionals to view these types of cases whether first, or at all. In some embodiments, artificial intelligence or a tier may be required to be a part of such as a subscription to view the publicly available information related to the case, such as ‘successful litigations, whether they have been sued in the past if they have a class action lawsuit, how much the company is worth, the contact information of the company or party, etc.) or any related information that may be separated based on subscriber tiers or groups such as ‘professionals that want to view cases first, or professionals that want to view all of the case information, or professionals that want to view the potential case's parties’ history of information in one or multiple groups together or a database viewing of a file or viewing it on the software, etc.)

In some embodiments, the seller of the tickets or the dates may be able to ‘approve or deny’ each sale of the ticket; for example, the initial user may approve the first transaction but then say they do not want their ticket resold, and only approving the first person for the date, etc. In some embodiments, the seller of the date may be able to have an open marketplace where anyone may be able to book or buy the tickets, or they may have a list of people or previously paying clients or previously paying users, or current subscribers that are able to purchase tickets, at that point the seller of the ticket may be able to determine if those tickets are allowed to be resold or not, etc. In some embodiments, ai search results of the specific search of ‘pink shirts less than 20 dollars’ may result in pink shirts coming in less than 20 for sale currently, etc. In some embodiments, there may be other ways, such as ‘pink and or purple shirts, cute logos, bubble letters, under 25,’ which may result in further or longer or more results to show what is currently being sold on the market, etc. In some embodiments, pre-approve dating profiles in which the user may be able to pre-approve who they like from a list and or search based on income, money, status, looks, education, etc. In some embodiments, the user may be able to approve profiles or pre-approve any communication from this or these person(s) or users or profiles or messages, etc.

In some embodiments, an which may include but not be limited to (e.g., app or website or software system, etc.) for centralized case in-take for lawyers to go and review it and give them an offer or a call within a certain amount of time to secure their case and sign a contract. In some embodiments, it may be Personal injury lawyers and personal injury cases or defense cases or defense lawyers. In some embodiments, there may be a Monthly, yearly, or annual fee to access the potential cases. In some embodiments, if laws or regulations allow and/or take a percentage of the recovery in the case. For example, 3-10% etc.) In some embodiments, there may be an option for a which may include but not be limited to (e.g., victim or a potential client, etc.) to record a which may include but not be limited to (e.g., periods, such as 30-minute private and confidential statement, etc.) to be reviewed by barred attorneys under confidentiality. In some embodiments, the which may include but not be limited to (e.g., personal injury attorney, attorney, or representative, etc.) makes a database request to view their case. In some embodiments, the victim gets an alert and either approves or denies the attorney, legal representative, attorney, or law firm to review.

In some embodiments, It is up to the attorney to either say this case is for me, and I'd like you to give an offer or a denied offer. In some embodiments, the ability to streamline personal injury cases without wasting additional time. In some embodiments, Any plaintiff cases, such as patent infringement cases. In some embodiments, Contingency fee cases may be required to upload all of their medical documents, evidence, etc., and record their statement. Or, in some embodiments, they may be required to submit a summary of what happened or why they need legal assistance. In some embodiments, there may be long versions and short versions of cases or options to submit a potential case to the platform. In some embodiments, there may be ‘required and not required’ options or ways to submit a case or submit information. In some embodiments, sensitive information may not be required to be submitted in case form. In some embodiments, cases or submitted information or typed or uploaded information may be deleted after a set period. In some embodiments, basic information or non-sensitive information may be stored, such as (‘type of case, first and last name, email address, phone number, state, city, etc.’)

In some embodiments, Mobile Laundry Service System with Integrated Computing for Scheduling, Payment, Tracking, and Robotic Assistance. In some embodiments, This invention pertains to the field of laundry services and, more particularly, to a mobile laundry mat system that incorporates advanced computing technology for customer convenience. It addresses the growing demand for efficient, on-demand laundry services. In some embodiments, It integrates a system for scheduling, payment, tracking, and completion of laundry tasks through various digital interfaces such as mobile apps, websites, voice command systems, holographic assistants, or robotic services. In some embodiments, The invention provides a mobile laundry mat system equipped with a computing infrastructure that allows users to schedule, pay for, and track the status of their laundry through an application, website, or voice-controlled devices. In some embodiments, It also integrates with advanced technologies like holographic assistants, robotic services, and AI-driven control mechanisms, ensuring a seamless customer experience. The system automates the entire process, from pick-up to drop-off, providing real-time updates, tracking, and payment processing. In some embodiments, The mobile laundry mat system may include: A fleet of mobile laundry service vehicles, each equipped with washers, dryers, and an integrated computing unit. A centralized server managing service requests, user profiles, payment information, and real-time tracking. User interfaces through a mobile app, website, and voice command systems, such as Amazon Alexa, Google Assistant, or proprietary AI assistants. Integration with robotic services for automated laundry collection, washing, folding, and delivery.

In some embodiments, Optional holographic assistants for user interaction, service confirmation, or notifications. In some embodiments, Scheduling and Service Management: In some embodiments, User Interface: In some embodiments, The user can schedule a laundry service through various channels: a mobile app, a website, or via voice commands through smart home devices or wearables. In some embodiments, The app or website allows users to select service types (e.g., washing, drying, folding), pick-up times, delivery times, and the type of fabric or special instructions (e.g., delicate, dry clean, or high-temperature wash). In some embodiments, Integration with voice assistants enables users to schedule services hands-free by simply stating commands such as, “Schedule laundry pick-up for tomorrow morning.” In some embodiments, Calendar Management: In some embodiments, The system offers a dynamic scheduling module, which integrates real-time availability of the mobile laundry vehicles and delivery routes. Users can see available time slots and confirm bookings. In some embodiments, Upon scheduling, the system assigns the request to the nearest available mobile laundry unit and provides a confirmation. In some embodiments, a mobile laundry unit may be replaced with a non-mobile laundry unit (e.g., a washer and dryer in somebody's house, business (e.g., hotel, laundry mat, etc.), etc.

In some embodiments, Payment System: Secure Payment Gateway: In some embodiments, Users can pay for laundry services via credit card, mobile wallet (e.g., Apple Pay, Google Pay), or subscription-based payments for frequent users. In some embodiments, Payment is processed securely through a payment gateway integrated within the app, website, or through a voice command system, where users can authorize payments using secure voice recognition. In some embodiments, Dynamic Pricing: In some embodiments, The system offers dynamic pricing based on service type (e.g., standard wash, premium care), load weight, and location of the user. Prices are clearly displayed to the user before confirming the service. In some embodiments, Automated Invoicing: In some embodiments, After the service is completed, an invoice is generated automatically and sent to the user's email or app notification center. Recurring customers can opt for automated billing based on usage patterns. Real-Time Tracking and Notifications: In some embodiments, Service Progress Tracking: In some embodiments, The mobile app, website, and voice command system provide real-time tracking of the laundry service. Users can see when their laundry is picked up, processed, and ready for delivery.

In some embodiments, The system uses GPS tracking to allow users to follow the route of the mobile laundry mat vehicle, showing estimated pick-up and drop-off times. In some embodiments, Automated Notifications: In some embodiments, Push notifications, SMS, or voice notifications inform users of key events, such as pick-up confirmation, washing completion, and delivery status. In some embodiments, Holographic or AI-based assistants can display a visual status update, informing users of their laundry's progress. In some embodiments, Robotic and AI-Assisted Features: Robotic Laundry Collection and Delivery: In some embodiments, The system integrates with robotic systems for collecting and delivering laundry, allowing contactless pick-up and drop-off. Robots may be dispatched to a user's location, collect the laundry, and transport it to the mobile laundry mat vehicle or a central processing hub. In some embodiments, Upon delivery, the robot can bring the cleaned laundry back to the user's home or a specified location, guided by GPS and AI. In some embodiments, laundry is done completely by robotics; robotics deliver and wash items and return items, etc. In some embodiments, robotic assistants that deliver and do laundry, etc.

In some embodiments, laundry processing robots are used inside mobile laundry vehicles. Robotic arms and automated machinery handle sorting, washing, drying, and folding of clothes. In some embodiments, The user's instructions (e.g., delicate wash) are followed precisely by the robotic system to ensure proper care. In some embodiments, Voice and Hologram Control: In some embodiments, Users can interact with the service through voice-controlled devices like Alexa or proprietary holographic assistants. In some embodiments, The system recognizes voice commands for rescheduling, payment authorization, and tracking status. In some embodiments, Holographic projections offer a visual interface to guide users through the laundry process, helping them choose the right service or check on their order status. In some embodiments, System Architecture: In some embodiments, Computing Infrastructure: In some embodiments, The system relies on cloud computing and edge computing technologies. A centralized server processes requests, manages user data, and coordinates the movement of the mobile laundry units. Edge computing nodes within the vehicles optimize local tasks like robotic control and AI-driven sorting and folding. In some embodiments, Mobile Application: In some embodiments, The mobile app is available on iOS and Android, featuring a user-friendly interface for scheduling, payment, and tracking. It integrates with voice assistants and wearables for hands-free operation. In some embodiments, Web Portal: In some embodiments, The web-based platform mirrors the functionality of the mobile app, allowing users to book and manage laundry services from any device with internet access. In some embodiments, Security and Privacy: In some embodiments, Data Encryption: In some embodiments, All user data, including payment information, is encrypted using industry-standard encryption protocols. Personal information is securely stored and protected against unauthorized access. In some embodiments, Authentication:

In some embodiments, The system supports multi-factor authentication for account security, especially for voice-command transactions. In some embodiments, Compliance: The system is compliant with local data protection regulations, such as GDPR or CCPA, ensuring user privacy and data protection. In some embodiments, This invention presents a fully automated, highly integrated mobile laundry service that leverages modern computing technology, robotic assistance, and voice-or holographic-based interfaces to provide customers with a convenient, on-demand laundry solution. In some embodiments, The system improves efficiency, enhances user experience, and offers flexibility in service delivery through a wide range of digital platforms. In some embodiments, Mobile Laundry Delivery and Management Service Using Local Residential Laundry Systems In some embodiments, This invention relates to the field of on-demand laundry services, specifically utilizing local residents' in-home or apartment-based laundry systems to perform laundry tasks as a service. Traditional laundry services are either centralized (with dedicated facilities) or mobile (operating from vans with laundry equipment). In some embodiments, This invention decentralizes the laundry service model, allowing gig workers to perform laundry tasks using local laundry machines in homes or apartments, with a computing system managing scheduling, pick-up, washing, and delivery.

In some embodiments, The invention provides a mobile laundry delivery and management service where users can place laundry orders through a computing platform (e.g., mobile app or website). In some embodiments, Gig workers use their own in-home or apartment laundry systems to fulfill these orders. The system manages the entire process, including scheduling pick-ups and deliveries, tracking order progress, and managing payments. In some embodiments, Laundry is processed by gig workers who complete the wash/dry/fold process and place the cleaned laundry in a designated area for pick-up or delivery back to the user. In some embodiments, The computing platform facilitates communication between the users and gig workers, ensuring seamless coordination and service completion. In some embodiments, System Overview: The mobile laundry service system may include: In some embodiments, A computing platform that manages user profiles, laundry service requests, gig worker assignments, scheduling, payment processing, and order tracking.

In some embodiments, Gig workers who use their own in-home or apartment laundry systems to perform laundry services. In some embodiments, User interfaces that allow customers to schedule laundry services via a mobile app, website, or voice command. In some embodiments, Pick-up and delivery logistics are managed by the platform, connecting gig workers and users for seamless laundry service transactions. In some embodiments, Designated laundry pick-up and drop-off areas at users' homes for contactless or scheduled delivery. In some embodiments, Laundry Service Scheduling and Assignment: In some embodiments, User Interface: In some embodiments, Users place a laundry service order through the mobile app, website, or voice assistant (e.g., Alexa, Google Assistant). In some embodiments, The user selects their desired service (e.g., wash, dry, fold), provides special care instructions (e.g., delicate items), and schedules a time for laundry pick-up. In some embodiments, Users also choose between a regular or express service, based on the turnaround time they need. In some embodiments, Gig Worker Assignment: In some embodiments, The system automatically assigns a gig worker based on availability, proximity to the user, and the worker's ability to fulfill the service. Gig workers are notified via the app or SMS of their assigned task. In some embodiments, Workers with laundry systems in their own homes or apartments accept tasks and are provided the necessary details (e.g., pick-up time, laundry care instructions).Pick-up Coordination:

In some embodiments, The computing system sends notifications to the user and gig worker when pick-up is imminent. The user places their laundry in a designated area (e.g., front porch, lobby, or agreed-upon location) for the gig worker to collect. In some embodiments, Laundry Processing: In some embodiments, Gig Worker's In-home Laundry System: In some embodiments, Gig workers use their own home or apartment-based laundry machines to process the laundry. In some embodiments, The system ensures that gig workers meet specific requirements (e.g., having functional washers and dryers) to perform laundry tasks. In some embodiments, The user can specify detergent preferences, temperature settings, and other special instructions in the app, which are communicated directly to the assigned gig worker. In some embodiments, The worker follows these instructions, washing, drying, and folding the clothes according to the user's specifications. In some embodiments, Order Tracking: In some embodiments, The system provides real-time updates to the user, informing them when the laundry has been picked up, when it's being washed, and when the service is complete. In some embodiments, Gig workers can mark the laundry process steps as complete in the app, triggering automatic notifications to the user.

In some embodiments, Payment Processing: In some embodiments, Secure Payment Gateway: In some embodiments, Payment is processed through the app or website after the service is complete. Users can choose to pay by credit card, mobile wallet (e.g., Apple Pay, Google Pay), or prepaid plans. In some embodiments, Gig workers are compensated based on the type of service provided and the time spent fulfilling the order. In some embodiments, Dynamic Pricing: In some embodiments, The platform uses dynamic pricing based on the weight of the laundry load, type of service, and delivery urgency. All fees are transparently displayed to the user before confirming the order. In some embodiments, Users can also tip gig workers within the app after receiving their laundry. In some embodiments, Laundry Delivery: In some embodiments, Pick-up and Delivery Logistics: In some embodiments, After the laundry is completed, the gig worker places the clean, folded laundry in a specific area (e.g., front door, lobby, or any designated location for contactless delivery). In some embodiments, The system automatically notifies the user when the laundry is ready for delivery or pick-up. If the user chooses delivery, the gig worker or a third-party delivery partner handles the drop-off. In some embodiments, Designated Pick-up Locations: In some embodiments, For users who prefer to pick up their laundry themselves, the system notifies them when and where the clean laundry is available. In some embodiments, Real-time Delivery Tracking: In some embodiments, For users opting for delivery, the system provides real-time GPS tracking of the delivery process, ensuring they are aware of the exact delivery time.

In some embodiments, Computing System Architecture: In some embodiments, Centralized Cloud-based Platform: In some embodiments, The computing system operates on a cloud-based infrastructure, allowing for scalable and efficient management of multiple service requests, gig workers, and logistics simultaneously. In some embodiments, The platform coordinates between users and gig workers, ensuring that assignments, pick-ups, and deliveries are synchronized across multiple locations. In some embodiments, User Mobile Application: In some embodiments, The app is available on iOS and Android, offering an intuitive interface for placing orders, managing profiles, and tracking services. In some embodiments, It also supports real-time messaging between the user and the assigned gig worker for special instructions or last-minute changes. In some embodiments, Web-based Platform: In some embodiments, A web-based portal mirrors the functionality of the mobile app, allowing users to manage their laundry requests from any internet-enabled device. In some embodiments, Gig Worker Portal: In some embodiments, Gig Worker Dashboard: In some embodiments, Gig workers have access to a dashboard where they can view assigned tasks, mark service progress (e.g., laundry picked up, in progress, completed), and receive payments for completed orders.

In some embodiments, Laundry System Verification: In some embodiments, The platform may include a verification process ensuring gig workers have properly functioning washing machines, dryers, and necessary supplies to provide a high-quality laundry service. In some embodiments, Ratings and Reviews: In some embodiments, Gig workers and users rate each other after the service, allowing for quality control and customer satisfaction. In some embodiments, Highly rated workers are prioritized for future assignments. In some embodiments, Voice Command and Smart Home Integration: In some embodiments, Voice-controlled Scheduling: In some embodiments, Users can schedule laundry pick-ups and deliveries through voice assistants like Amazon Alexa, Google Assistant, or proprietary AI voice platforms. In some embodiments, Voice commands like “Schedule my laundry pick-up for tomorrow at 10 AM” are processed by the computing platform and automatically scheduled with the next available gig worker.

In some embodiments, Smart Home Device Integration: In some embodiments, The system integrates with smart home systems, allowing users to receive laundry notifications directly to their smart devices (e.g., smart speakers, smart displays) when pick-up or delivery is completed. In some embodiments, Security and Privacy: In some embodiments, Data Encryption: In some embodiments, All user data, including personal details and payment information, is securely encrypted using industry-standard encryption protocols. In some embodiments, Authentication: In some embodiments, Multi-factor authentication (MFA) is used for both users and gig workers to prevent unauthorized access to accounts and service orders. In some embodiments, Privacy Compliance: In some embodiments, The platform is compliant with privacy regulations like GDPR and CCPA, ensuring user and worker data is handled securely and ethically. In some embodiments, This invention provides a decentralized, gig-based laundry service that leverages local residents' in-home or apartment laundry systems, offering an efficient, on-demand service. The computing platform seamlessly manages scheduling, payment, and logistics while providing a user-friendly experience via mobile, web, and voice.

In some embodiments, Main Analytics (most important) (auto-updated). In some embodiments, how many legal professionals have signed up (which means they have been submitted for approval in the second stage)? In some embodiments, How many potential cases have been posted in total number (even if the case has been deleted)? In some embodiments, How many potential cases are being posted per day (each day should be a new number per day, even if the case has been deleted). In some embodiments, How many times has a legal professional requested to view a case (every time a case has been requested to be viewed, this recorded number is saved even if the case has been deleted). In some embodiments, How many cases have been ‘taken on’? In some embodiments, Secondary Analytics (less important) (auto-updated). In some embodiments, how many times was a legal professional denied after requesting to view a case? In some embodiments, how many times was a legal professional accepted after requesting to view a case? In some embodiments, How many times has a first-page sign-up been made for potential clients.

In some embodiments, How many times has a first-page sign-up been made for legal professionals? In some embodiments, Legal Professional Database Master Client List (exportable by CSV file, google file, other file types, etc.) (auto-updated, meaning every time someone signs up, etc.). In some embodiments, a Database list of all emails, phone numbers, state, type of cases they are interested in, first and last name, professional they are (licensed attorney, paralegal, legal assistant, other), etc.) (everything may be saved even if they don't proceed, profile photo does not need to be saved). In some embodiments, Potential Client Database Master Client List (exportable by CSV file, google file, other file types, etc.) In some embodiments, (auto-updated, meaning every time someone signs up, etc.). In some embodiments, a database list of all emails, phone numbers, state, type of cases they have posted, first and last name, etc.) (everything besides the case details, everything may be saved even if they don't proceed). In some embodiments, the Cases list may be displayed with the pre-applied filter values entered by the user when filling out the profile. In some embodiments, the filter may be changed once the landing page is there, but the user may still be able to change it on the cases feed.

In some embodiments, permanent changes may be made on the account page, search page, etc.) In some embodiments, All the attorneys must pay to be on their law firm or monthly fee for the software system, annual fee, etc.) In some embodiments, Prices are based on the firm's size and how many attorneys may be reviewing it. In some embodiments, Pictures of attorneys may look at your case for review, and the client approves every one. In some embodiments, Pictures, videos, and client profiles may be able to approve every person who wants to look at or view their details, which may automatically create an attorney-client confidentiality agreement due to the nature of why the attorney or legal professional wants to view the information and the purpose of the platform.

In some embodiments, there is a pro bono network. Cases that no one is interested in or has no traction or viewings, pro bono recommendations. In some embodiments, a ranking list may be shown to potential clients for law firms that open cases, request cases, take on cases, etc.) In some embodiments, law firms may be ranked on a platform or computing system based on parameters or some ranking system or reasoning, subscriptions, payments, cases, etc.) In some embodiments, advertisements may be separate from ranking systems on a platform or site or computing software or system. In some embodiments, how many attorneys or legal professionals have requested to view a case, viewed a case, are reviewing the case, have seen a case, have clicked on a case, have scrolled past a case, have been clicked on, etc.) may show up, for example, but not limited to which may include but not be limited to (e.g., “5+, 20+, 50+ Attorneys Are Currently Reviewing This Case” etc.) In some embodiments, this may appear on the Posted Case View for Legal Professionals or any user's view. In some embodiments, “Close” Case Flow (may be seen or known as “Taken” Case Flow).

In some embodiments, After the “Conflicts Cleared” stage, and after the legal professional has spoken to the client and signed a contract with the client, the legal professional clicks “Request to Close Case.” In some embodiments, Upon clicking “Request to Close Case,” a pop-up asks, “Did you sign a Contract?” or something similar to prove is signing a contract, or ‘Did you speak to the client, etc.) In some embodiments, the user may be able to click a “Yes or No.” (If a legal professional clicks “No,” a pop-up message shows—“You have to sign a contract with the client to close this case.”) In some embodiments, Clicks yes-Request to close the case is sent to the Client to confirm. In some embodiments, the Legal Professional moves to the “Request to Close Case” progress tab.

In some embodiments, Case Now Shows “This Case is Pending Closing By Client” and informs all other legal professionals (on their notification tab, email, and text if they are opted in). In some embodiments, “This Case is Pending Closing By Client” shows on the Case Posting Feed; this is also shown on all notifications for all legal professionals who have requested to view the case. In some embodiments, there may be a pro-bono network of legal professionals that may have a separate screen or section for Pro bono-only cases. In some embodiments, there may be a premium option or an upgraded option to view potential self-proclaimed data submissions within a certain time period. In some embodiments, there may be an upgraded version that may require payment to view more data. In some embodiments, Professional View: Add Tab: Cases Just Posted. In some embodiments, This will be the tab the Cases Just Posted will go to. In some embodiments, After a time period, the case will transfer to All: Cases Posted More Than a time period. In some embodiments, All filters will remain the same or change as those in Cases Just Posted. In some embodiments, Professional View: Add Tab: All: Cases Posted More Than 7 Days Ago. In some embodiments, All filters will remain the same in All: Cases Posted More Than a time period ago.

In some embodiments, Professional View: Types of Tabs: In some embodiments, Type of Case, Client State, Incident Location, Incident Date, Indicated More Victims, Adverse Party. In some embodiments, Type of Sorting Options: In some embodiments, Incident Date, #of Requests, #of Reviews. In some embodiments, Professional View: Join The Pre-Approval Attorney List. This button takes you to the ‘Pre-Approval Attorney List’ Subscribe Button in some embodiments. In some embodiments, Professional View: ‘Pre-Approval Attorney List’ Subscribe Button. In some embodiments, join the “Pre-Approval Attorney List”—using your profile. In some embodiments, show your profile photo. In some embodiments, Show the cost. In some embodiments, the explanation of the benefits is as follows: Get Pre-Approval by Clients First, Hear From Clients Who Need Immediate Assistance, and Display Your Profile and Links to Clients. In some embodiments, Join Button.

In some embodiments, Client View: “Pre-Approval Attorney List. In some embodiments, Filter Tabs: Specialty (this means their preferred listed case types such as medical malpractice or assault listed on their profile), State Licensed (states), Office Location (states), In some embodiments, Sorting Options: #of cases closed. In some embodiments, Attorneys I've Submitted To: Profile Picture List, View All Button. In some embodiments, the Attorney Profile List is a clickable picture of the attorney that leads to the attorney's profile page. In some embodiments, First and Last Name of attorney, Licensed Attorney (all will be licensed attorneys), #of Closed Cases, Preferred Case Type(s), and (2) maximum will show to save space. In some embodiments, Represented by a photo of Paralegal, Other, or Assistant (clickable photo leading to paralegal's or other's profile page, Paralegal's or other's First and Last name, In some embodiments, ‘Submit my case for review’ button: immediately puts the case into the Approved Case List tab for ‘attorney or legal professional’ and notifies legal professional(s) they have been approved to view the case, etc.) In some embodiments, a paralegal, legal assistant, other, etc., may be able to be any legal assistant, legal case manager, legal manager, attorney, student attorney, etc.)

In some embodiments, a computing system forum may be available for a potential client or user to post anonymously or with their name to ask a legal question or question or topic. Thus, an attorney, a legal professional, or another user may be able to comment on that forum, but no other potential clients may be able to comment on the forum. In some embodiments, the forum computing system may be public, thus resulting in a public search result for the forum, the forum questions, and any posts or comments, etc.) In some embodiments, there may be a time period in which a case is posted and then moves from one list to another, then from the second list, there may be an additional time period that has to pass for additional features to show up such as ‘boost your case, etc.’

In some embodiments, ‘boosting a case’ may be taking a case from one list and adding it to a filtered list or another list in addition to the first list to show it nearest to the top, etc.) In some embodiments, In some embodiments, an additional time period may pass in which users may be able to ‘access the pro bono network’ or ‘site’ or ‘group’ in which their case may be considered only on a ‘pro bono basis’ and are not exposed to any contingency fee attorneys instead they are listed or exposed to only pro bono attorneys on a separate list or section of the platform intended for that specific purpose ‘pro bono cases or attorneys’ etc.) In some embodiments, there may be filters or tabs in which legal professionals may be able to filter through cases or ‘posted legal help’ to narrow down cases or types of cases. In some embodiments, filters may be used to separate data or filter through data. In some embodiments, data may be separated by payment to view data. In some embodiments, data may be viewed by members only, subscribers, paying customers, those entering the module, subscribing to the module, etc.) In some embodiments, subscribers of legal professionals may be able to create advertisements that may be directed to or shown directly to ‘potential clients’ within a region to show on their dashboard in any form, such as ‘legal news, sponsored advertisements, pictures and advertisements, a specific attorney's profile or information, etc.’

In some embodiments, potential clients may be able to look through profiles of legal professionals or attorneys to ‘submit’ their case directly to the attorney, which translates to the submission automatically putting the case ‘state’ at ‘conflicts check’ for the legal professional to do their due diligence of the ‘conflicts check’ of the case such as the person and or adverse party to see if they may be able to even view it under the ethics code, etc.) In some embodiments, users or legal professionals may be able to advertise themselves via notifications from potential clients or other users, etc.)

In some embodiments, there may be filters specialized such as ‘Do you have a corresponding criminal case? Is the adverse party an individual or an entity? Etc.) In some embodiments, filters may be ‘premium, basic, included, or not included, etc.’ In some embodiments, a review of a specific person for romantic reasons, such as one-star reviews and a story with proof, evidence, or any type of showing or explaining in detail, etc. In some embodiments, users may be able to review or add ‘cited’ information about a particular person, a group, a business, a romantic interest, etc. The invention relates to a robotic sports coach system integrated with a computing platform designed to physically demonstrate sports techniques, such as shooting a basketball, and provide real-time feedback to players. The system or computing system may include a robotic arm or humanoid robot capable of precisely replicating sports movements, a computing system that processes data and controls the robot's actions, and an AI-driven feedback mechanism that analyzes player performance and offers corrective guidance. The invention aims to enhance sports training by combining physical demonstration with data-driven coaching.

In some embodiments, Traditional sports coaching involves verbal instructions and visual demonstrations by coaches, which may not always effectively convey the nuances of specific techniques. Players often struggle to replicate these techniques accurately without precise, hands-on guidance in some embodiments. This invention addresses the need for a more interactive and precise coaching method by introducing a robotic system that physically demonstrates techniques and provides instant feedback. In some embodiments, a Robotic Demonstration Unit: A robotic arm, humanoid robot, or other robotic system capable of mimicking sports movements with high precision. In some embodiments, This unit is equipped with actuators, sensors, and motors to replicate complex sports techniques, such as shooting a basketball, swinging a bat, or kicking a soccer ball.

In some embodiments, Computing System: A computing platform integrated with AI and machine learning models that analyze player performance, control the robotic unit, and generate personalized feedback based on data collected from sensors. In some embodiments, Feedback Mechanism: The system or computing system may include real-time feedback tools, such as visual indicators, audio cues, or haptic responses, to guide the player in adjusting their technique. This feedback is based on data collected from sensors that monitor the player's movement, posture, and execution. In some embodiments, Training Mode: The system or computing system offers different training modes, including a demonstration mode where the robot performs the technique and a guided mode where the robot assists the player in performing the technique while providing feedback. In some embodiments, Robotic Demonstration Unit: In some embodiments, Design: The robotic unit is designed to closely mimic human biomechanics, allowing it to perform a wide range of sports techniques.

In some embodiments, scheduling or an app or webapp that allows 3rd party integration to show the full schedule of a person's activities across different computing systems, or apps, or applications, or websites, etc. in some embodiments, showing the schedule of a person automatically from multiple domains, websites, webapps and shows it automatically in the time zone of that person who is viewing at that moment to be able to see for example, this person is going live on this website at 10 am their time, but its p.m. my time, so user may be able to get an alert or something to remind to view this person or these alerts may integrate automatically or sync with a 3rd party calendar, or any calendar In some embodiments, System and Method for Automatically Displaying and Synchronizing a User's Schedule Across Multiple Domains with Time Zone Adjustments and Calendar Integration. In some embodiments, In today's interconnected world, individuals often participate in various activities, events, and live sessions across multiple websites, web applications, and platforms. However, keeping track of these schedules, especially when considering time zone differences, may be challenging for both the individual and their audience.

In some embodiments, There is a need for a system that automatically aggregates, adjusts for time zones, and integrates such schedules with third-party calendars, allowing viewers to receive timely alerts and stay updated on events of interest. In some embodiments, The present invention relates to a system and method for automatically aggregating, displaying, and synchronizing a user's schedule from multiple online sources, such as websites, web applications, and domains. The computing system adjusts the schedule to the time zone of the viewer and provides integration with third-party calendar systems. This ensures that the viewer may receive alerts and reminders about the user's activities in their local time, enhancing accessibility and engagement. In some embodiments, System Overview: In some embodiments, The system or computing system comprises a schedule aggregation module, a time zone conversion module, a calendar integration module, and an alert generation module.

In some embodiments, The schedule aggregation module collects and consolidates a user's schedule from multiple domains, websites, and web applications. In some embodiments, The time zone conversion module automatically adjusts the schedule to match the viewer's local time zone. In some embodiments, The calendar integration module allows synchronization with third-party calendar services (e.g., Google Calendar, Outlook) to facilitate seamless integration. In some embodiments, The alert generation module provides notifications or reminders to the viewer, which may be set manually or automatically. In some embodiments, Schedule Aggregation Module: In some embodiments, This module interfaces with various online sources (domains, websites, web applications) via APIs or web scraping techniques to extract the schedule data of a specified user. In some embodiments, The extracted data may include event names, descriptions, dates, and times, which are then standardized into a unified format.

In some embodiments, Time Zone Conversion Module: In some embodiments, Upon retrieval of the schedule, the time zone conversion module identifies the time zone of the viewer based on their device settings, IP address, or user profile data. In some embodiments, The module converts the event times from the user's original time zone to the viewer's local time zone, ensuring accurate display. In some embodiments, Calendar Integration Module: In some embodiments, The system or computing system integrates with third-party calendar systems via API connections, allowing the converted schedule to be automatically synced with the viewer's preferred calendar. In some embodiments, The module supports bi-directional synchronization, ensuring that any updates or changes to the schedule are reflected in the viewer's calendar in real-time. In some embodiments, Alert Generation Module: In some embodiments, The alert generation module enables the system or computing system to send notifications or reminders to the viewer at a specified time before the event occurs in their local time zone. In some embodiments, Alerts may be delivered via various methods, including email, SMS, push notifications, or directly within a third-party calendar application. In some embodiments, The system or computing system may automatically set alerts based on predefined user preferences or allow manual customization of alert timings.

In some embodiments, Use Case Example: In some embodiments, A content creator schedules a live stream on a social media platform for 10:00 AM PST. In some embodiments, A viewer in New York (EST) uses the system or computing system to view the creator's schedule. In some embodiments, The time zone conversion module adjusts the live stream time to 1:00 PM EST for the viewer. In some embodiments, The viewer opts to sync this event with their Google Calendar via the calendar integration module. In some embodiments, An alert is automatically set to remind the viewer for example, 15 minutes before the live stream begins, in their local time zone. In some embodiments, The proposed system and method provide a comprehensive solution for automatically managing and displaying a user's schedule across multiple online platforms, while adjusting for time zones and integrating with third-party calendar services. In some embodiments, This innovation enhances the viewer's ability to stay informed and engaged with the user's activities in their local time, leading to increased convenience and accessibility. In some embodiments, The present invention relates to digital content platforms and web applications, particularly those offering creators a range of subscription and payment options for delivering media, live events, messages, and private services. In some embodiments, The invention allows for flexible content monetization, including subscription tiers, tipping, and pay-per-view or pay-to-unlock features. In some embodiments, The present invention provides a method and system for enabling creators to offer a variety of subscription services and payment-based content through a web application. In some embodiments, This platform allows for diverse forms of content delivery, including live and recorded media, private events, and messaging, all of which may be locked behind a payment gateway or offered through subscription models. In some embodiments, Users may be tip creators, purchase content on a per-item basis, or subscribe for regular access to premium content. In some embodiments, Subscription Services for Media and Events: Creators may be offer subscription-based access to different types of content, such as videos, live streams, and private events. Subscriptions may be tiered, allowing for various levels of access, including: In some embodiments, Subscription to Media: Access to recorded videos, podcasts, or other digital media on an ongoing basis. In some embodiments, Subscription for Live Events: Users may be subscribe to gain access to scheduled live events such as webinars, concerts, or private streams. In some embodiments, Subscription for Private Events: Access to exclusive, invitation-only live or recorded events that are not available to the general public. In some embodiments, Subscription for Premium Events: Higher-tier subscriptions providing access to premium or VIP events with special privileges or interactions. In some embodiments, Payment for Access to Content: Creators may be lock content such as media files, messages, or event tickets behind a payment gateway, where users must pay to unlock the content. Payment models include: In some embodiments, Pay-per-view for Live or Recorded Events: Users may be able to pay a one-time fee to watch a live event or access recorded content. In some embodiments, Locked Messages and Content: Messages or other forms of communication (e.g., private videos, documents) may be able to be locked until payment is made to unlock them. In some embodiments, Flexible Messaging Options: In some embodiments, Paid Messaging: Users may be required to pay to send messages to creators. In some embodiments, Subscription for Unlimited Messages: Users may be able to subscribe to send unlimited messages to creators during a set period (e.g., monthly). In some embodiments, Subscription for Limited Messages: Users may subscribe for a certain number of messages per month, after which additional payments may be required. In some embodiments, Tip-Based Payments: Users may be able to send tips to creators at any time to support them, independent of other payments or subscriptions. Tips may be able to be added alongside other transactions or sent spontaneously. In some embodiments, Premium Content Access via Subscriptions or Tickets: Creators may be able to offer ticketed access to special events or content, where users either purchase tickets directly or gain access through specific subscription plans: In some embodiments, Ticketing for Premium Events: Users may be able to purchase one-time tickets for premium live events, which may include special interactions or VIP access. In some embodiments, Subscription for Premium Event Access: Subscriptions may be able to be structured to grant users automatic access to future premium events or special content. In some embodiments, Flexible Payment Options and Revenue Models: The system supports multiple revenue models, giving creators flexibility in how they monetize their content and services. This may include: In some embodiments, One-time Payments: Users may be able to make one-time payments for specific content, such as paying to unlock a message or event. In some embodiments, Recurring Subscriptions: Users subscribe on a recurring basis (e.g., monthly or annually) to gain ongoing access to content or services. In some embodiments, Combined Payment Models: Creators may be able to offer a combination of subscription-based access and pay-per-view or pay-to-unlock content within the same platform. In some embodiments, Content Unlocking Mechanisms: The platform allows for content or messages to be locked until a payment is made. This may be able to include: In some embodiments, Locked Content: Digital content such as videos, images, or documents is locked and only accessible after payment. In some embodiments, Locked Messages: Messages or private communications between users and creators may be able to be locked until a payment is made to unlock the conversation. In some embodiments, The system provides a comprehensive platform where creators may be able to manage their content and services, and users may be able to subscribe, pay, and interact with content according to varying levels of access. In some embodiments, The platform supports different forms of digital content, including video, live streams, private messages, and event ticketing. In some embodiments, Subscription-Based Services Upon creating an account, a creator may be able to set up subscription services that offer different types of access: In some embodiments, Media Subscription: A recurring subscription allows users to access digital media like videos, podcasts, or articles. In some embodiments, Event Subscription: Creators may be able to schedule live events, and users may be able to subscribe to gain access to those events on a recurring basis. In some embodiments, Private and Premium Event Subscription: Users subscribing at higher tiers gain access to exclusive, private, or premium events. In some embodiments, Payment Gateways for Content and Messages In some embodiments, The platform integrates various payment mechanisms to allow users to unlock content: In some embodiments, Pay-per-view Content: Users may be able to pay a one-time fee to access certain content. In some embodiments, Locked Content and Messages: Content or communication between creators and users may be able to be locked, requiring a payment to unlock. In some embodiments, For example, a creator may send a locked message to a user, which may be able to only be viewed once the user has paid a fee. In some embodiments, Messaging Payment and Subscription Options In some embodiments, The platform allows creators to monetize messaging in various ways: In some embodiments, Paid Messaging: Users must pay to send a message or receive a response from the creator. In some embodiments, Subscription for Unlimited Messaging: Users may be able to subscribe for unlimited messaging during a period (e.g., monthly). In some embodiments, Subscription for Limited Messaging: Users subscribe for a specific number of messages, and must pay for any additional messages beyond that limit. In some embodiments, Event Ticketing and Premium Access In some embodiments, Creators may be able to offer premium access to events through a combination of subscriptions and tickets: In some embodiments, Ticketed Premium Events: Creators may be able to set up ticketed events, where users must purchase tickets for one-time access. In some embodiments, Subscription for Event Access: Users may be able to subscribe to automatically receive access to future events or special content. In some embodiments, Tip-Based Payments. In some embodiments, At any time, users may be able to send tips to creators to support their content. In some embodiments, Tipping may be independent of subscription or payment for specific content.

In some embodiments, Actuators and Sensors: The robotic unit is equipped with actuators that control its movements and sensors that provide feedback on force, angle, and speed. In some embodiments, Movement Algorithms are algorithms that translate sports techniques into precise robotic movements, ensuring accurate demonstrations. In some embodiments, Computing System: In some embodiments, Data Processing: The computing system processes data from sensors and controls the robotic unit's actions. In some embodiments, AI and Machine Learning: AI models are trained on extensive sports data to analyze player performance and provide personalized feedback. In some embodiments, User Interface: A user-friendly interface that allows coaches and players to select training modes, view feedback, and track progress. In some embodiments, the feedback mechanism is visual feedback, where the system or computing system uses screens, LED indicators, or augmented reality (AR) to provide visual cues during training. In some embodiments, Audio Feedback: Real-time audio cues guide the player in making adjustments with any movement etc. In some embodiments, Haptic Feedback: Vibration or pressure sensors in wearable devices provide tactile feedback to the player. In some embodiments, Demonstration Mode: The robotic unit performs the selected technique, allowing the player to observe and learn. In some embodiments, Guided Mode: The robotic unit assists the player in performing the technique, offering real-time feedback to ensure correct execution. In some embodiments, Assessment Mode: The system or computing system analyzes the player's technique and provides a detailed report with suggestions for improvement. In some embodiments, such as basketball shooting, the robot demonstrates the correct shooting form, including arm angle, wrist action, and follow-through. The player then practices the shot, receiving feedback on posture, release timing, and accuracy. In some embodiments, Baseball Pitching, The robot demonstrates the correct pitching mechanics, including grip, arm rotation, and release. The player is guided through the motion with speed, spin, and trajectory feedback. In some embodiments, such as soccer kicking, the robot demonstrates various kicking techniques, such as a free kick or penalty shot. The player practices the kick, receiving feedback on foot placement, angle, and force.

In some embodiments, a sports coach may analyze the formation of the player positions on the field, look at the statistics of all the plays on the field and in the squads, and then output a decision, etc. In some embodiments, an AI sports coach may be trained on past games, any games, rules, players, etc. In some embodiments, this may be a computer system, a device, a robotics system, etc. “AI Sports Coach: A System and Method for Data-Driven Sports Strategy Analysis and Play Recommendations.” In some embodiments, The invention relates to an AI-powered sports coach system that integrates computing systems, devices, or robotics to analyze real-time and historical data from players, games, and strategic models. In some embodiments, The system or computing system may provide real-time strategic recommendations and play adjustments tailored to the dynamic conditions of a sports game, thereby enhancing team performance and decision-making. In some embodiments, The system or computing system may function as a standalone device, integrated with existing coaching tools, or as part of a robotic coaching assistant. In some embodiments, The AI sports coach consists of one or more of the following components: In some embodiments, Computing System: A cloud-based or local computing system that processes and analyzes large datasets, including player statistics, game footage, and opponent data. In some embodiments, Device Integration is a wearable or handheld device that delivers real-time recommendations to players or coaches during a game. In some embodiments, Robotics is an autonomous or semi-autonomous robot that may interact with players and coaches on the field, offering strategic advice and play-by-play instructions based on AI analysis. In some embodiments, Machine Learning Models: Trained on historical game data, player performance metrics, and tactical scenarios, these models generate insights and predictive analyses to optimize in-game strategies. In some embodiments, System Architecture: In some embodiments, Data Collection: Integration with wearable sensors, cameras, and databases to collect data from players and games. Data processing uses machine learning algorithms to analyze collected data, identify patterns, and predict outcomes in some embodiments.

In some embodiments, a Recommendation Engine is an AI-driven engine that processes insights and suggests optimal plays, formations, or strategies. In some embodiments, the User Interface is a dashboard accessible via devices or robotics that displays real-time recommendations, analytics, and performance metrics. In some embodiments, Robotic Integration is an optional robotics component that may physically accompany the team, providing real-time feedback and motivational cues. In some embodiments, Training of the AI: Detailed process of training the AI models using supervised and unsupervised learning techniques, leveraging historical game data, and simulating various game scenarios. In some embodiments, Pre-Game Analysis: AI analyzes the opponent's previous games and suggests initial strategies. In some embodiments, In-Game Adjustments: AI provides play-by-play suggestions based on real-time analysis of ongoing game conditions. In some embodiments, Post-Game Review: The system or computing system offers insights into what worked, what didn't, and how strategies may be improved for future games.

In some embodiments, a potentially waterproof or non waterproof robotic arm or hands or both or a combination that makes motions such as washing hair, shampooing hair, conditioning hair, applying serums, applying hair treatments, applying hair dye, brushing hair, cutting hair, or blowing drying hair with any combination of or just one, etc. In some embodiments, the robotic arms or hands or body with attached arms or hands may memorize a specific shower routine or a particular way to apply shampoo, etc., by learning and then repeating the motion or using AI to train using inputs of showing or telling the robotic arms how to wash and condition hair, or telling it, or showing it a video or uploading a video, etc. In some embodiments, robotics or AI is able to train by analyzing videos such as instruction videos to understand how to wash hair or do some tasks or a mix of tasks, and then using the specific person's input on exactly how they like it or want it done, etc.

In some embodiments, The client accepts the legal professional's request on the “Request to Close Case” tab. In some embodiments, Legal Professional moves to the “Closed Case” tab. In some embodiments, Notifications to clients and legal professionals on case update “This Case Has Been Closed and is Pending Deletion” (also email and text if they are opted in) each day counting down a time period to deletion. In some embodiments, a message to the client is given: “Congratulations on securing an attorney!” (virtual confetti). “In a few days, your case will be completely deleted from our system. Your attorney has also been notified that your case will be deleted in a time period. In some embodiments, You are now ready to continue pursuing justice with your attorney outside of our system.” In some embodiments, two Clickable Options: “Please download your case now, or Delete Your Case Now. In some embodiments, a Message to the legal professional: “Congratulations on securing a client! (Countdown begins) In a few days, this case will be completely deleted from our system. Please download the case materials if you have not already done so. Click the option “Download Case Now.” In some embodiments, All, some, or any Notifications that are shown in each user's dashboard are also sent to the legal professional and to the client as an email and text message (email and texts aren't sent only if they ‘uncheck’ the mandatory email and text notifications upon sign-up).

In some embodiments, the software system or computing system may have a pay-per-lead pay-per-case viewing, pay-to-open data viewing, pay-to-view data, or pay-to-view names or parties—In some embodiments, only ‘legal professionals’ who have not yet been approved are allowed to view a specified number of cases. In some embodiments, the remaining cases are blurry, and they may not be able to view more until they are approved (with notification of this requirement). In some embodiments, the adverse party may only be seen at the time of approval by the attorney to the client; the adverse party and name of the client are not listed publicly on the list of cases. In some embodiments, Publicly listed cases are a type of case with other details like city/state, date of incident, zip code, medical records, and yes or no questions. In some embodiments, artificial intelligence may analyze submitted data or any data to insert its information and give an estimated value based on trained model inputs or general inputs that the AI module is trained on or generally the value of the information. In some embodiments, artificial intelligence may be trained to analyze submitted data and put a value or a number or a range of values on a specific set of information and show that value or value range to the other set of users. In some embodiments, artificial intelligence may be used to analyze submitted case data, assign a value, a number, a number range, and show that number to legal professionals or attorneys who are or may be which may include but not be limited to (e.g., paying for that information, paying a subscription fee, paying per information module, paying to view case number ranges, paying to view leads, paying to view this database or artificial intelligence-created value number, or any case related information which may include this ai-created value or range based on common knowledge or trained ai model input values to detect value, etc.)

In some embodiments, a software system is disclosed to facilitate attorneys in efficiently reviewing and managing cases submitted by potential clients. This system comprises a user interface (a) that allows potential clients to submit detailed case information, including case particulars, legal matters, and accompanying documents. The user interface is equipped with input fields and document upload features, allowing potential clients to provide comprehensive case information and upload relevant documents for attorneys to review. In some embodiments, the software system may include a secure database (b) designed to store the submitted case information securely while ensuring the association of this data with potential client profiles. The database architecture adheres to stringent security protocols to maintain confidentiality and comply with legal and ethical standards governing attorney-client privilege. In some embodiments, the software system incorporates a case management module (c) that empowers attorneys with the necessary tools to efficiently access and review the submitted case information. Attorneys may be able to use the module to accept or decline cases and effectively communicate with potential clients. This module offers document viewing, case summaries, and communication capabilities, enabling attorneys to interact seamlessly with potential clients. In some embodiments, the software system integrates a notification system (d) that plays a pivotal role in keeping attorneys informed about the status of their cases. In some embodiments, This system sends real-time alerts to attorneys when new case submissions are received, ensuring timely responses and efficient case management. In some embodiments, the software system incorporates a reporting and analytics component (e) that provides attorneys valuable insights into case acceptance rates, attorney responsiveness, and potential client needs. It aids in optimizing legal services by offering a data-driven approach to decision-making. Additionally, it contributes to enhancing the attorney-client relationship by promoting continuous improvement and transparency. In some embodiments, a method is disclosed for attorneys to efficiently review and manage cases using the software system described above. In some embodiments, potential clients may be able to submit case information and documents via the user interface, securely storing the submitted case information in a database, enabling attorneys to access, review, and accept or decline cases through the case management module, notifying attorneys of new case submissions or client communications via the notification system, and providing reporting and analytics on case acceptance rates and potential client needs for the continuous improvement of legal services. In some embodiments, there may be an analytics tab that contains all database information, such as how many users have signed up, which type of cases, how many cases have been opened, etc.) In some embodiments, AI algorithms may detect, separate, or categorize different types of cases or analyze cases for any reason to be viewed or sorted on feed or groups or visual states, etc.)

In some embodiments, the invention described herein relates to a software system that facilitates the interaction between potential clients seeking legal representation and attorneys willing to pay for access to case information, promoting transparency and efficiency in the legal field. In some embodiments, clients post their case or information related to their case or post that they need help, and attorneys or legal professionals will then either reach out to them or review or submit their information for the client to consider. In some embodiments, the software system may include a user interface accessible to potential clients, enabling them to provide comprehensive case details, legal issues, and supporting documents. In some embodiments, a payment processing module is integrated into the software system, allowing attorneys to make payments in exchange for access to the case information submitted by potential clients. In some embodiments, This payment processing module offers flexibility by accommodating various fee structures, including flat fees, subscription-based models, or pay-per-case access, catering to the preferences of both potential clients and attorneys.

In some embodiments, the software system incorporates a secure database that serves as a repository for potential client-submitted case information. In some embodiments, This database employs encryption and other security measures to safeguard the confidentiality of case data and financial transactions, thereby ensuring compliance with legal and ethical standards. In some embodiments, a case management module is a central component of the software system, granting attorneys access to the submitted case data.

In some embodiments, This module empowers attorneys to efficiently review case information, communicate with potential clients, and make informed decisions regarding case acceptance. In some embodiments, an audit trail system within the software system maintains comprehensive records of all financial transactions and interactions, promoting transparency and accountability. In some embodiments, the posting of a video, photo, information, or input, with the ability to leave a review of a person or event or system or group or business, etc. In some embodiments, star or review or verified review of a person and what that person did to them, such as physical assault and proof sent to the computing system administrator or verification to be able to post review or information regarding that person, etc. In some embodiments, the ability to post a review of a person, for example, physical violence or assault, etc. system and Method for Aggregating and Displaying User-Generated Reviews on a Variety of Categories and Items I

n some embodiments, The present invention relates to a system and method for aggregating, displaying, and managing user-generated reviews across a diverse range of categories, including but not limited to businesses, products, services, events, media, locations, and more. The system provides a platform where users can submit, view, and interact with reviews, ratings, and recommendations for different types of items, enhanced by search functionality, data filters, and personalized content based on user preferences. It also may include mechanisms for verifying reviews to ensure authenticity. In some embodiments, User-generated reviews have become a key resource in decision-making for consumers. Various platforms exist, allowing users to review specific types of services (e.g., restaurants, products, hotels), but these platforms are often limited to certain industries. There is a need for a flexible and scalable platform that allows users to leave and access reviews on a wide range of subjects, including both traditional categories (like businesses and services) and non-traditional categories (such as events, digital content, and specific locations). The proposed invention addresses this by offering an integrated platform where users can review, rate, and explore a variety of items and experiences. In some embodiments, User Registration and Profiles: Users can create accounts, enabling them to post reviews, rate items, and engage with other users. In some embodiments, Profiles may track individual preferences, reviews posted, and ratings given. In some embodiments, Review Submission Module: Users can submit reviews on various categories, including but not limited to: Businesses (restaurants, stores, etc.) Products (electronics, clothing, etc.), people, persons, dating, romantic partners, husbands, wives, co-workers, workers, colleagues, Services (plumbing, consulting, etc.) Events (concerts, sports, etc. Media (movies, books, music, etc.) Locations (parks, landmarks, etc.) In some embodiments, a rating system is a multi-dimensional rating system that allows users to rate different aspects of the reviewed item (e.g., quality, service, value). In some embodiments, The overall rating may be averaged or broken down into individual components. In some embodiments, Search and Filter Features: The platform provides advanced search and filtering options, allowing users to search for reviews by location, category, rating, or specific keywords. Filters help users find the most relevant reviews based on their preferences. In some embodiments, Verification Mechanism: To ensure the authenticity of reviews, the system incorporates a verification mechanism. This may include: Verified purchases (linking reviews to actual transactions). Verified relationships with proof or some information to confirm as proof such as personal information about person, etc. In some embodiments, location-based verification is performed for physical businesses (ensuring the reviewer has visited the business). In some embodiments, User reputation scores based on past reviews and feedback from other users. In some embodiments, Content Moderation: A moderation system is in place to ensure reviews adhere to community guidelines. The platform may use AI-driven algorithms and human moderators to detect spam, inappropriate content, or fraudulent activity. In some embodiments, Recommendation Engine: The platform features a recommendation engine that suggests items to users based on their review history, ratings, and preferences. This engine continuously learns from user interactions to provide personalized content. In some embodiments, Social Features: Users can interact with each other by liking, sharing, or commenting on reviews. The system may also enable following specific users to receive updates when they post new reviews. In some embodiments, Business/Owner Interaction: Business owners, product manufacturers, or event organizers can respond to user reviews, provide feedback, resolve issues, or thank users for the positive feedback or respond to negative feedback, or pay to remove or pay to respond, or pay to access review, or have no ability to respond, etc., In some embodiments, The invention consists of an interconnected software platform, accessible via web or mobile application, that allows users to post and access reviews on a wide variety of items and experiences. In some embodiments, The system's primary function is to gather and organize user input in the form of text, images, videos, and numerical ratings. In some embodiments, Users register by creating an account, providing basic information, and selecting areas of interest or categories they prefer to review. In some embodiments, Each user has a profile page, displaying their past reviews, overall ratings, and any interactions with other users. In some embodiments, The system allows users to submit reviews by selecting the relevant category and item. In some embodiments, a structured input interface guides the user to rate the item based on various attributes (e.g., “service,” “quality,” “cleanliness,” for a restaurant) and leave a free-form review. Users can also upload multimedia content such as photos or videos. In some embodiments, The multi-dimensional rating system enables detailed feedback. For example, a product review might allow users to rate “durability,” “design,” and “value for money” individually. The platform automatically calculates an overall rating based on these sub-scores. In some embodiments, A comprehensive search engine enables users to locate reviews based on category, location, rating range, or specific keywords. Filters allow users to refine their search based on the date of the review, the reviewer's reputation, or specific aspects of the item. In some embodiments, The system implements a variety of methods to ensure that reviews are genuine. These include: In some embodiments, purchase verification is done by linking reviews to confirmed transactions. In some embodiments, geolocation verification is used for location-based reviews (e.g., restaurants or hotels). In some embodiments, Review history and user reputation scores to assess the credibility of reviewers. In some embodiments, AI algorithms and human moderators ensure that reviews are fair, constructive, and free from inappropriate or fraudulent content. In some embodiments, The system also provides a reporting mechanism for users to flag suspicious or inappropriate reviews. In some embodiments, The system uses machine learning algorithms to analyze user behavior, suggesting items, businesses, or services that the user might enjoy based on previous reviews, ratings, and preferences. In some embodiments, Users can engage with reviews by liking, commenting, or sharing. In some embodiments, They can also follow other users to keep track of their reviews and interactions on the platform. In some embodiments, Business owners or product manufacturers can claim their business pages and respond directly to reviews. In some embodiments, This feature allows for dispute resolution and building relationships with customers.

In some embodiments, potential clients are provided with clear and transparent information about the fee structure associated with attorney access to their case information. This transparency ensures that potential clients make informed decisions regarding submitting their cases and engaging legal representation. In some embodiments, the software system may include a rating and review system that allows attorneys to provide feedback and reviews on potential client-submitted cases. In some embodiments, This system enhances transparency and accountability within the platform in some embodiments, facilitating a reliable and reputable environment for attorneys and potential clients to engage. In some embodiments, The software system generates reports and analytics in some embodiments, offering valuable insights into fee transactions, case acceptance rates, and attorney-client interactions. In some embodiments, These insights empower attorneys and potential clients to make data-driven decisions, optimize their legal processes, and enhance the overall efficiency of legal services. In some embodiments, A software system designed for pro bono attorneys to efficiently oversee and manage cases submitted by potential clients is presented. In some embodiments, The system or computing system may incorporate: In some embodiments, A user interface that allows potential clients to conveniently submit comprehensive case information, encompassing case particulars, legal matters, and pertinent supporting documents. In some embodiments, A secure database stores submitted case information and associate it meticulously with potential client profiles, upholding confidentiality and complying with the legal and ethical standards governing attorney-client privilege. In some embodiments, A case management module empowers pro bono attorneys by granting them access to the submitted case data, enabling them to meticulously review, accept, or decline cases and communicate seamlessly with potential clients. In some embodiments, after a case submission or lead is made, there may be a specific type of information pulled from that submission that may be displayed uniformly by each database set to be seen by legal professionals to decide if they want to see the lead, case, or information. In some embodiments, set request limits to incoming submissions or requests, etc.) In some embodiments, the user may be able to only receive a certain amount of requests at a time or set those preferences, etc.)

In some embodiments, the stepper, progress bar, progress panel, or progress tracker may be used for a date, meeting, interaction, scheduled date, quick date, etc.) In some embodiments, a payment may be required to (e.g., send a message to another user, create a message for another user, or ensure a user sees the message, etc.) In some embodiments, payment may be required for someone to (e.g., view their message, send a message, open a message, respond to a message, get a response, obtain tickets to view, tickets to see, meet the user, video chat with a user, etc.) In some embodiments, the user may have a lead such as (e.g., dating need, dating, wanting to date, a profile, needing an attorney, needing a doctor, needing a lawyer, needing a contingency-fee attorney, needing a quote, needing management, case management, etc.) In some embodiments, the user may be able to (e.g., manage their case dashboard, their case, their database, etc.)

In some embodiments, This invention relates to a computing system and method for processing applications. Specifically, it addresses the need for an adaptable system where applications can be categorized and processed based on various user-defined criteria, such as application type, pre-qualification screening, and payment requirements. In some embodiments, This system is applicable across industries like education, employment, finance, and more, where different conditions must be met before applications are submitted. In some embodiments, The invention provides a computing system and method that categorizes and processes applications based on certain criteria, which may include the type of application, whether pre-qualification screening is required, and whether payment is needed prior to submission. The system allows for the dynamic configuration of the application process based on the user's (application provider's) specific requirements, and provides an efficient and flexible method to manage, review, and approve applications in a wide range of fields. In some embodiments, The computing system consists of a server, database, and a user interface (UI) for both applicants and application providers. The server executes processes that receive, store, and manage the submission of applications, while the database holds application data, user profiles, and application status.

In some embodiments, The UI facilitates interaction with both applicants and providers. In some embodiments, The system enables categorization of applications by type, such as job applications, educational admissions, grant proposals, loan applications, etc. In some embodiments, Application providers can create specific categories with unique processing rules. In some embodiments, The system identifies the type of application and routes it through the appropriate workflow. In some embodiments, Conditional Pre-Qualification Screening: In some embodiments, The system allows for pre-qualification screening depending on the application type or the provider's preferences. In some embodiments, Screening criteria can be defined by the provider and can include eligibility requirements, background checks, credit score verifications, etc. In some embodiments, If pre-qualification is required, the system checks the applicant's details against predefined criteria before allowing the application to proceed.

In some embodiments, If no pre-qualification is required, the application skips this step and moves directly to the submission process. In some embodiments, Payment Requirements: In some embodiments, The system dynamically manages payment requirements based on the provider's specifications. Some application types may require payment before submission, while others may not. In some embodiments, The system is integrated with payment gateways to process payments securely. In some embodiments, Depending on the provider's setup, the system can either: In some embodiments, Require full payment before submission. In some embodiments, Provide options for deferred or split payments. In some embodiments, Waive the payment if the provider does not require it. In some embodiments, Dynamic Application Workflow: In some embodiments, The system uses an adaptable workflow engine that adjusts the steps applicants need to follow based on pre-configured conditions such as type of application, pre-qualification requirements, and payment.

In some embodiments, The workflow dynamically adjusts to each application category: In some embodiments, For applications requiring pre-qualification and payment, both steps are mandatory before submission. In some embodiments, For applications not requiring these steps, the system bypasses unnecessary processes, improving efficiency. In some embodiments, User and Provider Interfaces: In some embodiments, For Applicants: The system provides a user-friendly interface where applicants are guided through the steps based on the specific type of application they are submitting. They are notified of any pre-qualification screenings or payment requirements during the process. In some embodiments, For Providers: The system may include an administrative panel where providers can define and configure: In some embodiments, Application categories. In some embodiments, Pre-qualification criteria. In some embodiments, Payment options and requirements. In some embodiments, Approval workflows and review protocols.

In some embodiments, Processing and Submission: In some embodiments, After completing any required pre-qualification and payment steps, the system allows the application to be submitted for final review. In some embodiments, The system automatically logs the submission and generates a confirmation for the applicant. In some embodiments, The application provider is then notified of a new submission, and the system provides tools for reviewing, approving, or rejecting applications. In some embodiments, Notification System: In some embodiments, The system sends automated notifications and reminders to applicants regarding the status of their applications, such as pending pre-qualification, payment reminders, submission confirmation, and final results. In some embodiments, A computing system method for processing applications based on categories, comprising: In some embodiments, a categorization module for assigning applications into types; In some embodiments, a dynamic workflow engine for determining if pre-qualification screening is required for a given type of application; In some embodiments, a payment processing module for managing conditional payment requirements; In some embodiments, a submission module for finalizing applications once all conditions are met. In some embodiments, This invention simplifies the application submission process by allowing application providers to define customized workflows based on the application type. In some embodiments, It streamlines the applicant experience by dynamically adjusting the workflow to meet pre-qualification and payment requirements, and offers flexibility for providers in managing applications across multiple industries.

In some embodiments, (e.g., AI may be able to manage outside data such as state of limitations or internal inputted data such as statute of limitations, time span, time limits, on cases, etc.) In some embodiments, the stepper or progress bar may be used to manage the case, etc.) In some embodiments, clients may purchase or offer insurance, whether online through the computing system, which they may be able to pay into and obtain a lawyer or legal services at needed or at a later time or once their policy begins, etc.)

In some embodiments, insurance may be purchased, covering legal services, etc.) In some embodiments, lawyers may be able to (e.g., request, share, post, save, download, etc.) (e.g., leads, postings, cases, contact information, etc.) In some embodiments, Systems, and Methods for Finding Similar-Looking Profiles in a Web Application Using Artificial Intelligence. In some embodiments, The present invention relates to a system and method for finding similar-looking profiles in web applications or mobile apps. In some embodiments, it involves using artificial intelligence (AI) to analyze and compare visual data (such as images) to suggest profiles that have a similar appearance to the selected or uploaded image.

In some embodiments, Online platforms, particularly dating apps, often rely on visual impressions as a key factor in user engagement. While these apps allow users to browse various profiles, there is no widely implemented method for a user to find profiles of individuals who visually resemble a particular person, either based on uploaded images or selected from a set of profiles. In some embodiments, Current technologies are limited in their ability to personalize this visual search process.

In some embodiments, A user may want to find people who look similar to someone they find attractive, whether that be based on facial features, hair color, or other appearance attributes. The proposed invention provides a solution that uses advanced AI techniques to analyze and recommend similar profiles based on these appearance characteristics. In some embodiments, The present invention provides a method and system for identifying and recommending similar-looking profiles in a web application, mobile app, or website by using an AI-powered image recognition model or any artificial intelligence recognition model, or any similar profile model’ such as ‘users also liked this person or clicked on this next person, etc., In some embodiments, The system allows users to upload or select an image of a person (e.g., their own photo or someone else's from an existing profile) and receive recommendations for other profiles that share similar visual attributes.

In some embodiments, System and Method for Estimating the Value of Specific Events Using Artificial Intelligence in a Web Application or Computing System In some embodiments, Technical Field: The present invention relates to the field of artificial intelligence and machine learning. In some embodiments, Specifically, it pertains to systems and methods that use AI to estimate the value of specific events that occur on web applications or computing systems. The invention may apply to a variety of industries, including e-commerce, marketplace, legal websites, legal, social, financial services, gaming, and social networking platforms. In some embodiments, The increasing complexity and data-driven nature of web applications and computing systems require advanced techniques to evaluate the impact of specific events. In some embodiments, These events can range from user actions, transaction completions, or system interactions. In some embodiments, Traditional methods for determining the value of these events involve rule-based systems or static models, which often fail to consider real-time data, user behavior patterns, and historical information, leading to inaccurate or non-optimized value estimations. In some embodiments, There is a need for an intelligent system that can dynamically analyze and estimate the value of specific events in real-time, using advanced AI techniques to incorporate multiple variables and contextual data. In some embodiments, The present invention provides a novel system and method utilizing artificial intelligence for estimating the value of specific events that happen in a web application or computing system. The system employs machine learning models to analyze user behavior, historical data, event frequency, and other contextual information to estimate the real-time value of the event. In some embodiments, The system can be applied across a range of applications, including but not limited to, e-commerce sites to estimate the value of a user's purchase decision, financial platforms to estimate the value of a transaction, or social networks to estimate the impact of a user's post or interaction. In some embodiments, Description of the Drawings: Detailed Description of the Invention: In some embodiments, The system for estimating the value of specific events comprises the following components:

In some embodiments, Event Detection Module: The event detection module captures specific events in the web application or computing system. These events could be triggered by user actions (e.g., clicks, purchases, posts) or system actions (e.g., process completion, notification, data input). In some embodiments, Data Aggregation Module: This module collects relevant data points from the system, such as: In some embodiments, User behavior data (e.g., browsing history, previous interactions). In some embodiments, Event metadata (e.g., timestamp, location, duration). In some embodiments, Historical data (e.g., frequency of similar events). In some embodiments, Contextual data (e.g., device type, location). In some embodiments, Feature Extraction Engine: This engine processes the aggregated data to identify key features relevant to the estimation process. Features may include user behavior metrics, event type and frequency, real-time system conditions, and historical data trends. In some embodiments, Machine Learning Model: The AI system uses machine learning models (such as decision trees, neural networks, or reinforcement learning) to estimate the value of the specific event. The model is trained on historical data and continuously updated to improve its accuracy. This model may utilize various features extracted from the event data to make accurate estimations. In some embodiments, The model could include the following components: In some embodiments, Predictive Algorithm: Uses supervised or unsupervised learning to predict the value of the event based on historical and real-time data. In some embodiments, Evaluation Mechanism: A feedback loop that evaluates the model's performance over time, refining its parameters for future predictions. In some embodiments, Value Estimation Module: The estimated value is generated based on the output from the machine learning model. The value can represent various forms, such as monetary value (in the case of e-commerce or financial services), engagement value (for social media interactions), or operational value (in case of system events). In some embodiments, Visualization and Reporting Interface: The system includes a user interface to display the estimated event value in a comprehensible format. This interface may include dashboards, charts, and reports that help users understand the event's value, enabling them to make informed decisions. In some embodiments, API for External Integration: The system provides an API that allows external systems to communicate with it. This enables other web applications or computing systems to input event data and receive value estimations. The API may support RESTful calls, enabling smooth integration with third-party services. In some embodiments, Method for Estimating Event Value: In some embodiments, The method for estimating the value of a specific event includes the following steps: In some embodiments, Event Detection: The system detects an event triggered by a user or the system itself. This event may include a user action (e.g., purchase, click) or system event (e.g., transaction completion). In some embodiments, Data Collection: Once an event is detected, the system collects relevant data, including user information, historical events, and contextual data related to the event. In some embodiments, Feature Extraction: The system processes the collected data to extract key features necessary for event value estimation. In some embodiments, Model Application: The machine learning model is applied to the extracted features, using the learned patterns to estimate the event's value. In some embodiments, Value Estimation Output: The system generates an estimated value for the event, which may be in monetary terms, engagement metrics, or any other relevant measurement based on the application context. In some embodiments, Continuous Learning: The system uses feedback loops to improve its machine learning model over time by evaluating the accuracy of past predictions and refining its parameters. In some embodiments, E-commerce Platform: On an e-commerce website, the system estimates the value of a user's “Add to Cart” event based on user history, previous interactions, the type of product added, and real-time sales data. This estimation helps the platform optimize its marketing strategies and offer dynamic discounts to the user. In some embodiments, Social Media Platform: On a social networking site, the system estimates the value of a user's post by analyzing the user's network size, engagement history, and the content of the post. This estimation can be used to prioritize content in the feed or target advertising. In some embodiments, Financial System: In a banking application, the system estimates the value of a completed transaction, factoring in the transaction type, historical data of similar transactions, and user behavior, allowing the system to assess risk or reward for future actions.

In some embodiments, The invention utilizes AI algorithms such as deep learning, neural networks, and computer vision to analyze features like facial structure, hair color, and other visual aspects. In some embodiments, The invention further optimizes user experience by refining the recommendation process based on user preferences, historical behavior, and the degree of similarity sought by the user. In some embodiments, The system consists of the following components: In some embodiments, User Interface (UI): A user-facing interface where users can upload or select an image of a person. In some embodiments, AI-Powered Image Recognition Engine: A backend engine that processes the uploaded or selected image using computer vision and machine learning algorithms to extract visual features. In some embodiments, Profile Database: A database storing profile images and associated data (e.g., name, age, location) of registered users.

In some embodiments, Similarity Matching Algorithm: A specialized algorithm that compares the extracted features from the input image with those stored in the profile database, assigning a similarity score to each profile. In some embodiments, Recommendation Module: A component that ranks and returns the most visually similar profiles based on the similarity scores. In some embodiments, Image Processing and Feature Extraction: In some embodiments, Upon uploading an image or selecting a profile, the AI engine performs the following: In some embodiments, Face Detection: Identifies and isolates the face from the image using pre-trained models (e.g., CNN-based object detection). In some embodiments, Feature Extraction: Breaks down the face into measurable attributes, such as facial structure, skin tone, eye shape, hair color, etc. In some embodiments, Dimensionality Reduction Converts extracted features into a numerical vector for efficient comparison.

In some embodiments, Similarity Matching Algorithm: In some embodiments, The system employs a similarity matching algorithm that calculates how closely other profile images match the uploaded or selected image. This involves: In some embodiments, Cosine Similarity or Euclidean Distance: Mathematical functions used to compare the numerical vectors of the input image with those of the database images. In some embodiments, Weighted Similarity Score: The system can assign weights to certain features (e.g., facial structure, hair type) to prioritize some aspects of similarity over others based on user preference or context. In some embodiments, Personalized Results and User Feedback Loop: In some embodiments, The system allows users to adjust the similarity threshold to control how closely the results must match the selected image. Additionally, the recommendation module takes into account, In some embodiments, User Interaction Data: As the user interacts with the app (e.g., likes, swipes), the system learns preferences and adjusts future recommendations. In some embodiments, Filtering Criteria: Users can apply filters such as location, age, and other parameters to refine results. In some embodiments, Real-Time Recommendations: Once the image is processed, the system generates and presents a ranked list of profiles, each showing how similar the appearance is to the original photo. The results are displayed in real-time, allowing users to browse and further refine their search.

In some embodiments, AI may be able to track (e.g., insurance policy claims, insurance claims, rules and or regulations, or state or legal policies or rules, etc.) In some embodiments, legal insurance may be able to be obtained by a (e.g. single person, a client, a regular person, a law firm, a big law firm, etc.) In some embodiments, insurance policies may be able to be obtained from a (e.g., user, person, group, entity, business, etc.) for example after (e.g., answering some questions or inserting their data, or filing a claim, or accepting or asking for insurance, or integrating insurance, etc.) into the computing system. In some embodiments, the (e.g., legal or otherwise insurance policy, etc.) may be able to be created by using ai for example by (e.g., integrating their personal data and adding it to the policy, or changing the policy, or creating a separate or a new policy, etc.) In some embodiments, legal insurance may be able to be (e.g., combined with another insurance policy, for example, as an ‘add on’ through the computing system, whether (e.g., manually or using AI using a human or a hybrid of any, etc.) In some embodiments, legal insurance policies may be able to be (e.g., obtained by a user through the computing system, etc.) for example and the computing system may be able to (e.g., send their legal policy, file their legal policy, change their legal policy, cover their legal policy, pay out their legal policy, etc.) In some embodiments, the computing system may (e.g., payout, pay, cover, file claims for, file claim on, etc.) their legal policy by (e.g., clicking any button or inputting any information or filing and claims, etc.)

In some embodiments, clients may have a subscription model or model or payment paying into a certain amount per month; for the price, the user may receive a certain number of legal or medical consultations, etc. In some embodiments, the lawyer or doctor may receive a (e.g., percentage of a pre-contracted amount or a percentage or a part of the amount that was already paid in into the insurance or the system or computing system, etc.) In some embodiments, if the client engages the lawyer or medical person after the consultation, the insurance or the subscription may (e.g., pay through the computing system or come up with a report, etc.) a certain amount of the total legal or medical fee, etc. In some embodiments, lawyers or attorneys may be able to create their own advertisement system through the site or computing system such as create their own advertisement or ad that may show on the site based on (e.g., location, city, type of case, where the client is located, location of the situation, etc.)

In some embodiments, a manager may be able to create their own profile, page, managing system, management system, and the manager may be able to organize the model's profile page, model's calendar, creators calendar, creators profile page, creator or model's prices, make changes to prices, make changes to scheduling, create schedules, obtain a percentage payment through the system per each confirmed, paid, completed date, or show, or entertainment service, etc. In some embodiments, the manager's page may be able to obtain specific less or more permissions based on each model's preferences on allowing the person or user or manager to obtain such as ‘permission to schedule on my behalf, permission to book dates on my behalf, permission to message clients regarding pricing, permission to send exclusive content to paying customers, permission to create date bids, permission to close on dates, etc.

In some embodiments, users may be able to insert data into a system or computing system and obtain information regarding the probability data of a case, such as (e.g., the percent chance of a single attorney winning this case, the chance of a law firm with a combined 40 years of experience wins this case, a big law firm winning this case, senior versus new attorneys winning this case, the adverse party probability, taking other data from other sources such as public legal records and winning the case based on those information data points, etc.) for example and this information being able to come back through the computing system into a report or some type of a chart of percent database or percent winning or percent of winning, or how much time and or money it may cost to win this case, or how much risk is involved, etc.) In some embodiments, the computing system may integrate information using (e.g., inputting or considered data, or possible data, or data that may be involved in the case, etc.) and or (e.g., combine it, use with, consider, etc.) outside data points of (e.g., past cases or another current or recent case, etc.) and give a percent chance of (e.g., winning, how to win, what law firm has the higher chance, what type of attorney would be best for this case, whether or the adverse party is a viable one to attempt to file a case against, etc.)

In some embodiments, users may have options (e.g., after conflicts check or at any time, etc.) to (e.g., integrate their calendars, set up their calendars, change their calendars, book calendars, book, accept bookings, set a type of calendar or a third-party calendar to set up the ‘interview’ or ‘discussion’, etc.) In some embodiments, users may be able to link to (e.g., 3rd party calendars or integrated calendars, etc.)

In some embodiments, litigation funders may be able to view leads, parts of leads, parts of information, possibly less sensitive information, or non-sensitive information and suggest that they want to fund this case for the lawyers by indicating to the attorney that reviews that case they may be interested in funding this case or possible litigation related to the case, etc.) In some embodiments, ligation funders may have access to a certain amount of non-sensitive material related to a potential case and indicate if they may be interested in funding it for the attorney or legal professional to review. In some embodiments, legal professionals may be able to add themselves to pay to have themselves into a list that may be displayed or shown on the client's dashboard, visual states, visual areas, computing system screens such as their (e.g., web app, or website, etc.) In some embodiments, legal professionals may pay to be shown as a pre-approved or pre-selected or accept submission cases on their dashboard or the client's dashboard. In some embodiments, legal professionals may be shown as (e.g., ‘pre-approved’ or ‘pre-vetted’ or ‘accepting any submissions of cases, etc.’ In some embodiments, advertisers may be able to (e.g., create their own ad from their dashboard and target the state, city, area, or part of a state or jurisdiction and be able to create an ad that may show on the desktop of those persons or clients or persons with a legal issue or a case, etc.) In some embodiments, legal professionals may be able to (e.g., create their own ad, which may be shown on clients' dashboards or lists or attorneys or the area in which they make a case, etc. Then, clients may be able to either submit directly to the (e.g., attorney, law firm, or legal professional, etc.) or (e.g., click out of the site and go directly to their site, etc.) In some embodiments, legal professionals may be able to (e.g., advertise, show ads to, show up for, recommend for, etc.) to anyone they want to based on targeted computing systems and data based on the (e.g., client's state of the case, current state, or any data related to the client's potential case, etc.) In some embodiments, It is created directly from the legal professional's dashboard, advertisement studio, method, computing system area, or visual state, which may include payments made directly from that area. In some embodiments, litigation funders may pay or be part of a (e.g., lead paying system or a subscribing system per month for a specific number of leads or information related to a potential case and either indicate that they are interested or contact the legal professional to request that they take this case, etc.) In some embodiments, ligation funders may have access to artificial intelligence combining and may be able to obtain data for possible class action lawsuits and may have access to a (e.g., a specific amount of non-sensitive data material to decide if they want to fund a class action or any individual cases; this indication of interested by the litigation funders may be indicated or added along to the data submission once a lawyer or legal professional requests to view a case, or during the time of case review or learning the facts of the case from the database or platform or computing system, etc.) In some embodiments, ads may be displayed only after a potential client has submitted at least (e.g., one case, many cases, just logged in, etc.

In some embodiments, the stylist, manicurist, license manicurist, amateur manicurist, hair stylist, blow-out salon stylist, hair cutter, barber, may be able to be booked on the app, or webapp, and have a ‘tracking system’ when the in-home stylist is on their way, or if the client is on their way to the salon or the appointment, etc. This invention relates to a mobile application, web-based platform, or hologram-based system for providing on-demand services. Specifically, the platform connects clients with service providers, such as nail artists, hair stylists, barbers, massage therapists, personal trainers, or any other type of professional service provider, allowing them to be dispatched to a client's location or vice versa. The system enables real-time tracking and displays the location and distance of both the client and the service provider using GPS technology.

The platform operates similarly to existing on-demand transportation applications by allowing users to Request a service through an app, web application, or hologram interface. The platform matches the client with an available service provider based on proximity, preferences, or availability. Both the client and service provider can see each other's real-time GPS location. This ensures that: The client can see how far the service provider is from their location. The service provider can monitor the client's arrival if the service is taking place at a salon or business location. The system calculates estimated time of arrival (ETA) based on the current location, traffic conditions, and distance. Payment can be made through the app, with options for tipping, reviewing, and re-booking the same service provider in the future. The platform's unique feature includes hologram integration, enabling users to visually interact with a 3D holographic interface, making the process more immersive and intuitive.

In some embodiments, a notification system proficient in sending real-time alerts to pro bono attorneys immediately upon receiving new case submissions, updates, or client communications guarantees timely responsiveness and fosters efficient case management. In some embodiments, a reporting and analytics component that bestows invaluable insights into pertinent case acceptance trends, attorney performance metrics, and potential client needs upon pro bono organizations. In some embodiments, This component assists in optimizing the delivery of pro bono legal services. In some embodiments, Within the software system, the user interface is equipped with user-friendly input fields and document upload features, thereby allowing potential clients to provide an exhaustive array of case information and conveniently upload relevant documents for thorough review by pro bono attorneys. In some embodiments, The software system prudently stores potential client profiles and their corresponding case information within a secure database, ensuring that data confidentiality is upheld to the highest degree. In some embodiments, This measure fully complies with the legal and ethical standards governing attorney-client privilege, reaffirming the system or computing system's commitment to data privacy and integrity. In some embodiments of the software system described, the case management module extends comprehensive tools to pro bono attorneys, thus enabling them to conduct detailed reviews of the submitted case information. In some embodiments, This may include features such as document viewing capabilities, case summarization tools, and communication functionalities to engage with potential clients efficiently and effectively. Within the software system outlined in some embodiments, the notification system operates adeptly, dispatching real-time alerts to pro bono attorneys immediately upon receiving new case submissions. In some embodiments, This real-time functionality guarantees swift responses and ensures the overall efficiency of the case management process. In some embodiments, artificial intelligence matching case to an attorney using knowledge, past information, or case types or information from the computing system or information from the internet or outside web domains, etc.

In some embodiments, a swiping or pre-approval method is used in which females or one party or type pre-approve their profile to be seen by men or other persons that she likes, etc. In some embodiments, the other user has to pay to connect with her, either by paying her directly or paying the website, computing system, business, etc. In some embodiments, users may be able to pre-approve other users to view their profile or contact them, etc. In some embodiments, there may be a requirement to complete the contact such as subscription or a payment, etc. In some embodiments, a story feature where clients may be able to see the attorneys daily progress on a case or some update in which the client may be able to then go and pre-approve that attorney to view their case, etc.

In some embodiments, an (e.g., ai search engine or search bar or ai search etc.) may be able to use (e.g., typing, voice, text, commands, etc.) may be able to have (e.g., inputted information, or an input of information, etc.) on what they want to (e.g., do today, want to buy today, want to explore, want to search for, etc.) and the ai tool may be able to make (e.g., a purchase, show items, display items that are on sale, show items that are on sale, show items to be purchased, show items to be made, show items that may be able to be bought etc.) In some embodiments, the ai tool may be able to make the (e.g., purchase, display, showing, order, online order, place a delivery order for, etc.) for the client or person or user from the (e.g., 3rd party websites, or any website, or any ordering system, or any 3rd party apps, etc.) using the ai tool. In some embodiments, the (e.g., client or person's wallet, etc.) may be able to be loaded with (e.g., money, credit, crypto, exchange rates, exchanges, any medium of exchange, etc.) or (e.g., integrated, 3rd party integrated, or connected to their credit card or credit card processor, etc.) and the ai tool or ai search engine or ai tools may be able to make purchases through the (e.g., ai website or ai too, or ai assistant, etc.

In some embodiments, a process in which attorneys may be able to be pre-approved to view a case, which would skip a step such as back and forth computing systems of approval and allow the approval, the attorney may have another step such as ‘conflicts check’ prior to actually seeing the actual case, etc. In some embodiments, there may be a way to filter subscribed attorneys by female, male, experience, state, etc. In some embodiments, there may be a way to view all of the pre-approved attorneys in a list and click or remove their access from that list or section, etc. In some embodiments, there may be a way to revoke access to attorneys view at anytime through the process of a case. In some embodiments, there may be a way to delete or remove access from viewing a case. In some embodiments, there may be ways to sign representation agreement through the computing system, etc. In some embodiments, pre-approval attorneys list may be non-subscribed attorneys or any attorney that signs up, etc. In some embodiments, attorneys or professionals may have to be approved by admin or site or 3rd party or ai or intelligence system, etc. In some embodiments, information posted or listed on site may be encrypted, or non accessible, etc.

In some embodiments, pro bono attorneys may have access to cases last at a (e.g., lower tier subscription, etc.) for example after all paid legal professionals have had a (e.g., decent amount of time to review the cases or after a time period has passed, etc. In some embodiments, The software system presented incorporates a reporting and analytics component ready to provide pro bono organizations with crucial insights into a spectrum of relevant metrics. In some embodiments, These may include case acceptance rates, attorney performance, and the evolving needs of potential clients. In some embodiments, the availability of such insights contributes significantly to the optimization of pro bono legal services. In some embodiments, the process of pro bono attorneys managing and reviewing cases through the software system is elucidated. In some embodiments, a method unfolds. In some embodiments, this method may include the sequential steps of facilitating potential clients' submission of case information and pertinent documents through a user-friendly interface. In some embodiments, Securely storing the wealth of submitted case information in a database preserves its association with potential client profiles. In some embodiments, pro bono attorneys are empowered to access, assess, and make decisions regarding cases through the case management module. In some embodiments, pro bono attorneys are promptly notified of new case submissions or client communications through the notification system. In some embodiments, reporting and analytics on relevant metrics, such as case acceptance rates and potential client needs, are presented to pro bono organizations, thereby supporting their evaluation and continuous improvement efforts. In some embodiments, based on what tier, subscription, frequency of logging in, notification setting, tier and or pay per open case, etc., or any combination may result in the time legal professional may be able to view or have access to the case. In some embodiments, other groups or tiers, subscription models, amount bided, amount paid, amount per lead, or amount per case information may result in how quickly or frequently that legal professional may be able to access the case or cases information.

In some embodiments, professionals or users may be able to submit a ‘personalized proposal’ or ‘statement’ or client or ‘attorney’ with a limited state or amount of words to explain why they are interested in viewing or seeing or learning more, etc.) In some embodiments, there may be a separated or designated ‘pro bono’ database of attorneys that are not allowed to take any recovery from clients, etc.) In some embodiments, there may be an online button or online notification for a client when the case is posted or a case has been submitted to the database. In some embodiments, attorneys or legal professionals may have an online now button or an online notification to show that they are active on the site or, at that moment, by clients or possible clients or persons needing or seeking an attorney or legal professionals for their case or legal issue. In some embodiments, on the signup page, from client and professional to legal professional and potential client may have character fields to sign up; there may be error boxes if it doesn't align with instructions or terms.

In some embodiments, notification emails may be sent as soon as a professional logs in, a client, a person with potential legal issues, etc.) In some embodiments, UI may show the term “legal type” to the legal role such as ‘legal professional, legal assistant, licensed attorney, a licensed attorney in the state of XYZ, an attorney in this country, an attorney in a specific country, an attorney in school, law student, pro bono attorney, volunteer legal professional unlicensed, legal assistant (unlicensed), working under an attorney, working at a law firm without a law degree, not a barred attorney but with a J.D, J.D degree, no barred license, personal assistant, executive assistant, customer service representative, etc.) In some embodiments, country code may appear for the phone number. In some embodiments, the admin page may say “verification” and “updates” on the awaiting approval page for those that need to be approved or accepted, meet minimum standards, or meet standards or terms of the website or web app, etc.) In some embodiments, approved or denied legal professionals may disappear from a list once they are approved or accepted. In some embodiments, there may be a notification or a visual state that shows verified on the professional's profile or professional dashboard or visual UI, etc.)

In some embodiments, there may be an option for a legal professional to “submit to approval” to save their profile or submission. In some embodiments, submit only if the req field is changed or terms are met. In some embodiments, a professional may be able to remove or set their email preferences from their profile edit. In some embodiments, email or phone number or any notification may be able to be changed by the client or professional and may or may not need to be approved by admin or website or web app, etc.) In some embodiments, any changes may be made to the analytics page, etc.) In some embodiments, there may be a terms and conditions popup that may require approval, selection, or agreement to continue, etc.) In some embodiments, there may be exclusions for emails such as Gmail and yahoo for a professional account, etc.) In some embodiments, there may be a link to the profile on notifications to view items directly from notifications. In some embodiments, there may be a link to more details on notifications to or from the admin panel, client, or professional. In some embodiments, there may be a different state, such as green for positive use cases and red for negative or UI changes for negative or positive viewings. In some embodiments, deleted accounts may receive an email and then periodic emails later that say you may be able to come back, etc.) In some embodiments, there may be an ‘unsubscribe’ option to never receive emails again, etc.) In some embodiments, there may be a ‘create a shorter version for the create case’ which may include but not be limited to which may include but not be limited to (e.g., state, zip code of the case, client, phone, email ID, date of the incident, Type of cases, etc.) In some embodiments, a short create case form will have the above req fields and a text area to enter extra information, attesting, confirming, legal terms, CAPTCHA, etc.) In some embodiments, For the longer version, there may be another panel or option for the user to have topics that the user may be able to click and enter details on or add any other information, etc.)

In some embodiments, On the cases list, there may be options such as which may include but not be limited to (e.g., progress bar, actual states that show user updates or user activities, client activities, or online now, or information about how long it was posted, information on where it was posted from, how long it has been there, how many users have seen or looked at the case, or scrolled over the case, showcase type, status, date created, etc.) In some embodiments, the status of cases would be published and closed. In some embodiments, there may be options such as Uploading videos as documents, recording a statement, etc.) In some embodiments, there may be a notification, such as showing a popup on create case after 3 cases that tells the user that only three may be able to be created or a limited number at a time, etc.) In some embodiments, showcase professional details on the top of the case details page, etc.) In some embodiments, there may be a Change in the message conflict check within the firm on the conflict popup, etc.) In some embodiments, Denied legal professionals may disappear on the client's end, not be shown again, or shown in a different state, etc.) In some embodiments, there may be an adverse party, anonymous, or some details listed such as name or contact information. Also, on the conflict popup, there may be any information related to contact information, ‘adverse party’, conflicts check, etc.) In some embodiments, the case disappears on professional when there is a conflict of interest, and it may notify the client, etc.) In some embodiments, in there is no conflict, there is also a tab separately to notify or send the case or data to ‘no conflict tab or state, etc.’ on notification, showing more details like the date of the incident and state of incident, etc.) In some embodiments, there may be constant Changes or updates on how many professionals on the professor details page of the case have viewed the case, seen the case, opened the case, liked the case, etc.) In some embodiments, if it is the second time requesting to view a case, notify the client, etc.

In some embodiments, there may be changed, updated, or refreshed, changing numbers, etc., on the stepper or progress bar of case info of clients or professionals to show the status or current status of their case until finding an attorney or getting their case taken on, or obtaining a case, etc.) In some embodiments, Show the number of prof sessions on the stepper as an icon for any viewpoint. In some embodiments, the taken-on flow may allow data, cases, accounts, or case, or information to disappear after seven days or any time. In some embodiments, when cases or items are deleted, there may be options or notify or notifications to all professionals involved, depending on whether they need to be approved from the client end or if they are already approved, etc.) In some embodiments, upon submitting or before submitting a case or posting to the database, there may be a captcha—for case creation or to confirm that it is not a robot or human, etc.) In some embodiments, users, clients, the public, etc., may choose to go anonymous when creating cases and/or on conflict checks show their contact, etc.) In some embodiments, there may be an option to Give a unique number for each user, etc.) In some embodiments, the case details or details may be downloaded as a single folder or any folder, or downloadable or only viewing, or options not to allow downloading or options to download, etc.) In some embodiments, there may be a ‘currently reviewing’ or ‘requested details on case list,’ etc.) In some embodiments, there may be a ‘case pending date information’ or ‘case pending closing my client’ or case pending or ‘legal signatures have been conducted’ or ‘case has been closed’ etc.)

In some embodiments, there may be a request to close on the side tab of professional, etc.) In some embodiments, a ‘Not interested flow’ may show in the conflict itself as a filter option or options to change the ‘not interested flow’ or ‘not interested’ or ‘select case as not interested, etc.’ In some embodiments, there may be a ‘filter’ in the no conflict page to show the ‘interested’ or ‘not interested’ cases, etc.) In some embodiments, there may be a ‘clear option’ or ‘read’ option on notifications. In some embodiments, there may be a notification on admin and client pages. In some embodiments, clients, users, persons, etc., may choose to go anonymous when creating cases and, on conflict check, show their contact or show an option to contact a person directly whether ‘whether displaying their contact information, setting up a video chat, video call, phone call, calendar options to book directly with the client to learn their name, or intake form’ or intake’ or legal signatures, or document signing’ or ‘live video chat, etc.) In some embodiments, there may be options to Include more links on the professional profile page when the client is viewing, receiving, or considering legal professional pages or information, etc.) In some embodiments, the links may be links to websites, law firm websites, professional profiles, blogs, and state bar information. There also may be options for ‘video’ or ‘pictures’ or visual displays. A video explainer for a law firm, or a video introducing themselves, or a picture of the law firm or the attorney winning a case, etc.) In some embodiments, there may be a ‘count’ in the tabs of professionals that keeps track of how many clients are in each tab, such as ‘opened cases,’ ‘approved cases,’ ‘approved viewings,’ ‘approved’, ‘interested cases,’, etc.) In some embodiments, these may all be marked or shown as live numbers based on current data, etc.)

In some embodiments, A software database system for legal cases filed in the United States or any country comprises a data collection module configured to gather and compile case data from various legal databases and sources. In some embodiments, This data collection module ensures that the system or computing system maintains a comprehensive and up-to-date repository of legal case information. In some embodiments, the software database system incorporates a data processing module that utilizes advanced artificial intelligence (AI) algorithms. In some embodiments, these AI algorithms are employed to analyze and categorize the gathered case data effectively, whether to be displayed, shown, considered, etc.) In some embodiments, This analysis may include extracting key case details, such as case titles, parties' names, case descriptions, key dates, and relevant legal precedents, facilitating streamlined case management and searchability. In some embodiments, the software database system features a user interface designed to cater to the specific needs of law firms and attorneys. In some embodiments, This user interface provides advanced search functionalities, including keyword searches, case status filters, jurisdiction preferences, and customizable notifications. In some embodiments, these features ensure that legal professionals may be able to discover and track relevant cases tailored to their practice areas and preferences efficiently.

### User Interfaces/Figures

In some embodiments, Professional dashboard or interface or screen may show multiple tabs, there may be which may include but not be limited to (e.g., a scoreboard of how many cases or any type of cases-related numbers or statistics, advertisements, add professional to the list of all professionals or attorneys or persons, or medical persons, active, closed, available cases, cases recent or just posted, available cases, certain time period cases, requested cases, profile of attorney, settings, notifications, filters, ai-powered systems, ai-powered filters or suggestions, suggestions of cases, new cases, suggested or hand picked cases, specific filters or suggestions or news bulletins, news, live news, live streams, messages, requests, case export database, exporting data to case management system, admin login for professional to manage their paralegals or survivor resources, therapist resources, case management resources, attorney or legal professional resources, news for attorneys or professionals, pro bono network, pro bono dashboard or system, calendar status, new cases, case filters, premium filters, premium dashboard, etc.)

In some embodiments, the Professional dashboard or interface or screen may allow the screen to go to the screen by clearing all their preferences or removing any filters that may reveal any new cases, alternative cases, visuals, postings, etc.) In some embodiments, there may not be a filter in place, and may be a form of a first visual state or second visual state depending on which tabs are clicked or selected. In some embodiments, certain tabs may be for premium members only; some tabs may land for different people based on their current state, status, membership, payment going through, statistics, or any other reason such as their type of professional such as an assistant or a legal professional, etc.) In some embodiments, there may be interactive parts of the dashboard or screen depending on the status or state the user is in. In some embodiments, in, there may be case postings or postings for the need of an attorney or professional or legal professional or any type of professional needed. In some embodiments, these informational postings may be interactive and be able to be clicked to reveal more information, or there may be options in which the user may have to request and be approved by interacting with the posting or case. In some embodiments, the original poster or user who posted it may be required to approve this user who requests, and they may able to ignore, approve, or deny the user or block the user, etc.) In some embodiments, the postings may have interactive or time-based information that may change or change states or change visuals or colors or information or summaries, or change dates or names or times or colors, or a different visual or informational state, etc.)

In some embodiments a user interface is a scrolled-down version of where the interactive parts are more showing, and more information may be shown based on viewing the entirety of the posting or the informational post or the informational section. In some embodiments, there may be current status numbers based on how many users are persons are viewing a particular case or what state or status the case is in at any moment based on the type of case or the needs of the case or where the case is in in being evaluated by others or by this person or user, etc.)

In some embodiments, a user may be able to scroll, click, move, or select other tabs that may reveal other information or tabs or sections from the main page. In some embodiments, requested tabs or requested cases, or tabs that show the progress of the case or cases the user may be interested in, may reveal other information, other postings, premium postings, premium information, premium tabs, premium filters, etc.)

In some embodiments, a user may be able to click or show another section or tab, which may be their active cases, cases they are discussing with a client, or any case they may be interested in or marked, or was approved by client to view, etc.)

In some embodiments, the side tabs or side area or any area section that may be separate from another may reveal other statuses of any type of cases or case, etc.) In some embodiments, there may be notifications or messages or important messages listed or shown or updated or status updates, etc.)

In some embodiments, a professionals profile may be listed or shown, which may also include their admin database for their (e.g., employees or co-workers such as paralegals, assistants, receptionists, call center, etc.) In some embodiments, the admin database or admin section may allow professionals to add, remove, revoke access, etc., to employees if they leave or are no longer employed. In some embodiments, this may or may not include their email addresses, changing emails, changing pictures, changing employees linked, accepting or denying requests to be an authorized user to represent an attorney to view cases, etc.) In some embodiments, adding information to be accepted by a managing employee, such as a paralegal may be able to request access from an attorney through this section or database. In some embodiments, paralegals may be able to create their profile and won't have any access to view cases until their profile is approved by the computing system admin, the managing attorney, the managing director or their boss, etc.)

In some embodiments, it may be a scrolled version or a version that adds mor, which may show more formation or have more options to add, accept, request, request access, revoke access, send information to admin for approval, denial, changes, etc.) In some embodiments, this may show the status of the profile or the user; for example, it may show verified, not verified, revoked access, no access, access denied, needing approval from attorney, needing managing attorney approval for access, status message explaining what that means, or resources to explain the status, etc.)

In some embodiments, this may be an alternative version or a scrolled version of user interfaces.

In some embodiments, an admin panel or admin system may show information for anything such as (e.g., case statistics such as types of cases posted, professionals, emails, how many cases, logins, amounts of logins, reports, etc.)

In some embodiments, lists, emails, types, charts, statistics, email download options, charts may show statistics for users, professionals, cases created, how many cases created, different methods to download or different options to download, professionals pictures and profiles, awaiting approval, profiles, pictures of professionals, verified or not verified, notifications, mark as read, read, notifications, admin panel, approval panel for admins, awaiting approval, successful logins, denials, types of cases, client statistics, admin statistics, login counts, types of cases reported, pie charts, bar charts, graphs, etc.)

In some embodiments, the user may have an interface where cases may be able to be (e.g., created, posted, visuals of available attorneys, submission to attorneys, submission to professionals, available professionals, notifications, online attorneys, online professionals, etc.)

In some embodiments, cases may be able to be created, there may be a number of limit of cases to be created, there may be an insertion place to put information, you may be able to speak directly to an AI in order to create your case, you may be able to be interviewed by an AI in order to get your case details or to put together a case posting or a case submission, going anonymous may be an option, remaining anonymous, there may be a ‘create case’ button or option to submission, requiring to sign a document may be implemented by the computing system, there may be a document signing device or option or statement, a recorded statement, a video recorded statement, a statement that is locked based on the number or requirement, a password protected login or viewing of documents or cases, etc.)

In some embodiments, user may be able to see their case created and or posted, there may be additional steps to find cases, submit cases, submit more information, fill in additional information, wait until later, do it now, submit it along with your cases, submit it as a separate submission, view their case details, etc.)

In some embodiments, the user may be able to create additional submissions, questions, and answers, give more details, create new details, add new evidence or case information, select questions, a selection of questions, typing in questions, ai-suggested answers, ai-fill in form, typing, speaking, recording, etc.) In some embodiments, the user may be able to submit a case, etc.) In some embodiments, submission may be posted on a wall or a page or a section where it may be accessed in part, in full, by attorneys or other people or approved persons, or partially viewed, or viewed only by payment or premium members or subscribers only, etc.)

In some embodiments, interface may show or user may be able to (e.g., create a new case, delete case, edit case, resubmit case, send case to pro bono network, send case to attorneys, send information to law enforcement, schedule video call with attorney or professional, schedule or view their calendar, view other attorneys calendars, view calendar, manage calendar, schedule through calendar, schedule meeting, schedule in person meeting, schedule virtual meeting, view all of their pending, posted, draft cases, or submit cases, or see selections to do with their cases such as moving it to pro bono network, or find volunteer attorneys to take their case, or view all requests, or view new requests, or post cases, or post case, or view statistics, or view updates on their case, messages, notifications, edit their information, remain anonymous, create a submission for help, view who is looking at their case, or view who is interested in their case, an overview of their case, their case progress, recommended attorneys, new attorneys, just joined attorneys, added attorneys, resources, sexual assault resources, domestic resources, abuse resources, police information, how to file a restraining order, how to report crime to police, how to manage your case, how to manage emotions, therapists, etc.)

In some embodiments, the interface may show or the user may be able to see a stepper or a progress report or a progress list or a progress screen such as creation, request, approval, conflicts check, request to close, close, close their case, create their case, requests made, requests created, requests received, approvals, not approvals, conflicts check results, how many interests, interested parties, interested attorneys, etc.) In some embodiments, a case more detailed view may be available such as another screen or an area or portion or separate screen where the user may be able to see all of their case details; this may be password protected, or a second form of security in order to view these results or view this additional or personal information to user or any authorized user, user may be able to add more details on this page, or on these screens or protected areas, add documents, upload documents, add video files, lists of all of the basic or detailed information regarding their case such as adverse party, city details, state details, contact information, emails, interested parties, progress report, progress bars, etc.) in some embodiments, deleted case, add video files, upload any supporting documents, create a recording video or voice or audio, etc.)

In some embodiments, users may be able to create a profile where they may be able to offer services, barter services, paid services, listing services, etc.) In some embodiments, there may be an exchange of money or services or exchange of value or booked sessions, there may be video chats, video calls, voice calls, voice messages, hologram, 3-D models, ai-created content, ai-created information, posts, or content, etc.)

In some embodiments, user may be required to complete their profile in order to view cases, offer services, list themselves, join the network, join a database, join the list, create profiles, etc.) In some embodiments, users may be able to create ads by themselves, through a 3rd party network, through sponsors, through other attorneys, through their law firm, users may be able to offer free services, offer pro bono services, etc.)

n some embodiments, user may be required or required to fill out their information such as name, company, law firm information, legal license information, law firm link, preferred case type, phone number, etc.) In some embodiments, users information may go through AI in which artificial intelligence will be able to determine if this user is a real person, has a license, has any ability to practice law, is employed at a law firm, is employed or not employed, has any convictions, has any legal convictions, delete account, password security, information, admin panels to manage employees access or employees information, revoke access to employees or hired persons, do a background check on persons, submit for verifications, submit changes, see their changes, see their verification status, be approved or denied, etc.) In some embodiments, the user may be required to upload a photo in order to be identified, and the user may be required to state their role, such as attorney, professional, assistant, paralegal, etc.) In some embodiments, case preference type may be required or optional, as well as state preferences or states the user is licensed in, etc.) In some embodiments, who they are representing, such as an attorney, etc.) In some embodiments, submission to verify or change account details or major or minor account details, or verify their employees, change networks, add pro bono network, add services, offer services, set prices, change prices, change services, add list of services, add calendar, change calendar, change calendar schedule, create schedules, create calendar schedule, send calendar to another site, export calendar, combine calendar, etc.) In some embodiments, users may be able to see their account profile verification submission, or their employee's verification submission or pending requests; there may be pending verification requests or submissions or revoke or give access or verify access to pending accounts or create new accounts to verify or revoke or give access as a paralegal, or assistant, or attorney, or partnership, or partner, or law firm, or network, etc.)

In some embodiments, users may be able to see the changes that may be made to an employee or a verification status or a verification of user or persons, or employees, or users given access, or any changes that may have been made, etc.)

In some embodiments, In some embodiments user may be able to view cases such as available, active, created, closed, just posted, posted after a specific time period, posted but time has passed, etc.) In some embodiments, there may be requested cases, disliked cases, pro bono network cases, available cases, filters, information, joining list of attorneys, creating list profile for attorneys, etc.)

In some embodiments, users may be able to view their status of cases or create cases, view an overview of progress for their cases, view how many professionals may be able to view their case, or see a list of attorneys who may be able to see their cases, see who all has viewed their cases, see who has opened their case, view resources, find therapists, find attorneys, find non-profit networks, find groups, etc.

In some embodiments, the user may be able to view progress, see how many are in each progress, view profile pictures, view attorneys or persons who are submitted, closed, opened, viewing, delete their case, edit their case, move their case, unpublish their case, etc.) In some embodiments, each professionals details, profile, picture, system, person, law firm, profile, etc., may be visible to the user at any time or at each place, or by clicking or by viewing each progress bar or each part or each section of their progress, user may be able to change their mind or revoke access to view the case at any time, etc.) In some embodiments, each person's information may be underneath or on the page; User may be able to change details which may reflect on the user who has already opened or viewed their case or seen the previous progress or information, the user may be able to delete the profile or cases at any time, etc.) In some embodiments, the user may be able to view a popup or a section of each person who has requested to view the case and all of their details; it may lead to a larger profile page or additional links or details outside of the popup or the section showing a few details or information, etc.) In some embodiments, the user may be able to approve, deny, block, or wait until later to decide, etc.) In some embodiments, users may be able to scroll or pan through any users that want to view their profile or their data or their case details or their case, etc.) In some embodiments, the user may be able to see the attorney and their assistant on one popup or one area where both may be listed; the user may be able to scroll between assistant and or the attorney or the representative of the attorney in order to see who wants to view their profile or their case details, etc.) In some embodiments, the user may be able to see how many cases the user has closed how many cases the user has seen or viewed, how many profile views they've had, how many views or viewers they have received or submissions, etc.)

In some embodiments, users may be able to see progress for the other user on their end and where they are at on their own personal progress, such as viewing your case, how many cases they have, how many requests they've made, etc.)

In some embodiments, the user may be able to see a dashboard view or an overview of statistics such as how many requests made, how many attorneys, how many interests, how many ‘uninterested cases’ how many interested cases, how many closed cases, how many active, sexual assault resources, resources, therapists, resources based on states, resources or organizational groups, nonprofit groups, suggested attorneys, advertisements for attorneys, users that need assistance or help or needs, etc.) In some embodiments, user may be able to go between screens or boxes or types or sections, etc.)

In some embodiments, user may be able to not view their personal data, instead, they may be promoted to use the available contact information to contact user to ask them about their case, or to schedule a video or a phone call, etc.) In some embodiments, user may be able to see that they have chosen the option to remain anonymous and have to contact them directly to move forward, etc.) In some embodiments, user may be able to suggest or click ‘conflict or no conflict’ based on their legal duties as an attorney to not have any conflict of interested on two people they may represent, etc.)

In some embodiments, user may be able to see status of each case or number or users or attorneys or persons viewing case, etc.) In some embodiments, user may have real-time updated or once a day updated results of each case or status of the cases listed, posted, or by any viewpoint, etc.)

In some embodiments, status, payment status may show on screen or be visible, or subscription status, or membership status, or type of status such as a specific type of case or a pro bono status, etc.)

In some embodiments, The software database system incorporates an AI-powered sophisticated recommendation engine in some embodiments. In some embodiments, This recommendation engine leverages machine learning algorithms to analyze the historical search patterns, preferences, and interactions of law firms and attorneys with the system or computing system. In some embodiments, Doing so may enable the provision of highly personalized case recommendations. In some embodiments, These recommendations align with each user's unique areas of legal expertise, client profiles, and interests, enhancing their ability to identify and engage with relevant cases more efficiently. In some embodiments, the software database system also may include a notification system. In some embodiments, This notification system delivers real-time alerts and updates to law firms or attorneys based on their search criteria and preferences. In some embodiments, These notifications ensure that legal professionals receive timely information about relevant cases, facilitating swift action and outreach to clients or potential clients. In some embodiments, the system or computing system accommodates different communication preferences, offering email and in-app notifications. In some embodiments, the method for using the software database system described herein involves a series of steps. In some embodiments, these steps include collecting case data from various legal databases and sources, processing the gathered data to categorize case details, utilizing the user interface for customized case searching, receiving personalized case recommendations from the recommendation engine, and accessing real-time alerts and updates through the notification system. In some embodiments, these steps collectively enable efficient case discovery and engagement for law firms and attorneys in the legal field.

In some embodiments, a computer-implemented system for automated information dissemination is disclosed. In some embodiments, the system or computing system comprises an artificial intelligence module designed to analyze news articles and social media content automatically. In some embodiments, this analysis involves the extraction of pertinent information based on predefined criteria, which may include keywords, topics, or other user-specified preferences. In some embodiments, the system or computing system further incorporates a data processing module tasked with organizing and categorizing the extracted information into a structured format. In some embodiments, the system or computing system may include a decision-making module that employs machine learning algorithms. In some embodiments, these algorithms are utilized to assess the significance and reliability of the extracted information. In some embodiments, The decision-making module plays a pivotal role in determining the content of posts generated by a posting module. In some embodiments, the posting module is responsible for creating and disseminating posts on various platforms. In some embodiments, The content of these posts is dynamically generated, taking into account the analyzed information and the decision-making module's assessment of significance and reliability. In some embodiments, the disclosed system further comprises a user interface module. In some embodiments, This module facilitates user interaction with the artificial intelligence module, allowing users to customize criteria for information extraction and modify posting preferences. In some embodiments, a feedback loop is established between the posting module and the artificial intelligence module. In some embodiments, user feedback on posted content is collected through this loop and used to train and improve the performance of the artificial intelligence module over time. In some embodiments, a computer-implemented method for automated information dissemination is provided. In some embodiments, the method involves automatically analyzing news articles and social media content using an artificial intelligence module. In some embodiments, This analysis incorporates natural language processing and sentiment analysis techniques. In some embodiments, Relevant information is then extracted from the analyzed content based on predefined criteria, such as keywords, topics, or user preferences. In some embodiments, the method may include structuring the extracted information into a format suitable for dissemination. In some embodiments, This format may include text, images, or multimedia content. In some embodiments, the method further utilizes machine learning algorithms to assess the significance and reliability of the extracted information. In some embodiments, posts are generated for dissemination on various platforms, with the content dynamically created based on the analyzed information and the machine learning assessment. In some embodiments, the method allows user customization of criteria for information extraction and posting preferences through a user interface module. In some embodiments, a feedback loop is established between the posting module and the artificial intelligence module. In some embodiments, This loop facilitates the collection of user feedback on posted content, which is then utilized to improve the performance of the artificial intelligence module continuously.

In some embodiments, a method is provided for prioritizing access to legal cases among a plurality of attorneys. This method involves a computing software system receiving a plurality of bids from attorneys or legal professionals who wish to view cases stored in a database. In some embodiments, the method continues by analyzing these bids using predetermined criteria, which may include factors such as case relevance, attorney qualifications, and bid amount. In some embodiments, The analysis is a crucial step in determining the priority access to the cases. In some embodiments, the method allocates priority access to the attorneys based on the analysis of the bids. In some embodiments, Attorneys with bids that meet the predetermined criteria are granted priority access to the legal cases. In some embodiments, the method further comprises periodically updating the database of legal cases with new case data and notifying attorneys of new case opportunities. This ensures that attorneys have access to the most up-to-date case information and opportunities. In some embodiments, the method also may include generating a user interface for attorneys to input their bids and view relevant case information.

In some embodiments, This user interface streamlines the bidding process and enhances the user experience by providing attorneys with a convenient platform for their interactions. In some embodiments, the predetermined criteria for bid analysis include at least one case type, case jurisdiction, case status, and case urgency. In some embodiments, These criteria help to refine the prioritization process, taking into account specific case attributes and attorney qualifications. In some embodiments, a computer system is provided to implement the method described above. In some embodiments, This computer system comprises a processor configured to execute the software system, memory for storing the database of cases, bids, and bid history, and a communication module for receiving bids from attorneys and notifying attorneys of their priority access. In some embodiments, the computer system further comprises a user interface for attorneys to input bids and view case information. In some embodiments, This user interface enhances the user experience, making it more convenient for attorneys to interact with the system or computing system. In some embodiments, the computer system is configured to perform the method of prioritizing access to legal cases as described in some embodiments. In some embodiments, a non-transitory computer-readable storage medium is provided, encoded with instructions that, when executed by a computer, cause the computer to perform the method of prioritizing access to legal cases among attorneys based on their bids and other relevant criteria. In some embodiments, cases may be separated based on any categories such as which may include but not be limited to (e.g., ‘type of case, zip code, distance, state, city, age range, male or female, previous history of cases, first-time personal injury case, amount of information submitted, frequency of submitted information, etc.) In some embodiments, a daily, monthly, weekly, yearly breakdown of successful cases from the site, or beginning on the site, etc.)

In some embodiments, A software system for automated gathering and summarization of cases is disclosed. In some embodiments, the system or computing system comprises several key components, which may include a) a data collection module configured to retrieve case information from various sources, encompassing databases, government websites, and proprietary data sources. In some embodiments, this module provides comprehensive coverage for gathering case data. In some embodiments, a data processing module plays a pivotal role in the system or computing system, utilizing advanced natural language processing techniques and machine learning algorithms to parse and extract relevant information from the case data. In some embodiments, this information may include but is not limited to case titles, parties' names, case descriptions, and key dates, ensuring that essential details are accurately identified and categorized. In some embodiments, law firms, legal entities, or businesses may be able to set their preferences or get suggestions based on AI-created cases, news articles, public information, or private information. In some embodiments, AI-created information may be sent to law firms, businesses, or persons considering a case without any use of human interaction or creation of a case.

In some embodiments, a summarization module is integrated within the software system, which employs machine learning techniques to discern and prioritize pertinent details within the case data. In some embodiments, this module generates concise and informative summaries of the extracted information, encapsulates key case details, parties involved, and case status, and provides users with a quick and comprehensive overview. In some embodiments, a dedicated database is provided for storing both the gathered case data and the summaries generated by the summarization module. In some embodiments, This database is a valuable repository for maintaining historical and real-time case information, including case numbers, case titles, parties' names, case descriptions, key dates, and accessible links to the full case documents. In some embodiments, This storage infrastructure enables users to access detailed case information whenever necessary. In some embodiments, an email notification system adds another layer of user convenience and engagement to the software system. In some embodiments, This system is designed to send regular email updates to users daily or periodically, ensuring that users receive timely and summarized case information directly in their inboxes. In some embodiments, the email notification system may be configured to align with users' preferences, allowing for personalized content and frequency settings.

In some embodiments, the software system, as claimed, benefits from the data collection module's capability to access a wide range of databases, government websites, and proprietary data sources. In some embodiments, This access ensures comprehensive coverage and up-to-date retrieval of case information, contributing to the system or computing system's accuracy and completeness. In some embodiments, the data processing module described leverages advanced natural language processing algorithms, enabling it to extract and process information from case documents effectively. In some embodiments, This module may be able to identify and extract critical details, such as case titles, parties' names, case descriptions, and key dates, with a high degree of accuracy, enhancing the system or computing system's ability to provide users with precise and relevant summaries. In some embodiments, the summarization module, in some embodiments, utilizes machine learning techniques to further enhance the quality of the summaries generated by the software system. In some embodiments, By identifying and prioritizing pertinent information within the case data, this module condenses complex case details into concise and informative summaries, streamlining the user experience and ensuring that key information is readily accessible. In some embodiments, The database component of the software system, In some embodiments, serves as a centralized repository for both the case data and the generated summaries. In some embodiments, It offers comprehensive storage, including case numbers, case titles, parties' names, case descriptions, key dates, and accessible links to the full case documents. In some embodiments, This storage infrastructure enhances the system or computing system's usability, allowing users to retrieve detailed information and access case documents as needed.

In some embodiments, the email notification system, described in some embodiments, adds a layer of user-centric customization to the software system. Users may be able to configure their preferences in some embodiments, specifying the frequency and content of email updates to align with their needs and preferences. This feature ensures users receive personalized and timely case summaries in some embodiments, enhancing their overall experience and engagement with the software system. In some embodiments, A method for utilizing the software system described In some embodiments, for automated gathering and summarization of cases is disclosed. In some embodiments, case information is from diverse databases or sources. The gathered data is processed in some embodiments to extract and categorize relevant case details. In some embodiments, Generating concise summaries of the extracted case information are generated.

In some embodiments, the gathered case data and summaries are stored in a dedicated database. In some embodiments, Sending email updates to users with the summarized case information allows users to stay informed and engaged with case developments efficiently. In some embodiments, a software system enables attorneys, law firms, paralegals, litigation funders, etc., to review case information submitted by potential clients. In some embodiments, a software system enables attorneys to access and review case information submitted by potential clients, comprising a) A user interface allowing potential clients to submit case details, legal issues, and supporting documents. b) A payment processing module that facilitates payments from attorneys seeking access to the software system. c) A secure database for storing potential client-submitted case information. d) A case management module that grants attorneys access to the submitted case data, enabling them to review and communicate with potential clients. e) An audit trail system that maintains records of all interactions within the software system.

The software system, wherein potential clients are provided with clear and transparent information regarding the fee structure for attorney access to their case information, ensures informed consent.

The software system, wherein the payment processing module offers various payment options, including flat fees, subscription-based models, or pay-per-case access, to accommodate the preferences of both potential clients and attorneys.

In some embodiments, the software system employs encryption and other security measures to protect the confidentiality of potential client-submitted case information and financial transactions, ensuring compliance with legal and ethical standards.

The software system may include a rating and review system where attorneys may be able to provide feedback and reviews on potential client-submitted cases, enhancing transparency and accountability within the platform, and wherein potential clients may be able to provide feedback and reviews and attorneys.

In some embodiments, the software system generates reports and analytics on fee transactions, case acceptance rates, and attorney-client interactions, providing valuable insights for attorneys and potential clients.

A software system for automated gathering and summarization of cases, comprising:
a) a data collection module configured to case information from one or more databases or sources;
b) a data processing module utilizing natural language processing and machine learning techniques to extract and categorize relevant information from the retrieved case data;
c) a summarization module that generates concise summaries of the extracted case information, including key case details, parties involved, and case status;
d) a database for storing the gathered case data and generated summaries; and
e) an email notification system that sends daily or periodic email updates to users, providing them with the summarized case information.

The software system, wherein the data collection module accesses publicly available databases, government websites, or proprietary data sources to gather case information.

The software system, wherein the data processing module employs natural language processing algorithms to extract information from case documents, including case titles, parties' names, case descriptions, and key dates.

The software system, wherein the summarization module utilizes machine learning techniques to identify and prioritize relevant details within the case data, condensing the information into concise and informative summaries.

The software system, wherein the database stores the gathered case data, including case numbers, case titles, parties' names, case descriptions, key dates, and links to the full case documents, allowing users to access detailed information when needed.

The software system, wherein the email notification system allows users to configure their preferences, including the frequency and content of email updates, enabling personalized and timely access to case summaries.

A method for automated gathering and summarization of cases using the software system, comprising the steps of: a) collecting case information from one or more databases or sources; b) processing the gathered data to extract and categorize relevant case details; c) generating concise summaries of the extracted case information; d) storing the gathered case data and summaries in a database; and e) sending email updates to users with the summarized case information.

A software database system for legal cases filed any country, comprising:
a) A data collection module configured to gather and compile case data from various legal databases and sources; b) A data processing module incorporating artificial intelligence (AI) algorithms to analyze and categorize the gathered case data; c) A user interface that enables law firms or attorneys to search for cases using keywords, filters, and preferences; d) A recommendation engine utilizing AI to provide case recommendations to law firms or attorneys based on their historical preferences, areas of expertise, and client profiles; and e) A notification system that alerts law firms or attorneys to relevant cases matching their search criteria and recommendations.

The software database system, wherein the data collection module accesses publicly available legal databases, government websites, court records, and proprietary legal data sources to gather case data, ensuring comprehensive coverage and up-to-date information.

The software database system, wherein the data processing module employs natural language processing (NLP) and machine learning techniques to extract and categorize relevant case details, including case titles, parties' names, case descriptions, key dates, and legal precedents.

The software database system, wherein the user interface offers law firms and attorneys advanced search functionalities, including keyword searches, case status filters, jurisdiction preferences, and customizable notifications, ensuring tailored and user-friendly case discovery.

The software database system, wherein the recommendation engine utilizes machine learning algorithms to analyze historical search patterns, preferences, and case interactions of law firms and attorneys. It provides personalized case recommendations that align with each user's unique areas of expertise, client profiles, and interests, enhancing their ability to identify relevant cases efficiently.

The software database system, wherein the notification system delivers real-time alerts and updates to law firms or attorneys based on their search criteria, ensuring that they receive timely information about relevant cases. The system or computing system offers both email and in-app notifications to accommodate user preferences.

A method for using the software database system for efficient case searching and recommendation in the legal field, comprising the steps of: a) Collecting case data from diverse legal databases and sources using the data collection module; b) Processing the gathered data to analyze and categorize case details with the data processing module; c) Utilizing the user interface to input keywords, filters, and preferences for case searching; d) Receiving personalized case recommendations from the recommendation engine based on historical preferences, areas of expertise, and client profiles; e) Accessing real-time alerts and updates about relevant cases through the notification system, facilitating efficient case discovery and outreach to clients or potential clients.

A software system for which may include but not be limited to (e.g., pro bono) attorneys to efficiently review and manage cases submitted by potential clients, comprising: a) A user interface allowing potential clients to submit case information, including case details, legal issues, and supporting documents; b) A database for storing the submitted case information securely and associating it with potential client profiles; c) A case management module that enables pro bono attorneys to access and review the submitted case information, accept or decline cases, and communicate with potential clients; d) A notification system that alerts pro bono attorneys to new case submissions, updates, or client communications; and e) A reporting and analytics component that provides insights into case acceptance rates, attorney responsiveness, and potential client needs.

The software system, wherein the user interface may include input fields and document upload features, allowing potential clients to provide comprehensive case information and upload relevant documents for review by pro bono attorneys.

The software system, wherein the database securely stores potential client profiles and associated case information, ensuring confidentiality and compliance with legal and ethical standards governing attorney-client privilege.

The software system, wherein the case management module provides pro bono attorneys with tools to efficiently review submitted case information, including document viewing, case summaries, and communication features to interact with potential clients.

The software system, wherein the notification system sends real-time alerts to pro bono attorneys when new case submissions are received, ensuring timely response and efficient case management.

The software system, wherein the reporting and analytics component offers pro bono organizations valuable insights into case acceptance trends, attorney performance, and potential client needs. It aids in optimizing pro bono legal services.

A method for which may include but not be limited to (e.g., pro bono) attorneys to review and manage cases using the software system, comprising the steps of:
a) Allowing potential clients to submit case information and documents via the user interface;
b) Storing the submitted case information securely in a database and associating it with potential client profiles;
c) Enabling pro bono attorneys to access, review, and accept or decline cases through the case management module;
d) Notifying pro bono attorneys of new case submissions or client communications via the notification system;
e) Providing reporting and analytics on case acceptance rates and potential client needs for pro bono organizations' evaluation and improvement.

A software system for attorneys to efficiently review and manage cases submitted by potential clients, comprising:
a) A user interface allowing potential clients to submit case information, including case details, legal issues, and supporting documents;
b) A secure database for storing the submitted case information and associating it with potential client profiles;
c) A case management module that enables attorneys to access and review the submitted case information, accept or decline cases, and communicate with potential clients;
d) A notification system that alerts attorneys to new case submissions, updates, or client communications; and
e) A reporting and analytics component that provides insights into case acceptance rates, attorney responsiveness, and potential client needs.

The software system, wherein the user interface may include input fields and document upload features, allowing potential clients to provide comprehensive case information and upload relevant documents for review by attorneys.

The software system, wherein the secure database securely stores potential client profiles and associated case information, ensuring confidentiality and compliance with legal and ethical standards governing attorney-client privilege.

The software system, wherein the case management module provides attorneys with tools to efficiently review submitted case information, including document viewing, case summaries, and communication features to interact with potential clients.

The software system, wherein the notification system sends real-time alerts to attorneys when new case submissions are received, ensuring timely response and efficient case management.

The software system, wherein the reporting and analytics component offers valuable insights into case acceptance trends, attorney performance, and potential client needs. It aids in optimizing legal services and enhancing the attorney-client relationship.

A method for attorneys to review and manage cases using the software system described, comprising the steps of:
a) Allowing potential clients to submit case information and documents via the user interface;
b) Storing the submitted case information securely in a database and associating it with potential client profiles;
c) Enabling attorneys to access, review, and accept or decline cases through the case management module;
d) Notifying attorneys of new case submissions or client communications via the notification system;
e) Providing reporting and analytics on case acceptance rates and potential client needs for continuous improvement in legal services.

A software system for summarizing client-inputted information, comprising:
a) A user interface allowing clients to input detailed information, including text, documents, or multimedia content;
b) A natural language processing (NLP) module utilizing artificial intelligence (AI) to analyze and extract key information from the client-inputted data;
c) A summarization module that generates concise summaries or brief descriptions of the client-inputted information based on the analysis conducted by the NLP module;
d) An interactive interface that presents the generated summaries to clients and enables them to modify and customize the summaries according to their preferences; and
e) A storage component for storing the client-inputted information and the modified summaries.

The software system, wherein the user interface may include options for clients to input textual data, upload documents, or provide links to multimedia content, ensuring versatility in data submission.

The software system, wherein the NLP module employs machine learning algorithms to identify and prioritize key information within the client-inputted data, enhancing the quality and relevance of the generated summaries.

The software system, wherein the summarization module offers multiple summarization options, including short sentences, bullet points, or paragraph-length summaries, allowing clients to select the most suitable format for their needs.

The software system, wherein the interactive interface provides clients with editing tools, including text editing, formatting, and content reordering options, to facilitate customization of the generated summaries.

The software system, wherein the storage component securely stores both the original client-inputted information and the modified summaries, ensuring data integrity and privacy.

A method for summarizing client-inputted information using the software system, comprising the steps of:
a) Allowing clients to input detailed information via the user interface;
b) Analyzing and extracting key information from the client-inputted data using the NLP module;
c) Generating concise summaries or brief descriptions of the client-inputted information with the summarization module;
d) Presenting the generated summaries to clients through the interactive interface;
e) Allowing clients to modify and customize the summaries according to their preferences; and
f) Storing both the original client-inputted information and the modified summaries using the storage component.

In some embodiments, the location of a user may be collected by including but not be limited to which may include but not be limited to (e.g., satellite, router, phone, network, cell phone, pinging towers, servers, manual, automatic, AI, machine learning, 3rd party data, self-reporting, etc.)

In some embodiments, any databases, as described herein, may refer to one or more controlled content repositories.

The term signal, signals, or data may refer to a single or multiple signals which are non-transitory in nature. Any reference to a signal may be a reference to an attribute of the signal, and any reference to a signal attribute may refer to a signal associated with the signal attribute. As used herein, the term “real-time” or “dynamically” in any context may refer to any of current, immediately after, simultaneously as, substantially simultaneously as, a few microseconds later, a few milliseconds after, a few seconds subsequently, a few minutes after, a few hours after, a few days after, a period after, etc. In some embodiments, the term “modify” or “modification” may be interchangeably used with the term “transform” or “transformation.”

The present disclosure provides several critical technical advantages that may be readily apparent to one skilled in the art from the figures, descriptions, and claims. Moreover, while specific advantages have been enumerated above, various embodiments may include all, some, or none of the listed advantages. Any sentence or statement in this disclosure may be associated with one or more embodiments. Reference numerals are provided in the specification for the first instance of an element numbered in the figures. In some embodiments, the reference numerals for the first instance of the element are also applicable to subsequent instances of the component of the specification, even though reference numerals may not be provided for the subsequent instances of the element.

While various embodiments in accordance with the disclosed principles have been described above, it should be understood that they have been presented by way of example only and are not limiting. Thus, the breadth and scope of the disclosure(s) should not be limited by any of the above-described exemplary embodiments but should be defined only in accordance with the claims and their equivalents issued from this disclosure. Furthermore, the above advantages and features are provided in described embodiments. Still, they shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the disclosure(s) set out in any claims that may issue from this disclosure. Specifically, a description of a technology in the “background” is not to be construed as an admission that technology is prior art to any disclosure(s) in this disclosure. Neither is the “summary” to be considered as a characterization of the disclosure(s) outlined in issued claims. Furthermore, any reference in this disclosure to “disclosure” in the singular should not be used to argue that there is only a single point of novelty in this disclosure. Multiple disclosures may be set forth according to the limitations of the various claims issuing from this disclosure, and such claims accordingly define the disclosure(s), and their equivalents, that are protected thereby. In all instances, the scope of such claims shall be considered on their own merits in light of this disclosure but should not be constrained by the headings herein. Any features or embodiments described in one section or paragraph anywhere in this disclosure, or in any reference or application incorporated by reference herein, may be able to be combined with any other features or embodiments described in another section or paragraph anywhere in this disclosure, or in any reference or application incorporated by reference herein.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to explain the principles of the disclosed subject-matter and its practical applications, to thereby enable others skilled in the art to use the technology disclosed and various embodiments with various modifications as are suited to the particular use contemplated. It is appreciated that the term optimize/optimal and its variants which may include but not be limited to (e.g., efficient or optimally) may simply indicate improving, rather than the ultimate form of ‘perfection’ or the like.

Furthermore, the functions or operations described above may be able to be implemented in digital electronic circuitry, in computer software, firmware or hardware. In particular, the disclosed techniques may be able to be implemented using one or more computer program products. The computer program products, in some embodiments, comprises non-transitory computer-readable media comprising code configured to execute the disclosed approach. Programmable processors and computers may be able to be included in or packaged as mobile devices according to some embodiments. The processes and logic flows may be able to be performed by one or more programmable processors and by one or more programmable logic circuitry. General and special purpose computing devices and storage devices may be able to be interconnected through communication networks.

It may also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the disclosure. The first object or step, and the second object or step, are both objects or steps, respectively, but they are not to be considered the same object or step.

The terminology used in the description herein is for the purpose of describing particular embodiments and is not intended to be limiting. As used in the description of the disclosure and the appended claims, the singular forms “a,” “an” and “the” are intended to include the plural forms as well, unless the context clearly indicates otherwise. It may also be understood that the term “and/or” as used herein refers to and encompasses any possible combination of one or more of the associated listed items. It may be further understood that the terms “may include,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art may appreciate that while some terms in this disclosure may refer to absolutes, e.g., all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset. m to perform the methods described herein. In some embodiments, a system may comprise one or more physical housings that include various units, such as those illustrated in FIG. 1B. In some embodiments, a chipset may be disposed in one or more housings and interfaced with one or more hardware processors. The chipset may have hardware which may include but not be limited to (e.g., electronic components in an electronic circuit) for supporting various connections within the system or computing system or any other link from the system or computing system to external systems. Any embodiments, elements, features, processes, etc.) which may be combined with any other embodiments, elements, features, processes, etc.) Any description in this disclosure associated with an interface, process flow, system, or embodiment may apply to one or more of any other interface, process flow, system, or embodiment.

In some embodiments, a system that enables users to access and review processed data, comprising: a) A user interface allowing first users to submit raw case details, video statement, and supporting documents; b) A payment processing module that facilitates payments from second user seeking access to the software system; c) A secure database for storing potential first users-submitted case information; d) A case management module that grants second users access to processed case data, enabling them to review and communicate with potential clients; and e) An audit trail system that maintains records of all interactions within the software system.

In some embodiments, A Computing System for Professional-User Interaction, comprising: a) a user database configured to store information related to a plurality of professionals (referred to as User 2); b) a submission module enabling said professionals to submit their credentials to the user database; c) a user interface accessible by a general user (referred to as User 1), the user interface configured to allow User 1 to pre-approve selected professionals from the user database to view User 1's personal information; d) a verification module to verify the credentials of the professionals submitted to the user database; e) a privacy control module configured to manage the access of the professionals to the personal information of User 1 based on the pre-approval by User 1. In some embodiments, a) the submission module may include a registration process for professionals, which comprises the submission of professional credentials and personal information. In some embodiments, a) the user interface for User 1 may include a selection tool for User 1 to selectively pre-approve professionals from the user database. The Computing System, wherein: a) the privacy control module may include a dynamic access control mechanism that adjusts the access rights of professionals based on ongoing preferences set by User 1. The Computing System, wherein: a) the system or computing system further comprises a notification module configured to notify User 1 when a professional accesses User 1's information.

A method for managing professional-user interactions in a computing system, comprising: a) allowing professionals to submit their credentials to a user database; b) enabling users to pre-approve selected professionals from the user database; c) verifying the credentials of the professionals; d) controlling access of the professionals to the user's personal information based on the user's pre-approval.

A Computing System for Data Exchange Control, comprising: a) a user interface configured for a first user (referred to as User 1) to manage personal data; b) a request module enabling a second user (referred to as User 2) to submit their personal data to User 1; c) an approval mechanism within the user interface allowing User 1 to approve or deny access to their personal data by User 2; d) an access control system, activated upon approval by User 1, to grant User 2 access to view and interact with User 1's personal data.

The Computing System, wherein:
a) the request module may include a submission form for User 2 to enter and submit their personal data to User 1.

The Computing System, wherein:
a) the approval mechanism may include options for User 1 to selectively approve or deny access to specific portions of their personal data.

The Computing System, wherein:
a) the access control system restricts the interaction of User 2 with User 1's data to predefined actions.

The Computing System, further comprising:
a) a notification module configured to alert User 1 upon the receipt of a data access request from User 2.

A method for managing data access requests in a computing system, comprising:
a) receiving personal data from a second user (User 2) submitted to a first user (User 1);
b) presenting an approval or denial option to User 1 for the access request;
c) granting User 2 access to interact with User 1's data upon approval by User 1;
d) restricting access to User 1's data by User 2 based on the approval status.

A software computing system comprising:
a user interface module configured to receive and display cases submitted by users;
a bidding module configured to allocate a specific time frame during which lawyers or professionals may be able to submit bids for said cases;
a communication module configured to facilitate the exchange of information between users and lawyers or professionals, allowing lawyers or professionals to provide reasons for their bids and present their work related to the case; and
a recommendation module configured to provide recommendations to users based on the bids and information exchanged between users and lawyers or professionals.

The system or computing system wherein the user interface module further comprises a case creation interface allowing users to input case details and specifications, and wherein the bidding module is configured to categorize and match lawyers or professionals with cases based on case details and specifications.

The system or computing system wherein the communication module enables real-time messaging and video conferencing between users and lawyers or professionals, allowing for direct interaction during the bidding process.

The system or computing system wherein the recommendation module utilizes machine learning algorithms to analyze user preferences and feedback, and to provide personalized recommendations to users regarding which lawyer or professional to select for their case.

The system or computing system wherein the bidding module further may include a review and rating system, enabling users to provide feedback and ratings for lawyers or professionals, which are used to enhance the quality of recommendations and to build a reputation system for lawyers or professionals.

A method for facilitating the selection of legal or professional services for cases submitted by users, comprising the steps of:
receiving case details and specifications from users;
allocating a specific time frame for lawyers or professionals to submit bids for said cases;
enabling communication between users and lawyers or professionals to exchange information and reasons for bids, and to showcase
work related to the case; and
providing recommendations to users based on the bids and information exchanged.

The method further comprising the step of categorizing and matching lawyers or professionals with cases based on case details and specifications provided by users.

The method further comprising the step of analyzing user preferences and feedback using machine learning algorithms to provide personalized recommendations to users regarding the selection of lawyers or professionals for their cases.

The method further comprising the step of implementing a review and rating system to collect feedback and ratings from users for lawyers or professionals, which are used to enhance the quality of recommendations and to build a reputation system for lawyers or professionals.

A computer-readable storage medium containing instructions for executing the method of facilitating the selection of legal or professional services for cases submitted by users.

A computer-implemented method for organizing and presenting information related to legal cases in a database, comprising:

A computer system configured to access a database containing a plurality of legal cases, each legal case having a set of associated data points, said database being searchable and sortable based on the data points.

A user interface enabling a user to pre-select or select a list of facts or ranges to define filter criteria.

A processor configured to execute instructions to apply the filter criteria to the database to identify legal cases that meet the selected filter criteria.

A processor configured to present the identified legal cases in a list or visual representation, wherein each legal case that matches the selected filter criteria is displayed as a separated piece of data in the list, distinct from non-matching legal cases.

A processor configured to order the identified legal cases in the list based on one or more factors, including but not limited to, relevance, recency, the degree of match to the selected filter criteria, or user-defined criteria.

A processor configured to dynamically reorder the list as new data points are added or updated, such that a legal case matching the filter criteria is brought to the top of the list or displayed in a specific manner, in real-time.

A user interface enabling the user to interact with the legal cases in the list, including accessing detailed information about each legal case.

A processor configured to update the list and reorder the legal cases as the user interacts with the legal cases in the user interface.

A processor configured to store the filter criteria for future use and allow the user to save, modify, or delete the criteria.

A processor configured to provide notifications to the user when new legal cases that match the selected filter criteria are added to the database.

A processor configured to provide reporting and analytics based on the selected filter criteria and user interactions with the legal cases.

A method for processing textual data, comprising:

Receiving user input selecting a pre-written question.

Extracting textual data relevant to the selected question.

Analyzing the extracted textual data to identify factual or key information.

Generating a concise summary of the textual data, based on the identified factual or key information.

Storing or presenting the concise summary for data analysis purposes.

The method further comprising:

Allowing the user to customize the concise summary generation parameters.

A computing system for simplifying textual data for data analysis, the system or computing system comprising:

A user interface for receiving user input to select a pre-written question.

A data extraction module configured to extract textual data related to the selected question.

A text analysis module for identifying factual or key information within the extracted textual data.

A summary generation module for generating a concise summary of the extracted textual data based on the identified factual or key information.

A data storage or presentation module for storing or presenting the concise summary for data analysis purposes.

The computing system wherein the user interface allows user customization of concise summary generation parameters.

A computer-implemented method for facilitating attorney case selection, comprising:

A computing software system receiving, from a plurality of attorneys, bids to view cases stored in a database.

Analyzing the bids based on predetermined criteria, including case relevance, attorney experience, and bid amount.

Determining a winning bid for each case, wherein the winning bid corresponds to the highest bid satisfying the predetermined criteria.

Granting access to the selected cases to attorneys associated with the winning bids.

The method further comprising:

Periodically updating the database of cases with new case data, and notifying attorneys of new case opportunities.

The method, further comprising:

Generating a user interface for attorneys to input their bids and view relevant case information.

The method, wherein the predetermined criteria include at least one of case type, case location, case status, and case timeline.

A computer system for implementing the method, comprising:

A processor for executing the software system.

Memory for storing the database of cases, bids, and bid history.

A communication module for receiving bids from attorneys and notifying attorneys of winning bids.

The computer system further comprising a user interface for displaying case information and enabling attorney bidding.

The computer system, wherein the software system is configured to perform the method.

A non-transitory computer-readable storage medium encoded with instructions that, when executed by a computer, cause the computer to perform the method.

A method for prioritizing access to legal cases among a plurality of attorneys, comprising:

Receiving, by a computing software system, a plurality of bids from the attorneys to view cases stored in a database.

Analyzing the bids based on predetermined criteria, including at least one of case relevance, attorney qualifications, and bid amount.

Allocating priority access to the attorneys based on the analysis of the bids.

The method further comprising:

Periodically updating the database of legal cases with new case data and notifying attorneys of new case opportunities.)

The method, further comprising:

Generating a user interface for attorneys to input their bids and view relevant case information.

The method, wherein the predetermined criteria for bid analysis include at least one of case type, case jurisdiction, case status, and case urgency.

A computer system for implementing the method, comprising:

A processor configured to execute the software system.

Memory for storing the database of cases, bids, and bid history.

A communication module for receiving bids from attorneys and notifying attorneys of their priority access.

The computer system further comprising a user interface for attorneys to input bids and view case information.

The computer system, wherein the software system is configured to perform the method.

A non-transitory computer-readable storage medium encoded with instructions that, when executed by a computer, cause the computer to perform the method.

A computer-implemented method for prioritizing access to legal cases among attorneys based on a tier or subscription level, comprising:

Receiving, by a computing software system, subscription information from a plurality of attorneys, wherein the subscription information may include tier levels associated with respective attorneys.

Receiving, by the computing software system, requests from the attorneys to view cases stored in a database.

Analyzing the tier levels of the attorneys and the case requests to determine priority access to cases based on the tier levels.

The method further comprising:

Periodically updating the database of legal cases with new case data and notifying attorneys of new case opportunities.

The method, further comprising:

Generating a user interface for attorneys to input case requests and manage their subscription information, including tier levels.

The method, wherein the tier levels are associated with subscription fees, and the priority access is determined based on a combination of the tier level and subscription fee.

A computer system for implementing the method, comprising:

A processor configured to execute the software system.

Memory for storing the database of cases, subscription information, and case request history.

A communication module for receiving subscription information and case requests from attorneys and notifying attorneys of their priority access.

The computer system further comprising a user interface for attorneys to input case requests and manage their subscription information.

The computer system, wherein the software system is configured to perform the method.

A non-transitory computer-readable storage medium encoded with instructions that, when executed by a computer, cause the computer to perform the method.

A computing system for collecting and organizing public information from the internet and/or public records, comprising:

A data gathering module configured to access and retrieve public information from the internet and/or public records.

An artificial intelligence module programmed to analyze and categorize the retrieved information, including but not limited to text, images, and data structures.

A database system for storing the analyzed information, said database system being searchable and accessible to authorized users.

A user interface that allows authorized users to access, search, and interact with the information stored in the database.

In some embodiments, social media posts, news articles, news posts, and public records information to be gathered together by Artificial intelligence on the website or system and makes an AI post of a case using these public information gatherings (the post may say “artificial intelligence created post’)

A computer-implemented method for monetizing data access, comprising:

A processor receiving a request from a user to access specific data.

Determining a payment model associated with the requested data, the payment model selected from the group consisting of pay-per-lead, pay-per-view, and pay-to-open data viewing.

Authenticating the user and validating the user's payment credentials.

Granting access to the requested data upon successful authentication and payment validation.

The method wherein the payment model is dynamically selected based on user preferences, historical usage patterns, or data popularity.

A computer system for monetizing data access, comprising:

A memory storing a database of data sets.

A processor configured to receive a data access request from a user.

Means for determining a payment model associated with the requested data, the payment model selected from the group consisting of pay-per-lead, pay-per-view, and pay-to-open data viewing.

Means for authenticating the user and validating the user's payment credentials.

Means for granting access to the requested data upon successful authentication and payment validation.

The system or computing system further comprising a user interface for presenting users with payment options and obtaining user consent for the selected payment model.

A non-transitory computer-readable storage medium storing instructions that, when executed by a processor, cause the processor to perform a method for monetizing data access, the method comprising:

Receiving a request from a user to access specific data.

Determining a payment model associated with the requested data, the payment model selected from the group consisting of pay-per-lead, pay-per-view, and pay-to-open data viewing.

Authenticating the user and validating the user's payment credentials.

Granting access to the requested data upon successful authentication and payment validation.

The computer-readable storage medium wherein the payment model is adjusted based on real-time market demand for the requested data.

A computer-implemented method for prioritizing access to data based on a subscription model, comprising:

Receiving a data access request from a user.

Identifying a subscription level associated with the user, the subscription level selected from a plurality of subscription levels, each level providing different access privileges.

Determining the priority of the data access request based on the identified subscription level.

Granting access to the requested data in accordance with the determined priority.

The method wherein the subscription levels comprise tiered access levels, each tier corresponding to a different set of data access privileges.

A computer system for prioritizing access to data based on a subscription model, comprising:

A memory storing subscription data associating users with subscription levels.

A processor configured to receive a data access request from a user.

Means for identifying a subscription level associated with the user from the stored subscription data.

Means for determining the priority of the data access request based on the identified subscription level.

Means for granting access to the requested data in accordance with the determined priority.

The system or computing system further comprising a user interface for managing and updating subscription levels associated with users.

A non-transitory computer-readable storage medium storing instructions that, when executed by a processor, cause the processor to perform a method for prioritizing access to data based on a subscription model, the method comprising:

Receiving a data access request from a user.

Identifying a subscription level associated with the user from stored subscription data, the subscription level selected from a plurality of subscription levels.

Determining the priority of the data access request based on the identified subscription level.

Granting access to the requested data in accordance with the determined priority.

The computer-readable storage medium wherein the subscription model is adjustable based on user preferences, historical usage patterns, or system requirements.

A computer-implemented method for dynamic pricing and prioritizing access to data, comprising:

Receiving a data access request from a user.

Identifying a subscription level associated with the user from stored subscription data, the subscription level selected from a plurality of subscription levels, each level providing different access privileges.

Determining the priority of the data access request based on the identified subscription level.

Charging the user for the data access based on a pay-per-lead model, wherein the charge is adjusted based on the determined priority of the data access request.

Modifying the user's subscription level based on the pay-per-lead model, wherein the subscription level is adjusted in response to the number of leads accessed by the user.

The method wherein the adjustment of the subscription level is further based on historical usage patterns, user preferences, or system requirements.

A computer system for dynamic pricing and prioritizing access to data, comprising:

A memory storing subscription data associating users with subscription levels.

A processor configured to receive a data access request from a user.

Means for identifying a subscription level associated with the user from the stored subscription data.

Means for determining the priority of the data access request based on the identified subscription level.

Means for charging the user for the data access based on a pay-per-lead model, wherein the charge is adjusted based on the determined priority of the data access request.

Means for modifying the user's subscription level based on the pay-per-lead model, wherein the subscription level is adjusted in response to the number of leads accessed by the user.

The system or computing system further comprising a user interface for managing and updating subscription levels associated with users.

A non-transitory computer-readable storage medium storing instructions that, when executed by a processor, cause the processor to perform a method for dynamic pricing and prioritizing access to data, the method comprising:

Receiving a data access request from a user.

Identifying a subscription level associated with the user from stored subscription data, the subscription level selected from a plurality of subscription levels.

Determining the priority of the data access request based on the identified subscription level.

Charging the user for the data access based on a pay-per-lead model, wherein the charge is adjusted based on the determined priority of the data access request.

Modifying the user's subscription level based on the pay-per-lead model, wherein the subscription level is adjusted in response to the number of leads accessed by the user.

The computer-readable storage medium wherein the adjustment of the subscription level is further based on historical usage patterns, user preferences, or system requirements.

A computer-implemented method for prioritizing access to data based on geographical parameters and a subscription model, comprising:

Receiving a data access request from a user.

Determining the geographical location of the user based on parameters selected from the group consisting of zip code, distance from a specified location, and state lines.

Identifying a subscription level associated with the user from stored subscription data, the subscription level selected from a plurality of subscription levels, each level providing different access privileges.

Determining the priority of the data access request based on the geographical location and the identified subscription level.

Granting access to the requested data in accordance with the determined priority.

The method further comprising:

Charging the user for the data access based on a pay-per-lead model, wherein the charge is adjusted based on the determined priority of the data access request.

The method wherein the adjustment of the subscription level and the pay-per-lead charge is further based on historical usage patterns, user preferences, or system requirements.

A computer system for prioritizing access to data based on geographical parameters and a subscription model, comprising:

A memory storing subscription data associating users with subscription levels.

A processor configured to receive a data access request from a user.

Means for determining the geographical location of the user based on parameters selected from the group consisting of zip code, distance from a specified location, and state lines.

Means for identifying a subscription level associated with the user from the stored subscription data.

Means for determining the priority of the data access request based on the geographical location and the identified subscription level.

Means for granting access to the requested data in accordance with the determined priority.

The system or computing system further comprising means for charging the user for the data access based on a pay-per-lead model, wherein the charge is adjusted based on the determined priority of the data access request.

The system or computing system further comprising a user interface for managing and updating subscription levels associated with users and configuring geographical parameters for data access.

A non-transitory computer-readable storage medium storing instructions that, when executed by a processor, cause the processor to perform a method for prioritizing access to data based on geographical parameters and a subscription model, the method comprising:

Receiving a data access request from a user.

Determining the geographical location of the user based on parameters selected from the group consisting of zip code, distance from a specified location, and state lines.

Identifying a subscription level associated with the user from stored subscription data, the subscription level selected from a plurality of subscription levels.

Determining the priority of the data access request based on the geographical location and the identified subscription level.

Granting access to the requested data in accordance with the determined priority.

Charging the user for the data access based on a pay-per-lead model, wherein the charge is adjusted based on the determined priority of the data access request.

The computer-readable storage medium wherein the adjustment of the subscription level and the pay-per-lead charge is further based on historical usage patterns, user preferences, or system requirements.

A computer-implemented method for displaying targeted advertisements, comprising:

Receiving a user request for content.

Determining the geographical location of the user based on parameters selected from the group consisting of zip code, distance from a specified location, and state lines.

Identifying one or more keywords associated with the user request.

Retrieving advertisements associated with the determined geographical location and the identified keywords.

Displaying the retrieved advertisements to the user in conjunction with the requested content.

The method wherein the identified keywords are determined based on a type of keyword or keywords associated with the user request.

The method further comprising:

Adjusting the frequency and prominence of displayed advertisements based on the identified geographical location and the type of keyword or keywords.

A computer system for displaying targeted advertisements, comprising:

A memory storing advertisement data associating advertisements with geographical locations and keywords.

A processor configured to receive a user request for content.

Means for determining the geographical location of the user based on parameters selected from the group consisting of zip code, distance from a specified location, and state lines.

Means for identifying one or more keywords associated with the user request.

Means for retrieving advertisements associated with the determined geographical location and the identified keywords.

Means for displaying the retrieved advertisements to the user in conjunction with the requested content.

The system or computing system further comprising means for adjusting the frequency and prominence of displayed advertisements based on the identified geographical location and the type of keyword or keywords.

A non-transitory computer-readable storage medium storing instructions that, when executed by a processor, cause the processor to perform a method for displaying targeted advertisements, the method comprising:

Receiving a user request for content.

Determining the geographical location of the user based on parameters selected from the group consisting of zip code, distance from a specified location, and state lines.

Identifying one or more keywords associated with the user request.

Retrieving advertisements associated with the determined geographical location and the identified keywords.

Displaying the retrieved advertisements to the user in conjunction with the requested content.

Adjusting the frequency and prominence of displayed advertisements based on the identified geographical location and the type of keyword or keywords.

The computer-readable storage medium wherein the identified keywords are determined based on a type of keyword or keywords associated with the user request.

A computer-implemented method for targeted advertisement display, comprising:

Receiving a user request for content.

Determining the geographical location of the user based on parameters selected from the group consisting of zip code, distance from a specified location, and state lines.

Identifying one or more keywords associated with the user request.

Retrieving advertisements associated with the determined geographical location, the identified keywords, and a subscription model or pay-per-lead model.

Displaying the retrieved advertisements to the user in conjunction with the requested content.

The method wherein the identified keywords are determined based on a type of keyword or keywords associated with the user request.

The method further comprising:

Adjusting the frequency and prominence of displayed advertisements based on the identified geographical location, the type of keyword or keywords, and the subscription model or pay-per-lead model.

A computer system for targeted advertisement display, comprising:

A memory storing advertisement data associating advertisements with geographical locations, keywords, and a subscription model or pay-per-lead model.

A processor configured to receive a user request for content.

Means for determining the geographical location of the user based on parameters selected from the group consisting of zip code, distance from a specified location, and state lines.

Means for identifying one or more keywords associated with the user request.

Means for retrieving advertisements associated with the determined geographical location, the identified keywords, and a subscription model or pay-per-lead model.

Means for displaying the retrieved advertisements to the user in conjunction with the requested content.

The system or computing system further comprising means for adjusting the frequency and prominence of displayed advertisements based on the identified geographical location, the type of keyword or keywords, and the subscription model or pay-per-lead model.

A non-transitory computer-readable storage medium storing instructions that, when executed by a processor, cause the processor to perform a method for targeted advertisement display, the method comprising:

Receiving a user request for content.

Determining the geographical location of the user based on parameters selected from the group consisting of zip code, distance from a specified location, and state lines.

Identifying one or more keywords associated with the user request.

Retrieving advertisements associated with the determined geographical location, the identified keywords, and a subscription model or pay-per-lead model.

Displaying the retrieved advertisements to the user in conjunction with the requested content.

Adjusting the frequency and prominence of displayed advertisements based on the identified geographical location, the type of keyword or keywords, and the subscription model or pay-per-lead model.

The computer-readable storage medium wherein the identified keywords are determined based on a type of keyword or keywords associated with the user request.

A computer-implemented method for immediate or bid-based database viewing of potential leads or potential client information, comprising:

Receiving a request to access a database containing potential leads or client information.

Determining if immediate access is requested or if a bid for access is initiated.

If immediate access is requested, granting immediate access to the requested database.

If a bid for access is initiated, conducting a bidding process among multiple users or entities.

Granting access to the database to the highest bidder upon completion of the bidding process.

The method further comprising:

Authenticating users or entities participating in the bidding process.

Providing real-time updates on the status of the bidding process to participating users or entities.

A computer system for immediate or bid-based database viewing of potential leads or potential client information, comprising:

A memory storing a database of potential leads or client information.

A processor configured to receive requests to access the database.

Means for determining if immediate access is requested or if a bid for access is initiated.

Means for conducting a bidding process among multiple users or entities if a bid for access is initiated.

Means for granting immediate access to the requested database or granting access to the highest bidder upon completion of the bidding process.

The system or computing system further comprising means for authenticating users or entities participating in the bidding process.

A non-transitory computer-readable storage medium storing instructions that, when executed by a processor, cause the processor to perform a method for immediate or bid-based database viewing of potential leads or potential client information, the method comprising:

Receiving a request to access a database containing potential leads or client information.

Determining if immediate access is requested or if a bid for access is initiated.

If immediate access is requested, granting immediate access to the requested database.

If a bid for access is initiated, conducting a bidding process among multiple users or entities.

Granting access to the database to the highest bidder upon completion of the bidding process.

The computer-readable storage medium further comprising instructions for authenticating users or entities participating in the bidding process.

A computer-implemented method for facilitating the exchange of information between users, comprising:
a. Receiving, by a server, information from User 1 through a form, questionnaire, or document upload;
b. Storing said information in a database associated with User 1;
c. Receiving, by the server, a request from User 2 to access the information submitted by User 1;
d. Verifying whether User 2 is authorized to access said information;
e. Providing access to the information to User 2 upon successful verification;
f. Implementing a payment mechanism comprising at least one of a paywall, subscription, pay-per-view, or pay-for-group-access to control access to the information.

The method further comprising:
a. Notifying User 1 upon each successful access request by User 2;
b. Facilitating a payment transaction between User 2 and a payment processor based on the selected payment mechanism.

A computing system for managing the exchange of information between users, comprising:
a. A server configured to receive, store, and retrieve information submitted by User 1;
b. A database associated with User 1 to store the submitted information;
c. An authentication module to verify the authorization of User 2 to access information submitted by User 1;
d. A payment module comprising a paywall, subscription management, pay-per-view, or pay-for-group-access mechanism to control access to the information.

The computing system further comprising:
a. A notification module to inform User 1 of access requests by User 2;
b. A payment processing module to facilitate transactions between User 2 and a payment processor based on the selected payment mechanism.

A computer-implemented system for facilitating the controlled access to user-submitted information, comprising:
a. A server configured to receive, store, and manage information submitted by User 1 through a form, questionnaire, or document upload;
b. A database associated with User 1 to store the submitted information;
c. An auction module configured to receive bids from User 2 for access to the information submitted by User 1;
d. A verification module to verify the authenticity and sufficiency of bids submitted by User 2;
e. An access control module to grant access to the information to User 2 based on the highest valid bid.

The system or computing system further comprising:
a. A notification module to inform User 1 of the bidding activity and the successful bid for access to their information;
b. A bidding history module to store and display the bidding history associated with User 1's information.

A computer-implemented method for managing access to user-submitted information, comprising:
a. Receiving, by a server, information from User 1 through a form, questionnaire, or document upload;
b. Storing said information in a database associated with User 1;
c. Initiating an auction for access to the information by User 2, wherein User 2 submits bids for access rights;
d. Verifying and validating the submitted bids by User 2;
e. Granting access to the information to User 2 based on the highest valid bid.

The method further comprising:
a. Notifying User 1 of the bidding activity and the successful bid for access to their information;
b. Providing a bidding history associated with User 1's information.

A computer-implemented system for managing confidential information submitted by User 1, comprising:
a. A server configured to receive, store, and manage confidential information submitted by User 1 through a form or data entry, said confidential information including personally identifiable information (PII);
b. A database associated with User 1 to store the confidential information in a secure and confidential manner, the confidential information being segregated from the rest of the data associated with User 1;
c. A data access module configured to allow User 2 to selectively view, via a list or data display, a limited set of non-confidential data associated with User 1, the non-confidential data being devoid of PII;
d. An authorization mechanism to allow User 2 to request access to view additional details of the confidential information, wherein access is granted based on predefined criteria or explicit permission from User 1.

The system or computing system further comprising:
a. A notification module configured to notify User 2, either through an email or in-app notification, about the availability of additional details of the confidential information for viewing;
b. A confidentiality setting module allowing User 1 to set preferences on which parts of the submitted information are deemed confidential, wherein the server automatically segregates and secures the designated confidential information.

A computer-implemented method for managing confidential information submitted by User 1, comprising:
a. Receiving, by a server, confidential information from User 1 through a form or data entry, said confidential information comprising PII;
b. Storing said confidential information in a database associated with User 1 in a segregated and confidential manner, separate from the rest of the data associated with User 1;
c. Generating a limited set of non-confidential data associated with User 1 for display to User 2, said non-confidential data being devoid of PII;
d. Receiving a request from User 2 to access additional details of the confidential information;
e. Verifying authorization for User 2 to access the additional details based on predefined criteria or explicit permission from User 1;
f. Providing access to the additional details of the confidential information to User 2 upon successful verification.

The method further comprising:
a. Notifying User 2 about the availability of additional details of the confidential information, either through an email or in-app notification;
b. Allowing User 1 to configure confidentiality settings, specifying which parts of the submitted information are considered confidential, with the server automatically segregating and securing the designated confidential information.

A computer-implemented system for automated information dissemination, comprising:
a. An artificial intelligence module configured to automatically analyze news articles and social media content, extracting relevant information based on predefined criteria;
b. A data processing module to organize and categorize the extracted information into a structured format;
c. A decision-making module utilizing machine learning algorithms to determine the significance and reliability of the extracted information;
d. A posting module to create and disseminate posts on various platforms, wherein the content of the posts is generated based on the analyzed information and the decision-making module's assessment of significance and reliability.

The system or computing system further comprising:
a. A user interface module enabling user interaction with the artificial intelligence module, allowing users to customize criteria for information extraction and modify posting preferences;
b. A feedback loop connecting the posting module to the artificial intelligence module, wherein user feedback on posted content is used to train and improve the performance of the artificial intelligence module.

A computer-implemented method for automated information dissemination, comprising:
a. Automatically analyzing news articles and social media content using an artificial intelligence module, wherein the analysis may include natural language processing and sentiment analysis;
b. Extracting relevant information from the analyzed content based on predefined criteria, the criteria including keywords, topics, or user preferences;
c. Structuring the extracted information into a format suitable for dissemination, the format including text, images, or multimedia content;
d. Utilizing machine learning algorithms to assess the significance and reliability of the extracted information;
e. Generating posts for dissemination on various platforms, the content of the posts being dynamically created based on the analyzed information and the machine learning assessment.

The method further comprising:
a. Allowing user customization of criteria for information extraction and posting preferences through a user interface module;
b. Establishing a feedback loop between the posting module and the artificial intelligence module, wherein user feedback on posted content is used to continuously improve the performance of the artificial intelligence module.

In some embodiments, a computer-implemented method for controlling the frequency of User 2's access to information posted by User 1, comprising:
a. Receiving a subscription tier selection from User 2, wherein each subscription tier corresponds to a predetermined frequency of access to information posted by User 1;
b. Associating the selected subscription tier with User 2's account, wherein the predetermined frequency determines the frequency of access to information posted by User 1.

In some embodiments, the method further comprising:
a. Calculating the amount paid by User 2 for the selected subscription tier,
b. Adjusting the frequency of access to information posted by User 1 based on the calculated amount paid.

In some embodiments, a computer-implemented method for controlling the frequency of User 2's access to information posted by User 1, comprising:
a. Receiving a bid from User 2 for access to specific information posted by User 1, wherein the bid amount corresponds to the desired frequency of access;
b. Associating the accepted bid amount with User 2's account, wherein the accepted bid amount determines the frequency of access to the specific information.

In some embodiments, a computer-implemented system for controlling the frequency of User 2's access to information posted by User 1, comprising:
a. A payment module configured to receive a payment amount from User 2, wherein the payment amount corresponds to a predetermined frequency of access to information posted by User 1;
b. An access control module adjusting the frequency of access based on the received payment amount.

In some embodiments, a computer-implemented method for controlling the frequency of User 2's access to information posted by User 1 within a payment group, comprising:
a. Receiving a payment from User 2 for participation in a payment group, wherein the payment group corresponds to a predetermined frequency of access to information posted by User 1;
b. Associating User 2 with the payment group, wherein the predetermined frequency is applied to determine access frequency for all members of the payment group.

In some embodiments, a computer-implemented system for estimating the value of information submitted by a user, comprising:
a. An artificial intelligence module configured to analyze information submitted by a user through natural language processing, machine learning, or similar techniques;
b. A data processing module to organize and categorize the analyzed information into relevant categories;
c. An estimation module utilizing machine learning algorithms to determine an estimated value for the analyzed information based on predetermined criteria or user-specific parameters.

A feedback loop connecting the estimation module to the artificial intelligence module, wherein user feedback on the estimated value is used to refine and improve the accuracy of future estimations.

In some embodiments, the system or computing system further comprising:

In some embodiments, a computer-implemented method for estimating the value of information submitted by a user, comprising:
a. Analyzing information submitted by a user using an artificial intelligence module, the analysis employing natural language processing, machine learning, or similar techniques;
b. Organizing and categorizing the analyzed information into relevant categories using a data processing module;
c. Utilizing machine learning algorithms within an estimation module to determine an estimated value for the analyzed information based on predetermined criteria or user-specific parameters.

In some embodiments, the method further comprising:
a. Providing an interface for the user to input additional data or feedback, influencing the estimated value assigned by the estimation module;
b. Continuously updating the estimation module based on user feedback to enhance the accuracy of future estimations.

In some embodiments, a computer-implemented system for estimating the value of information submitted by a user within a marketplace environment, comprising:
a. An artificial intelligence module configured to analyze information submitted by a user, employing natural language processing, machine learning, or similar techniques;
b. A marketplace module to facilitate the exchange of information, wherein the estimated value determined by the estimation module influences pricing or prioritization within the marketplace.

A computing system comprising:
A user interface module configured to receive information submitted by a user through one or more input means selected from the group consisting of typing, writing, uploading, submitting, and input devices.

A storage module configured to store the received information in a database.

A deletion control module configured to automatically initiate a deletion process for the stored information based on predefined criteria.

A processor configured to execute instructions associated with the user interface module, storage module, and deletion control module.

The computing system wherein the deletion control module is further configured to determine the eligibility of information for deletion based on at least one criterion selected from the group consisting of time elapsed since submission, user preferences, and system-defined policies.

The computing system wherein the deletion control module is further configured to provide notification to the user prior to initiating the deletion process, allowing the user to override the automatic deletion for specific information.

The computing system wherein the deletion control module is further configured to perform data anonymization or pseudonymization prior to deletion, in accordance with privacy regulations.

The computing system wherein the deletion control module is further configured to generate audit logs documenting the deletion process, including the date, time, and reason for deletion.

A computing system comprising:

A user interface module configured to receive information entered, typed, written, or otherwise inputted by a user, irrespective of whether the information is submitted, not submitted, reviewed, not reviewed, looked at, or submitted to a database.

A storage module configured to store the received information in a database.

An automatic deletion control module configured to initiate a deletion process for the stored information, wherein the initiation is independent of the submission, review, or any specific action taken on the information.

A processor configured to execute instructions associated with the user interface module, storage module, and automatic deletion control module.

The computing system wherein the automatic deletion control module is further configured to establish deletion criteria based on factors including but not limited to time elapsed since input, user preferences, and system-defined policies.

The computing system wherein the automatic deletion control module is further configured to perform selective deletion based on user-specified parameters, allowing users to define criteria for automatic deletion of specific information.

The computing system wherein the automatic deletion control module is further configured to execute deletion processes in a manner compliant with privacy regulations, including but not limited to data anonymization or pseudonymization before deletion.

The computing system wherein the automatic deletion control module is further configured to generate and maintain an audit trail documenting the automatic deletion events, comprising information such as date, time, and rationale for deletion.

A computing system for dynamic information submission and updating, comprising:
a user interface configured to receive a portion of information from a user for submission to a database;
a database module configured to store said portion of information in association with a unique identifier;
a navigation module enabling a user to revisit the submitted information and add supplementary data to the original submission, wherein the added information is linked to the unique identifier;
a display module configured to present the original and added information as a unified dataset when accessed by another user.

The computing system wherein the user interface further comprises an option for the user to selectively submit the original portion of information or to defer submission for later additions.

The computing system wherein the navigation module allows users to revisit and modify any previously submitted information, maintaining a version history for each update.

A method for dynamic information submission and updating in a computing system, comprising:
receiving a portion of information from a user for submission to a database;
storing the submitted information in association with a unique identifier;
enabling the user to revisit the submitted information and add supplementary data at a later time, wherein the added information is
linked to the unique identifier;
presenting the original and added information as a unified dataset when accessed by another user.

The method further comprising providing the user with the option to selectively submit the original portion of information or to defer submission for later additions.

The method further comprising maintaining a version history for each update, allowing users to track changes made to the submitted information over time.

A computer-readable storage medium comprising instructions that, when executed by a processor, cause the processor to perform the method of dynamic information submission and updating.

A computing system comprising:
a user interface module configured to display information associated with User 1;
a pop-up module configured to generate a pop-up window upon receipt of a request to access User 1's information;
an access control module configured to initiate a ‘specific check’ process to verify the authenticity and authority of User 2; and
an approval module configured to grant access to User 1's information only upon successful approval from User 2.

The computing system wherein the ‘specific check’ process comprises at least one of biometric authentication, multi-factor authentication, or a unique access code.

The computing system wherein the access control module is further configured to log and track access requests, approvals, and denials.

The computing system wherein the pop-up window may include information about the requestor and the nature of the information being requested.

A method for controlling access to User 1's information in a computing system, comprising the steps of:
receiving a request to access User 1's information;
generating a pop-up window displaying information associated with the request;
initiating a ‘specific check’ process to authenticate and authorize the requestor, wherein the ‘specific check’ process comprises at least
one of biometric authentication, multi-factor authentication, or a unique access code; and
granting access to User 1's information only upon successful approval from User 2.

The method further comprising the step of logging and tracking access requests, approvals, and denials for audit purposes.

The method wherein the pop-up window may include information about the requestor and the nature of the information being requested.

A system for managing the progress of pre-approval, pre-signing, pre-negotiation, pre-contract signing or showing, discovery, scope of work, proposal of work, proposing work, or similar processes, comprising:
a. A status bar interface displayed in each part of said processes;
b. Said status bar interface configured to assist a customer or client in providing a status update for each part, including finding a lawyer, professional, or relevant individual involved in said processes;
c. Said status bar interface dynamically indicating the current status of each part of said processes.

The system or computing system, wherein said status bar interface further comprises:
a. Means for receiving input from a user regarding the progress of each part of said processes;
b. Means for updating the status displayed on said status bar interface based on said input.

A method for managing the progress of pre-approval, pre-signing, pre-negotiation, pre-contract signing or showing, discovery, scope of work, proposal of work, proposing work, or similar processes, comprising:
a. Displaying a status bar interface in each part of said processes;
b. Assisting a customer or client in providing a status update for each part, including finding a lawyer, professional, or relevant individual involved in said processes;
c. Dynamically indicating the current status of each part of said processes on said status bar interface.

The method, further comprising:
a. Receiving input from a user regarding the progress of each part of said processes;
b. Updating the status displayed on said status bar interface based on said input.

A computer-readable storage medium storing instructions that, when executed by a processor, cause the processor to perform a method for managing the progress of pre-approval, pre-signing, pre-negotiation, pre-contract signing or showing, discovery, scope of work, proposal of work, proposing work, or similar processes, comprising:
a. Displaying a status bar interface in each part of said processes;
b. Assisting a customer or client in providing a status update for each part, including finding a lawyer, professional, or relevant individual involved in said processes;
c. Dynamically indicating the current status of each part of said processes on said status bar interface.

A computer-implemented method for managing subscription pricing, comprising:
(a) receiving, from a subscriber via a user interface of a computing device, an offer for a lower subscription price than a listed subscription price;
(b) accessing, by one or more processors, a set of criteria predefined by a service provider, wherein the set of criteria may include at least one of revenue growth, projected revenue, or other financial indicators;
(c) evaluating, by the one or more processors, the offer based on the set of criteria to determine whether the offer meets predefined conditions for acceptance;
(d) automatically accepting the offer when the evaluation indicates that the predefined conditions are met;
(e) wherein the predefined conditions for acceptance are configurable by the service provider either manually or automatically based on the service provider's financial data.

2. The computer-implemented method, further comprising:
(a) notifying the subscriber via the computing device when the offer is accepted;
(b) adjusting the subscription price to the offered lower subscription price for the duration specified by the offer.

3. The computer-implemented method, wherein the evaluating step further may include:
(a) analyzing historical data related to the subscriber's usage or payment patterns;
(b) adjusting the set of criteria based on external economic factors.

4. A system for managing subscription pricing, comprising:
(a) a memory storing instructions;
(b) one or more processors configured to execute the instructions to:
i. receive an offer for a lower subscription price from a subscriber;
ii. access a set of criteria predefined by a service provider that may include financial indicators;
iii. evaluate the offer against the set of criteria;
iv. automatically accept the offer based on the evaluation;
v. adjust the subscription price upon acceptance.

5. The system or computing system, wherein the one or more processors are further configured to:
(a) provide feedback to the subscriber regarding the status of the offer,
(b) update the set of criteria based on changes in the service provider's financial situation or market conditions.

6. A non-transitory computer-readable medium storing instructions that, when executed by one or more processors of a computing device, perform a method for subscription price negotiation, the method comprising:
(a) prompting a subscriber to submit an offer for a lower subscription price;
(b) analyzing the offer against a set of pre-established criteria related to the service provider's financial health;
(c) automatically accepting or rejecting the offer based on the analysis;
(d) adjusting the subscriber's subscription price based on the outcome of the offer.

7. The method, wherein the set of criteria is dynamically adjustable based on real-time financial data of the service provider.

A computer-implemented method for generating new postings on an application or software, comprising:
a. Receiving news data or filing data from one or more sources;
b. Analyzing said news data or filing data using natural language processing techniques to identify relevant topics or subjects;
c. Generating new postings based on said identified relevant topics or subjects using machine learning algorithms;
d. Publishing said new postings on said application or software.

The method, wherein said news data comprises textual information obtained from online news articles, blogs, social media platforms, or other online sources.

The method, wherein said filing data comprises textual information obtained from patent filings, regulatory filings, financial reports, or other publicly available documents.

The method, wherein said natural language processing techniques comprise tokenization, part-of-speech tagging, named entity recognition, sentiment analysis, topic modeling, or text summarization.

The method, wherein said machine learning algorithms comprise deep learning models, recurrent neural networks, convolutional neural networks, or generative models.

The method, further comprising:
a. Monitoring user engagement with said new postings;
b. Adjusting future posting generation based on said user engagement.

An AI computing system configured to perform the method described herein.

A computer-readable storage medium having stored thereon instructions that, when executed by a computing device, cause the computing device to perform the method.

A computing system comprising:

A user interface module configured to receive inputs from a user;
A categorization module configured to analyze said inputs and categorize them into distinct tabs or groups based on predefined criteria;
A storage module configured to store said categorized inputs in separate data structures associated with each tab or group;
A display module configured to present said tabs or groups to the user for easy access and navigation.

The computing system, wherein the categorization module employs machine learning algorithms to continuously improve the accuracy of categorization based on user behavior and feedback.

The computing system, wherein the categorization module utilizes natural language processing techniques to understand the context and semantics of the inputs for more precise categorization.

The computing system, wherein the user interface module provides customization options for users to define their own criteria for categorization and create personalized tabs or groups.

The computing system, wherein the storage module utilizes cloud-based storage for seamless synchronization of categorized inputs across multiple devices.

A method for managing the sale and distribution of (dates, times, events, or experiences) tickets, comprising:

Providing a platform for (models, daters, users, persons, creators, actors, personalities) to list (dates, times, events, or experiences) tickets for sale, including setting prices and managing availability;
Enabling (customers or users) to purchase tickets directly from (models, daters, users, persons, creators, actors, personalities) (primary sales) or from other customers (secondary sales);
Implementing a dynamic pricing mechanism that adjusts ticket prices in real-time based on factors including demand, event popularity, and time until the event;
Facilitating secure electronic delivery of tickets, including digital tickets that may be accessed via mobile devices, devices, 3rd party devices, holograms, printed by customer, or printed by the purchaser;
Providing physical ticket delivery options, including mail and express shipping, with tracking and security features;
Ensuring the authenticity of tickets sold on the platform through a verification process that may include barcode, digital watermarking, special code, special colors that may be scanned, or integration with the event venue's entry systems;
Offering a customer guarantee to protect buyers from fraud, including (replacement tickets or credits or refunds) in case of issues such as event cancellation or invalid tickets;
Providing (models, daters, users, persons, creators, actors, personalities) with tools to track ticket sales, attendance, and customer demographics, and to manage marketing campaigns directly through the platform;
Enabling seamless resale of tickets by purchasers who may no longer attend the event, including automatic adjustment of resale prices based on market conditions and platform guidelines;
Integrating advertising and promotional tools within the platform to increase ticket visibility and sales.

The method, wherein the dynamic pricing mechanism further comprises:
An algorithm that considers historical sales data, current ticket inventory, customer behavior, and external market factors to optimize ticket pricing;
Real-time updates to ticket prices displayed to potential buyers based on the aforementioned factors;
Notifications to potential buyers regarding price changes, availability alerts, and special promotions.

A system for facilitating secure and efficient ticket transactions on a comprehensive ticketing platform, comprising:
A user interface that allows (models, daters, users, persons, creators, actors, personalities) to upload or integrate from 3rd party or directly from platform the (event or date) details, set ticket prices, and manage date ticket availability;
A customer interface that allows users to browse (dates, types of dates, activities, models, categories, options, cities, states, distance, experiences) select tickets, complete purchases, and receive tickets electronically or physically;
A backend system that handles payment processing, ticket verification, and dynamic pricing adjustments;
A security module that verifies the authenticity of tickets, prevents fraud, and integrates with venue entry systems to ensure only valid tickets are accepted or scanned or validated;
A customer support system that provides assistance with ticket issues, including a refund or credit or replacement process managed through the platform.

The system or computing system, further comprising:
A mobile application that provides users with real-time access to ticket purchases, digital ticket storage, and date or event updates;
Integration with social media platforms to allow users to share event information and ticket availability with their networks;
Analytics tools for event organizers to monitor sales performance, customer engagement, and overall event success.

A method for managing a (models, daters, users, persons, creators, actors, personalities) online marketplace for the resale of date tickets, comprising:
Enabling (models, daters, users, persons, creators, actors, personalities) to create listings for tickets they possess, including setting a price for the ticket(s) availability quantity, type, selecting a delivery method, and providing ticket details;
Implementing a dynamic pricing mechanism that offers (models, daters, users, persons, creators, actors, personalities) real-time pricing suggestions based on market demand, historical sales data, and event proximity;
Allowing buyers to browse available date listings, select tickets, and complete purchases through the marketplace platform;
Processing payments from buyers and disbursing funds to sellers after successful ticket delivery and event completion;
Providing a buyer protection guarantee that ensures tickets purchased are valid for entry, offering refunds or replacements in cases of invalidity, event cancellation, or other issues;
Facilitating secure ticket delivery options, including digital ticket transfers, physical shipment, or integration with external ticketing platforms for barcode transfer;
Offering customer support services to assist with disputes, ticket issues, and transaction queries.

The method, wherein the dynamic pricing mechanism further comprises:
An algorithm that analyzes factors including current demand for the event, the number of tickets available, historical price trends, and timing relative to the event date to provide real-time price recommendations to sellers;
Real-time adjustments to suggested prices, with notifications to sellers regarding market changes or high-demand periods.

A system for facilitating transactions in a secondary ticket marketplace, comprising:
A seller interface that allows users to list date tickets for sale, set prices, and manage their listings, including the ability to adjust prices or remove listings as needed;
A buyer interface that allows users to search for events, browse ticket listings, and complete purchases with secure payment options;
A backend system that manages payment processing, ticket verification, and dynamic pricing calculations, ensuring secure and efficient transactions between buyers and sellers;
A verification module that ensures the authenticity of tickets sold on the platform, preventing fraud and validating tickets through integration with event venues or primary ticketing systems;
A customer support system that manages buyer protection claims, facilitates refunds or replacements, and resolves disputes between buyers and sellers.

The system or computing system, further comprising:
A mobile application that allows users to manage ticket listings, browse events, purchase tickets, and access tickets digitally through mobile devices;
Integration with social media platforms to allow sellers to share their listings and buyers to discover events through their networks;
Analytics tools for sellers to monitor the performance of their listings, including views, pricing trends, and sales velocity.
managing access to ‘cases’

A method for managing access to business leads on an online platform, comprising:
Allowing a first user to post a business lead on the platform, including relevant details and contact information;
Restricting access to the posted lead for a predefined time period, during which only users with a premium subscription may view the lead;
Granting premium subscribers immediate access to newly posted leads during the predefined restricted access period;
Allowing non-premium users to access the lead after the restricted access period has expired, provided the lead has not been claimed by a premium subscriber;
Marking a lead as ‘taken’ or ‘in process’ once it has been claimed by a premium subscriber, making it unavailable for viewing by other users;
Removing or marking the lead as unavailable from the platform once it has been successfully claimed by a premium subscriber during the restricted access period, thereby preventing further access.

The method, further comprising:
An option for non-premium users to be notified when the restricted access period has expired, allowing them to view the lead if it is still available;
A process for premium subscribers to claim leads, including steps for confirming interest and initiating communication with the lead provider;
A system for updating the status of the lead in real-time, reflecting whether the lead is available, in process, or taken.

A system for providing prioritized access to business leads through a subscription model, comprising:
A lead posting module that allows users to submit business leads to the platform, including all necessary details for potential claimants;
A subscription management module that tracks users' subscription status and determines access privileges based on whether they have a premium subscription;
A time-based restriction module that limits access to newly posted leads to premium subscribers for a predefined period;
A notification module that alerts non-premium users when the restricted access period has expired, provided the lead remains unclaimed;
A lead status management system that updates and displays the current status of each lead as available, in process, or taken, depending on user actions.

The system or computing system, further comprising:
A user interface that allows premium subscribers to browse and claim leads during the restricted access period, with real-time updates on lead availability;
A feature that automatically removes or marks leads as unavailable once they have been claimed by a premium subscriber, preventing access by other users;
Integration with communication tools to facilitate immediate contact between the lead provider and the claimant once a lead is taken.

A method for managing access to and interaction with business leads on an online platform, comprising:
Allowing a first user to post a business lead on the platform, including relevant details, contact information, and pre-approval settings for specific viewers;
Restricting access to the posted lead for a predefined time period, during which only users with a premium subscription may view the lead or certain detailed information about the lead;
Granting premium subscribers immediate access to newly posted leads during the predefined restricted access period, with the option to contact the lead poster directly through the platform;
Allowing non-premium users to access the lead after the restricted access period has expired, provided the lead has not been marked as “taken” or “in process”;
Displaying the status of the lead as “available,” “in process,” or “taken” based on interactions initiated by premium subscribers, while still allowing non-premium users to view the lead;
Enabling the lead poster to pre-approve specific users to view and interact with the lead based on the users' profiles, preferences, or previous interactions;
Allowing users to post, manage, and update their profiles, including adding profile pictures, business details, and contact information, which may be viewed by lead posters for potential pre-approval;
Providing a dashboard for users to manage their leads, view interactions, and monitor the status of their posted or viewed leads, including who has been pre-approved, contacted, or engaged with each lead.

The method, wherein the premium subscription further comprises:
Early access to leads before the restricted access period expires;
Advanced filtering options to search for leads by specific cities, states, industries, or other detailed criteria;
Access to more detailed information within each lead, such as specific business opportunities, financial details, or other key data points that are hidden from non-premium users until the restricted access period expires;
The ability to post an unlimited number of business leads or a specific number of leads based on the subscription tier.

A system for managing business leads on an online platform, comprising:
A lead posting module that allows users to submit business leads, set viewing restrictions, and define pre-approval criteria for other users;
A subscription management module that tracks users' subscription status and determines access privileges, including early access to leads and advanced filtering capabilities;
A user interface that allows users to view, manage, and interact with leads, including tools for contacting lead posters, managing profile details, and tracking the status of interactions;
A notification system that alerts non-premium users when the restricted access period for a lead has expired, and provides updates on the status of leads they are interested in;
A lead status management system that updates and displays the current status of each lead as “available,” “in process,” or “taken,” depending on user actions and interactions.

The system or computing system, further comprising:
A feature that allows lead posters to browse user profiles and pre-approve specific users for immediate access to their leads, based on factors such as industry relevance, location, or previous interactions on the platform;
Integration with communication tools to facilitate direct contact between lead posters and users who have been pre-approved or who gain early access through a premium subscription;
Analytics tools for users to monitor the performance of their leads, including the number of views, interactions, and successful connections made through the platform.

Blockchain for shareholders, founders giving assets to their employees, shares of the company

A method for generating and storing a private key securely within a digital or hardware wallet, wherein the private key is generated using a secure random number generator and is used to derive a public key for blockchain transactions.

A system for creating and signing blockchain transactions within a crypto wallet, wherein the transaction is cryptographically signed using the private key and broadcast to the blockchain network for validation.

A method for managing multiple cryptographic assets within a single wallet interface, allowing the user to interact with different blockchain networks and currencies securely.

Romantic Date insurance claims policies. A system for automating the management of insurance policies, comprising:
A cloud-based server configured to host a web-based platform and a mobile application;
A database for storing user data and insurance policy details;
An artificial intelligence engine that analyzes user data to recommend insurance policies, automate underwriting, and process claims;
A user interface that allows users to register, purchase, manage policies, and file claims;
A communication module for providing real-time customer support via a chatbot and live agents. he system or computing system,
wherein the artificial intelligence engine is further configured to:
Automatically adjust policy coverage based on real-time data input from the user;
Expedite claims processing by automating approval for straightforward claims.

A method for automating the insurance policy management process, comprising:
Receiving user data via a web-based platform or mobile application;
Analyzing the data using an artificial intelligence engine to recommend suitable insurance policies;
Facilitating the purchase of insurance policies through the platform;
Automatically managing policy renewals, premium payments, and coverage adjustments;
Processing claims submitted by users through the platform and automating the approval process where applicable. Ai sports coach

A system for analyzing sports data and providing real-time play recommendations, comprising a computing system that processes player and game data, an AI engine trained on historical game data, and a recommendation module that outputs strategic play suggestions.

The system or computing system, wherein the AI engine is trained using a combination of supervised and unsupervised learning techniques to predict game outcomes and optimize play strategies.

The system or computing system, further comprising a wearable or handheld device that delivers real-time strategic recommendations to players or coaches.

The system or computing system, further comprising a robotic coach that interacts with players and coaches, providing strategic advice and motivational cues based on AI analysis.

A method for training an AI sports coach, comprising collecting and processing historical game data, training machine learning models on said data, and generating strategic recommendations based on real-time analysis during a game. In some embodiments, the result of the AI analysis is communicated to the players in the game (e.g., quarterback for example).

The system or computing system, wherein the recommendation engine continuously updates strategies based on the real-time performance metrics of the players and opponents.

Physical sports coach to demonstrate playing basketball and giving live feedback etc.

A robotic sports coach system comprising a robotic demonstration unit capable of mimicking sports techniques, a computing system for controlling the robotic unit and analyzing player performance, and a feedback mechanism for providing real-time guidance to the player.

The system or computing system, wherein the robotic demonstration unit may include actuators and sensors designed to replicate human biomechanics and provide accurate physical demonstrations of sports techniques.

The system or computing system, wherein the computing system may include AI and machine learning models trained on sports data to analyze player performance and generate personalized feedback.

The system or computing system, further comprising a user interface that allows coaches and players to select training modes, view feedback, and track progress.

The system or computing system, wherein the feedback mechanism may include visual, audio, and haptic cues to guide the player in adjusting their technique during training.

The system or computing system, wherein the robotic unit is capable of assisting the player in performing the technique by providing real-time feedback and physical guidance.

The system or computing system, further comprising multiple training modes, including demonstration mode, guided mode, and assessment mode, to provide a comprehensive training experience.

The present invention relates to a system and method for automatically aggregating, displaying, and synchronizing a user's schedule from multiple online sources, such as websites, web applications, and domains. The system or computing system adjusts the schedule to the time zone of the viewer and provides integration with third-party calendar systems. This ensures that the viewer may receive alerts and reminders about the user's activities in their local time, enhancing accessibility and engagement.

A system for aggregating and displaying a user's schedule from multiple online sources, comprising:
a schedule aggregation module configured to collect schedule data from multiple domains, websites, and web applications;
a time zone conversion module configured to adjust the schedule data to the local time zone of a viewer;
a calendar integration module configured to sync the adjusted schedule data with third-party calendar services; and
an alert generation module configured to provide notifications or reminders to the viewer based on the adjusted schedule data.

The system or computing system, wherein the schedule aggregation module utilizes APIs or web scraping techniques to retrieve schedule data.

The system or computing system, wherein the time zone conversion module determines the viewer's local time zone based on device settings, IP address, or user profile data.

The system or computing system, wherein the calendar integration module supports bi-directional synchronization with third-party calendars.

The system or computing system, wherein the alert generation module allows for both automatic and manual customization of alert timings.

A method for automatically displaying and synchronizing a user's schedule across multiple online sources, comprising the steps of:
collecting schedule data from multiple domains, websites, and web applications;
converting the collected schedule data to the local time zone of a viewer,
synchronizing the converted schedule data with third-party calendar services; and
generating alerts or reminders based on the converted schedule data in the viewer's local time zone.

The method, wherein the synchronization step may include updating the schedule data in real time within the third-party calendar services.

The method, wherein the alert generation step may include delivering notifications via email, SMS, push notifications, or within third-party calendar applications.

### Entertainment Ticket

A system for booking entertainment services and managing tickets, comprising:
a. A platform (web or mobile application) enabling users to book entertainment services and receive digital tickets.
b. A flexible refund system that allows for seller-defined and platform-defined refund policies, including conditions for refunds, exchanges, and transfers.
c. A ticket verification system that enables users to present tickets either in digital or physical form for entry into an entertainment service.
d. A ticket transfer system allowing users to transfer ownership of tickets to other users, subject to predefined conditions.
e. A no-show policy enforcement system where users may forfeit their tickets if they fail to attend an event without qualifying for a refund.

The system, wherein the platform allows for seller-defined refund windows, transfer policies, and ticket validity conditions, which are displayed to the user at the time of purchase.

The system, wherein the ticket may be scanned, visually inspected, or verified using near-field communication technology for entry into the entertainment service.

The system, wherein the platform tracks time-based conditions, including deadlines for refunds or transfers, and automatically enforces these conditions through the platform's logic.

### Subscription Based in Person Events

A system for managing digital content and events through a web application, comprising: a. A subscription-based service allowing creators to offer access to digital media, live events, and private events on a recurring basis. b. A payment system enabling users to pay for locked content or messages, with the content or communication unlocked upon successful payment. c. A flexible messaging system allowing creators to charge for messaging services, including options for paid messages, unlimited messaging subscriptions, and limited messaging subscriptions. d. A ticketing system for premium events, allowing users to purchase tickets for one-time access or gain access through subscriptions. e. A tipping system where users can send payments to creators independently of other transactions.

The system, wherein subscriptions can be tiered to provide different levels of access to content and events, including basic access, premium access, and private event invitations.

The system, wherein creators can lock content and messages behind a payment gateway, requiring users to make a payment to unlock access.

The system, wherein users can subscribe for recurring access to live events, recorded content, or premium entertainment services.

The system, further comprising a tipping feature allowing users to send monetary tips to creators at any time without requiring additional content access or subscription.

### Review System for Dating Men

A system for aggregating and displaying user-generated reviews, comprising: A user registration module for creating user profiles. A review submission module that allows users to post reviews, ratings, and multimedia content on a wide variety of categories and items. search and filtering module enabling users to search reviews based on keywords, location, ratings, and categories. verification mechanism to authenticate the legitimacy of reviews using purchase verification, geolocation data, and user reputation scores. recommendation engine that suggests items or experiences based on user preferences and behavior.

The system, wherein the reviews include multi-dimensional ratings that allow users to rate different aspects of the reviewed item.

The system, wherein business owners can interact with user reviews by responding to feedback or resolving issues.

A method for finding similar-looking profiles in a web or mobile application, comprising:
a) receiving a user-uploaded or selected image of a person;
b) processing said image using an AI-powered image recognition engine to extract visual features;
c) comparing the extracted features to a database of profile images;
d) calculating similarity scores between the uploaded/selected image and each profile in the database;
e) displaying a list of profiles ranked by similarity to the user.

The method, wherein the extracted visual features include facial structure, hair color, skin tone, and eye shape.

The method, wherein the AI-powered image recognition engine utilizes neural networks and computer vision algorithms.

The method, further comprising user feedback data to adjust future recommendations based on user preferences.

A system for finding similar-looking profiles in an application, comprising:
a) an AI-powered image recognition engine for processing images;
b) a profile database storing images and associated profile data;
c) a similarity matching algorithm for calculating similarity scores;
d) a recommendation module for presenting ranked profile suggestions to the user.

### Boyfriend Application Screening Process

The method, wherein the pre-qualification screening is conditional based on the application type and provider requirements.

The method, wherein the payment requirement is conditional and can be waived, deferred, or required before submission, as defined by the application provider.

The method, further comprising a user interface that adjusts the workflow dynamically for the applicant based on the category and conditions set by the provider.

The method, further comprising an administrative interface for application providers to define application categories, pre-qualification criteria, and payment options.

The method, further comprising an integrated notification system that alerts applicants and providers about the status and requirements of an application.

A mobile laundry delivery and management system, comprising:
a computing platform for managing user profiles, laundry service requests, gig worker assignments, scheduling, payment processing, and order tracking;
gig workers using their own home or apartment laundry systems to perform laundry services;
a user interface accessible via a mobile app, website, or voice-controlled devices for scheduling and managing laundry services;
a logistics system coordinating laundry pick-up and delivery between users and gig workers.

The system, wherein the computing platform may include real-time tracking of laundry progress, notifying the user of key events like laundry pick-up, processing, and delivery.

The system, further comprising a payment processing module that securely handles transactions via credit card, mobile wallets, or prepaid plans, and compensates gig workers for completed tasks.

The system, wherein the gig workers use their own laundry equipment to complete services based on user-provided instructions for washing, drying, and folding.

The system, wherein users can schedule laundry services through voice commands via smart home devices and receive real-time notifications about their laundry status.

The system, wherein the system manages logistics for delivery, including real-time GPS tracking for users who opt for delivery services.

A mobile laundry service system, comprising:
a fleet of mobile laundry vehicles equipped with washing, drying, and folding capabilities;
a centralized computing system for managing user profiles, scheduling, payment processing, and real-time tracking;
a user interface accessible via a mobile app, website, or voice-command systems for scheduling services and managing orders;
integration with robotic services for laundry collection, processing, and delivery;
optional holographic assistants for user interaction and service updates.

The system, further comprising a real-time tracking module that provides users with GPS-based location tracking of the laundry vehicle and progress updates on laundry processing.

The system, wherein the payment processing module allows users to securely pay for services through mobile wallets, voice-authorized payments, or subscription-based billing.

The system, wherein robotic systems are employed for collecting, processing, and delivering laundry, and are controlled by the central computing system to ensure efficient operation.

The system, wherein a voice-command interface enables users to schedule, track, and manage laundry services through devices like Amazon Alexa, Google Assistant, or proprietary AI-driven systems.

The system, wherein holographic assistants provide visual interaction, allowing users to control the service, receive status updates, and communicate with the system using holographic displays.

### Case Value AI

A system for estimating the value of a specific event in a web application or computing system, comprising:

An event detection module configured to detect user-triggered or system-triggered events.

A data aggregation module configured to collect data points related to the event.

A feature extraction engine to process the collected data and extract key features.

A machine learning model configured to estimate the event's value based on the extracted features.

A value estimation module configured to output an estimated value of the event.

The system, wherein the event detection module identifies specific user actions, including but not limited to clicks, purchases, or posts.

The system, wherein the machine learning model is selected from a group comprising decision trees, neural networks, and reinforcement learning algorithms.

The system, further comprising an API for integration with external systems to send event data and receive estimated values.

A method for estimating the value of a specific event in a web application or computing system, comprising the steps of:

Detecting an event triggered by a user or system action.

Collecting data points relevant to the event.

Extracting key features from the collected data.

Applying a machine learning model to estimate the value of the event.

Outputting the estimated value of the event.

A system for providing on-demand service ordering, comprising:
a client interface, where a client can request services from a nail artist, hair stylist, barber, massage therapist, personal trainer, or other service providers;
a service provider interface, allowing service providers to accept service requests;
a GPS-based tracking module that allows both the client and the service provider to see each other's real-time location;
an ETA calculation module configured to estimate the time of arrival based on current traffic conditions, distance, and travel speed;
an integrated payment system allowing clients to make payments directly through the application;
a holographic display system enabling the interaction with the interface via 3D holograms;
and a notification system that updates both the client and service provider when one party is nearing the destination.

The system, wherein the service provider is dispatched to the client's residential location or the client is directed to a service location, with both parties being able to track their movements in real-time on the platform.

The system, wherein the holographic display enables users to interact with service options and track the movements of the service provider or client using a 3D interface.

The system, wherein the ETA calculation module dynamically adjusts based on real-time changes in traffic patterns, road closures, or delays.

A method for providing on-demand personal services, comprising:
receiving a service request from a client through a mobile app or web-based application;
matching the client with an available service provider based on GPS location and service preferences;
displaying the real-time location of the client and service provider using GPS data;
calculating and displaying the ETA for both the client and service provider;
enabling communication between the client and service provider within the application;
processing payments and tips through the app, with the option to review the service upon completion.

The method, wherein the application provides a real-time notification system, alerting the client and service provider when the service is about to commence or the party has arrived.

This system enhances convenience, transparency, and safety, giving both clients and service providers a seamless experience with real-time updates and holographic interaction.

A method for configuring user controlled-access to database records in a computing network, the method comprising:
providing a computing network utilizable by computing users registered with the computing network;
determining, using one or more hardware computing device processors, a first user accesses, using a first computing device associated with the first user, the computing network;
enabling, using the one or more hardware computing device processors, the first user to create a first user profile;
determining, using the one or more hardware computing device processors, a second user accesses, using a second computing device associated with the second user, the computing network;
enabling, using the one or more hardware computing device processors, the second user to create a second user profile, wherein the second user profile is associated with a second location, wherein the second user profile comprises a first image and a first link to content outside the computing network;
receiving, using the one or more hardware computing device processors, first raw information from the first user, the first raw information comprising at least one identifying information associated with the first user, contact information associated with the first user, identifying information associated with a first party, a video associated with the first user, and first text information;
storing, using the one or more hardware computing device processors, the first raw information in at least one database;
processing, using the one or more hardware computing device processors, the first raw information to remove identification information associated with at least one of the first user or the first party, thereby resulting in first processed information, wherein the first processed information is editable by the first user, wherein the first processed information is available for viewing on the computing network, wherein viewing of the first processed information in the computing network is not controlled by the first user, wherein viewing of the first raw information in the computing network is controlled by the first user;
storing, using the one or more hardware computing device processors, the first processed information in the at least one database;
executing, using the one or more hardware computing device processors, a first search or browse operation, based on one or more first search or browse parameters associated with the second user;
generating, using the one or more hardware computing processors, based on the one or more first search parameters, one or more first search results;
transmitting, using the one or more hardware computing device processors, the one or more first search or browse results to the second computing device of the second user,
wherein the one or more first search or browse results comprises at least a portion of the first processed information associated with the first user,
wherein a first search result and a second search result are comprised in the at least one search result,
wherein the first search result and the second search result are presented either sequentially or are arranged together on at least one interface,
wherein a sequential order of the first search result and the second search result, or an arrangement of the first search result and the second search result, is based on at least one of a first activity or first user data at least one of associated with the second user or associated with the first user;
receiving, using the one or more hardware computing device processors, from the second user, a first request to view the first raw information associated with the first user;
transmitting, using the one or more hardware computing device processors, to the first user, the first request;
receiving, using the one or more hardware computing device processors, from the first user, an approval to view the first raw information associated with the first user;
transmitting, using the one or more hardware computing device processors, to the second user, a notification indicating the first user approved the first request, where in response to first user approving the first request, at least some of the first raw information is activated or unlocked for viewing by the second user, wherein the at least the some of the first raw information is not activated or not unlocked for viewing by a third user that did not transmit a second request to view the first raw information associated with the first user, wherein the at least the some of the first raw information is not activated or not unlocked for viewing by a fourth user that transmitted a third request to view the first raw information associated with the first user, wherein the third request was not approved by the first user;
receiving, using the one or more hardware computing device processors, from the second user, a notification associated with the first user;
in response to receiving the notification associated with the user, initiating, using the one or more hardware computing device processors, deletion of the first processed information from the at least one database; and
transmitting, using the one or more hardware computing device processors, a first search or browse operation, based on one or more first search or browse parameters associated with the second user, to the first user, notification of the deletion of the first processed information.

The method, wherein the at least one database comprises at least one cloud database.

The method, wherein the first raw information or the first processed information is encrypted or locked such that a key or decryption or unlocking information is required to decrypt or unlock the first raw information or the first processed information.

The method, wherein the processing is performed using a large language model.

The method, further comprising enabling the first user and the second user to submit first input and second input, respectively, onto a single document or file.

The method, further comprising receiving, from the second user, electronic transmittables which may include but not be limited to (e.g., payment or periodic payment) for enabling access to records on the computing network.

The method, further comprising adjusting, using a resource allocator, one or more available operations available to the first user or the second user, or transferring data from a first memory or storage location to a second memory or storage location, on the computing network, based on at least one of a computing load associated with the computing network, an available storage or memory associated with the computing network, a number or type of users associated with the computing network or online on the computing network, or a number of operations being executed or to be executed by the computing network.

The method, wherein the resource allocator is controlled by a basic input/output system (BIOS) or a resource-controlling system.

If a victim wants to find an attorney for their potential case, the only way to find an attorney is call hundreds of attorneys, repeat case details to each attorney, and hope that one attorney takes on the case. During the entire process, the victim receives no status updates and loses hope to ever find justice for their situation. This solution is the world's first ever system for victims to feel a sense of hope.

In some embodiments, any of the information described in this disclosure or incorporated by reference into this disclosure may entered as input into a large language model (LLM). The LLM may output data indicating a value of a particular case, a category associated with a potential client, a willingness to settle by a defendant, a predicted settlement amount and/or case outcome, a timeline for the case, a cost associated with pursuing a legal case, mediation, etc., a court or judge that could be assigned to the case, an appropriate court or district where the case should be pursued, a difficulty level of the case, a determination of how much funding will be needed for the case, a timeline and type of court filings, motions, and witnesses that will be needed in this case, names of firms that will likely be hired by the defendant, whether a case has potential to have more plaintiffs, whether a case has potential to be a class action case, etc.

Referring now to FIG. 2, a user can sign up or log in as a potential client or as a legal professional (attorney, paralegal, legal assistant, etc.). The potential client is a potential client of the attorney. In some embodiments, the attorney may be replaced by a doctor and all the legal professional could be replaced by a medical professional. In some embodiments, the computing environment described herein is implemented as a website or a computing application. In some embodiments, the orientation, configuration, or elements visible (and positions thereof) may change based on whether the website or computing application is accessed on a desktop, a tablet, a mobile phone, etc. For example, the mobile phone may see a more truncated version of any of the display pages described herein compared to a desktop or laptop computer.

In FIG. 3., after a legal professional signs up, he receives this message.

In FIG. 4, a screen shows up indicating that the professional has to have his account verified before he can start viewing and interacting with cases uploaded by potential clients.

In FIGS. 5 to 11, the display indicates all the information that needs to be entered by the professional to submit his profile for verification to an administrative user. In some embodiments, the administrative user may be a computer program or system.

FIG. 12 shows a display screen after the professional submits his profile for review.

FIG. 13 shows the professional's submission in the admin account.

FIG. 14 shows a notification of the professional's submission in the admin account.

FIG. 15 shows how a professional can add a team member (e.g., an assistant, a paralegal, etc.) to perform actions on their behalf on the platform.

FIG. 16 shows how a professional (e.g., an assistant) can find a registered attorney and send a request to the registered attorney to link up with them in the computing network environment so that the assistant can act on behalf of the attorney on the network. The assistant and the attorney can sent requests to add as team members only if the recipient works at the same law firm (i.e., has the email address of the law firm, i.e., lawfirm.com).

FIG. 17 shows a notification in attorney's notifications that the assistant has sent to request to interact with cases on behalf of the attorney.

FIG. 18 shows the “Team Management” tab of the attorney. The attorney can either approve or deny the assistant's request.

FIG. 19 shows that the attorney has approved the assistant's request.

FIG. 20 shows the attorney's statistics (how many cases requested (including or excluding pre-approvals), how many cases closed, etc.) versus other attorneys on the computing network platform. An assistant's activities on the platform (where the assistant is acting on behalf of the attorney) count towards the attorney's statistics. In some embodiments, the assistant may be able to view their own statistics (with respect to a particular attorney). In some embodiments, an assistant cannot act on their own behalf on the platform.

In some embodiments, each case will have unique identification information. In some embodiments, an attorney/assistant may be able to filter notifications based on this identification information or any other identification information (party name, email address, type of cases, etc.) associated with the case.

FIG. 22 is the information that needs to be entered when an attorney is changing law firms. This information is submitted to the admin for approval. In some embodiments, the admin may be a third-party computer system.

FIG. 21 shows the display from when the “Changing Law Firm” tab is selected from the menu.

FIG. 23 shows a client who uses a Gmail address to access the computing network platform. In some embodiments, for a legal professional to sign up, they can use only their work email addresses, and they cannot use gmail or yahoo email addresses.

FIG. 24 shows the homepage when a potential client (may also just be referred to as client) logs in. The page shows statistics associated with the client, including graphics. Although not shown, the homepage also shows a pre-approval attorney list link. By clicking this link, the client accesses a list of attorneys who would like to be pre-approved for cases. The client can view the list of attorney, filter based on any of the criteria or information described herein (e.g., practice area, location, etc., number of requests made on the platform, number of cases closed on the platform, years of experience, etc.). The client can then select an attorney and select which of their cases they would like to pre-approve the attorney for.

FIGS. 25 to 27 display all the various questions to create a case or a “quick case.” Some questions must be answered to proceed to the next step. Other questions are optional to answer to proceed to the next step.

FIG. 28 displays the message to the client after submitting the form.

FIGS. 29 to 31 display all the various questions additional questions that the client can answer (optional question). For example, some questions are directed to the net worth of the adverse party (e.g., market valuation), whether the adverse party owns any assets (revenues, real estate, personal property, businesses, etc.) in the location where the incident occurred that led to the case, the litigation history of the adverse party, whether the adverse party has a manager or representative, whether the adverse party previously committed the same offense, etc.

FIG. 32 shows the case stepper for the client. This is the one-stop page where the client can see the status of their case along with the attorneys/assistants who are interacting with the case.

FIG. 33 shows the bottom of the same page as that shown in FIG. 32. The client has the option of uploading supporting documents, a video statement, and additional details. This disclosure provides a great public benefit in that victims do not need to repeat their story to hundreds of attorneys.

FIGS. 33 and 34 present answers to questions asked in the case intake form.

FIG. 35 shows the homepage of the client. The stepper of each of the client's case is presented.

FIG. 36 shows a display page of an attorney signing up on the computing network platform.

FIG. 37 shows the next page of signing up.

FIG. 38 shows the next page after the attorney selects “Complete Profile” on FIG. 37.

FIG. 39 shows the requested information. Some questions must be answered to proceed to the next step. Other questions are optional to answer to proceed to the next step.

FIG. 40 shows the information filled in by an attorney. The attorney can choose multiple case type preferences and multiple states. These case type preferences and state preferences will be applied as filter parameters on the cases shown on the attorney's homepage, so that the attorney views cases customized for them upon logging in.

FIG. 41 shows that the attorney's photo is required to proceed to submit their profile.

FIG. 42 shows the attorney's profile submission that has been submitted for approval to the admin user.

FIG. 43 shows the lower part of the page shown in FIG. 42.

FIG. 44 shows an admin user's account. In the “Awaiting Approval” section, the admin user can approve, deny, or view information associated with the attorney's profile/submitted details.

FIG. 45 shows the notifications in an admin user's account indicating that the attorney profile needs to be checked.

FIG. 46 shows the admin user selecting “View” in FIG. 44.

FIG. 47 shows the display if the admin user selects the “Provide Feedback and Deny” option in FIG. 45.

FIG. 48 shows the notification in the attorney's account if the attorney's profile is approved by the admin user. The notifications are presented in order of time (most recent at the top). In some embodiments, the notifications may be input or processed through an LLM and recommendations to the attorney may be presented. In some embodiments, notifications of new cases (e.g., cases that meet the attorney's filter) may be presented (e.g., in real-time, once a day, once a week, etc.). In some embodiments, the type of notification may also be based on the tier/category of attorney. For example, subscribed attorneys get notifications of SOS (Save our Souls) cases and Cases just posted, while non-subscribed attorneys get notifications of Available Cases. In some embodiments, the attorneys receive notifications for any cases on which they have made progress on the “stepper” of that particular case.

FIG. 49 shows the notifications page in the attorney's account if the attorney selects the “Mark as Read” notification for all notifications on the page.

FIG. 50 shows the attorney's homepage upon getting approved/verified by the admin user and logging in successfully. The SOS cases lists cases where the client selects “need an attorney now” on their case intake form. The Cases Just Posted lists cases recently posted (e.g., a predetermined number of days such as less than 30 days from posting). Upon a case being present on the computing network platform for more than the predetermined number of days, it will automatically move to the Available Cases list. The SOS cases and Cases Just Posted may only be available to higher-tier attorneys (e.g., subscribed attorneys). The Available Cases may be available to all attorneys on the platform. In some embodiments, next to each label may show the total number of cases in that particular tab either with or without the filter applied. The filter is based on the attorney's case type and location selections when setting up the attorney's profile. A sorter is also presented to be able to sort the cases based on date of incident (newest, oldest, etc.), date of case creation (newest, oldest, etc.), location (closest, furthest, etc., e.g., based on the attorney's location as indicated in his profile), most requested, least requested, most reviewed, least reviewed, etc. In some embodiments, the customized filter is applied across SOS cases, Cases Just Posted, Available Cases, and Requested Cases, and in some embodiments, it is not. The attorney may select “Clear All” to clear the filter and view all cases. The type of user is also shown in the top right (Premium User, Normal User (Upgrade to Premium), etc.). In the top right, the attorney can select their profile picture which will take them to their settings page. The profile picture has a green border indicating that the attorney is verified/approved. Also in the top right is the bell icon indicating whether the attorney has any notifications. On the left side, the attorney can navigate through four options: Available Cases, My Active Cases, Closed Cases, and Statistics. The tabs of SOS cases, Cases just posted, Available cases, and Requested cases (where the attorney has submitted a request to the client to view the details of the case, the case moves from at least one of the SOS tab, the Cases just posted tab, the Available Cases tab to the Requested Cases tab) are associated with the Available Cases menu option. On any of the cases page, the attorney may be able to change the filters to customize their search. On any of the cases page, the attorney is provided with drop-down menus (Type of Case, Happened At, Date of Incident, Client's State, Class Action, Entity of Individual, Multiple Plaintiffs) to further filter the list of cases. In some embodiments, the term “client” here means “potential client” (i.e., they are not yet a client of the attorney but may potentially be in the future).

In some embodiments, the various parts of the computing solution may be integrated into a docketing computing application (e.g., for associating the case lead in this computing solution with an actual case in the attorney's docketing system), a scheduling computing application (to schedule a call or meeting between the client and the attorney), a billing computing application (to bill the client for costs and fees), a conflicts checking application, etc. In some embodiments, any of the embodiments may be applied to any kind of dispute resolution cases, including court cases, arbitration cases, mediation cases, settlement cases, small claims cases, international cases, etc. Any interaction with a case described as being performed by an attorney may be performed by an assistant, paralegal, or other user authorized by the attorney to perform actions on the computing platform on the attorney's behalf.

FIG. 51 shows the display page when the attorney selects My Active Cases. This shows the tabs Approved Cases (where the client has approved the attorney's request to view the known parties associated with the case, but not view any additional details associated with the case until the attorney selects the option that the attorney has no conflicts upon learning the names of both parties (the potential client and the potential defendant named by the potential client) and the type of case). In some embodiments where the client chooses to be anonymous (i.e., selected the appropriate option in the case intake form), only the client's contact information (and the defendant's name and the case type) is shown to the attorney at this stage. In some embodiments, the customized filters (based on the selected options at the time the attorney created their profile) are used to filter the cases in the Approved Cases (a case moves to this tab from the Requested Cases tab to the Approved Cases tab when the client approves the attorney's request to view case details), My Cases (a case moves to this tab after the attorney completes the conflicts check [using the client's name, the defendant's name, and the case type] and confirms that the attorney (and/or law firm that the attorney works for) has no conflicts with representing the client in the client's case), and Not Interested Cases (a case moves to this tab after the attorney reviews the case information of a case in the My Cases tab and selects an option indicating that the attorney is not interested in representing the client on the client's case) tabs. In some embodiments, when the attorney executes an interaction with a case, the client is notified of the interaction. The present disclosure provides hope to clients who are looking to secure an attorney for their case.

In some embodiments, the filters available to an attorney are based on the tier or type of attorney, as shown in FIGS. 52 to 54. For example, all registered attorneys on the platform can filter cases by type of case, happened at location, date of incident (past 1 month, 2 months, etc.), client's state of residence, etc. However, in some embodiments, a subset of attorneys (e.g., subscribed attorneys) can filter cases by class action (yes or no), entity or individual, multiple plaintiffs (yes or no). In some embodiments, the determination of whether a case is class action or would/could involve multiple plaintiffs is determined by the client or is determined based on processing the information received from the client through a large language model. As used herein, the term “large language model” is not limited to any minimum number of nodes of artificial neural network or graph. In some embodiments, the number next to each case tab (Approved Cases, My Cases, Not Interested Cases) indicates the number of cases present in each of those tab either with or without any filters applied.

FIG. 55 shows the SOS cases tab. FIG. 56 shows the Cases Just Posted tab. FIG. 57 shows the page that comes up if the attorney selects the Subscribe Now button, which may be present on the page (e.g., in the Cases Just Posted tab) or in the top right corner of the page. In some embodiments, the premium features (e.g., premium tabs such as SOS cases and Cases Just Posted) and Premium Filters are presented in a different color compared the features available to all attorneys on the network who are verified (approved by the admin user). Unverified attorneys may be able to view a certain number of cases and may be able to perform a certain or no types of interactions with cases. FIG. 58 shows the page if the attorney selects “Pay $40” on FIG. 56. Accordingly, if an execution of transmittables is performed successfully, the attorney is subscribed.

FIG. 59 shows that the attorney is subscribed and provides an option to cancel the subscription.

FIG. 60 shows the list of SOS cases. For each case, the date of incident, the date of case posted, the location of the incident, and the location of the client are shown. Also, for each case, the number of requests received and the number of “in review” instances are shown. The number of requests received means the number of attorneys who have requested to view the parties and/or details associated with the case. The number of “in review” instances indicates instances either the number of instances of the client approving the attorney's request to view the parties and/or details associated with the case and/or the number of instances whereby the attorney has performed a conflicts check and the details of the case are made accessible to the attorney. The number of “in review” instances and requests are shown to many attorneys. The class action, multiple plaintiffs, entity/individual information is shown only to subscribed attorneys. A case type is shown as the tile of each case. An option is presented for an attorney to “request to view more” for each case. This is a request to view the parties of the case and, ultimately, more details of each case.

FIG. 61 shows the list of SOS cases. FIG. 62 shows the change in form of the “request to view more” option immediately after being selected by the attorney. After a few moments, the case moves to the “Requested Cases” tab, as shown in FIG. 63. In FIG. 63, the attorney is provided with an option to Withdraw Request. FIG. 64 shows the SOS cases again. The total number of cases in the SOS Cases tab is also shown. After the attorney requests to view more for a case, the client approves the attorney's request. In response to this approval, the case moves to the attorney's Approved Cases tab, as shown in FIG. 65. Even at this stage, the party names (client and defendant named by client) are not presented to the attorney. FIG. 66 shows all the various ways in which the cases can be sorted (date of incident-recent first, date of incident-oldest first, most requested first, least requested first, most reviewed first, least reviewed first, etc.). FIG. 67 shows the homepage of a client. The homepage shows tabs for Cases and Notifications along with statistics associated with the client's cases and the stepper for each of the client's cases. FIG. 68 shows a notification being received by a client that a request was received to view more information for the client's case. FIG. 69 shows the stepper for the client. The display with the stepper shows the various stages of securing an attorney on the network platform. The “1” on the Requests stage shows that 1 attorney has requested more information. When the client selects the “Requests” stage the information below the stepper shows the Requested Legal Professionals and their information. The client has the option to view more details of this attorney and/or approve/deny the attorney to move to the next stage. Below this is shown the entire case details of the client's case. These details are based on the input entered onto the client's intake form. In some embodiments, this information may be entered into a large language model, and output may be displayed on this screen. FIG. 70 shows the screen when the client selects “More Details” on FIG. 69. The client is able to view the number of cases requested, the number of cases closed, appropriate hyperlinks associated with the attorney, their experience, etc.

FIG. 71 shows the updated stepper showing that one attorney has progressed to the Approval stage. The client has the option to remove approval so that the attorney can no longer see details of the case. FIG. 72 shows the notification in the attorney's account showing that the attorney is approved view more details. FIG. 73 shows that the case is no longer present in the “Requested Cases” list of the attorney. In FIG. 74, the case now shows up in the “Approved Cases” list of the attorney. The option presented on the case is an option to “Check for Conflicts.” When the attorney selects this option, the attorney is presented with a popup showing the name of the client and the name of the adverse party. The attorney is then provided with a message to conduct a conflicts search to determine whether the attorney would have a conflict in representing the client in this case. The attorney can select “No Conflict,” “Conflict,” or “Do Later.” In some embodiments, the conflicts check may be conducted by connected to the attorney's law firm's conflicts checking system. In other embodiments, the attorney can conduct the conflicts check on a third-party conflicts checking system and select the appropriate option. In FIG. 75, the attorney answer the question of whether the attorney is sure that there are no conflicts with representing the client. In FIG. 76, the client receives an update on the stepper of the case. In FIG. 77, the client receives a notification of no conflicts. In FIG. 78, when the client selects the case, the client views the stepper with the update indicating that the attorney has progressed to the Conflict Check stage. At any point here, the client has the option to remove approval. Upon clearing the conflict check stage, the case moves from the Approved Cases tab (may also be referred to as a case state) to the My Cases tab, as shown in FIG. 79. When the case is in this stage, the name of the client and the adverse party are shown. If the client chose to be anonymous, the name of the client is hidden. When the attorney selects the case, the full stepper of the case (different from the client's stepper) is shown in FIG. 80. The answers from the client's case intake form are shown in FIGS. 80 and 81, which is actually a single display screen. FIG. 82 shows that the attorney can report a case for a few reasons (e.g., spam, sellers, bot/robot, etc.). If the attorney reports a case, the case is moved to a deleted state for the attorney who reports the case but the case is still available to be interacted with for other attorneys. If three different attorneys report the case, the case is deleted entirely from the computing network and the client receives a notification that the case was reported by three different attorneys and therefore deleted from the platform. The client may choose to create another case. In some embodiments, there may be a limit on how many cases the client can create using a single email address or account (e.g., three cases simultaneously).

FIG. 83 shows that the attorney can select an option to indicate that the attorney is not interested in a case. When this option is selected, the case moves into the “Not Interested Cases” list/tab/state/section. FIG. 84 also shows the option to report the case.

FIG. 85 shows the case in the Not Interested tab after the attorney selects the “not interested” option. This option is shown in a different color in the Not Interested Cases tab. FIG. 86 shows the client's notifications indicating that attorney has marked the case as “not interested.”

FIG. 87 shows the “mark this case as interested” option. If the user selects this option, the case is moved back from the “Not Interested Cases” section to the “My Cases” section. FIG. 88 shows case stepper for each of the cases created by the client on the client's homepage. FIG. 89 shows the notification on the client's page after the attorney marks the case as interested.

FIG. 91 shows the pop-up when the client selects, on the client's homepage, attorneys to pre-approve for their cases. When the client selects the option (e.g., as shown in FIG. 88), the client is presented with a drop-down list prompting the client to choose one of their two cases. As shown in FIG. 92, there are currently no attorneys that the client has preapproved for the case or are available for pre-approval for the case (this is based on whether the case type preference and/or preferred location match at least one of the case type, client location, incident location of the case). FIG. 93 shows a case in the Cases Just Posted tab. FIG. 94 shows two attorneys at different stages on the stepper of the client's case. The client is shown

FIG. 90 shows SOS cases on the SOS case tab of another subscribed attorney. information indicating that the client has received two requests. In FIG. 94, the client selects the Conflict Check on the stepper, thereby revealing the attorney associated with this stage. In FIG. 95, the client selects the Requests on the stepper, thereby revealing the attorney associated with this stage. If the client approves the attorney in the Request stage, the attorney moves to the Approved stage, as shown in FIG. 96. In FIG. 97, the attorney selects a case in the Approved Cases tab and receives the Conflicts Check popup. If the attorney selects the option of “Conflict” in this stage, the client receives a notification that the attorney cannot take up the case. Also, the case disappears for the attorney; i.e., the attorney will no longer be able to view that case or interact with that case. It is essentially deleted for the attorney. FIG. 99 shows the stepper for the client with only one attorney because the other attorney was conflicted out of the case. FIG. 100 shows a case in the My Cases tab for an attorney. If the attorney selects No Conflicts, and then selects the case, FIG. 101 shows the stepper stage reached by the attorney. FIG. 101 presents a download option and once selected, a PDF or other document of the case details are downloaded as shown in FIG. 102 and FIG. 103. From the bottom of the stepper, the attorney may select the option to close the case. If the attorney selects this option, the attorney is presented with the screen in FIG. 104 prompting the attorney answer whether the client and the attorney have signed a contract. If the attorney says No, the process moves to the screen of FIG. 105 (i.e., the stepper screen of the attorney showing the attorney's progress on the case along with all the case details). Just as with the display page with the client's stepper, the information on this page may be input into a large language model and the output regarding the case, the client, the attorney, etc., may be presented on this page. If the attorney selects the attorney has signed a contract with the client, the process flow moves to FIG. 106. FIG. 106 shows the case has been moved to the Closed Cases menu (Pending Closing tab). When the attorney selects the case or selects the Complete Case Details option, the attorney is presented with the stepper and the case details as shown in FIG. 107 along with a message indicating that the system is waiting for the client's confirmation to close the case. FIG. 108 shows a notification in the client's notifications indicating that the attorney wants to close the case, presumably because the attorney signed a contract with the client. In some embodiments, the contract may need to be uploaded for verification by a computing application. In some embodiments, the contract may be established on the computing network (e.g., a blockchain based contract) such that the attorney and the client can sign a contract on the computing network. In some embodiments, customizations may be provided (e.g., contingency fee percentage, etc.). When the client selects their case in their account, they are taken to a stepper that shows the request to close stage, as shown in FIG. 109. At this stage, the client is presented with an option to “close case” or “keep the case open.” If the client selects the “keep the case open” option in FIG. 109, the client is taken to FIG. 110 where the attorney is moved back from the Request to Close stage to the Conflict Check stage. In FIG. 111, the attorney receives a notification indicating that the client has denied closing the case. The attorney may again send a request to close the case to the client. In FIG. 112, the client is again presented with the stepper and the option to close the case. If the client selects “close the case” in FIG. 111, the client is presented with the screen in FIG. 113. The message to the client indicates the date of closing and the details of the attorney that closed the case. A message is presented to the client that the case will be deleted from the system in 7 days (or other number of days) and an option is provided to download the case details and to delete the case now. The attorney who closed the case receives a positive (green) notification congratulating them on closing the case. All other attorneys who failed to close the case but reached various positions on the stepper receive notifications indicating that the case is closed (see, e.g., FIG. 114). When the attorney who closed the case accesses their Closed Cases tab, the case shows up there (FIG. 115). Essentially, upon closing of the case, the case moves from the Pending Closing tab to the Closed Cases tab. The stepper of the case is shown in FIG. 116 in the attorney's account. The attorney will also be informed that the case will deleted from the platform in 7 days or other number of days.

FIG. 117 shows a case in a client's account where an attorney has progressed to the Requests stage. FIG. 118 shows that the attorney has progressed to the Approved stage. FIG. 119 shows the profile page of an attorney. FIG. 120 shows that the attorney can change their case preference and state preference. Any updates will be sent to the admin user for approval. FIG. 121 shows the updated preferences set by the attorney. FIG. 122 shows the case page on the client's account. When the client selects the “See available professionals,” the platform shows in the popup the attorneys that meet the case type and/or client location and/or incident location associated with the case. In this case, the platform found one attorney who meets these parameters of the case and presents this attorney in the list. The client has the option to “see details” of the attorney and “approve” (pre-approve) the attorney. Essentially, this is a way for the client to pre-approve the attorney's request such that the attorney directly goes to the Approval stage. The attorney can view the parties of the case (client, adverse party) to conduct a conflicts check. In this screen, the profile picture of the attorney is shown. FIG. 123 shows the page of the attorney details when the clients selects “More details” or selects the attorney's photo. In this page, the client is presented with an option to approve the attorney. In the case page in the client's account as shown in FIG. 124, the pre-approved attorney is shown adjacent to the stepper. The pre-approved attorney is shown in the Pre-Approved Professionals list and also shown in the Approved (awaiting conflict clearance) list. The client is presented with an option to “Remove Approval” from the pre-approved attorney (and/or any other attorneys who had their previous requests approved). In FIG. 125, the attorney (pre-approved by the client) gets a notification indicating that they have been pre-approved to view the parties and/or other details associated with the client's case. To be part of the list of the attorneys that can get pre-approved, the attorney may need to be a subscribed user. FIG. 126 shows the statistics associated with the attorney comparing the attorney's case requests and/or case closings versus other attorneys on the platform during various periods (Today, Last 7 days, Last 30 days, custom date). FIG. 127 shows profile activity of the attorney. FIG. 128 shows how an attorney can select a custom date range to view their statistics.

FIG. 129 shows the statistics of a client when they log into their account. FIG. 130 shows the profile details of the client. FIG. 131 shows the email notification settings of a client. The client received attorney suggestion emails (e.g., for preapproval) based on matching the attorney's case preferences and/or location preferences with a case's incident location, client location, and/or case type. In some embodiments, any notifications described herein may also be sent via email. FIG. 132 provides an option to delete the client's account.

FIG. 133 shows the profile details page of an attorney. FIG. 134 provides an option for an attorney to add a team member to their account such that the team member can perform interactions with cases on the platform on behalf of the attorney. FIG. 135 shows the warning when the attorney selects the “Changing Law Firm” option. This message indicates that the attorney's activity associated with each case will be deleted; however, for the purpose of statistics, the attorney's overall numbers of number of case requests made and number of cases closed will be preserved in the attorney's account. In some embodiments, if the attorney leaves a firm, the client will also note on their stepper that the attorney has disappeared. The client may receive a notification indicating that the attorney has left the law firm and therefore the attorney's progress has been removed on the stepper. Additionally if an assistant was acting on behalf of the attorney on the platform, the assistant may no longer have access to the attorney's account, be able to interact with cases on behalf of the attorney, and may receive a notification indicating that the attorney has left the firm. FIG. 136 shows the “Delete Account” page.

FIG. 137 shows an attorney's My Cases page. For the displayed case, the attorney may report the case for one of three reasons. FIG. 138 shows a page asking the attorney to confirm that the attorney would like to “report” the case. If the attorney reports the case (or has a conflict with the case), the case becomes hidden or deleted for that particular attorney (or their team member such as assistant) such that the attorney (and/or their team member) cannot view or interact with that case. FIG. 139 shows that after the attorney reports the case, the case is deleted from the “My Cases” page. In some embodiments, the option to report the case (e.g., in FIG. 138) only shows up when the case enters the “My Cases” tab or stage.

In some embodiments, a legal case may refer to any kind of work. The client may also provide a proposed fee for the work. The attorney may represent any kind of professional, legal or otherwise (e.g., a doctor or other medical professional). A process may be provided where the service provider may counteroffer the proposed fee, whereby the client and the service provider keep counteroffering back and forth (with messages provided associated with each counteroffer) until they agree on a fee for the work.

FIG. 140 shows an assistant creating an account so that the assistant can act on behalf of an attorney. FIG. 140 shows the attorney entering their information on a form. When the assistant selects the “Attorneys” section, they are presented with a screen indicating that they are currently not associated with an attorney, as shown in FIG. 141. In FIG. 142, the attorney can search for a team member to add to their team. The second part of the email address on the display is a copy of the attorney's email address (i.e., the “@AAAlawfirm.com”). This means that attorneys (and assistants) can only add team members that share the same base law firm name (@AAAlawfirm.com).

FIG. 143 shows an admin user's analytics page. This “cases” page shows the number of cases created, the number of professionals who requested cases, the number of cases closed, etc., over a customizable timeframe. FIG. 144 shows analytics for professionals (e.g., number who signed up, number awaiting approval, number of verified/approved professionals, number of unverified professionals, etc.), over a customizable timeframe, in the admin account. FIG. 145 shows a user list in the admin's account. FIG. 146 shows client analytics (e.g., the number of clients who signed up over a customizable timeframe) in the admin account. FIG. 147 shows the client list in the admin account. FIG. 148 shows active logins associated with professionals, client, sub-admins, in the admin's account. FIG. 149 shows reports in an admin's account (i.e., the number of cases created, number of cases reported, number of cases deleted, etc.).

FIG. 150 shows an account profile page of an attorney. FIG. 151 shows a page when an attorney selects the “Changing Law Firm” tab. When the attorney selects that he wants to proceed, the attorney is presented with the page as shown in FIG. 152. In FIG. 152, the attorney is presented with a form to enter new law firm details (including new email address, etc.) FIG. 153 shows this information after having being filled in. In FIG. 154, when the attorney hits “Submit,” attorney is presented with a box to enter a confirmation code. This confirmation code is available in the attorney's new email address (for the new law firm). When the attorney correctly enters this confirmation code, the attorney's profile (with new email address) is sent to the admin user for confirmation. FIG. 155 shows the Awaiting Approval Tab for an admin user. Under the “Switching Law Firm” menu in the admin account, the attorney's profile will be presented for the admin to approve. Once the admin approves, the attorney's activity on the stepper (associated with the old email address and old firm) will disappear. If the attorney wants to request those same cases, the attorney will have to start afresh. However, the attorney's statistics on the website (number of requests, number of cases closed, etc.) will be preserved in the account that is now associated with a new email address.

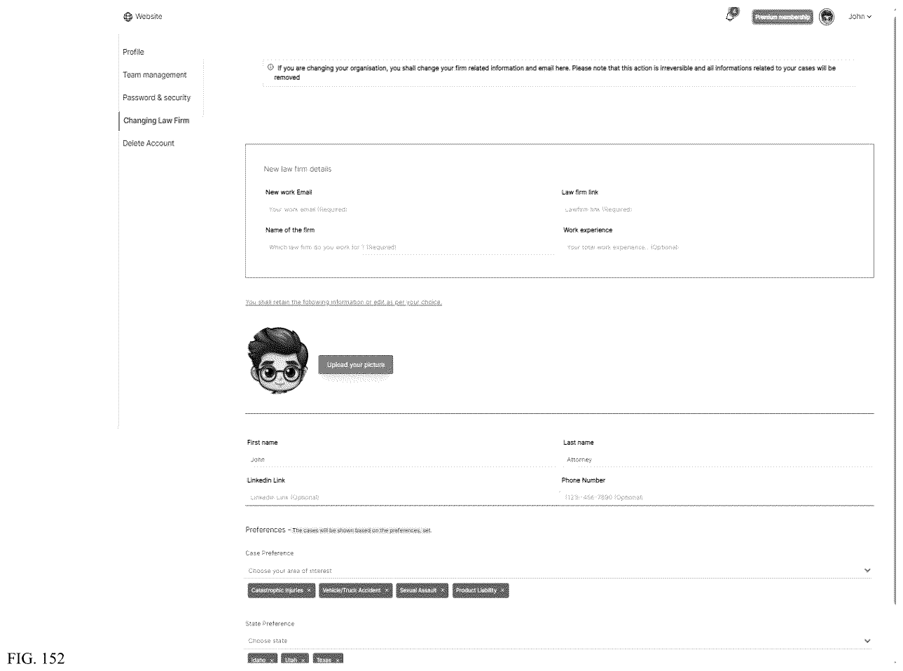

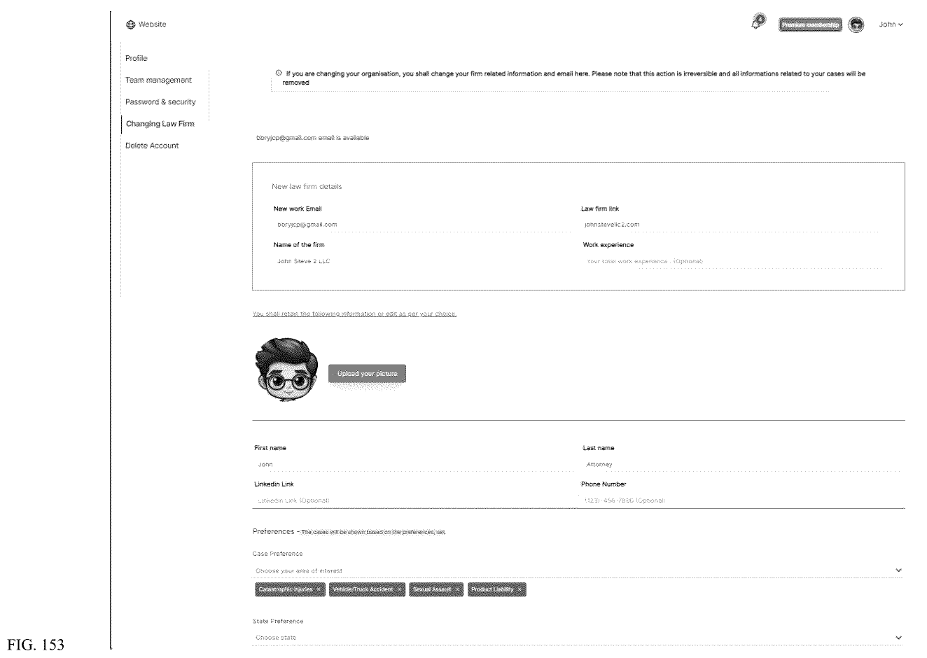

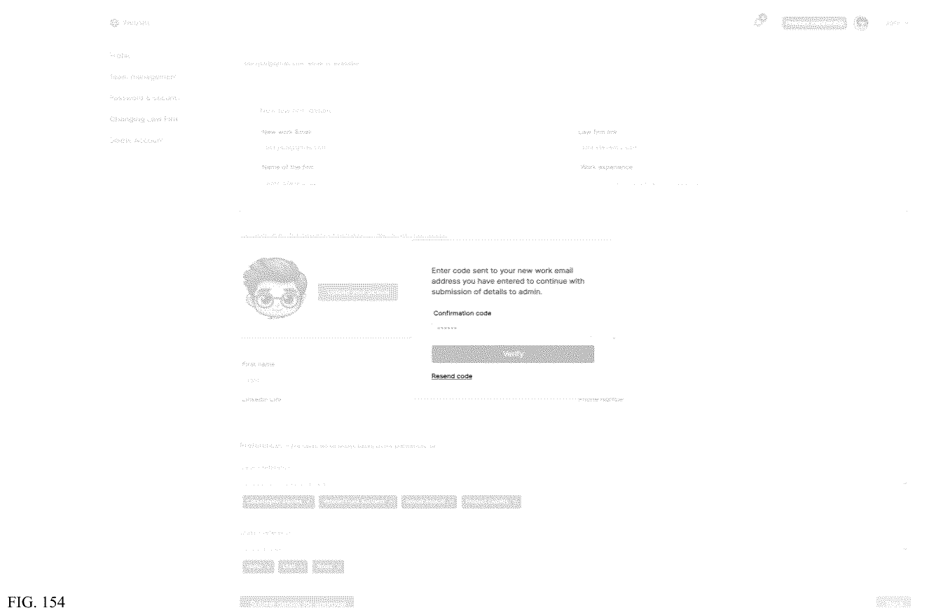

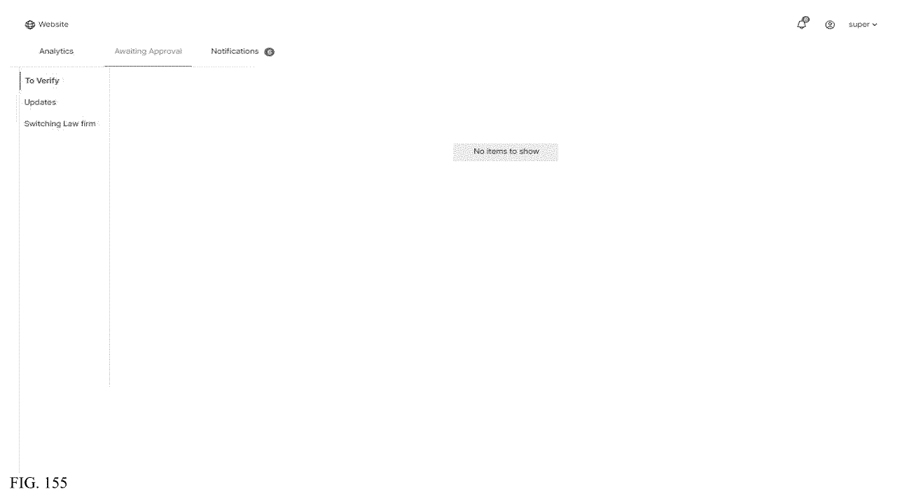

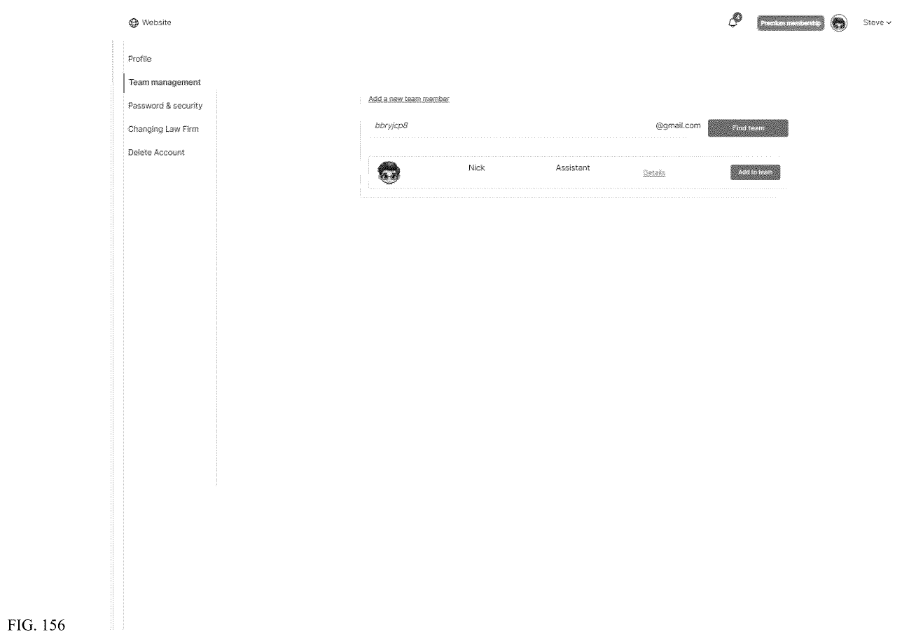

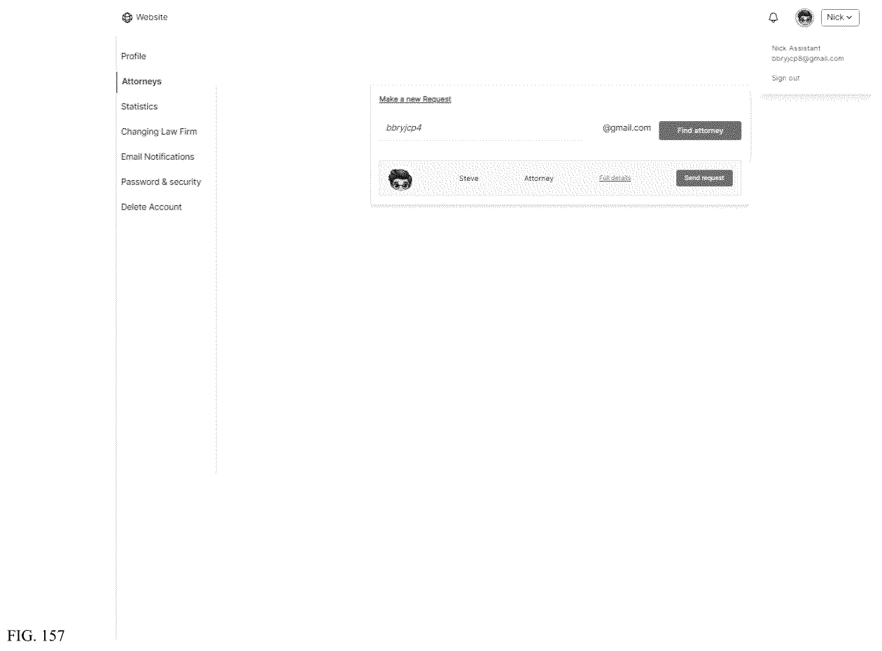

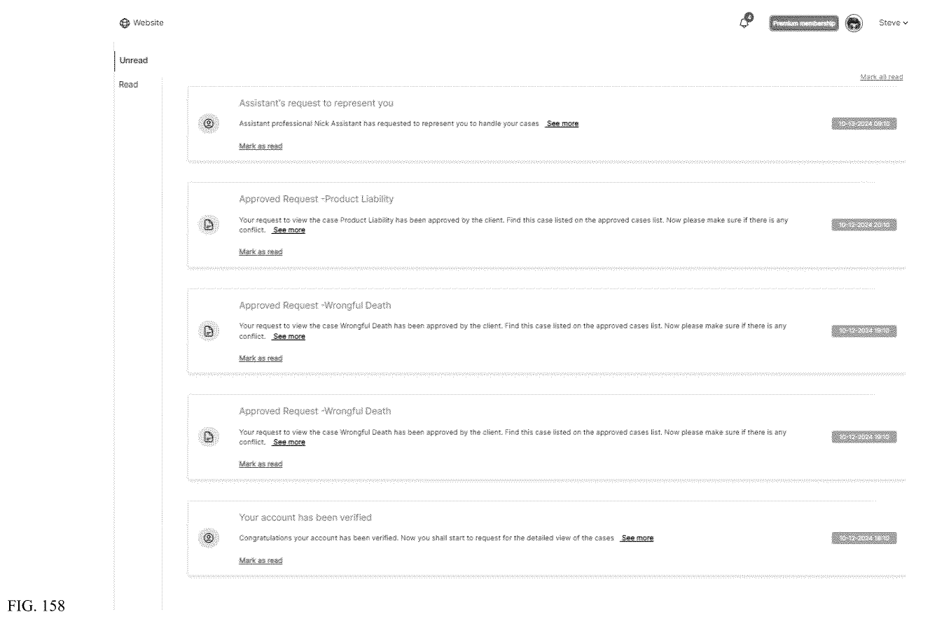

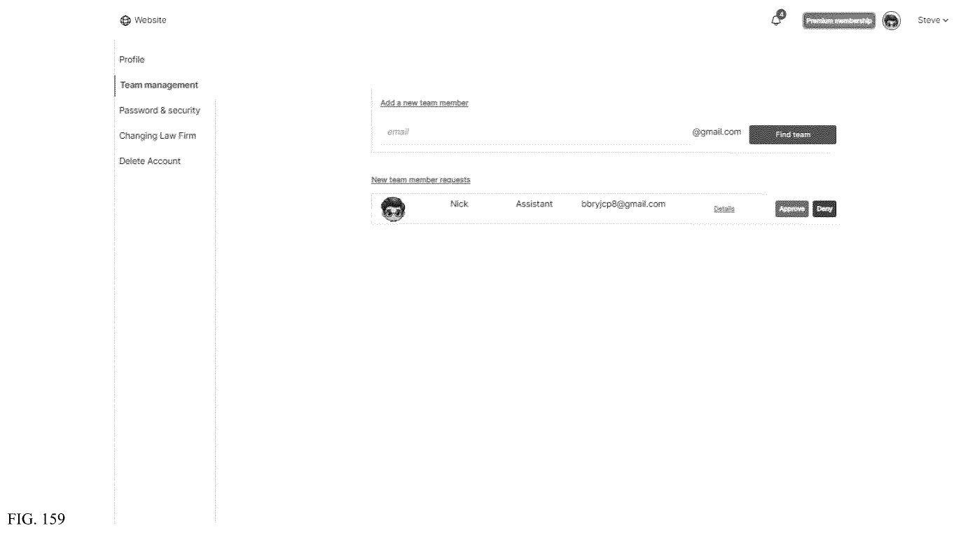

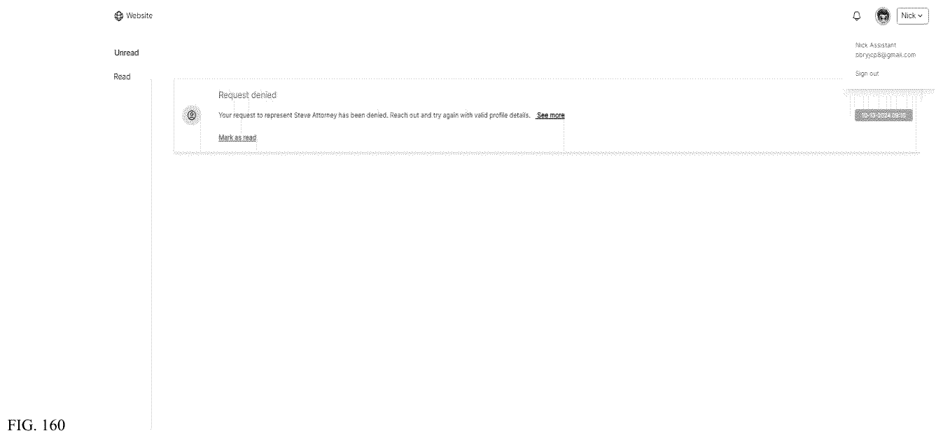

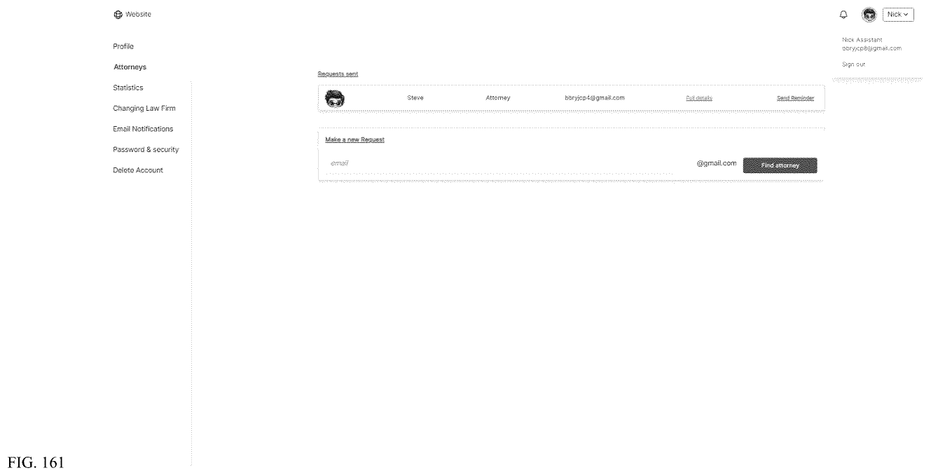

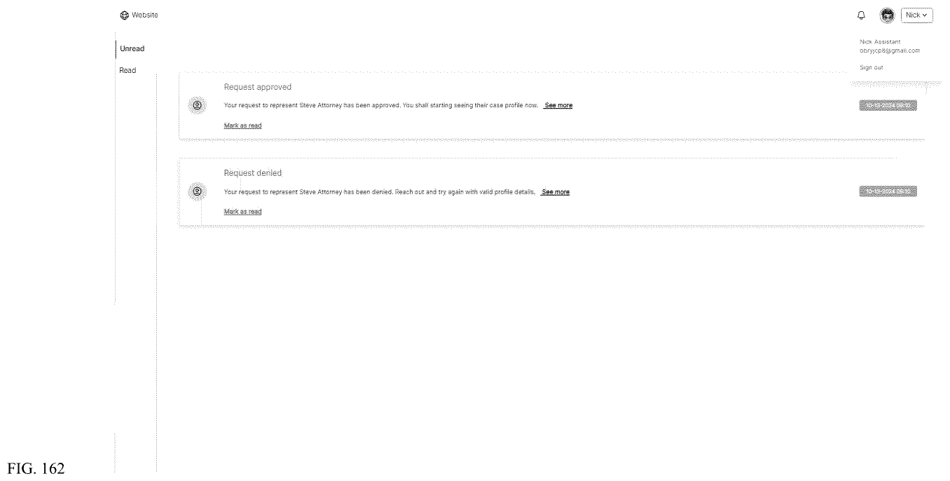

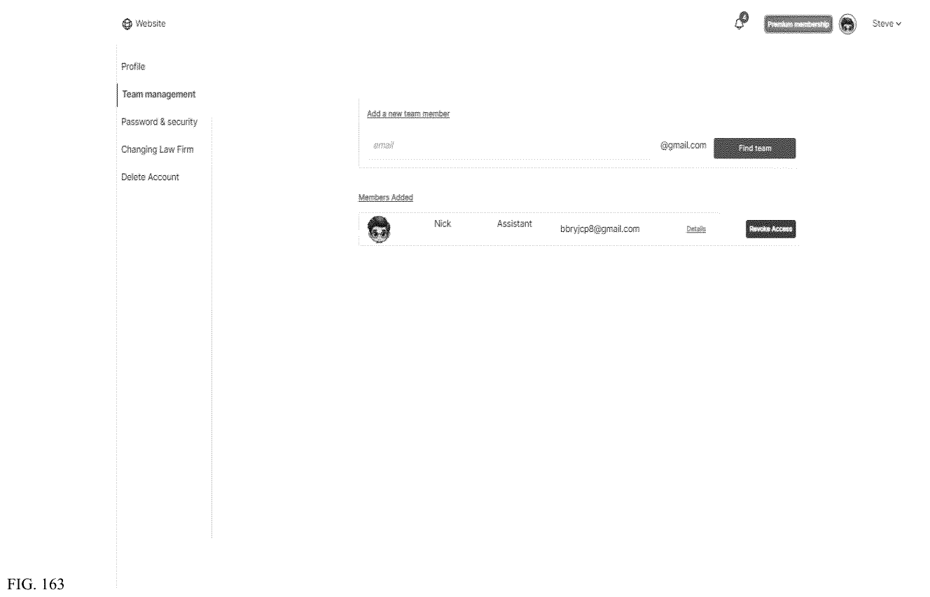

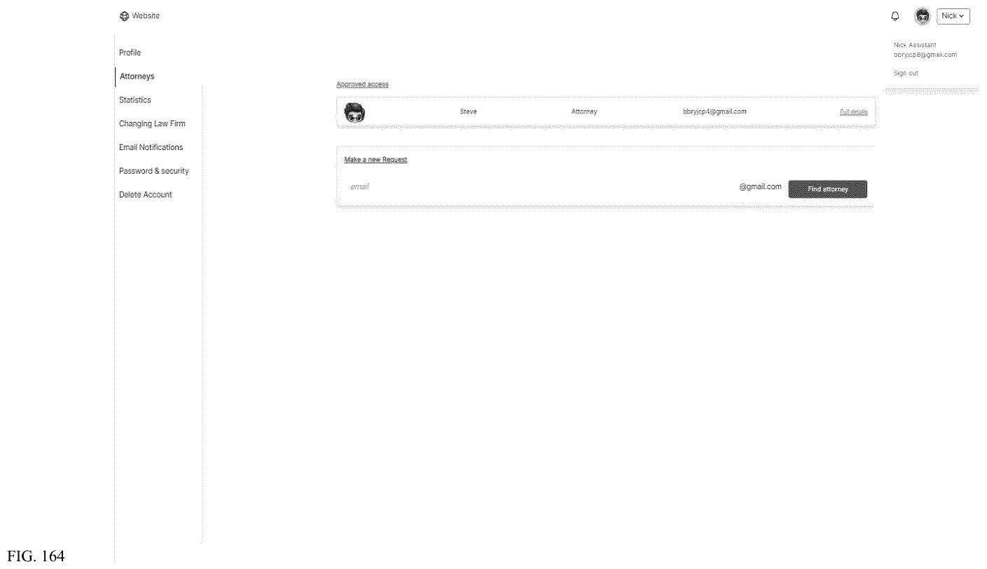

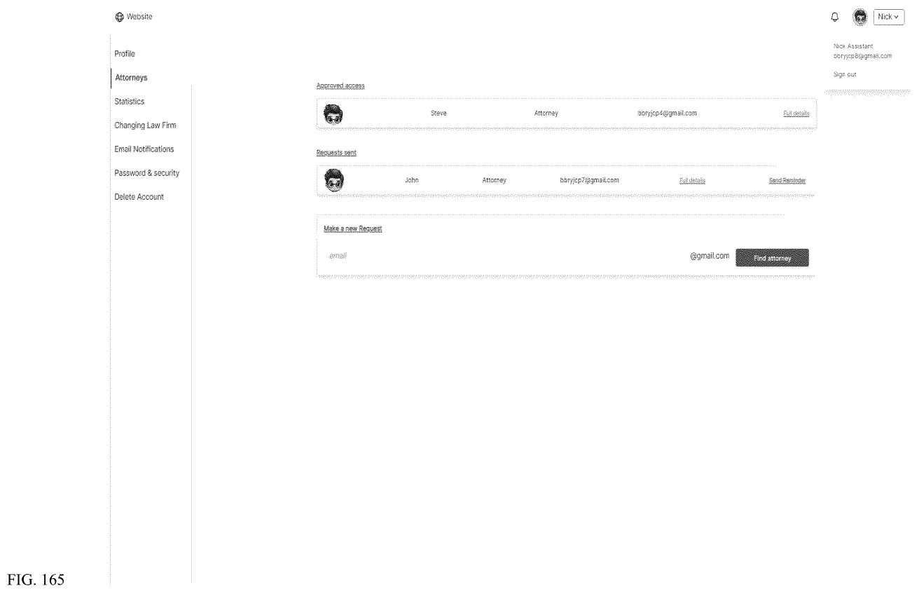

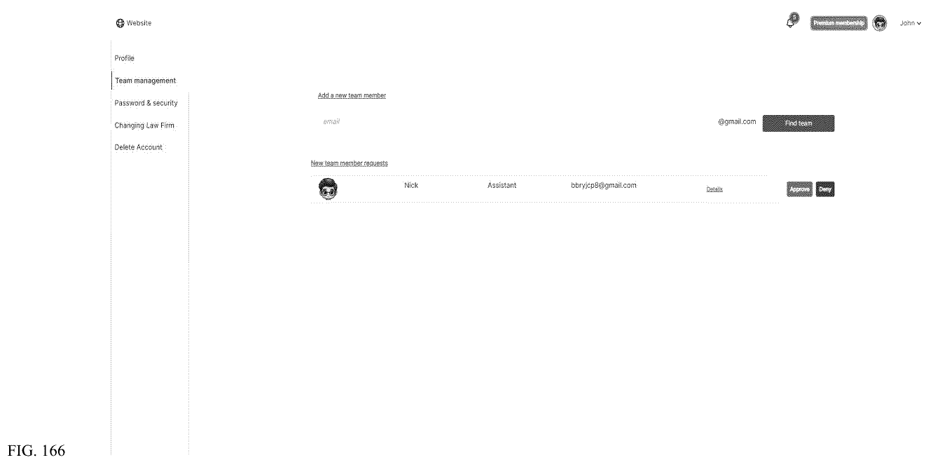

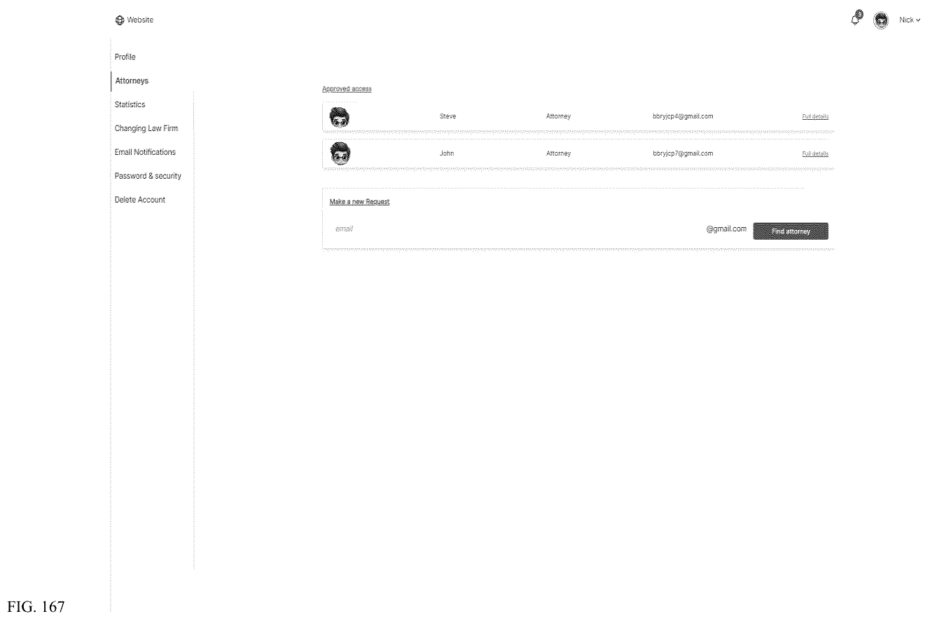

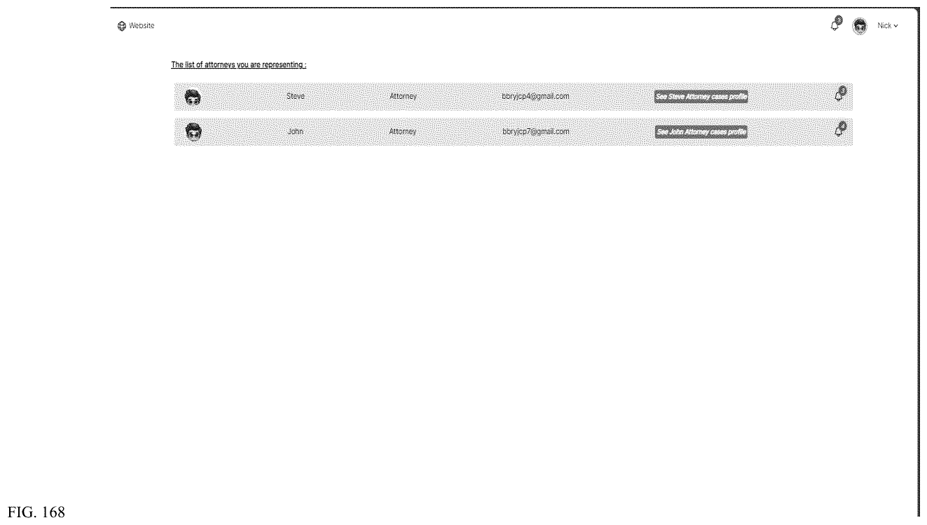

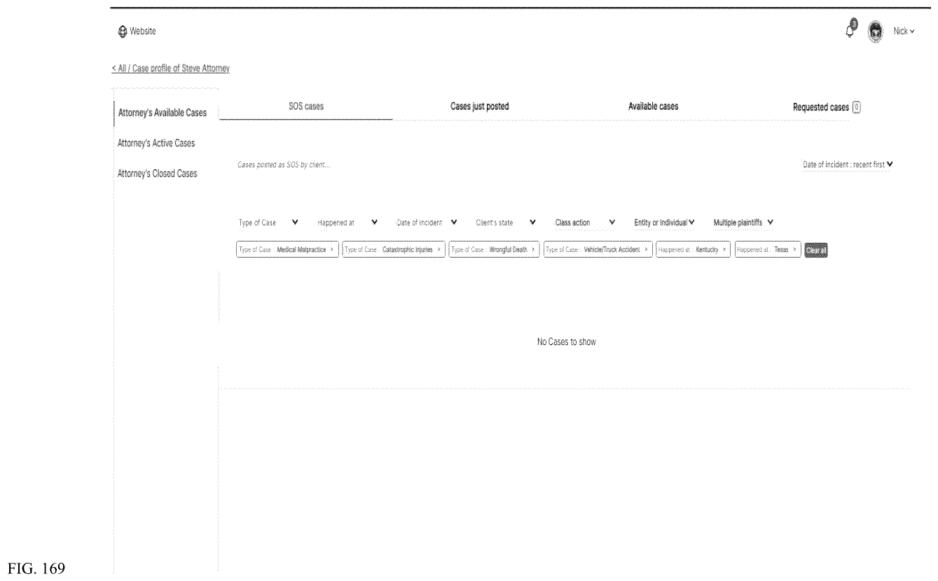

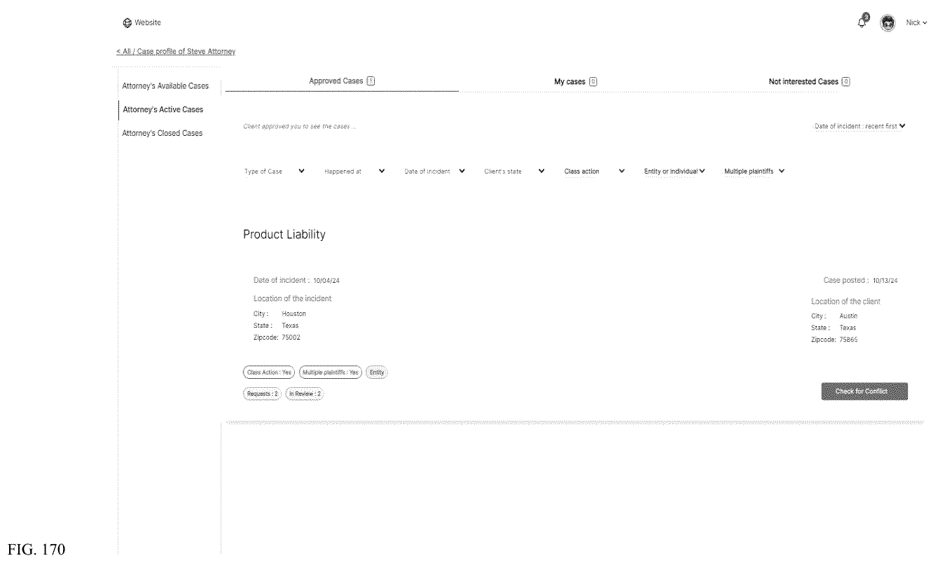

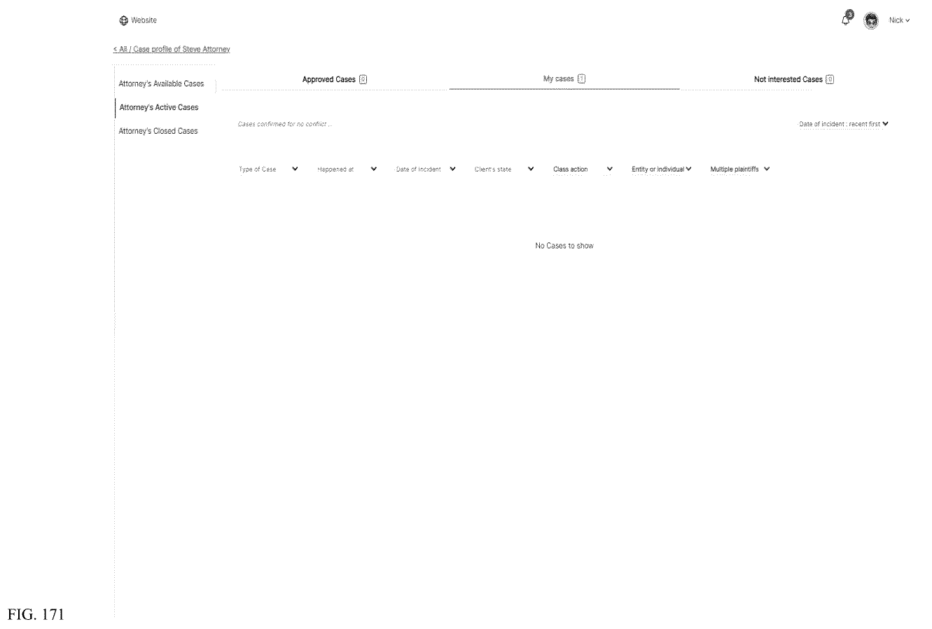

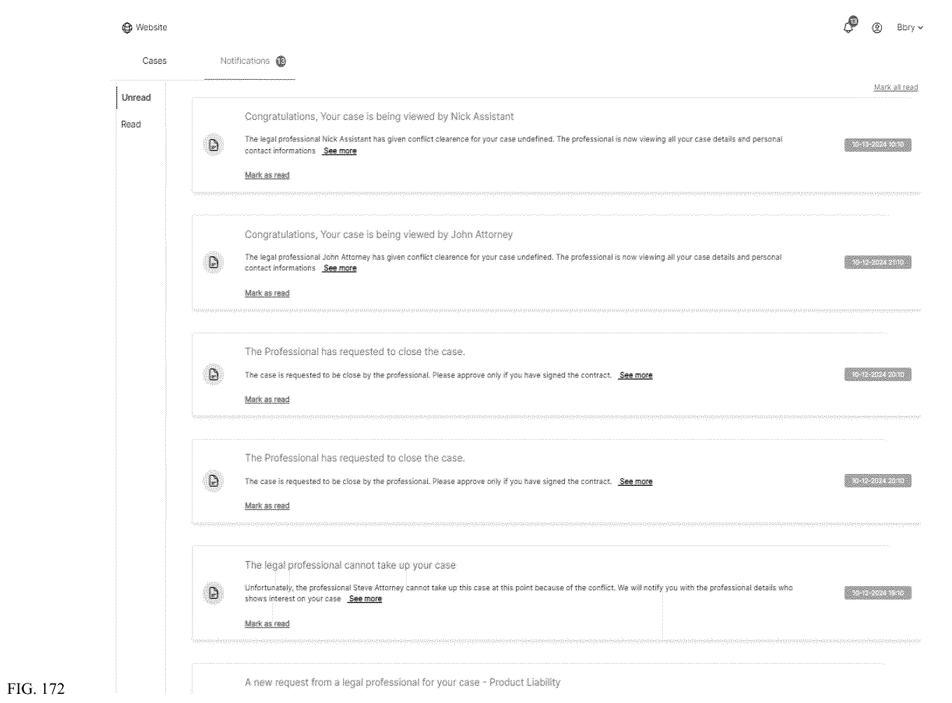

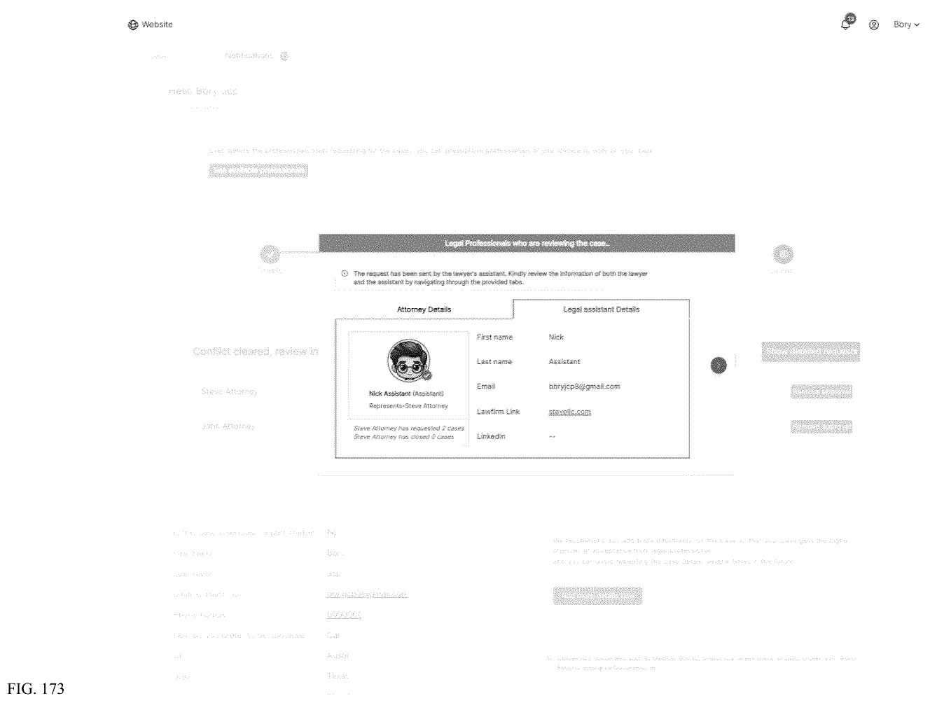

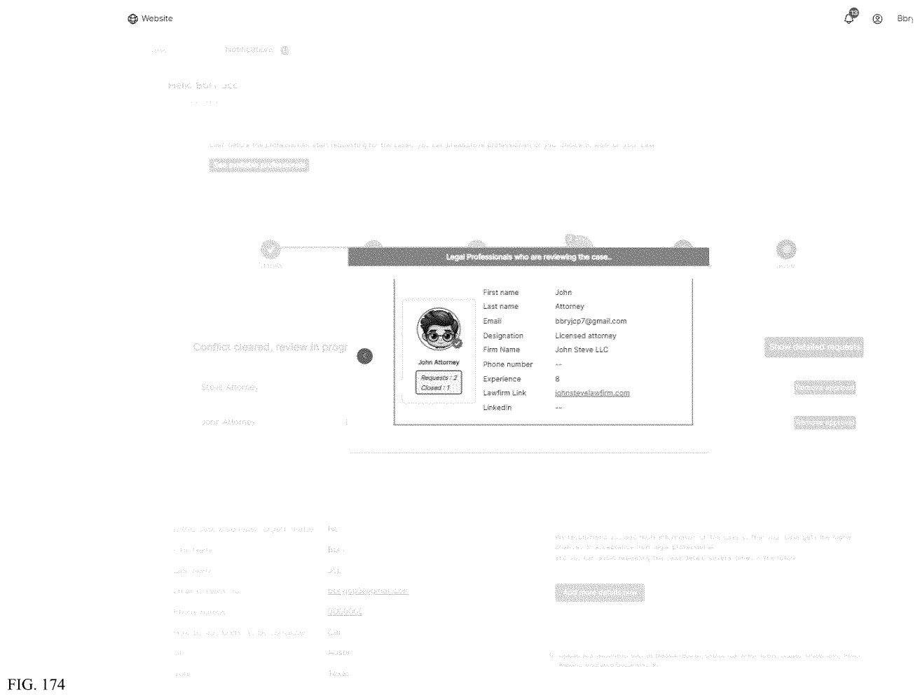

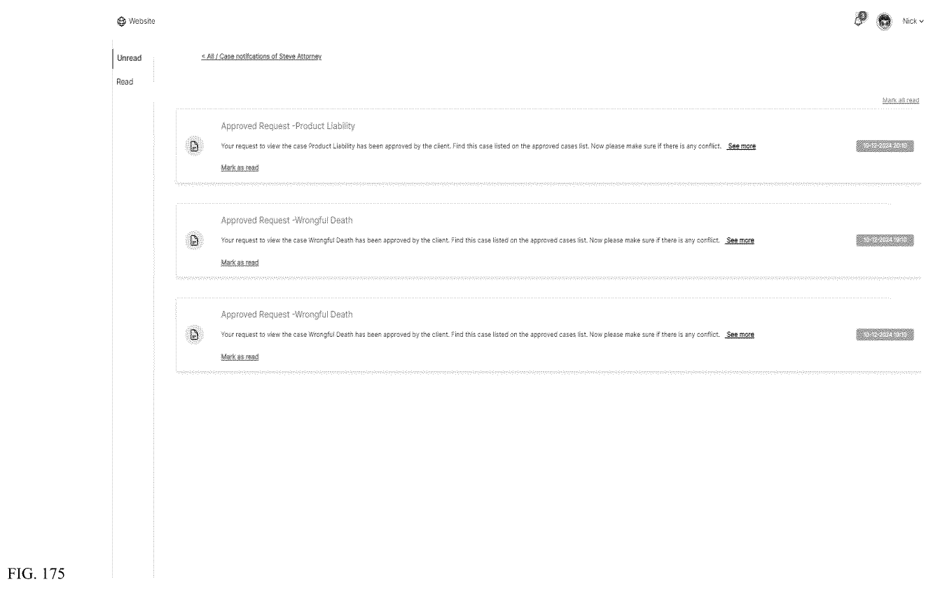

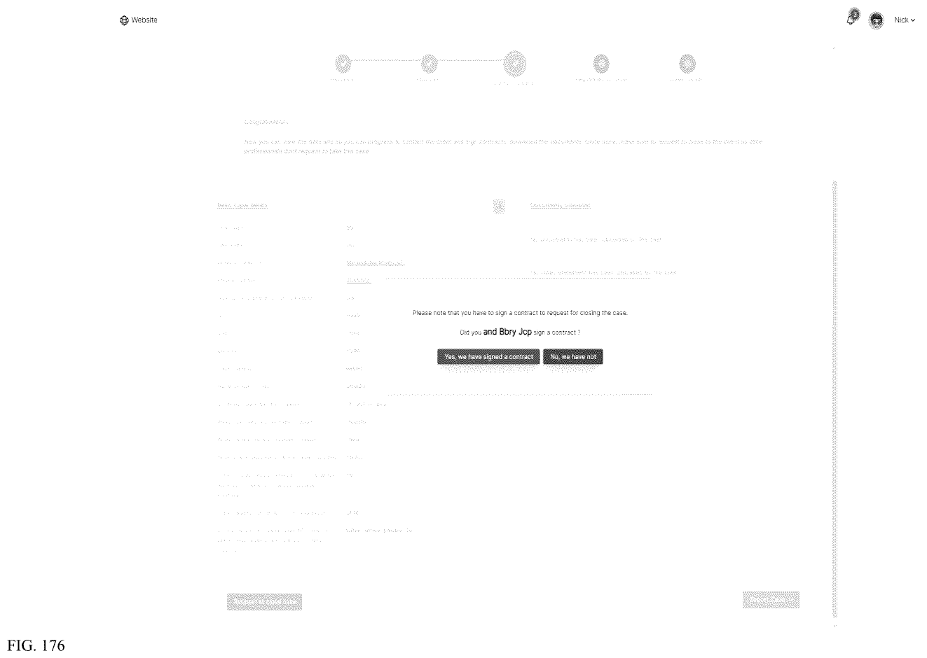

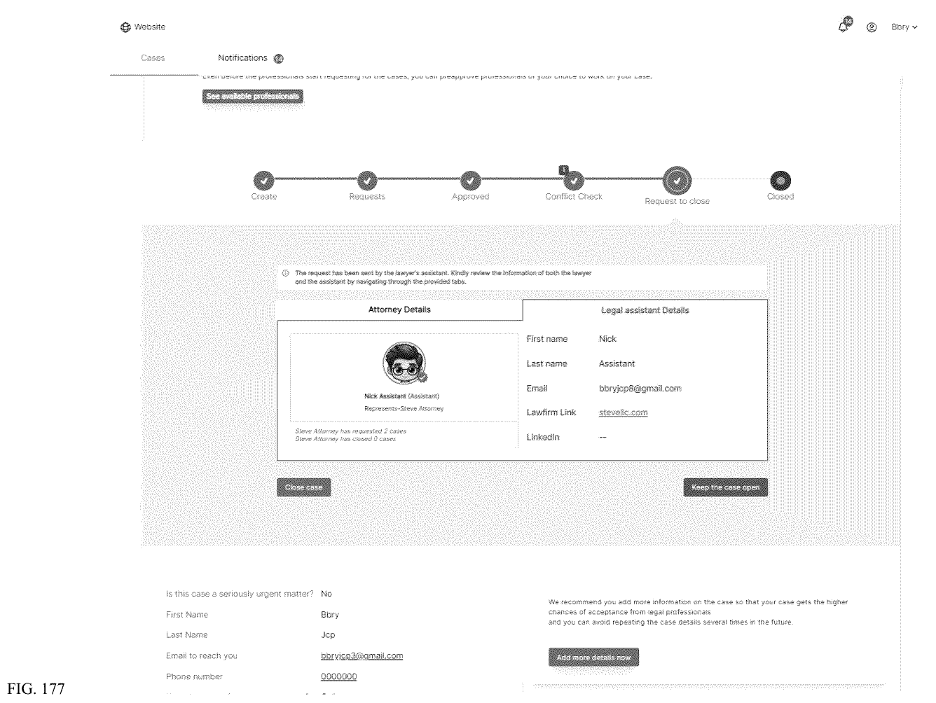

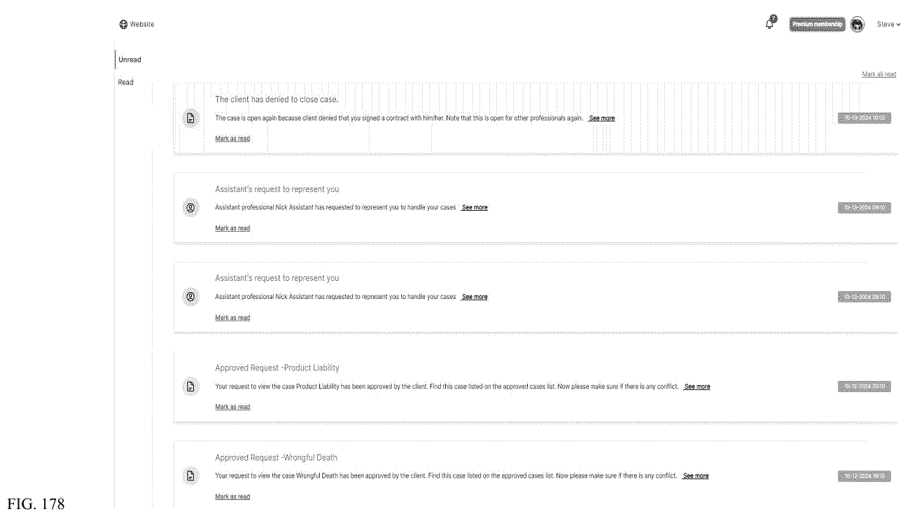

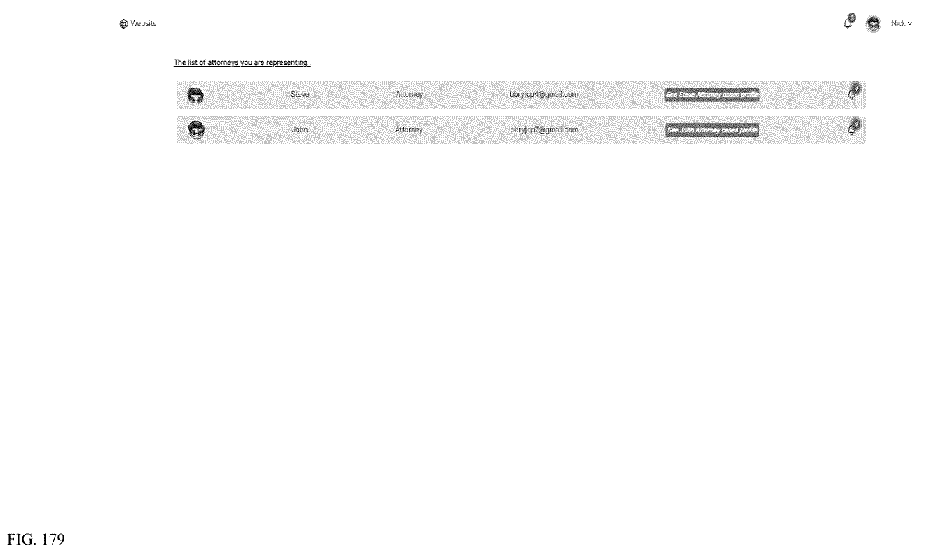

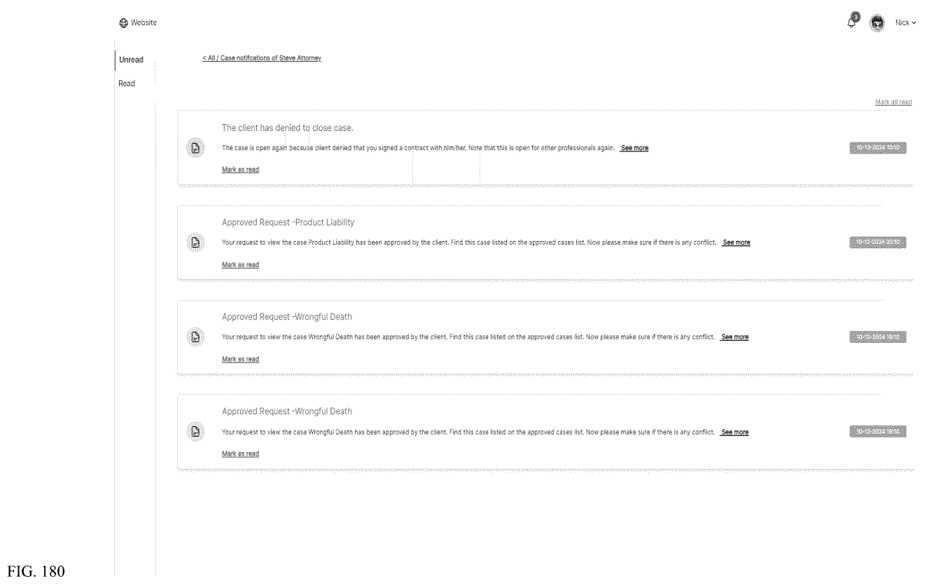

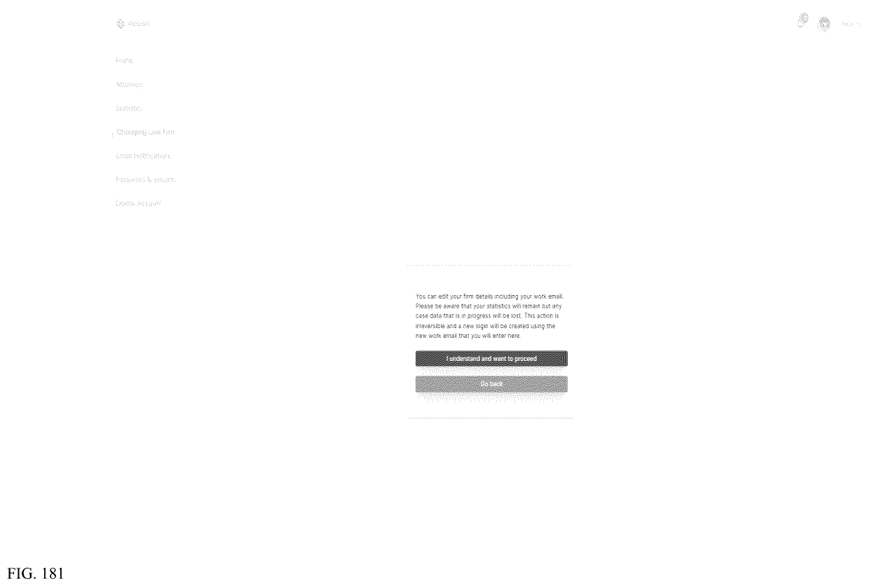

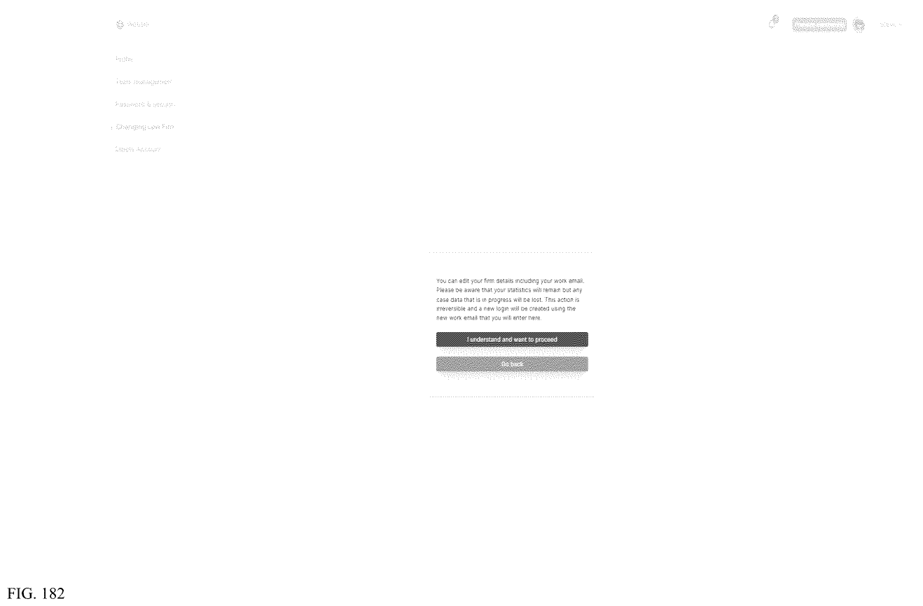

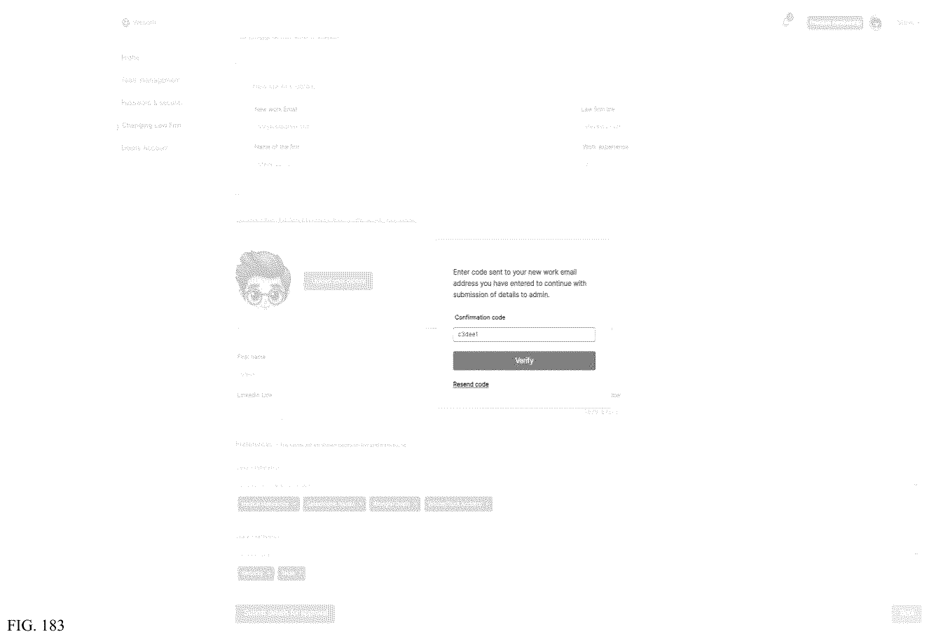

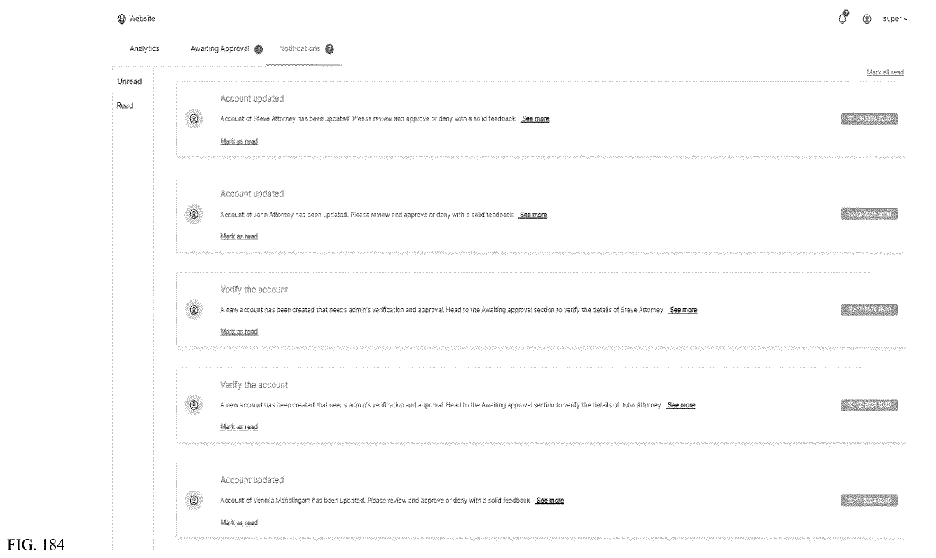

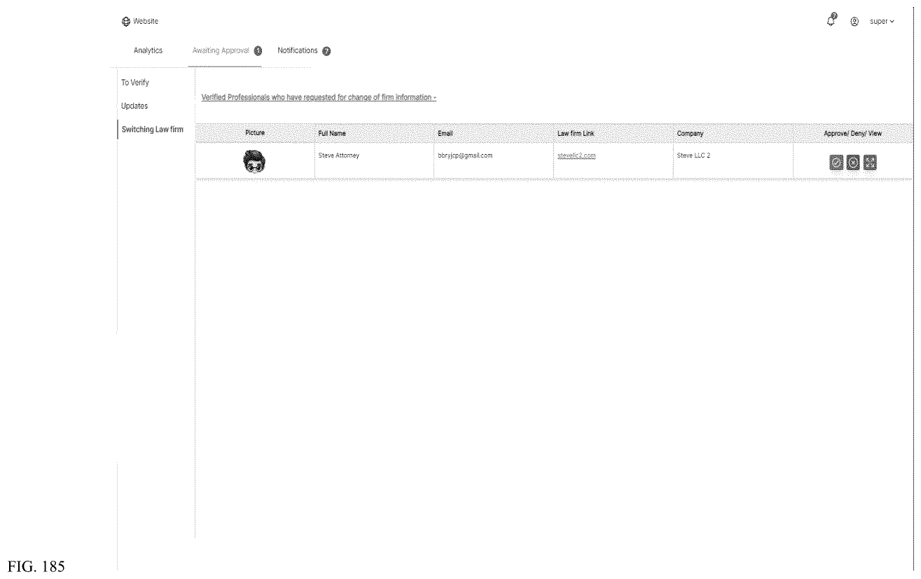

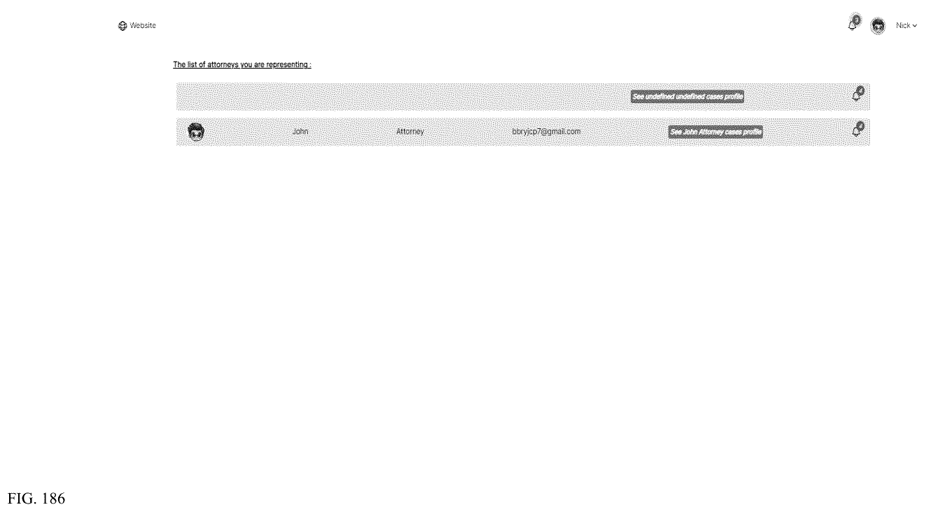

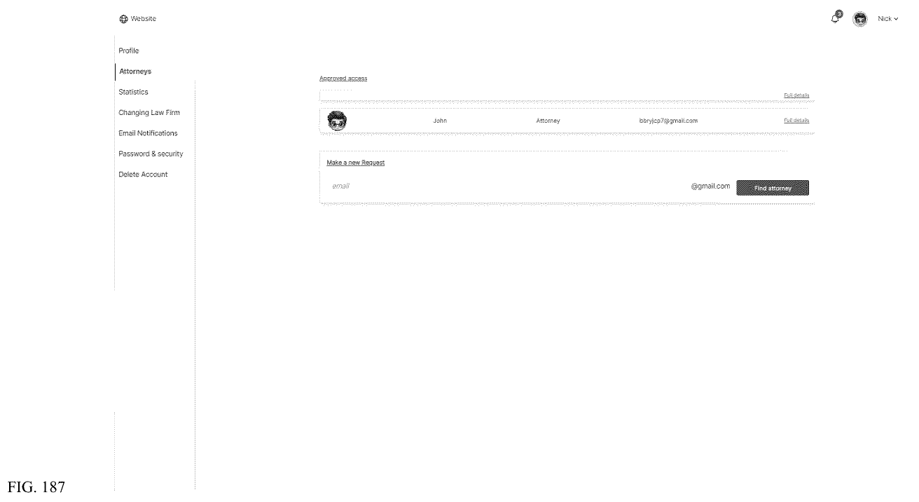

FIG. 156 shows a “Team Management” page in the attorney's profile. The attorney searches for his assistant using the assistant's email address (Find team). The system conducts a search for the email address and shows the results. In this instance, a team member is found. It is important to know that the attorney can only search for team members with the attorney's base email address (“@AAAlawfirm.com”). FIG. 157 shows the “Attorneys” page on an assistant's account. The assistant may send a request to attorneys in their law firm to interact with cases on the attorney's behalf. Here too, the assistant can only find and send requests to attorney that have the same base email address as the assistant (e.g., “@AAAlawfirm.com”). Here, the assistant sends a request to the attorney. In FIG. 158, the attorney receives a notification with this request. FIG. 159 shows the Team Management page on the attorney's account. The attorney can either approve or deny the request. In FIG. 160, the assistant receives a notification that the attorney has denied the assistant's request. In FIG. 161, the assistant sends another request to the attorney. In FIG. 162, the assistant receives a notification that the attorney has approved the request. FIG. 163 shows the Team Management page of the attorney's account profile indicating that he assistant has been added as a team member and the assistant can now act on behalf of the attorney on the platform. FIG. 164 shows the “Attorneys” page on the assistant's account indicating that the Assistant has approved access to act on behalf of the listed attorney from the same law firm as that of the assistant. FIG. 165 shows that the assistant sent another request to another attorney in the same law firm as that of the assistant. FIG. 166 shows the other attorney receiving the request from the assistant. Upon the other attorney approving the request, FIG. 167 shows that that the assistant now represents two different attorneys in the same law firm. When the assistant selects the top left indicator the assistant's account, the assistant is able to see the list of attorneys that the assistant is representing along indicator links to their own individual notifications, as shown in FIG. 168. The assistant's own notifications (not related to any attorney) are accessible via the bell icon in the top right. When the assistant selects “See Steve Attorney cases profile,” the assistant is taken to a page showing Steve Attorney's cases, as shown in FIG. 169 and FIG. 170. The assistant can then interact with these cases just as Steve Attorney would interact with them. In FIG. 170, the assistant selects “Check for Conflict” and selects “No conflicts” such that the case moves from the Approved Cases to My Cases. In some embodiments, a case is “in review” only if it moves to the “My Cases” tab of an attorney's profile. In some embodiments, the attorney's notifications link is also present below the “Attorney's Closed Cases” menu in FIG. 170. FIG. 171 is another view of the attorney's cases being accessed through the assistant's account. It is important to note that the assistant cannot access the attorney's account/profile editing area; he or she can only access the attorney's cases. FIG. 172 shows the client's notifications where the assistant's name shows up as interacting with the client's case. In another embodiments, the indicated message in the notification indicates that the assistant is acting on behalf of the attorney. In FIG. 172, when the client selects “See More,” the client is taken to the stepper. On the stepper when the client views “Steve Attorney,” the client will see both the attorney's information and the assistant's information, as shown in FIG. 173. When an attorney interacts with the case by themselves, the client does not see the assistant's profile (see, e.g., FIG. 174). FIG. 175 shows case notifications for a particular attorney accessed through the assistant's account. FIG. 176 shows an assistant selecting an option to close a case. A popup is presented to the assistant asking whether the attorney (associated with the assistant) and the client signed a contract. FIG. 177 shows a client's stepper indicating that the assistant (acting on behalf of the attorney) requested to close the case. FIG. 178 indicates a notification on an attorney's notifications indicating that a client has denied to close a case. FIG. 179 indicates on an assistant's homepage the list of attorneys that the assistant is acting on behalf of on the platform. FIG. 180 indicates a notification on the assistant's notifications page when the client denies closing of a case. FIG. 181 shows an assistant selecting “Changing Law Firm” on their profile. FIG. 182 shows the warning message presented to the assistant. FIG. 183 shows the confirmation code required for the email address and work details to be changed, for an assistant. The confirmation code is sent to the new email address. FIG. 184 shows notifications of an admin's account showing attorneys and/or assistant who have made major changes to their account and require approval (e.g., email address change). FIG. 185 shows an attorney who is switching law firms (switching email addresses) and requires admin approval. Upon the admin approving this change, the assistant associated with that attorney is no longer able to access that attorney's cases or notifications as shown in FIG. 186. In the “Attorneys” menu in the assistant's account, the attorney who moved law firms no longer appears in the “Approved access” list, as shown in FIG. 187.

1. (canceled)

2. A method for controlling a computing operation in a computing network, the method comprising:
providing a computing network usable by computing users registered with the computing network;
adjusting, using a resource allocator, one or more computing operations executable in the computing network, based on at least one of: a computing load associated with the computing network, an available storage or memory associated with the computing network, a number or type of users associated with the computing network or online on the computing network, or a number or type of operations being executed or to be executed by the computing network,
wherein the resource allocator is controlled by a basic input/output system (BIOS) or a resource-controlling system.
